(19) United States
(12) Patent Application Publication
(10) Pub. No.: US 2023/0143022 A1
(43) Pub. Date: May 11, 2023

(54) MAGNETOHYDRODYNAMIC HYDROGEN ELECTRICAL POWER GENERATOR

(71) Applicant: Brilliant Light Power, Inc., Cranbury, NJ (US)

(72) Inventor: Randell L. MILLS, Cranbury, NJ (US)

(73) Assignee: Brilliant Light Power, Inc., Cranbury, NJ (US)

(21) Appl. No.: 17/798,057

(22) PCT Filed: Feb. 8, 2021
(86) PCT No.: PCT/US2021/017148

§ 371 Date: Aug. 5, 2022

Related U.S. Application Data
(60) Provisional application No. 62/971,938, filed on Feb. 8, 2020.
(60) Provisional application No. 62/980,959, filed on Feb. 24, 2020.
(60) Provisional application No. 62/992,783, filed on Mar. 20, 2020.
(60) Provisional application No. 63/001,761, filed on Mar. 30, 2020.
(60) Provisional application No. 63/012,243, filed on Apr. 19, 2020.
(60) Provisional application No. 63/024,487, filed on May 13, 2020.
(60) Provisional application No. 63/031,557, filed on May 28, 2020.
(60) Provisional application No. 63/043,763, filed on Jun. 24, 2020.
(60) Provisional application No. 63/056,270, filed on Jul. 24, 2020.
(60) Provisional application No. 63/072,076, filed on Aug. 28, 2020.
(60) Provisional application No. 63/086,520, filed on Oct. 1, 2020.
(60) Provisional application No. 63/111,556, filed on Nov. 9, 2020.
(60) Provisional application No. 63/127,985, filed on Dec. 18, 2020.
(60) Provisional application No. 63/134,537, filed on Jan. 6, 2021.

(51) Int. Cl. B01J 23/08

(52) U.S. Cl. CPC B01J 23/08; B01J 2208/00053; B01J 2208/0007; B01J 2208/00088

(57) ABSTRACT

A power generator is described that provides at least one of electrical and thermal power comprising (i) at least one reaction cell for reactions involving atomic hydrogen hydrogen products identifiable by unique analytical and spectroscopic signatures, (ii) a molten metal injection system comprising at least one pump such as an electromagnetic pump that provides a molten metal stream to the reaction cell and at least one reservoir that receives the molten metal stream, and (iii) an ignition system comprising an electrical power source that provides low-voltage, high-current electrical energy to the at least one steam of molten metal to ignite a plasma to initiate rapid kinetics of the reaction and an energy gain. In some embodiments, the power generator may comprise: (v) a source of H₂ and O₂ supplied to the plasma, (vi) a molten metal recovery system, and (vii) a power converter capable of (a) converting the high-power light output from a blackbody radiator of the cell into electricity using concentrator thermophotovoltaic cells or (b) converting the energetic plasma into electricity using a magnetohydrodynamic converter.

### CROSS REFERENCE TO RELATED APPLICATIONS

This application claims priority to U.S. App. No. 62/971,938, filed 2020 Feb. 8, U.S. App. No. 62/980,959, filed 2020 Feb. 24, U.S. App. No. 62/992,783, filed 2020 Mar. 20, U.S. App. No. 63/001,761, filed 2020 Mar. 30, U.S. App. No. 63/012,243, filed 2020 Apr. 19, U.S. App. No. 63/024,487, filed 2020 May 13, U.S. App. No. 63/031,557, filed 2020 May 28, U.S. App. No. 63/043,763, filed 2020 Jun. 24, U.S. App. No. 63/056,270, filed 2020 Jul. 24, U.S. App. No. 63/072,076, filed 2020 Aug. 28, U.S. App. No. 63/086,520, filed 2020 Oct. 1, U.S. App. No. 63/111,556, filed 2020 Nov. 9, U.S. App. No. 63/127,985, filed 2020 Dec. 18, and U.S. App. No. 63/134,537, filed 2021 Jan. 6, each of which are hereby incorporated by reference in their entirety.

### FIELD OF DISCLOSURE

The present disclosure relates to the field of power generation and, in particular, to systems, devices, and methods for the generation of power. More specifically, embodiments of the present disclosure are directed to power generation devices and systems, as well as related methods, which produce optical power, plasma, and thermal power and produces electrical power via a magnetohydrodynamic power converter, an optical to electric power converter, plasma to electric power converter, photon to electric power converter, or a thermal to electric power converter. In addition, embodiments of the present disclosure describe systems, devices, and methods that use the ignition of a water or water-based fuel source to generate optical power, mechanical power, electrical power, and/or thermal power using photovoltaic power converters. These and other related embodiments are described in detail in the present disclosure.

### BACKGROUND

Power generation can take many forms, harnessing the power from plasma. Successful commercialization of plasma may depend on power generation systems capable of efficiently forming plasma and then capturing the power of the plasma produced.

Plasma may be formed during ignition of certain fuels. These fuels can include water or water-based fuel source. During ignition, a plasma cloud of electron-stripped atoms is formed, and high optical power may be released. The high optical power of the plasma can be harnessed by an electric converter of the present disclosure. The ions and excited state atoms can recombine and undergo electronic relaxation to emit optical power. The optical power can be converted to electricity with photovoltaics.

### SUMMARY

The present disclosure is directed to power systems that generates at least one of electrical energy and thermal energy comprising:
at least one vessel capable of a maintaining a pressure below atmospheric;
reactants capable of undergoing a reaction that produces enough energy to form a plasma in the vessel comprising:
   a) a mixture of hydrogen gas and oxygen gas, and/or
      water vapor, and/or
      a mixture of hydrogen gas and water vapor;
   b) a molten metal;
a mass flow controller to control the flow rate of at least one reactant into the vessel;
a vacuum pump to maintain the pressure in the vessel below atmospheric pressure when one or more reactants are flowing into the vessel;
a molten metal injector system comprising at least one reservoir that contains some of the molten metal, a molten metal pump system (e.g., one or more electromagnetic pumps) configured to deliver the molten metal in the reservoir and through an injector tube to provide a molten metal stream, and at least one non-injector molten metal reservoir for receiving the molten metal stream;
at least one ignition system comprising a source of electrical power or ignition current to supply electrical power to the at least one stream of molten metal to ignite the reaction when the hydrogen gas and/or oxygen gas and/or water vapor are flowing into the vessel;
a reactant supply system to replenish reactants that are consumed in the reaction;
   a power converter or output system to convert a portion of the energy produced from the reaction (e.g., light and/or thermal output from the plasma) to electrical power and/or thermal power.

Power systems (herein also referred to as “SunCells”) of the present disclosure may comprise:

a.) at least one vessel capable of a maintaining a pressure below atmospheric comprising a reaction chamber;

b) two electrodes configured to allow a molten metal flow therebetween to complete a circuit;

c) a power source connected to said two electrodes to apply a current therebetween when said circuit is closed;

d) a plasma generation cell (e.g., glow discharge cell) to induce the formation of a first plasma from a gas; wherein effluence of the plasma generation cell is directed towards the circuit (e.g., the molten metal, the anode, the cathode, an electrode submerged in a molten metal reservoir);

wherein when current is applied across the circuit, the effluence of the plasma generation cell undergoes a reaction to producing a second plasma and reaction products; and

e) a power adapter configured to convert and/or transfer energy from the second plasma into mechanical, thermal, and/or electrical energy. In some embodiments, the gas in the plasma generation cell is a mixture of hydrogen (H₂) and oxygen (O₂). For example, the relative molar ratio of oxygen to hydrogen is from 0.01%-50% (e.g. from 0.1%-20%, from 0.1-15%, etc.). In certain implementations, the molten metal is Gallium. In some embodiments, the reaction products have at least one spectroscopic signature as described herein (e.g., those described in Example 10). In various aspects, the second plasma is formed in a reaction cell, and the walls of said reaction cell comprise a liner having increased resistance to alloy formation (e.g., alloy formation with the molten metal such as Gallium) with the molten metal and the liner and the walls of the reaction cell have a high permability to the reaction products (e.g. stainless steel such as 347 SS such as 4130 alloy SS or Cr—Mo SS, nickel, Ti, niobium, vanadium, iron, W, Re, Ta, Mo, niobium, and Nb(94.33 wt %)-Mo(4.86 wt %)-Zr(0.81 wt %)). The liner may be made of a crystalline material (e.g., SiC, BN, quartz) and/or a refractory metal such as at least one of Nb, Ta, Mo, or W. In certain embodiments, the second plasma is formed in a reaction cell, wherein the walls reaction cell chamber comprise a first and a second section,

the first section composed of stainless steel such as 347 SS such as 4130 alloy SS or Cr—Mo SS, nickel, Ti, niobium, vanadium, iron, W, Re, Ta, Mo, niobium, and Nb(94.33 wt %)-Mo(4.86 wt %)-Zr(0.81 wt %);
the second section comprising a refractory metal different than the metal in the first section;
wherein the union between the different metals is formed by a lamination material (e.g., a ceramic such as BN).

A power system of the present disclosure may include:

a.) a vessel capable of a maintaining a pressure below atmospheric comprising a reaction chamber;

b) a plurality of electrode pairs, each pair comprising electrodes configured to allow a molten metal flow therebetween to complete a circuit.

c) a power source connected to said two electrodes to apply a current therebetween when said circuit is closed;

d) a plasma generation cell (e.g., glow discharge cell) to induce the formation of a first plasma from a gas; wherein effluence of the plasma generation cell is directed towards the circuit (e.g., the molten metal, the anode, the cathode, an electrode submerged in a molten metal reservoir);

wherein when current is applied across the circuit, the effluence of the plasma generation cell undergoes a reaction to producing a second plasma and reaction products; and

e) a power adapter configured to convert and/or transfer energy from the second plasma into mechanical, thermal, and/or electrical energy;

wherein at least one of the reaction products (e.g., intermediates, final products) has at least one spectroscopic signature as described herein (e.g., as shown in Example 10).

The power system may comprise a gas mixer for mixing the hydrogen and oxygen gases and/or water molecules and a hydrogen and oxygen recombiner and/or a hydrogen dissociator. In some embodiments, the hydrogen and oxygen recombiner comprises a plasma cell. The plasma cell may comprise a center positive electrode and a grounded tubular body counter electrode wherein a voltage (e.g., a voltage in the range of 50 V to 1000 V) is applied across the electrodes to induce the formation of a plasma from a hydrogen (H₂) and oxygen (O₂) gas mixture. In some embodiments, the hydrogen and oxygen recombiner comprises a recombiner catalytic metal supported by an inert support material. In certain implementations, the gas mixture supplied to the plasma generation cell to produce the first plasma comprises a non-stoichiometric H₂/O₂ mixture (e.g., an H₂/O₂ mixture having less than ⅓ mole % O₂ or from 0.01% to 30%, or from 0.1% to 20%, or less than 10%, or less than 5%, or less than 3% O₂ by mole percentage of the mixture) that is flowed through the plasma cell (e.g., a glow discharge cell) to create a reaction mixture capable of undergoing the reaction with sufficient exothermicity to produce the second plasma. A non-stoichiometric H₂/O₂ mixture may pass through the glow discharge to produce an effluence of atomic hydrogen and nascent H₂O (e.g., a mixture having water at a concentration and with an internal energy sufficient to prevent formation of hydrogen bonds);

the glow discharge effluence is directed into a reaction chamber where the ignition current is supplied between two electrodes (e.g., with a molten metal passed therebetween), and upon interaction of the effluence with the biased molten metal (e.g., gallium), the reaction between the nascent water and the atomic hydrogen is induced, for example, upon the formation of arc current.

The power system may comprise at least one of the reaction chamber (e.g. where the nascent water and atomic hydrogen undergo the plasma forming reaction) and/or reservoir comprising at least one refractory material liner that is resistant to forming an alloy with the molten metal. The inner wall of the reaction chamber may comprise a ceramic coating, a carbon liner lined with a W, Nb, or Mo liner, lined with W plates. In some embodiments, the reservoir comprises a carbon liner and the carbon is covered by the molten metal contained therein. In various implementations, the reaction chamber wall comprises a material that is highly permeable to the reaction product gas. In various embodiments, the reaction chamber wall comprises at least one of stainless steel (e.g., Mo—Cr stainless steel), niobium, molybdenum, or tungsten.

The power system may comprise a a condenser to condense molten metal vapor and metal oxide particles and vapor and returns them to the reaction cell chamber. In some embodiments, the power system may further comprise a vacuum line wherein the condenser comprises a section of the vacuum line from the reaction cell chamber to the vacuum pump that is vertical relative to the reaction cell chamber and comprises an inert, high-surface area filler material that condenses the molten metal vapor and metal oxide particles and vapor and returns them to the reaction cell chamber while permitting the vacuum pump to maintain a vacuum pressure in the reaction cell chamber.

The power system may comprise a blackbody radiator and a window to output light from the blackbody radiator. Such embodiments may be used to generate light (e.g., used for lighting).

In some embodiments, the power system may further comprise a gas mixer for mixing the hydrogen and oxygen gases and a hydrogen and oxygen recombiner and/or a hydrogen dissociator. For example, the power system may comprise a hydrogen and oxygen recombiner wherein the hydrogen and oxygen recombiner comprises a recombiner catalytic metal supported by an inert support material.

The power system may be operated with parameters that maximize reactions, and specifically, reactions capable of outputting enough energy to sustain plasma generation and net energy output. For example, in some embodiments, the pressure of the vessel during operation is in the range of 0.1 Torr to 50 Torr. In certain implementations, the hydrogen mass flow rate exceeds that of the oxygen mass flow rate by a factor in the range of 1.5 to 1000. In some embodiments, the pressure may be over 50 Torr and may further comprise a gas recirculation system.

In some embodiments, an inert gas (e.g., argon) is injected into the vessel. The inert gas may be used to prolong the lifetime of certain in situ formed reactants (such as nascent water).

The power system may comprise a water micro-injector configured to inject water into the vessel such that the plasma produced from the energy output from the reaction comprises water vapor. In some embodiments, the micro-injector injects water into the vessel. In some embodiments, the H₂ molar percentage is in the range of 1.5 to 1000 times the molar percent of the water vapor (e.g., the water vapor injected by the micro-injector).

The power system may further comprise a heater to melt a metal (e.g., gallium or silver or copper or combinations thereof) to form the molten metal. The power system may further comprise a molten metal recovery system configured to recover molten metal after the reaction comprising a molten metal overflow channel which collects overflow from the non-injector molten metal reservoir.

The molten metal injection system may further comprise electrodes in the molten metal reservoir and the non-injection molten metal reservoir; and the ignition system comprises a source of electrical power or ignition current to supply opposite voltages to the injector and non-injector reservoir electrodes; wherein the source of electrical power supplies current and power flow through the stream of molten metal to cause the reaction of the reactants to form a plasma inside of the vessel.

The source of electrical power typically delivers a high-current electrical energy sufficient to cause the reactants to react to form plasma. In certain embodiments, the source of electrical power comprises at least one supercapacitor. In various implementations, the current from the molten metal ignition system power is in the range of 10 A to 50,000 A.

Typically, the molten metal pump system is configured to pump molten metal from a molten metal reservoir to a non-injection reservoir, wherein a stream of molten metal is created therebetween. In some embodiments, the molten metal pump system is one or more electromagnetic pumps and each electromagnetic pump comprises one of a
a) DC or AC conduction type comprising a DC or AC current source supplied to the molten metal through electrodes and a source of constant or in-phase alternating vector-crossed magnetic field, or
b) induction type comprising a source of alternating magnetic field through a shorted loop of molten metal that induces an alternating current in the metal and a source of in-phase alternating vector-crossed magnetic field.
   In some embodiments, the circuit of the molten metal ignition system is closed by the molten metal stream to cause ignition to further cause ignition (e.g., with an ignition frequency less than 10,000 Hz). The injector reservoir may comprise an electrode in contact with the molten metal therein, and the non-injector reservoir comprises an electrode that makes contact with the molten metal provided by the injector system.

In various implementations, the non-injector reservoir is aligned above (e.g., vertically with) the injector and the injector is configured to produce the molten stream orientated towards the non-injector reservoir such that molten metal from the molten metal stream may collect in the reservoir and the molten metal stream makes electrical contact with the non-injector reservoir electrode; and wherein the molten metal pools on the non-injector reservoir electrode. In certain embodiments, the ignition current to the non-injector reservoir may comprise:
a) a hermitically sealed, high-temperature capable feed though that penetrates the vessel;
b) an electrode bus bar, and
c) an electrode.

The ignition current density may be related to the vessel geometry for at least the reason that the vessel geometry is related to the ultimate plasma shape. In various implementations, the vessel may comprise an hourglass geometry (e.g., a geometry wherein a middle portion of the internal surface area of the vessel has a smaller cross section than the cross section within 20% or 10% or 5% of each distal end along the major axis) and oriented in a vertical orientation (e.g., the major axis approximately parallel with the force of gravity) in cross section wherein the injector reservoir is below the waist and configured such that the level of molten metal in the reservoir is about proximal to the waist of the hourglass to increase the ignition current density. In some embodiments, the vessel is symmetric about the major longitudinal axis. In some embodiments, the vessel may an hourglass geometry and comprise a refractory metal liner. In some embodiments, the injector reservoir of the vessel having an hourglass geometry may comprise the positive electrode for the ignition current.

The molten metal may comprise at least one of silver, gallium, silver-copper alloy, copper, or combinations thereof. In some embodiments, the molten metal has a melting point below 700° C. For example, the molten metal may comprise at least one of bismuth, lead, tin, indium, cadmium, gallium, antimony, or alloys such as Rose's metal, Cerrosafe, Wood's metal, Field's metal, Cerrolow 136, Cerrolow 117, Bi—Pb—Sn—Cd—In—Tl, and Galinstan. In certain aspects, at least one of component of the power generation system that contacts that molten metal (e.g., reservoirs, electrodes) comprises, is clad with, or is coated with one or more alloy resistant material that resists formation of an alloy with the molten metal. Exemplary alloy resistant materials are W, Ta, Mo, Nb, Nb(94.33 wt %)-Mo(4.86 wt %)-Zr(0.81 wt %), Os, Ru, Hf, Re, 347 SS, Cr—Mo SS, silicide coated, carbon, and a ceramic such as BN, quartz, Si3N4, Shapal, AlN, Sialon, Al₂O₃, ZrO₂, or HfO₂. In some embodiments, at least a portion of the vessel is composed of a ceramic and/or a metal. The ceramic may comprise at least one of a metal oxide, quartz, alumina, zirconia, magnesia, hafnia, silicon carbide, zirconium carbide, zirconium diboride, silicon nitride, and a glass ceramic. In some embodiments, the metal of the vessel comprises at least one of a stainless steel and a refractory metal.

The molten metal may react with water to form atomic hydrogen in situ. In various implementations, the molten metal is gallium and the power system further comprises a gallium regeneration system to regenerate gallium from gallium oxide (e.g., gallium oxide produced in the reaction). The gallium regeneration system may comprise a source of at least one of hydrogen gas and atomic hydrogen to reduce gallium oxide to gallium metal. In some embodiments, hydrogen gas is delivered to the gallium regeneration system from sources external to the power generation system. In some embodiments, hydrogen gas and/or atomic hydrogen are generated in situ. The gallium regeneration system may comprise an ignition system that delivers electrical power to gallium (or gallium/gallium oxide combinations) produced in the reaction. In several implementations, such electrical power may electrolyze gallium oxide on the surface of gallium to gallium metal. In some embodiments, the gallium regeneration system may comprise an electrolyte (e.g., an electrolyte comprising an alkali or alkaline earth halide). In some embodiments, the gallium regeneration system may comprise a basic pH aqueous electrolysis system, a means to transport gallium oxide into the system, and a means to return the gallium to the vessel (e.g., to the molten metal reservoir). In some embodiments, the gallium regeneration system comprises a skimmer and a bucket elevator to remove gallium oxide from the surface of gallium. In various implementations, the power system may comprise an exhaust line to the vacuum pump to maintain an exhaust gas stream and further comprising an electrostatic precipitation system in the exhaust line to collect gallium oxide particles in the exhaust gas stream.

In some embodiments, the power generation system generates a water/hydrogen mixture to be directed towards the molten metal cell through a plasma generation cell. In these embodiments, the plasma generation cell such as a glow discharge cell induce the formation of a first plasma from a gas (e.g., a gas comprising a mixture oxygen and hydrogen); wherein effluence of the plasma generation cell is directed towards the any part of the molten metal circuit (e.g., the molten metal, the anode, the cathode, an electrode submerged in a molten metal reservoir). Upon interaction of the biased molten metal with this effluence, a second plasma (more energetic than that created by the plasma generation cell) may be formed. In these embodiments, the plasma generation cell may be fed hydrogen (H₂) and oxygen mixtures (O₂) having a molar excess of hydrogen such that the effluence comprises atomic hydrogen (H) and water (H₂O). The water in the effluence may be in the form of nascent water, water sufficiently energized and at a concentration such that it is not hydrogen bonded to other components in the effluence. This effluence may proceed in a second more energetic reaction involving the H and HOH that forms a plasma that intensifies upon interaction with the molten metal and a supplied external current through at least one of the molten metal and the plasma that may produce additional atomic hydrogen (from the H₂ in the effluence) to further propagate the second energetic reaction.

In some embodiments, the power system may further comprise at least one heat exchanger (e.g., a heat exchanger coupled to a wall of the vessel wall, a heat exchanger which may transfer heat to or from the molten metal or to or from the molten metal reservoir). In some embodiments, the heat exchanger comprises one of a (i) plate, (ii) block in shell, (iii) SiC annular groove, (iv) SiC polyblock, and (v) shell and tube heat exchanger. In certain implementations, the shell and tube heat exchanger comprises conduits, manifolds, distributors, a heat exchanger inlet line, a heat exchanger outlet line, a shell, an external coolant inlet, an external coolant outlet, baffles, at least one pump to recirculate the hot molten metal from the reservoir through the heat exchanger and return the cool molten metal to the reservoir, and one or more a water pumps and water coolant or one or more air blowers and air coolant to flow cold coolant through the external coolant inlet and shell wherein the coolant is heated by heat transfer from the conduits and exists the external coolant outlet. In some embodiments, the shell and tube heat exchanger comprise conduits, manifolds, distributors, a heat exchanger inlet line, and a heat exchanger outlet line comprising carbon that line and expand independently of conduits, manifolds, distributors, a heat exchanger inlet line, a heat exchanger outlet line, a shell, an external coolant inlet, an external coolant outlet, and baffles comprising stainless steel. The external coolant of the heat exchanger comprises air, and air from a microturbine compressor or a microturbine recuperator forces cool air through the external coolant inlet and shell wherein the coolant is heated by heat transfer from the conduits and exists the external coolant outlet, and the hot coolant output from the external coolant outlet flows into a microturbine to convert thermal power to electricity.

In some embodiments, the power system comprises at least one power converter or output system of the reaction power output comprises at least one of the group of a thermophotovoltaic converter, a photovoltaic converter, a photoelectronic converter, a magnetohydrodynamic converter, a plasmadynamic converter, a thermionic converter, a thermoelectric converter, a Sterling engine, a supercritical CO₂ cycle converter, a Brayton cycle converter, an external-combustor type Brayton cycle engine or converter, a Rankine cycle engine or converter, an organic Rankine cycle converter, an internal-combustion type engine, and a heat engine, a heater, and a boiler. The vessel may comprise a light transparent photovoltaic (PV) window to transmit light from the inside of the vessel to a photovoltaic converter and at least one of a vessel geometry and at least one baffle comprising a spinning window. The spinning window comprises a system to reduce gallium oxide comprising at least one of a hydrogen reduction system and an electrolysis system. In some embodiments the spinning window comprises or is composed of quartz, sapphire, magnesium fluoride, or combinations thereof. In several implementations, the spinning window is coated with a coating that suppresses adherence of at least one of gallium and gallium oxide. The spinning window coating may comprise at least one of diamond like carbon, carbon, boron nitride, and an alkali hydroxide. In some embodiments, the positive ignition electrode (e.g., the top ignition electrode, the electrode displaced above the the other electrode) is closer to the window (e.g., as compared to the negative ignition electrode) and the positive electrode emits blackbody radiation through the photovoltaic to the photovoltaic converter.

The power converter or output system may comprise a magnetohydrodynamic (MHD) converter comprising a nozzle connected to the vessel, a magnetohydrodynamic channel, electrodes, magnets, a metal collection system, a metal recirculation system, a heat exchanger, and optionally a gas recirculation system. In some embodiments, the molten metal may comprise silver. In embodiments with a magnetohydrodyanamic converter, the magnetohydrodynamic converter may be delivered oxygen gas to form silver particles nanoparticles (e.g., of size in the molecular regime such as less than about 10 nm or less than about 1 nm) upon interaction with the silver in the molten metal stream, wherein the silver nanoparticles are accelerated through the magnetohydrodynamic nozzle to impart a kinetic energy inventory of the power produced from the reaction. The reactant supply system may supply and control delivery of the oxygen gas to the converter. In various implementations, at least a portion of the kinetic energy inventory of the silver nanoparticles is converted to electrical energy in a magnetohydrodynamic channel. Such version of electrical energy may result in coalescence of the nanoparticles. The nanoparticles may coalesce as molten metal which at least partially absorbs the oxygen in a condensation section of the magnetohydrodynamic converter (also referred to herein as an MHD condensation section) and the molten metal comprising absorbed oxygen is returned to the injector reservoir by a metal recirculation system. In some embodiments, the oxygen may be released from the metal by the plasma in the vessel. In some embodiments, the plasma is maintained in the magnetohydrodynamic channel and metal collection system to enhance the absorption of the oxygen by the molten metal.

The molten metal pump system may comprise a first stage electromagnetic pump and a second stage electromagnetic pump, wherein the first stage comprises a pump for a metal recirculation system, and the second stage that comprises the pump of the metal injector system.

The reaction induced by the reactants produces enough energy in order to initiate the formation of a plasma in the vessel. The reactions may produce a hydrogen product characterized as one or more of:

a) a molecular hydrogen product H₂ (e.g., H₂(1/p) (p is an integer greater than 1 and less than or equal to 137) comprising an unpaired electron) which produces an electron paramagnetic resonance (EPR) spectroscopy signal;
b) a molecular hydrogen product H₂ (e.g., H₂(1/4)) having an EPR spectrum comprising a principal peak with a g-factor of 2.0046386 that is optionally split into a series of pairs of peaks with members separated by spin-orbital coupling energies that are a function of the corresponding electron spin-orbital coupling quantum numbers wherein

(i) the unpaired electron magnetic moment induces a diamagnetic moment in the paired electron of the H₂(1/4) molecular orbital based on the diamagnetic susceptibility of H₂(1/4);

(ii) the corresponding magnetic moments of the intrinsic paired-unpaired current interactions and those due to relative rotational motion about the internuclear axis give rise to the spin-orbital coupling energies;

(iii) each spin-orbital splitting peak is further sub-split into a series of equally spaced peaks that matched integer fluxon energies that are a function of the electron fluxon quantum number corresponding to the number of angular momentum components involved in the transition, and

(iv) additionally, the spin-orbital splitting increases with spin-orbital coupling quantum number on the downfield side of the series of pairs of peaks due to magnetic energies that increased with accumulated magnetic flux linkage by the molecular orbital.

c) for an EPR frequency of 9.820295 GHz,

(i) the downfield peak positions B_{S/Ocombined}^{downfield} due to the combined shifts due to the magnetic energy and the spin-orbital coupling energy of H₂(1/4) are

$${B}_{S / Ocombined}^{downfield} = ( 0.35001 - m 3.99427 \times {10}^{- 4} - ( 0.5 ) \frac{{( 2 π m 3.99427 \times {10}^{- 4} )}^{2}}{0.175} ) T ;$$

(ii) the upfield peak positions B_{S/O}^{upfield} with quantized spin-orbital splitting energies E_{S/O} and electron spin-orbital coupling quantum numbers m=0.5, 1, 2, 3, 5 . . . are

$${B}_{S / O}^{upfield} = 0.35001 ( 1 + m [ \frac{7.426 \times {10}^{- 27} J}{h 9.820295 GHz} ] ) T = ( 0.35001 + m 3.99427 \times {10}^{- 4} ) T ,$$

and/or

(iii) the separations ΔB_{Φ} of the integer series of peaks at each spin-orbital peak position are

$$Δ {B}_{Φ}^{downfield} = ( 0.35001 - m 3.99427 \times {10}^{- 4} -$$

$$( 0.5 ) \frac{{( 2 π m 3.99427 \times {10}^{- 4} )}^{2}}{0.175} ) [ \frac{{m}_{Φ} 5.783 \times {10}^{- 28} J}{h 9.820295 GHz} ] \times {10}^{4} G and \\ Δ {B}_{Φ}^{upfield} = ( 0.35001 + m 3.99427 \times {10}^{- 4} ) [ \frac{{m}_{Φ} 5.783 \times {10}^{- 28} J}{h 9.820295 GHz} ] \times {10}^{4} G$$

for electron fluxon quantum numbers m_{Φ}=1, 2, 3:
d) a hydride ion H⁻ (e.g., H⁻(1/p)) comprising a paired and unpaired electron in a common atomic orbital that demonstrates flux linkage in quantized units of h/2e observed on H⁻(1/2) by high-resolution visible spectroscopy in the 400-410 nm range;
e) flux linkage in quantized units of h/2e observed when the rotational energy levels of H₂(1/4) were excited by laser irradiation during Raman spectroscopy and by collisions of high energy electrons from an electron beam with H₂(1/4);
f) molecular hydrino (e.g., H₂(1/p)) having Raman spectral transitions of the spin-orbital coupling between the spin magnetic moment of the unpaired electron and the orbital magnetic moment due to molecular rotation wherein

(i) the energies of the rotational transitions are shifted by these spin-orbital coupling energies as a function of the corresponding electron spin-orbital coupling quantum numbers;

(ii) molecular rotational peaks shifted by spin-orbital energies are further shifted by fluxon linkage energies with each energy corresponding to its electron fluxon quantum number dependent on the number of angular momentum components involved in the rotational transition, and/or

(iii) the observed sub-splitting or shifting of Raman spectral peaks is due to flux linkage in units of the magnetic flux quantum h/2e during the spin-orbital coupling between spin and molecular rotational magnetic moments while the rotational transition occurs;

g) H₂(1/4) having Raman spectral transitions comprising

(i) either the pure H₂ (1/4) J=0 to J′=3 rotational transition with spin-orbital coupling and fluxon coupling: E_{Raman}=ΔE_{J=0→J′}+E_{S/O,rot}+E_{Φ,rot}=11701 cm⁻¹+m528 cm⁻¹+m_{Φ}31 cm⁻¹,

(ii) the concerted transitions comprising the J=0 to J′=2, 3 rotational transitions with the J=0 to J=1 spin rotational transition: E_{Raman}=ΔE_{J=0→J′}+E_{S/O,rot}+E_{Φ,rot}=7801 cm⁻¹(13,652 cm⁻¹)+m528 cm⁻¹+m_{Φ3/2} 46 cm⁻¹, or

(iii) the double transition for final rotational quantum numbers J′ₚ=2 and J′_{c}=1:

$${E}_{Raman} = Δ {E}_{J = 0 \to {J}_{P}^{′} = 2} + Δ {E}_{J = 0 \to {J}_{c}^{′} = 1} + {E}_{S / O , rot} + {E}_{Φ , rot} = 9 \; 751 {cm}^{- 1} + m 528 {cm}^{- 1} + {m}_{Φ} 31 {cm}^{- 1} + {m}_{Φ 3 / 2} 46 {cm}^{- 1}$$

wherein the corresponding spin-orbital coupling and fluxon coupling were also observed with the pure, concerted, and double transitions;
h) H₂(1/4) UV Raman peaks (e.g., as recorded on the complex GaOOH:H₂(1/4):H₂O and Ni foils exposed to the reaction plasma observed in the 12,250-15,000 cm⁻¹ region wherein the lines match the concerted pure rotational transition ΔJ=3 and ΔJ=1 spin transition with spin-orbital coupling and fluxon linkage splittings: E_{Raman}=ΔE_{J=0→3}+ΔE_{J=0→1}+E_{S/O,rot}+E_{Φ,rot}=13,652 cm⁻¹+m528 cm⁻¹+m_{Φ}31 cm⁻¹);
i) the rotational energies of the HD(1/4) Raman spectrum shifted by a factor of ¾ relative to that of H₂(1/4);
j) the rotational energies of the HD(1/4) Raman spectrum match those of

(i) either the pure HD(1/4) J=0 to J′=3,4 rotational transition with spin-orbital coupling and fluxon coupling: E_{Raman}=ΔE_{J=0→J′}+E_{S/O,rot}+E_{Φ,rot}=8776 cm⁻¹(14,627 cm⁻¹)+m528 cm⁻¹+m_{Φ}31 cm⁻¹,

(ii) the concerted transitions comprising the J=0 to J′=3 rotational transitions with the J=0 to J=1 spin rotational transition:

$${E}_{Raman} = Δ {E}_{J = 0 \to {J}^{′}} + {E}_{S / O , rot} + {E}_{Φ , rot} = 10 , 239 {cm}^{- 1} + m 528 {cm}^{- 1} + {m}_{Φ3 / 2} 46 {cm}^{- 1} ,$$

or

(iii) the double transition for final rotational quantum numbers J′ₚ=3; J′_{c}=1:

$${E}_{Raman} = Δ {E}_{J = 0 \to {J}_{P}^{′} = 2} + Δ {E}_{J = 0 \to {J}_{c}^{′} = 1} + {E}_{S / O , rot} + {E}_{Φ , rot} = 11 , 701 {cm}^{- 1} + m 528 {cm}^{- 1} + {m}_{Φ} 31 {cm}^{- 1} + {m}_{{m}_{Φ 3 / 2}} 46 {cm}^{- 1}$$

wherein spin-orbital coupling and fluxon coupling are also observed with both the pure and concerted transition;
k) H₂(1/4)-noble gas mixtures irradiated with high energy electrons of an electron beam show equal, 0.25 eV spaced line emission in the ultraviolet (150-180 nm) region with a cutoff at 8.25 eV that match the H₂(1/4) v=1 to v=0 vibrational transition with a series of rotational transitions corresponding to the H₂(1/4) P-branch wherein

(i) the spectral fit is a good match to 4²0.515 eV−4²(J+1)0.01509; J=0, 1, 2, 3 . . . wherein 0.515 eV and 0.01509 eV are the vibrational and rotational energies of ordinary molecular hydrogen, respectively,

(ii) small satellite lines are observed that match the rotational spin-orbital splitting energies that are also observed by Raman spectroscopy, and (iii) the rotational spin-orbital splitting energy separations match m528 cm⁻¹ m=1, 1.5 wherein 1.5 involves the m=0.5 and m=1 splittings;

l) the spectral emission of the H₂(1/4) P-branch rotational transitions with the v=1 to v=0 vibrational transition are observed by electron beam excitation of H₂(1/4) trapped in a KCl crystalline matrix wherein

(i) the rotational peaks match that of a free rotor;

(ii) the vibrational energy is shifted by the increase in the effective mass due to interaction of the vibration of H₂(1/4) with the KCl matrix;

(iii) the spectral fit is a good match to 5.8 eV−4²(J+1)0.01509; J=0, 1, 2, 3 . . . comprising peaks spaced at 0.25 eV, and

(iv) relative magnitude of the H₂(1/4) vibrational energy shift match the relative effect on the ro-vibrational spectrum caused by ordinary H₂ being trapped in KCl;

m) the Raman spectrum with a HeCd energy laser shows a series of 1000 cm⁻¹ (0.1234 eV) equal-energy spaced in the 8000 cm⁻¹ to 18,000 cm⁻¹ region wherein conversion of the Raman spectrum into the fluorescence or photoluminescence spectrum reveals a match as the second order ro-vibrational spectrum of H₂(1/4) corresponding to the e-beam excitation emission spectrum of H₂(1/4) in a KCl matrix given by 5.8 eV−4²(J+1)0.01509; J=0, 1, 2, 3 . . . and comprising the matrix shifted v=1 to v=0 vibrational transition with 0.25 eV energy-spaced rotational transition peaks;
n) infrared rotational transitions of H₂(1/4) are observed in an energy region higher than 4400 cm⁻¹ wherein the intensity increases with the application of a magnetic field in addition to an intrinsic magnetic field, and rotational transitions coupling with spin-orbital transitions are also observed;
o) the allowed double ionization of H₂(1/4) by the Compton effect corresponding to the total energy of 496 eV is observed by X-ray photoelectron spectroscopy (XPS);
p) H₂(1/4) is observed by gas chromatography that shows a faster migration rate than that of any known gas considering that hydrogen and helium have the fastest prior known migration rates and corresponding shortest retention times;
q) extreme ultraviolet (EUV) spectroscopy records extreme ultraviolet continuum radiation with a 10.1 nm cutoff (e.g., as corresponding to the hydrino reaction transition H to H(1/4) catalyzed by nascent HOH catalyst);
r) proton magic-angle spinning nuclear magnetic resonance spectroscopy (¹H MAS NMR) records an upfield matrix-water peak in the −4 ppm to −5 ppm region;
s) bulk magnetism such as paramagnetism, superparamagnetism and even ferromagnetism when the magnetic moments of a plurality of hydrogen product molecules interact cooperatively wherein superparamagnetism (e.g., as observed using a vibrating sample magnetometer to measure the magnetic susceptibility of compounds comprising reaction products);
t) time of flight secondary ion mass spectroscopy (ToF-SIMS) and electrospray time of flight secondary ion mass spectroscopy (ESI-ToF) recorded on K₂CO₃ and KOH exposed to a molecular gas source from the reaction products showing complexing of reaction products (e.g., H₂(1/4) gas) to the inorganic compounds comprising oxyanions by the unique observation of M+2 multimer units (e.g., K⁺[H₂: K₂CO₃]ₙ and K⁺[H₂: KOH]ₙ wherein n is an integer) and an intense H⁻ peak due to the stability of hydride ion, and
u) reaction products consisting of molecular hydrogen nuclei behaving like organic molecules as evidenced by a chromatographic peak on an organic molecular matrix column that fragments into inorganic ions. In various implementations, the reaction produces energetic signatures characterized as one or more of:

(i) extraordinary Doppler line broadening of the H Balmer a line of over 100 eV in plasmas comprising H atoms and nascent HOH or H based catalyst such as argon-H₂, H₂, and H₂O vapor plasmas,

(ii) H excited state line inversion,

(iii) anomalous H plasma afterglow duration,

(iv) shockwave propagation velocity and the corresponding pressure equivalent to about 10 times more moles of gunpowder with only about 1% of the power coupling to the shockwave,

(v) optical power of up to 20 MW from a 10 μl hydrated silver shot, and

(vi) calorimetry of the SunCell power system validated at a power level of 340,000 W. These reactions may produce a hydrogen product characterized as one or more of:
a) a hydrogen product with a Raman peak at one or more range of 1900 to 2200 cm⁻¹, 5500 to 6400 cm⁻¹, and 7500 to 8500 cm⁻¹, or an integer multiple of a range of 1900 to 2200 cm⁻¹;
b) a hydrogen product with a plurality of Raman peaks spaced at an integer multiple of 0.23 to 0.25 eV;
c) a hydrogen product with an infrared peak at a range of an integer multiple of 1900 to 2000 cm⁻¹;
d) a hydrogen product with a plurality of infrared peaks spaced at an integer multiple of 0.23 to 0.25 eV;
e) a hydrogen product with at a plurality of UV fluorescence emission spectral peaks in the range of 200 to 300 nm having a spacing at an integer multiple of 0.23 to 0.3 eV;
f) a hydrogen product with a plurality of electron-beam emission spectral peaks in the range of 200 to 300 nm having a spacing at an integer multiple of 0.2 to 0.3 eV;
g) a hydrogen product with a plurality of Raman spectral peaks in the range of 5000 to 20,000 cm⁻¹ having a spacing at an integer multiple of 1000±200 cm⁻¹;
h) a hydrogen product with a X-ray photoelectron spectroscopy peak at an energy in the range of 490 to 525 eV;
i) a hydrogen product that causes an upfield MAS NMR matrix shift;
j) a hydrogen product that has an upfield MAS NMR or liquid NMR shift of greater than −5 ppm relative to TMS;
m) a hydrogen product comprising at least one of a metal hydride and a metal oxide further comprising hydrogen wherein the metal comprises at least one of Zn, Fe, Mo, Cr, Cu, and W;
o) a hydrogen product comprising an inorganic compound MₓX_{y} and H₂ wherein M is a cation and X in an anion having at least one of electrospray ionization time of flight secondary ion mass spectroscopy (ESI-ToF) and time of flight secondary ion mass spectroscopy (ToF-SIMS) peaks of M(MₓX_{y}H₂)n wherein n is an integer;
p) a hydrogen product comprising at least one of K₂CO₃H₂ and KOHH₂ having at least one of electrospray ionization time of flight secondary ion mass spectroscopy (ESI-ToF) and time of flight secondary ion mass spectroscopy (ToF-SIMS) peaks of K(K₂H₂CO₃)ₙ⁺ and K(KOHH₂)ₙ⁺, respectively;
q) a magnetic hydrogen product comprising at least one of a metal hydride and a metal oxide further comprising hydrogen wherein the metal comprises at least one of Zn, Fe, Mo, Cr, Cu, W, and a diamagnetic metal;
r) a hydrogen product comprising at least one of a metal hydride and a metal oxide further comprising hydrogen wherein the metal comprises at least one of Zn, Fe, Mo, Cr, Cu, W, and a diamagnetic metal that demonstrates magnetism by magnetic susceptometry;
s) a hydrogen product comprising a metal that is not active in electron paramagnetic resonance (EPR) spectroscopy wherein the EPR spectrum comprises at least one of a g factor of about 2.0046±20%, a splitting of the EPR spectrum into a series of peaks with a separation of about 1 to 10 G wherein each main peak is sub-split into a series of peaks with spacing of about 0.1 to 1 G;
t) a hydrogen product comprising a metal that is not active in electron paramagnetic resonance (EPR) spectroscopy wherein the EPR spectrum comprises at least an electron spin-orbital coupling splitting energy of about m₁×7.43×10⁻²⁷ J±20%, and fluxon splitting of about m₂×5.78×10⁻²⁸ J±20%, and a dimer magnetic moment interaction splitting energy of about 1.58×10⁻²³ J±20%;
v) a hydrogen product comprising a gas having a negative gas chromatography peak with hydrogen or helium carrier;
w) a hydrogen product having a quadrupole moment/e of

$$\frac{1.70127 {a}_{0}^{2}}{{p}^{2}} \pm 10 \%$$

wherein p is an integer;
x) a protonic hydrogen product comprising a molecular dimer having an end over 20 end rotational energy for the integer J to J+1 transition in the range of (J+1)44.30 cm⁻¹±20 cm⁻¹ wherein the corresponding rotational energy of the molecular dimer comprising deuterium is ½ that of the dimer comprising protons;
y) a hydrogen product comprising molecular dimers having at least one parameter from the group of (i) a separation distance of hydrogen molecules of 1.028 Å±10%, (ii) a vibrational energy between hydrogen molecules of 23 cm⁻¹±10%, and (iii) a van der Waals energy between hydrogen molecules of 0.0011 eV±10%;
z) a hydrogen product comprising a solid having at least one parameter from the group of (i) a separation distance of hydrogen molecules of 1.028 Å±10%, (ii) a vibrational energy between hydrogen molecules of 23 cm⁻¹±10%, and (iii) a van der Waals energy between hydrogen molecules of 0.019 eV±10%;
aa) a hydrogen product having FTIR and Raman spectral signatures of (i) (J+1)44.30 cm⁻¹±20 cm⁻¹, (ii) (J+1)22.15 cm⁻¹±10 cm⁻¹ and (iii) 23 cm⁻¹±10% and/or an X-ray or neutron diffraction pattern showing a hydrogen molecule separation of 1.028 Å±10% and/or a calorimetric determination of the energy of vaporization of 0.0011 eV±10% per molecular hydrogen;
bb) a solid hydrogen product having FTIR and Raman spectral signatures of (i) (J+1)44.30 cm⁻¹±20 cm⁻¹, (ii) (J+1)22.15 cm⁻¹±10 cm⁻¹ and (iii) 23 cm⁻¹±10% and/or an X-ray or neutron diffraction pattern showing a hydrogen molecule separation of 1.028 Å±10% and/or a calorimetric determination of the energy of vaporization of 0.019 eV±10% per molecular hydrogen.
cc) a hydrogen product comprising a hydrogen hydride ion that is magnetic and links flux in units of the magnetic in its bound-free binding energy region, and
dd) a hydrogen product wherein the high pressure liquid chromatography (HPLC) shows chromatographic peaks having retention times longer than that of the carrier void volume time using an organic column with a solvent comprising water wherein the detection of the peaks by mass spectroscopy such as ESI-ToF shows fragments of at least one inorganic compound.
   In various implementations, the hydrogen product may be characterized similarly as products formed from various hydrino reactors such as those formed by wire detonation in an atmosphere comprising water vapor. Such products may:
a) comprise at least one of a metal hydride and a metal oxide further comprising hydrogen wherein the metal comprises at least one of Zn, Fe, Mo, Cr, Cu, and W and the hydrogen comprises H;
b) comprise an inorganic compound MₓX_{y} and H₂ wherein M is a metal cation and X is an anion and at least one of the electrospray ionization time of flight secondary ion mass spectrum (ESI-ToF) and the time of flight secondary ion mass spectrum (ToF-SIMS) comprises peaks of M(MₓX_{y}H(1/4)₂)n wherein n is an integer;
c) be magnetic and comprise at least one of a metal hydride and a metal oxide further comprising hydrogen wherein the metal comprises at least one of Zn, Fe, Mo, Cr, Cu, W, and a diamagnetic metal, and the hydrogen is H(1/4), and
d) comprise at least one of a metal hydride and a metal oxide further comprising hydrogen wherein the metal comprises at least one of Zn, Fe, Mo, Cr, Cu, W, and a diamagnetic metal and H is H(1/4) wherein the product demonstrates magnetism by magnetic susceptometry.

In some embodiments, the hydrogen product formed by the reaction comprises the hydrogen product complexed with at least one of (i) an element other than hydrogen, (ii) an ordinary hydrogen species comprising at least one of H⁺, ordinary H₂, ordinary H⁻, and ordinary H₃⁺, an organic molecular species, and (iv) an inorganic species. In some embodiments, the hydrogen product comprises an oxyanion compound. In various implementations, the hydrogen product (or a recovered hydrogen product from embodiments comprising a getter) may comprise at least one compound having the formula selected from the group of:
a) MH, MH₂, or M₂H₂, wherein M is an alkali cation and H or H₂ is the hydrogen product;
b) MHₙ wherein n is 1 or 2, M is an alkaline earth cation and H is the hydrogen product;
c) MHX wherein M is an alkali cation, X is one of a neutral atom such as halogen atom, a molecule, or a singly negatively charged anion such as halogen anion, and H is the hydrogen product;
d) MHX wherein M is an alkaline earth cation, X is a singly negatively charged anion, and H is H is the hydrogen product;
e) MHX wherein M is an alkaline earth cation, X is a double negatively charged anion, and H is the hydrogen product;
f) M₂HX wherein M is an alkali cation, X is a singly negatively charged anion, and H is the hydrogen product;
g) MHₙ wherein n is an integer, M is an alkaline cation and the hydrogen content Hₙ of the compound comprises at least one of the hydrogen products;
h) M₂Hₙ wherein n is an integer, M is an alkaline earth cation and the hydrogen content Hₙ of the compound comprises at least of the hydrogen products;
i) M₂XHₙ wherein n is an integer, M is an alkaline earth cation, X is a singly negatively charged anion, and the hydrogen content Hₙ of the compound comprises at least one of the hydrogen products;
j) M₂X₂Hₙ wherein n is 1 or 2, M is an alkaline earth cation, X is a singly negatively charged anion, and the hydrogen content Hₙ of the compound comprises at least one of the hydrogen products;
k) M₂X₃H wherein M is an alkaline earth cation, X is a singly negatively charged anion, and H is the hydrogen product;
l) M₂XHₙ wherein n is 1 or 2, M is an alkaline earth cation, X is a double negatively charged anion, and the hydrogen content Hₙ of the compound comprises at least one of the hydrogen products;
m) M₂XX′H wherein M is an alkaline earth cation, X is a singly negatively charged anion, X′ is a double negatively charged anion, and H is the hydrogen product;
n) MM′Hₙ wherein n is an integer from 1 to 3, M is an alkaline earth cation, M′ is an alkali metal cation and the hydrogen content Hₙ of the compound comprises at least one of the hydrogen products;
o) MM′XHₙ wherein n is 1 or 2, M is an alkaline earth cation, M′ is an alkali metal cation, X is a singly negatively charged anion and the hydrogen content Hₙ of the compound comprises at least one of the hydrogen products;
p) MM′XH wherein M is an alkaline earth cation, M′ is an alkali metal cation, X is a double negatively charged anion and H is the hydrogen products;
q) MM′XX′H wherein M is an alkaline earth cation, M′ is an alkali metal cation, X and X′ are singly negatively charged anion and H is the hydrogen product;
r) MXX′Hₙ wherein n is an integer from 1 to 5, M is an alkali or alkaline earth cation, X is a singly or double negatively charged anion, X′ is a metal or metalloid, a transition element, an inner transition element, or a rare earth element, and the hydrogen content Hₙ of the compound comprises at least one of the hydrogen products;
s) MHₙ wherein n is an integer, M is a cation such as a transition element, an inner transition element, or a rare earth element, and the hydrogen content Hₙ of the compound comprises at least one of the hydrogen products;
t) MXHₙ wherein n is an integer, M is an cation such as an alkali cation, alkaline earth cation, X is another cation such as a transition element, inner transition element, or a rare earth element cation, and the hydrogen content Hₙ of the compound comprises at least one of the hydrogen products;
u) (MHₘMCO₃)ₙ wherein M is an alkali cation or other+1 cation, m and n are each an integer, and the hydrogen content Hₘ of the compound comprises at least one of the hydrogen products;
v) (MHₘMNO₃)ₙ⁺ nX⁻ wherein M is an alkali cation or other +1 cation, m and n are each an integer, X is a singly negatively charged anion, and the hydrogen content Hₘ of the compound comprises at least one of the hydrogen products;
w) (MHMNO₃)ₙ wherein M is an alkali cation or other +1 cation, n is an integer and the hydrogen content H of the compound comprises at least one of the hydrogen products;
x) (MHMOH)ₙ wherein M is an alkali cation or other +1 cation, n is an integer, and the hydrogen content H of the compound comprises at least one of the hydrogen products;
y) (MHₘM′X)ₙ wherein m and n are each an integer, M and M′ are each an alkali or alkaline earth cation, X is a singly or double negatively charged anion, and the hydrogen content Hₘ of the compound comprises at least one of the hydrogen products; and
z) (MHₘM′X′)ₙ⁺ nX⁻ wherein m and n are each an integer, M and M′ are each an alkali or alkaline earth cation, X and X′ are a singly or double negatively charged anion, and the hydrogen content Hₘ of the compound comprises at least one of the hydrogen products.
   The anion of the hydrogen product formed by the reaction may be one or more singly negatively charged anions including a halide ion, a hydroxide ion, a hydrogen carbonate ion, a nitrate ion, a double negatively charged anions, a carbonate ion, an oxide, and a sulfate ion. In some embodiments, the hydrogen product is embedded in a crystalline lattice (e.g., with the use of a getter such as K₂CO₃ located, for example, in the vessel or in an exhaust line). For example, the hydrogen product may be embedded in a salt lattice. In various implementations, the salt lattice may comprise an alkali salt, an alkali halide, an alkali hydroxide, alkaline earth salt, an alkaline earth halide, an alkaline earth hydroxide, or combinations thereof.

Electrode systems are also provided comprising:
a) a first electrode and a second electrode;
b) a stream of molten metal (e.g., molten silver, molten gallium) in electrical contact with said first and second electrodes;
c) a circulation system comprising a pump to draw said molten metal from a reservoir and convey it through a conduit (e.g., a tube) to produce said stream of molten metal exiting said conduit;
d) a source of electrical power configured to provide an electrical potential difference between said first and second electrodes;
   wherein said stream of molten metal is in simultaneous contact with said first and second electrodes to create an electrical current between said electrodes. In some embodiments, the electrical power is sufficient to create a current in excess of 100 A.

Electrical circuits are also provided which may comprise:
a) a heating means for producing molten metal;
b) a pumping means for conveying said molten metal from a reservoir through a conduit to produce a stream of said molten metal exiting said conduit;
c) a first electrode and a second electrode in electrical communication with a power supply means for creating an electrical potential difference across said first and second electrode;
   wherein said stream of molten metal is in simultaneous contact with said first and second electrodes to create an electrical circuit between said first and second electrodes. For example, in an electrical circuit comprising a first and second electrode, the improvement may comprise passing a stream of molten metal across said electrodes to permit a current to flow there between.

Additionally, systems for producing a plasma (which may be used in the power generation systems described herein) are provided. These systems may comprise:
a) a molten metal injector system configured to produce a stream of molten metal from a metal reservoir;
b) an electrode system for inducing a current to flow through said stream of molten metal;
c) at least one of a (i) water injection system configured to bring a metered volume of water in contact with said molten metal, wherein a portion of said water and a portion of said molten metal react to form an oxide of said metal and hydrogen gas, (ii) a mixture of excess hydrogen gas an oxygen gas, and (iii) a mixture of excess hydrogen gas and water vapor, and
d) a power supply configured to supply said current;
   wherein said plasma is produced when current is supplied through said metal stream. In some embodiments, the system may further comprise:
   a pumping system configured to transfer metal collected after the production of said plasma to said metal reservoir. In some embodiments, the system may comprise:

a metal regeneration system configured to collect said metal oxide and convert said metal oxide to said metal; wherein said metal regeneration system comprises an anode, a cathode, electrolyte; wherein an electrical bias is supplied between said anode and cathode to convert said metal oxide to said metal. In certain implementations, the system may comprise:
a) a pumping system configured to transfer metal collected after the production of said plasma to said metal reservoir; and
b) a metal regeneration system configured to collect said metal oxide and convert said metal oxide to said metal; wherein said metal regeneration system comprises an anode, a cathode, electrolyte; wherein an electrical bias is supplied between said anode and cathode to convert said metal oxide to said metal;
   wherein metal regenerated in said metal regeneration system is transferred to said pumping system. In certain implementations, the metal is gallium, silver, or combinations thereof. In some embodiments, the electrolyte is an alkali hydroxide (e.g., sodium hydroxide, potassium hydroxide).

Systems for producing a plasma of the present disclosure may comprise:

a) a molten metal injector system configured to produce a stream of molten metal from a metal reservoir;
b) an electrode system for inducing a current to flow through said stream of molten metal;
c) at least one of a (i) water injection system configured to bring a metered volume of water in contact with molten metal, wherein a portion of said water and a portion of said molten metal react to form an oxide of said metal and hydrogen gas, (ii) a mixture of excess hydrogen gas an oxygen gas, and (iii) a mixture of excess hydrogen gas and water vapor, and
d) a power supply configured to supply said current;
wherein said plasma is produced when current is supplied through said metal stream. In some embodiments, the system may further comprise:
a) a pumping system configured to transfer metal collected after the production of said plasma to said metal reservoir; and
b) a metal regeneration system configured to collect said metal oxide and convert said metal oxide to said metal; wherein said metal regeneration system comprises an anode, a cathode, electrolyte; wherein an electrical bias is supplied between said anode and cathode to convert said metal oxide to said metal;
wherein metal regenerated in said metal regeneration system is transferred to said pumping system.

The system for generating a plasma may comprise:

a) two electrodes configured to allow a molten metal flow therebetween to complete a circuit;

b) a power source connected to said two electrodes to apply a current therebetween when said circuit is closed;

c) a recombiner cell (e.g., glow discharge cell) to induce the formation of nascent water and atomic hydrogen from a gas; wherein effluence of the recombiner is directed towards the circuit (e.g., the molten metal, the anode, the cathode, an electrode submerged in a molten metal reservoir);

wherein when current is applied across the circuit, the effluence of the recombiner cell undergoes a reaction to produce a plasma. In some embodiments, the system is used to generate heat from the plasma. In various implementations, the system is used to generate light from the plasma.

The systems of the present disclosure may comprise (or be part of) a mesh network comprising a plurality of power-system-transmitter-receiver nodes that transmit and received electromagnetic signals in at least one frequency band, the frequency of the band may be high frequency due to the ability to position nodes locally with short separation distance wherein the frequency may be in at least one range of about 0.1 GHz to 500 GHz, 1 GHz to 250 GHz, 1 GHz to 100 GHz, 1 GHz to 50 GHz, and 1 GHz to 25 GHz.

The unique spectroscopic signatures measured in the reaction products produces hydrogen products with unique characteristics. These hydrogen reaction products may be used in various devices, each part of the present disclosure.

The present disclosure also embraces superconducting quantum interference devices (SQUIDs) or SQUID-type electronic elements which may comprise at least one hydrino species H⁻(1/p) and H₂(1/p) (or species having spectroscopic features that match these species) and at least one of an input current and input voltage circuit and an output current and output voltage circuit to at least one of sense and change the flux linkage state of at least one of the hydrino hydride ion and molecular hydrino. In some embodiments, the circuits comprise AC resonant circuits comprising radio frequency RLC circuits. In various implementations, the SQUIDs or SQUID-type electronic element further comprises at least one source of electromagnetic radiation (e.g., a source of at least one of microwave, infrared, visible, or ultraviolet radiation) to, for example, induce a magnetic field in a sample. In some embodiments, the source of radiation comprises a laser or a microwave generator. The laser radiation may be applied in a focused manner by lens or fiber optics (e.g. to a sample of interest). In some embodiments, the SQUID or SQUID-type electronic element further comprises a source of magnetic field applied to at least one of the hydrino hydride ion and molecular hydrino. The magnetic field may be tunable. Such tunability of at least one of the source of radiation and magnetic field may enables the selective and controlled achievement of resonance between the source of electromagnetic radiation and the magnetic field. The SQUID or SQUID-type electronic element may comprise a computer logic gate, memory element, and other electronic measurement or actuator devices such as magnetometers, sensors, and switches that operates at elevated temperature.

A SQUID of the present disclosure may comprise: at least two Josephson junctions electrically connected to a superconducting loop,

wherein the Josephson Junction comprising a hydrogen species H₂ that is EPR active. In certain embodiments, the hydrogen species is MOOH:H₂, wherein M is a metal (e.g., Ag, Ga).

The present reaction products produced, for example, from the operation of power generation systems of the disclosure may be used as or in a cryogen, a gaseous heat transfer agent, and/or an agent for buoyancy comprising molecular hydrino (e.g., species having spectroscopic features that match molecular hydrino).

MRI gas contrast agents are also provided comprising molecular hydrino (e.g., species having spectroscopic features that match molecular hydrino).

The reaction products also may be used as the excitation medium in lasers. The disclosure embraces hydrino molecular gas laser which may comprise molecular hydrino gas (H₂(1/p) p=2, 3, 4, 5, . . . , 137) (e.g., species having spectroscopic features that match molecular hydrino), a laser cavity containing the molecular hydrino gas, a source of excitation of rotation energy levels of the molecular hydrino gas, and laser optics. In some embodiments, the laser optics comprise mirrors at the ends of the cavity comprising molecular hydrino gas in excited rotational states, and one of the mirrors is semitransparent to permit the laser light to be emitted from the cavity. In various implementations, the source of excitation comprises at least one of a laser, a flash lamp, a gas discharge system (e.g. a glow, microwave, radio frequency (RF), inductively couples RF, capacitively coupled RF, or other plasma discharge system). In certain aspects, the laser may further comprise an external or internal field source (e.g., a source of electric or magnetic field) to cause at least one desired molecular hydrino rotational energy level to be populated wherein the level comprises at least one of a desired spin-orbital and fluxon linkage energy shift. The laser transition may occur between an inverted population of a selected rotational state to that of lower energy that is less populated. In some embodiments, the laser cavity, optics, excitation source, and external field source are selected to achieve the desired inverted population and stimulated emission to the desired less populated lower-energy state. The laser may comprise a solid laser medium. For example, the solid laser medium comprises molecular hydrino trapped in a solid matrix wherein the hydrino molecules may be free rotors and the solid medium replaces the gas cavity of a molecular hydrino gas laser. In certain implementations, the solid lasing media comprises at least one of GaOOH:H₂(1/4), KCl:H₂(1/4), and silicon having trapped molecular hydrino (e.g., Si(crystal):H₂(1/4)) (or species having spectroscopic signatures thereof).

Methods are also provided. The method may, for example, generate power or produce light, or product a plasma. In some embodiments, the method comprises:

a) electrically biasing a molten metal;

b) directing the effluence of a plasma generation cell (e.g., a glow discharge cell) to interact with the biased molten metal and induce the formation of a plasma. In certain implementations, the effluence of the plasma generation cell is generated from a hydrogen (H₂) and oxygen (O₂) gas mixture passing through the plasma generation cell during operation.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is a schematic drawing of magnetohydrodynamic (MHD) converter components of a cathode, anode, insulator, and bus bar feed-through flange in accordance with an embodiment of the present disclosure.

FIGS. 2-3 are schematic drawings of a SunCell® power generator comprising dual EM pump injectors as liquid electrodes showing tilted reservoirs and a magnetohydrodynamic (MHD) converter comprising a pair of MHD return EM pumps in accordance with an embodiment of the present disclosure.

FIG. 4 is schematic drawings of a single-stage induction injection EM pump in accordance with an embodiment of the present disclosure.

FIG. 5 is schematic drawings of magnetohydrodynamic (MHD) SunCell® power generators comprising dual EM pump injectors as liquid electrodes showing tilted reservoirs, a spherical reaction cell chamber, a straight magnetohydrodynamic (MHD) channel, gas addition housing, and single-stage induction EM pumps for injection and either single-stage induction or DC conduction MHD return EM pumps in accordance with an embodiment of the present disclosure.

FIG. 6 is schematic drawings of a two-stage induction EM pump wherein the first stage serves as the MHD return EM pump and the second stage serves as the injection EM pump in accordance with an embodiment of the present disclosure.

FIG. 7 is schematic drawings of a two-stage induction EM pump wherein the first stage serves as the MHD return EM pump and the second stage serves as the injection EM pump wherein the Lorentz pumping force is more optimized in accordance with an embodiment of the present disclosure.

FIG. 8 is schematic drawings of an induction ignition system in accordance with an embodiment of the present disclosure.

FIGS. 9-10 are schematic drawings of a magnetohydrodynamic (MHD) SunCell® power generator comprising dual EM pump injectors as liquid electrodes showing tilted reservoirs, a spherical reaction cell chamber, a straight magnetohydrodynamic (MHD) channel, gas addition housing, two-stage induction EM pumps for both injection and MHD return each having a forced air-cooling system, and an induction ignition system in accordance with an embodiment of the present disclosure.

FIG. 11 is a schematic drawings of a magnetohydrodynamic (MHD) SunCell® power generator comprising dual EM pump injectors as liquid electrodes showing tilted reservoirs, a spherical reaction cell chamber, a straight magnetohydrodynamic (MHD) channel, gas addition housing, two-stage induction EM pumps for both injection and MHD return each having a forced liquid cooling system, an induction ignition system, and inductively coupled heating antennas on the EM pump tubes, reservoirs, reaction cell chamber, and MHD return conduit in accordance with an embodiment of the present disclosure.

FIGS. 12-19 are schematic drawings of a magnetohydrodynamic (MHD) SunCell® power generator comprising dual EM pump injectors as liquid electrodes showing tilted reservoirs, a spherical reaction cell chamber, a straight magnetohydrodynamic (MHD) channel, gas addition housing, two-stage induction EM pumps for both injection and MHD return each having an air-cooling system, and an induction ignition system in accordance with an embodiment of the present disclosure.

FIG. 20 is schematic drawings showing an exemplary helical-shaped flame heater of the SunCell® and a flame heater comprising a series of annular rings in accordance with an embodiment of the present disclosure.

FIG. 21 is schematic drawings showing an electrolyzer in accordance with an embodiment of the present disclosure.

FIG. 22 is a schematic drawing of a SunCell® power generator comprising dual EM pump injectors as liquid electrodes showing tilted reservoirs and a magnetohydrodynamic (MHD) converter comprising a pair of MHD return EM pumps and a pair of MHD return gas pumps or compressors in accordance with an embodiment of the present disclosure.

FIG. 25 is schematic drawings showing details of the SunCell® thermal power generator comprising a single EM pump injector in an injector reservoir and an inverted pedestal as liquid electrodes in accordance with an embodiment of the present disclosure.

FIGS. 26-28 are schematic drawings showing details of the SunCell® thermal power generator comprising a single EM pump injector in an injector reservoir and a partially inverted pedestal as liquid electrodes and a tapered reaction cell chamber to suppress metallization of a PV window in accordance with an embodiment of the present disclosure.

FIG. 29 is a schematic drawing showing details of the SunCell® thermal power generator comprising a single EM pump injector in an injector reservoir, a partially inverted pedestal as liquid electrodes, an induction ignition system, and a PV window in accordance with an embodiment of the present disclosure.

FIG. 30 is a schematic drawing showing details of the SunCell® thermal power generator comprising a cube-shaped reaction cell chamber with a liner and a single EM pump injector in an injector reservoir and an inverted pedestal as liquid electrodes in accordance with an embodiment of the present disclosure.

FIG. 31A is a schematic drawing showing details of the SunCell® thermal power generator comprising an hour-glass-shaped reaction cell chamber liner and a single EM pump injector in an injector reservoir and an inverted pedestal as liquid electrodes in accordance with an embodiment of the present disclosure.

FIG. 31B is schematic drawing showing details of the SunCell® thermal power generator comprising a single EM pump injector in an injector reservoir and an inverted pedestal as electrodes in accordance with an embodiment of the present disclosure.

FIG. 31C is schematic drawing showing details of the SunCell® thermal power generator comprising a single EM pump injector in an injector reservoir and an inverted pedestal as electrodes wherein the EM pump tube comprises an assembly of a plurality of parts that are resistant to at least one of gallium alloy formation and oxidation in accordance with an embodiment of the present disclosure.

FIGS. 31D-H are schematic drawings showing details of the SunCell® pumped-molten metal-to-air heat exchanger in accordance with an embodiment of the present disclosure.

FIGS. 66A-B are schematic drawings of a ceramic SunCell® power generator comprising dual reservoirs and DC EM pump injectors as liquid electrodes having reservoirs that join to form the reaction cell chamber in accordance with an embodiment of the present disclosure.

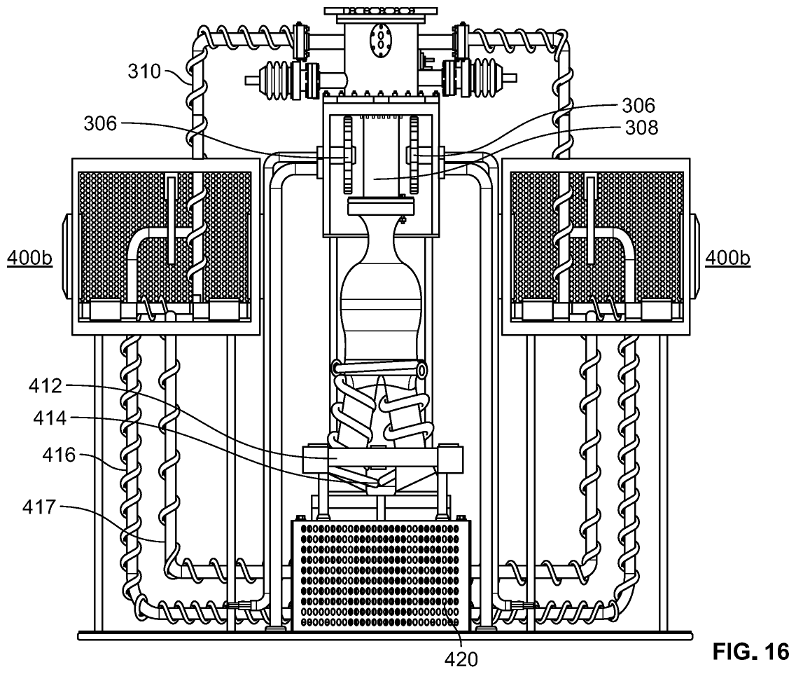

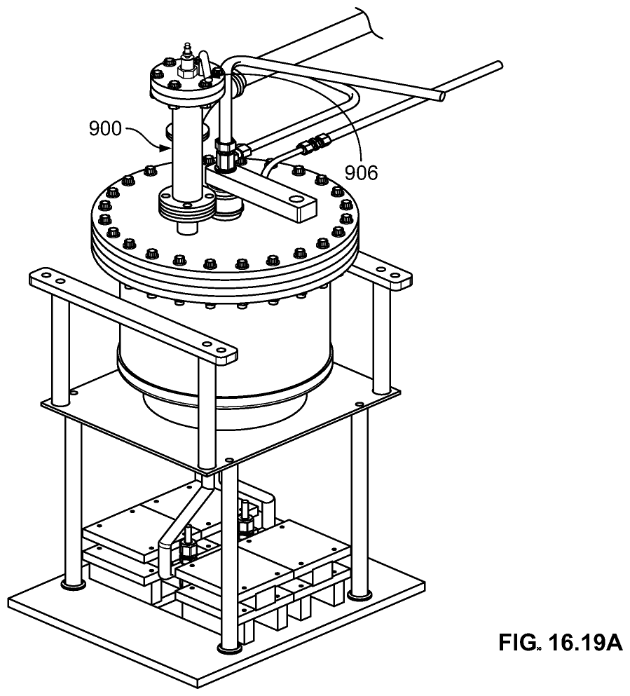

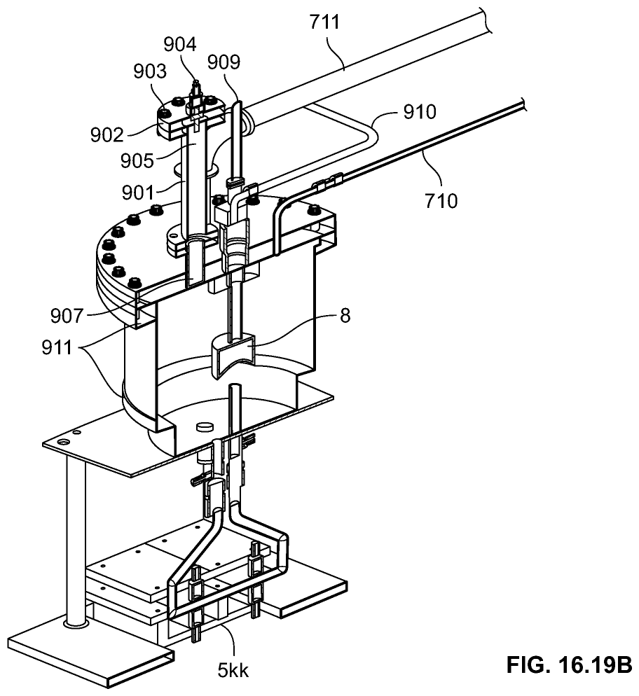

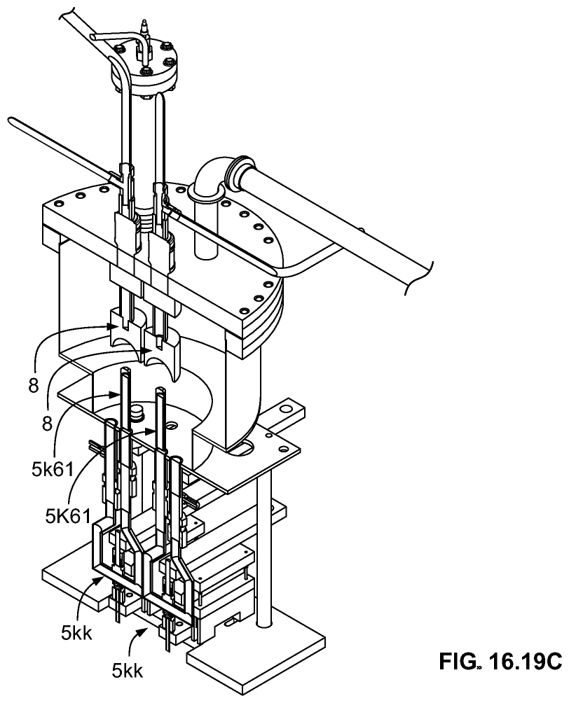

FIGS. 16.19A-C are schematics of a SunCell® hydrino power generator comprising at least one electromagnetic pump injector and electrode in an injector reservoir electrode, at least one vertically aligned counter electrode, and a glow discharge cell connected to a top flange to form HOH catalyst and atomic H. A. Exterior view of one-electrode pair embodiment. B. Cross sectional view of one-electrode pair embodiment. C. Cross sectional view of two-electrode pair embodiment.

FIG. 33 is a schematic drawing of a hydrino reaction cell chamber comprising a means to detonate a wire to serve as at least one of a source of reactants and a means to propagate the hydrino reaction to form lower-energy hydrogen species such as molecular hydrino in accordance with an embodiment of the present disclosure.

FIG. 34 shows the measured EPR spectra of GaOOH:H₂(1/4) collected from power system operation. The EPR spectra have been replicated by Bruker using two instruments on two samples. (A) EMXnano data. (B) EMXplus data. (C) Expansion of EMXplus data, 3503 G-3508 G region.

FIG. 35 shows the EPR spectrum of GaOOH:HD(1/4) (3464.65 G-3564.65 G) region.

FIGS. 36A-C show the Raman spectra obtained using a Horiba Jobin Yvon LabRam ARAMIS spectrometer with a 785 nm laser on a Ni foil prepared by immersion in the molten gallium of a SunCell that maintained a hydrino plasma reaction for 10 minutes. (A) 2500 cm⁻¹ to 11,000 cm⁻¹ region. (B) 8500 cm⁻¹ to 11,000 cm⁻¹ region. (C) 6000 cm⁻¹ to 11,000 cm⁻¹ region. All of the novel lines matched those of either (i) the pure H₂ (1/4) J=0 to J′=2,3 rotational transition, (ii) the concerted transitions comprising the J=0 to J′=1,2 rotational transitions with the J=0 to J=1 spin rotational transition, or (iii) the double transition for final rotational quantum numbers J′ₚ=2 and J′_{c}=1. Corresponding spin-orbital coupling and fluxon coupling were also observed with the pure, concerted, and double transitions.

FIG. 37A is the Raman spectra (2200 cm⁻¹ to 11,000 cm⁻¹) obtained using a Horiba Jobin Yvon LabRam ARAMIS spectrometer with a 785 nm laser on GaOOH:H₂(1/4) showing H₂(1/4) rotational transitions with spin-orbital coupling and fluxon linkage shifts. FIG. 37B is the Raman spectrum (2500 cm⁻¹ to 11,000 cm⁻¹) obtained using a Horiba Jobin Yvon LabRam ARAMIS spectrometer with a 785 nm laser on a silver shot electrode post detonation showing H₂(1/4) rotational transitions with spin-orbital coupling and fluxon linkage shifts.

FIGS. 38A-C show the Raman spectra obtained using a Horiba Jobin Yvon LabRam ARAMIS spectrometer with a 785 nm laser on GaOOH:HD(1/4). A. 2500 cm⁻¹ to 11,000 cm⁻¹ region. B. 6000 cm⁻¹ to 11,000 cm⁻¹ region. C. 8000 cm⁻¹ to 11,000 cm⁻¹ region. All of the novel lines matched those of either (i) the pure HD(1/4) J=0 to J′=3,4 rotational transition, (ii) the concerted transitions comprising the J=0 to J′=3 rotational transitions with the J=0 to J=1 spin rotational transition, or (iii) the double transition for final rotational quantum numbers J′ₚ=3; J′_{c}=1. Corresponding spin-orbital coupling and fluxon coupling were also observed with both the pure and concerted transition.

FIG. 39A is the FTIR spectra (200-8200 cm⁻¹) showing the effect of the application of a magnetic field on the FTIR spectrum (200 cm⁻¹ to 8000 cm⁻¹) recorded on GaOOH:H₂(1/4). The application of a magnetic field gave rise to an FTIR peak at 4164 cm⁻¹ which is an exact match to the concerted rotational and spin-orbital transition J=0 to J′=1, m=0.5. An intensity increase of a peak at 1801 cm⁻¹ was observed that matched the concerted rotational and spin-orbital transition J=0 to J′=0, m=−0.5, m_{Φ3/2}=2.5.

FIG. 39B is the FTIR spectra (4000-8500 cm⁻¹) recorded on GaOOH:H₂(1/4) showing addition peaks having the very high energies of 4899 cm⁻¹, 5318 cm⁻¹, and 6690 cm⁻¹ matching H₂(1/4) rotational and spin-orbital transitions.

FIG. 40A shows the Raman spectrum (3420 cm⁻¹ to 4850 cm⁻¹) obtained using a Horiba Jobin Yvon LabRam ARAMIS spectrometer with a 785 nm laser on solid web-like fibers (Fe web) prepared by wire detonation of an ultrahigh purity Fe wire in air maintained with 20 Torr of water vapor showing a periodic series of peaks assigned to fluxon linkages during the H₂ (1/4) concerted rotational and spin-orbital transition J=0 to J′=2, m=0.5, and m_{Φ3/2}=1.

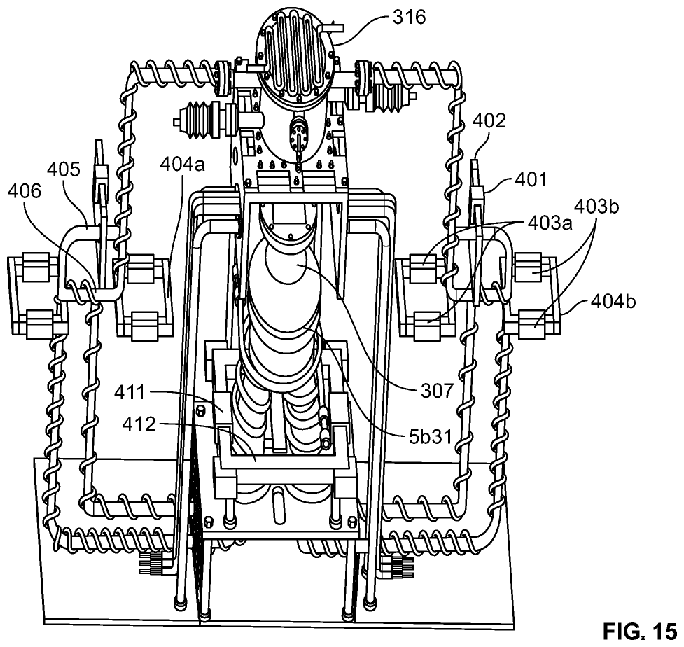

FIG. 40B is the Raman spectrum (3420 cm⁻¹ to 4850 cm⁻¹) obtained using a Horiba Jobin Yvon LabRam ARAMIS spectrometer with a 785 nm laser showing that all of the Raman peaks of FIG. 15 were eliminated by the acid treatment of the Fe-web:H₂(1/4) sample with HCl.

FIG. 41 is a schematic of a water bath calorimetric system used to measure operation of the power systems of the present disclosure.

### DETAILED DESCRIPTION

Disclosed herein are power generation systems and methods of power generation which convert the energy output from reactions involving atomic hydrogen into electrical and/or thermal energy. These reactions may involve catalyst systems which release energy from atomic hydrogen to form lower energy states wherein the electron shell is at a closer position relative to the nucleus. The released power is harnessed for power generation and additionally new hydrogen species and compounds are desired products. These energy states are predicted by classical physical laws and require a catalyst to accept energy from the hydrogen in order to undergo the corresponding energy-releasing transition.

A theory which may explain the exothermic reactions produced by the power generation systems of the present disclosure involves a nonradiative transfer of energy from atomic hydrogen to certain catalysts (e.g., nascent water). Classical physics gives closed-form solutions of the hydrogen atom, the hydride ion, the hydrogen molecular ion, and the hydrogen molecule and predicts corresponding species having fractional principal quantum numbers. Atomic hydrogen may undergo a catalytic reaction with certain species, including itself, that can accept energy in integer multiples of the potential energy of atomic hydrogen, m·27.2 eV, wherein m is an integer. The predicted reaction involves a resonant, nonradiative energy transfer from otherwise stable atomic hydrogen to the catalyst capable of accepting the energy. The product is H(1/p), fractional Rydberg states of atomic hydrogen called “hydrino atoms,” wherein n=1/2, 1/3, 1/4, . . . , 1/p (p<137 is an integer) replaces the well-known parameter n=integer in the Rydberg equation for hydrogen excited states. Each hydrino state also comprises an electron, a proton, and a photon, but the field contribution from the photon increases the binding energy rather than decreasing it corresponding to energy desorption rather than absorption. Since the potential energy of atomic hydrogen is 27.2 eV, m H atoms serve as a catalyst of m·27.2 eV for another m+1)th H atom [R. Mills, The Grand Unified Theory of Classical Physics; September 2016 Edition, posted at https://brilliantlightpower.com/book-download-and-streaming/(“Mills GUTCP”)]. For example, a H atom can act as a catalyst for another H by accepting 27.2 eV from it via through-space energy transfer such as by magnetic or induced electric dipole-dipole coupling to form an intermediate that decays with the emission of continuum bands with short wavelength cutoffs and energies of

$${m}^{2} \cdot 13.6 eV ( \frac{91.2}{{m}^{2}} nm ) .$$

In addition to atomic H, a molecule that accepts m·27.2 eV from atomic H with a decrease in the magnitude of the potential energy of the molecule by the same energy may also serve as a catalyst. The potential energy of H₂O is 81.6 eV. Then, by the same mechanism, the nascent H₂O molecule (not hydrogen bonded in solid, liquid, or gaseous state) formed by a thermodynamically favorable reduction of a metal oxide is predicted to serve as a catalyst to form H(1/4) with an energy release of 204 eV, comprising an 81.6 eV transfer to HOH and a release of continuum radiation with a cutoff at 10.1 nm (122.4 eV).

In the H-atom catalyst reaction involving a transition to the

$$H [ \frac{{a}_{H}}{p = m + 1} ]$$

state, m H atoms serve as a catalyst of m·27.2 eV for another (m+1)th H atom. Then, the reaction between m+1 hydrogen atoms whereby m atoms resonantly and nonradiatively accept m·27.2 eV from the (m+1)th hydrogen atom such that mH serves as the catalyst is given by

$$m \cdot 27.2 eV + mH + H \to {mH}_{fast}^{+} + {me}^{-} + H * [ \frac{{a}_{H}}{m + 1} ] + m \cdot 27.2 eV \qquad ( 1 )$$

$$H * [ \frac{{a}_{H}}{m + 1} ] \to H [ \frac{{a}_{H}}{m + 1} ] + [ {( m + 1 )}^{2} - {1}^{2} ] \cdot 13.6 eV - m \cdot 27.2 eV \qquad ( 2 )$$

$${mH}_{fast}^{+} + {me}^{-} \to mH + m \cdot 27.2 eV \qquad ( 3 )$$

And, the overall reaction is

$$H \to H [ \frac{{a}_{H}}{p = m + 1} ] + [ {( m + 1 )}^{2} - {1}^{2} ] \cdot 13.6 eV \qquad ( 4 )$$

The catalysis reaction (m=3) regarding the potential energy of nascent H₂O [R. Mills, The Grand Unified Theory of Classical Physics; September 2016 Edition, posted at https://brilliantlightpower.com/book-download-and-streaming/] is

$$81.6 eV + {H}_{2} O + H [ {a}_{H} ] \to 2 {H}_{fast}^{+} + {O}^{-} + {e}^{-} + H * [ \frac{{a}_{H}}{4} ] + 81.6 eV \qquad ( 5 )$$

$$H * [ \frac{{a}_{H}}{4} ] \to H [ \frac{{a}_{H}}{4} ] + 122.4 eV \qquad ( 6 )$$

$$2 {H}_{fast}^{+} + {O}^{-} + {e}^{-} \to {H}_{2} O + 81.6 eV \qquad ( 7 )$$

And, the overall reaction is

$$H [ {a}_{h} ] \to H [ \frac{{a}_{H}}{4} ] + 81.6 eV + 122.4 eV \qquad ( 8 )$$

After the energy transfer to the catalyst (Eqs. (1) and (5)), an intermediate

$$H * [ \frac{{a}_{H}}{m + 1} ]$$

is formed having the radius of the H atom and a central field of m+1 times the central field of a proton. The radius is predicted to decrease as the electron undergoes radial acceleration to a stable state having a radius of 1/(m+1) the radius of the uncatalyzed hydrogen atom, with the release of m²·13.6 eV of energy. The extreme-ultraviolet continuum radiation band due to the

$${H}^{*} [ \frac{{a}_{H}}{m + 1} ]$$

intermediate (e.g. Eq. (2) and Eq. (6)) is predicted to have a short wavelength cutoff and energy

$${E}_{( H \to H [ \frac{{a}_{H}}{p = m + 1} ] )}$$

given by

$${E}_{( H \to H [ \frac{{a}_{H}}{p = m + 1} ] )} = {m}^{2} \cdot 13.6 eV ; {λ}_{( H \to H [ \frac{{a}_{H}}{p = m + 1} ] )} = \frac{91.2}{{m}^{2}} nm$$

and extending to longer wavelengths than the corresponding cutoff. Here the extreme-ultraviolet continuum radiation band due to the decay of the H*[a_{H}/4] intermediate is predicted to have a short wavelength cutoff at E=m²·13.6=9·13.6=122.4 eV (10.1 nm) [where p=m+1=4 and m=3 in Eq. (9)] and extending to longer wavelengths. The continuum radiation band at 10.1 nm and going to longer wavelengths for the theoretically predicted transition of H to lower-energy, so called “hydrino” state H(1/4), was observed only arising from pulsed pinch gas discharges comprising some hydrogen. Another observation predicted by Eqs. (1) and (5) is the formation of fast, excited state H atoms from recombination of fast H⁺. The fast atoms give rise to broadened Balmer α emission. Greater than 50 eV Balmer α line broadening that reveals a population of extraordinarily high-kinetic-energy hydrogen atoms in certain mixed hydrogen plasmas is a well-established phenomenon wherein the cause is due to the energy released in the formation of hydrinos. Fast H was previously observed in continuum-emitting hydrogen pinch plasmas.

Additional catalyst and reactions to form hydrino are possible. Specific species (e.g. He⁺, Ar⁺, Sr⁺, K, Li, HCl, and NaH, OH, SH, SeH, nascent H₂O, nH (n=integer)) identifiable on the basis of their known electron energy levels are required to be present with atomic hydrogen to catalyze the process. The reaction involves a nonradiative energy transfer followed by q·13.6 eV continuum emission or q·13.6 eV transfer to H to form extraordinarily hot, excited-state H and a hydrogen atom that is lower in energy than unreacted atomic hydrogen that corresponds to a fractional principal quantum number. That is, in the formula for the principal energy levels of the hydrogen atom:

$${E}_{n} = - \frac{{e}^{2}}{{n}^{2} 8 {πε}_{o} {a}_{H}} = - \frac{13.5 \; 98 eV}{{n}^{2}} \qquad ( 10 )$$

$$n = 1 , 2 , 3 , \qquad ( 11 )$$

where a_{H} is the Bohr radius for the hydrogen atom (52.947 pm), e is the magnitude of the charge of the electron, and ε₀ is the vacuum permittivity, fractional quantum numbers:

$$n = 1 , \frac{1}{2} , \frac{1}{3} , \frac{1}{4} , … , \frac{1}{p} ; where p \leq 137 is an integer \qquad ( 12 )$$

replace the well known parameter n=integer in the Rydberg equation for hydrogen excited states and represent lower-energy-state hydrogen atoms called “hydrinos.” The n=1 state of hydrogen and the

$$n = \frac{1}{integer}$$

states of hydrogen are nonradiative, but a transition between two nonradiative states, say n=1 to n=½, is possible via a nonradiative energy transfer. Hydrogen is a special case of the stable states given by Eqs. (10) and (12) wherein the corresponding radius of the hydrogen or hydrino atom is given by

$$r = \frac{{a}_{H}}{p} , \qquad ( 13 )$$

where p=1,2,3, . . . . In order to conserve energy, energy must be transferred from the hydrogen atom to the catalyst in units of an integer of the potential energy of the hydrogen atom in the normal n=1 state, and the radius transitions to

$$\frac{{a}_{H}}{m + p} .$$

Hydrinos are formed by reacting an ordinary hydrogen atom with a suitable catalyst having a net enthalpy of reaction of

m·27.2 eV (14)

where m is an integer. It is believed that the rate of catalysis is increased as the net enthalpy of reaction is more closely matched to m·27.2 eV. It has been found that catalysts having a net enthalpy of reaction within ±10%, preferably ±5%, of m·27.2 eV are suitable for most applications.

The catalyst reactions involve two steps of energy release: a nonradiative energy transfer to the catalyst followed by additional energy release as the radius decreases to the corresponding stable final state. Thus, the general reaction is given by

$$m \cdot 27.2 eV + {Cat}^{q +} + H [ \frac{{a}_{H}}{p} ] \to {Cat}^{( q + r ) +} + {re}^{-} + H ⋆ [ \frac{{a}_{H}}{( m + p )} ] + m \cdot 27.2 eV \qquad ( 15 )$$

$$H ⋆ [ \frac{{a}_{H}}{( m + p )} ] \to H [ \frac{{a}_{H}}{( m + p )} ] + [ {( p + m )}^{2} - {p}^{2} ] \cdot 13.6 eV - m \cdot 27.2 eV \qquad ( 16 )$$

$${Cat}^{( q + r ) +} + {re}^{-} \to {Cat}^{q +} + m \cdot 27.2 eV and \qquad ( 17 )$$

the overall reaction is

$$H [ \frac{{a}_{H}}{p} ] \to H [ \frac{{a}_{H}}{( m + p )} ] + [ {( p + m )}^{2} - {p}^{2} ] \cdot 13.6 eV \qquad ( 18 )$$

q, r, m, and p are integers.

$$H ⋆ [ \frac{{a}_{H}}{( m + p )} ]$$

has the radius of the hydrogen atom (corresponding to the 1 in the denominator) and a central field equivalent to (m+p) times that of a proton, and

$$H [ \frac{{a}_{H}}{( m + p )} ]$$

is the corresponding stable state with the radius of

$$\frac{1}{( m + p )}$$

that of H.

The catalyst product, H(1/p), may also react with an electron to form a hydrino hydride ion H⁻(1/p), or two H(1/p) may react to form the corresponding molecular hydrino H₂(1/p). Specifically, the catalyst product, H(1/p), may also react with an electron to form a novel hydride ion H⁻(1/p) with a binding energy E_{B}:

$${E}_{B} = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) \qquad ( 19 )$$

where p=integer>1, s=½, ℏ is Planck's constant bar, μₒ is the permeability of vacuum, mₑ is the mass of the electron, μₑ is the reduced electron mass given by

$${μ}_{e} = \frac{{m}_{e} {m}_{p}}{\frac{{m}_{e}}{\sqrt{\frac{3}{4}}} + {m}_{p}}$$

where mₚ is the mass of the proton, aₒ is the Bohr radius, and the ionic radius is

$${r}_{1} = \frac{{a}_{0}}{p} ( 1 + \sqrt{s ( s + 1 )} ) .$$

From Eq. (19), the calculated ionization energy of the hydride ion is 0.75418 eV, and the experimental value is 6082.99±0.15 cm⁻¹ (0.75418 eV). The binding energies of hydrino hydride ions may be measured by X-ray photoelectron spectroscopy (XPS).

Upfield-shifted NMR peaks are direct evidence of the existence of lower-energy state hydrogen with a reduced radius relative to ordinary hydride ion and having an increase in diamagnetic shielding of the proton. The shift is given by the sum of the contributions of the diamagnetism of the two electrons and the photon field of magnitude p (Mills GUTCP Eq. (7.87)):

$$\frac{Δ {B}_{T}}{B} = - {μ}_{0} \frac{{pe}^{2}}{12 {m}_{e} {a}_{0} ( 1 + \sqrt{s ( s + 1 )} )} ( 1 + p {α}^{2} ) = - ( p29 \text{.9} + {p}^{2} 1.59 \times {10}^{- 3} ) ppm \qquad ( 20 )$$

where the first term applies to H⁻ with p=1 and p=integer>1 for H⁻(1/p) and α is the fine structure constant. The predicted hydrino hydride peaks are extraordinarily upfield shifted relative to ordinary hydride ion. In an embodiment, the peaks are upfield of TMS. The NMR shift relative to TMS may be greater than that known for at least one of ordinary H⁻, H, H₂, or H⁺ alone or comprising a compound. The shift may be greater than at least one of 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, −30, −31, −32, −33, −34, −35, −36, −37, −38, −39, and −40 ppm. The range of the absolute shift relative to a bare proton, wherein the shift of TMS is about −31.5 relative to a bare proton, may be −(p29.9+p²2.74) ppm (Eq. (20)) within a range of about at least one of ±5 ppm, ±10 ppm, ±20 ppm, ±30 ppm, ±40 ppm, ±50 ppm, ±60 ppm, ±70 ppm, ±80 ppm, ±90 ppm, and ±100 ppm. The range of the absolute shift relative to a bare proton may be −(p29.9+p²1.59×10⁻³) ppm (Eq. (20)) within a range of about at least one of about 0.1% to 99%, 1% to 50%, and 1% to 10%. In another embodiment, the presence of a hydrino species such as a hydrino atom, hydride ion, or molecule in a solid matrix such as a matrix of a hydroxide such as NaOH or KOH causes the matrix protons to shift upfield. The matrix protons such as those of NaOH or KOH may exchange. In an embodiment, the shift may cause the matrix peak to be in the range of about −0.1 ppm to −5 ppm relative to TMS. The NMR determination may comprise magic angle spinning ¹H nuclear magnetic resonance spectroscopy (MAS ¹H NMR)

H(1/p) may react with a proton and two H(1/p) may react to form H₂(1/p)⁺ and H₂(1/p), respectively. The hydrogen molecular ion and molecular charge and current density functions, bond distances, and energies were solved from the Laplacian in ellipsoidal coordinates with the constraint of nonradiation.

$$( η - ζ ) {R}_{ξ} \frac{\partial }{\partial ξ} ( {R}_{ξ} \frac{\partial ϕ}{\partial ξ} ) + ( ζ - ξ ) {R}_{η} \frac{\partial }{\partial η} ( {R}_{η} \frac{\partial ϕ}{\partial η} ) + ( ξ - η ) {R}_{ζ} \frac{\partial }{\partial ζ} ( {R}_{ζ} \frac{\partial ϕ}{\partial ζ} ) = 0 \qquad ( 21 )$$

The total energy E_{T} of the hydrogen molecular ion having a central field of +pe at each focus of the prolate spheroid molecular orbital is

$${E}_{T} = - {p}^{2} \{ \frac{{e}^{2}}{8 {πε}_{o} {a}_{H}} ( 4 ln 3 - 1 - 2 ln 3 ) [ 1 + p \sqrt{\frac{2 ℏ \sqrt{\frac{2 {e}^{2}}{\frac{4 {{πε}_{o} ( 2 {a}_{H} )}^{3}}{{m}_{e}}}}}{{m}_{e} {c}^{2}}} ] - \frac{1}{2} ℏ \sqrt{\frac{\frac{{pe}^{2}}{4 {{πε}_{o} ( \frac{2 {a}_{H}}{p} )}^{3}} - \frac{{pe}^{2}}{8 {{πε}_{o} ( \frac{3 {a}_{H}}{p} )}^{3}}}{μ}} \} = - {p}^{2} 16.13392 eV - {p}^{3} 0.118755 eV \qquad ( 22 )$$

where p is an integer, c is the speed of light in vacuum, and μ is the reduced nuclear mass. The total energy of the hydrogen molecule having a central field of +pe at each focus of the prolate spheroid molecular orbital is

$${E}_{T} = - {p}^{2} \{ \frac{{e}^{2}}{8 {πε}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] [ 1 + p \sqrt{\frac{2 ℏ \sqrt{\frac{\frac{{e}^{2}}{4 {πε}_{o} {a}_{0}^{3}}}{{m}_{e}}}}{{m}_{e} {c}^{2}}} ] - \frac{1}{2} ℏ \sqrt{\frac{\frac{{pe}^{2}}{8 {{πε}_{o} ( \frac{{a}_{0}}{p} )}^{3}} - \frac{{pe}^{2}}{8 {{πε}_{o} ( \frac{( 1 + \frac{1}{\sqrt{2}} ) {a}_{0}}{p} )}^{3}}}{μ}} \} = - {p}^{2} 31.351 eV - {p}^{3} 0.326469 eV \qquad ( 23 )$$

The bond dissociation energy, E_{D}, of the hydrogen molecule H₂(1/p) is the difference between the total energy of the corresponding hydrogen atoms and E_{T}

E_{D}=E(2H(1/p))−E_{T} (24)

where

E(2H(1/p))=−p²27.20 eV (25)

Eₙ is given by Eqs. (23-25):

$$\begin{matrix}{E}_{p} = - {p}^{2} 27.2 eV - {E}_{r} \\ = - {p}^{2} 27.2 eV - ( - {p}^{2} 31.351 eV - {p}^{3} 0.326469 eV ) \\ = {p}^{2} 4.151 eV + {p}^{3} 0.326469 eV\end{matrix} \qquad ( 26 )$$

H₂(1/p) may be identified by X-ray photoelectron spectroscopy (XPS) wherein the ionization product in addition to the ionized electron may be at least one of the possibilities such as those comprising two protons and an electron, a hydrogen (H) atom, a hydrino atom, a molecular ion, hydrogen molecular ion, and H₂(1/p)⁺ wherein the energies may be shifted by the matrix.

The NMR of catalysis-product gas provides a definitive test of the theoretically predicted chemical shift of H₂ (1/p). In general, the ¹H NMR resonance of H₂(1/p) is predicted to be upfield from that of H₂ due to the fractional radius in elliptic coordinates wherein the electrons are significantly closer to the nuclei. The predicted shift,

$$\frac{Δ {B}_{T}}{B} ,$$

for H₂ (1/p) is given by the sum of the contributions of the diamagnetism of the two electrons and the photon field of magnitude p (Mills GUTCP Eqs. (11.415-11.416)):

$$\frac{Δ {B}_{T}}{B} = - {μ}_{0} ( 4 - \sqrt{2} ln \frac{\sqrt{2} + 1}{\sqrt{2} - 1} ) \frac{{pe}^{2}}{36 {a}_{0} {m}_{e}} ( 1 + p {α}^{2} ) \qquad ( 27 )$$

$$\frac{Δ {B}_{T}}{B} = - ( p 28.01 + {p}^{2} 1.49 \times {10}^{- 3} ) ppm \qquad ( 28 )$$

where the first term applies to H₂ with p=1 and p=integer>1 for H₂ (1/p). The experimental absolute H₂ gas-phase resonance shift of −28.0 ppm is in excellent agreement with the predicted absolute gas-phase shift of −28.01 ppm (Eq. (28)). The predicted molecular hydrino peaks are extraordinarily upfield shifted relative to ordinary H₂. In an embodiment, the peaks are upfield of TMS. The NMR shift relative to TMS may be greater than that known for at least one of ordinary H⁻, H, H₂, or H⁺ alone or comprising a compound. The shift may be greater than at least one of 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, −30, −31, −32, −33, −34, −35, −36, −37, −38, −39, and −40 ppm. The range of the absolute shift relative to a bare proton, wherein the shift of TMS is about −31.5 ppm relative to a bare proton, may be −(p28.01+p²2.56) ppm (Eq. (28)) within a range of about at least one of ±5 ppm, ±10 ppm, ±20 ppm, ±30 ppm, ±40 ppm, ±50 ppm, ±60 ppm, ±70 ppm, ±80 ppm, ±90 ppm, and ±100 ppm. The range of the absolute shift relative to a bare proton may be −(p28.01+p²1.49×10⁻³) ppm (Eq. (28)) within a range of about at least one of about 0.1% to 99%, 1% to 50%, and 1% to 10%.

The vibrational energies, E_{vib}, for the v=0 to v=1 transition of hydrogen-type molecules H₂(1/p) are

E_{vib}=p²0.515902 eV (29)

where p is an integer.

The rotational energies, Eᵣₒₜ, for the J to J+1 transition of hydrogen-type molecules H₂(1/p) are

$${E}_{rot} = {E}_{J + 1} - {E}_{J} = \frac{{ℏ}^{2}}{I} [ J + 1 ] = {p}^{2} ( J + 1 ) 0.01509 eV \qquad ( 30 )$$

where p is an integer and I is the moment of inertia. Ro-vibrational emission of H₂(1/4) was observed on e-beam excited molecules in gases and trapped in solid matrix.

The p² dependence of the rotational energies results from an inverse p dependence of the internuclear distance and the corresponding impact on the moment of inertia I. The predicted internuclear distance 2c′ for H₂(1/p) is

$$2 {c}^{′} = \frac{{a}_{o} \sqrt{2}}{p} \qquad ( 31 )$$

At least one of the rotational and vibration energies of H₂(1/p) may be measured by at least one of electron-beam excitation emission spectroscopy, Raman spectroscopy, and Fourier transform infrared (FTIR) spectroscopy. H₂(1/p) may be trapped in a matrix for measurement such as in at least one of MOH, MX, and M₂CO₃ (M=alkali; X=halide) matrix.

In an embodiment, the molecular hydrino product is observed as an inverse Raman effect (IRE) peak at about 1950 cm⁻¹. The peak is enhanced by using a conductive material comprising roughness features or particle size comparable to that of the Raman laser wavelength that supports a Surface Enhanced Raman Scattering (SERS) to show the IRE peak.

I. Catalysts

In the present disclosure the terms such as hydrino reaction, H catalysis, H catalysis reaction, catalysis when referring to hydrogen, the reaction of hydrogen to form hydrinos, and hydrino formation reaction all refer to the reaction such as that of Eqs. (15-18) of a catalyst defined by Eq. (14) with atomic H to form states of hydrogen having energy levels given by Eqs. (10) and (12). The corresponding terms such as hydrino reactants, hydrino reaction mixture, catalyst mixture, reactants for hydrino formation, reactants that produce or form lower-energy state hydrogen or hydrinos are also used interchangeably when referring to the reaction mixture that performs the catalysis of H to H states or hydrino states having energy levels given by Eqs. (10) and (12).

The catalytic lower-energy hydrogen transitions of the present disclosure require a catalyst that may be in the form of an endothermic chemical reaction of an integer m of the potential energy of uncatalyzed atomic hydrogen, 27.2 eV, that accepts the energy from atomic H to cause the transition. The endothermic catalyst reaction may be the ionization of one or more electrons from a species such as an atom or ion (e.g. m=3 for Li→Li²⁺) and may further comprise the concerted reaction of a bond cleavage with ionization of one or more electrons from one or more of the partners of the initial bond (e.g. m=2 for NaH→Na²⁺+H). He⁺ fulfills the catalyst criterion—a chemical or physical process with an enthalpy change equal to an integer multiple of 27.2 eV since it ionizes at 54417 eV, which is 2·27.2 eV. An integer number of hydrogen atoms may also serve as the catalyst of an integer multiple of 27.2 eV enthalpy. catalyst is capable of accepting energy from atomic hydrogen in integer units of one of about 27.2 eV±0.5 eV and

$$\frac{27.2}{2} eV \pm 0.5 eV .$$

In an embodiment, the catalyst comprises an atom or ion M wherein the ionization of t electrons from the atom or ion M each to a continuum energy level is such that the sum of ionization energies of the t electrons is approximately one of m·27.2 eV and

$$m \cdot \frac{27.2}{2} eV$$

where m is an integer.

In an embodiment, the catalyst comprises a diatomic molecule MH wherein the breakage of the M-H bond plus the ionization of t electrons from the atom M each to a continuum energy level is such that the sum of the bond energy and ionization energies of the t electrons is approximately one of m·27.2 eV and

$$m \cdot \frac{27.2}{2} eV$$

where m is an integer.

In an embodiment, the catalyst comprises atoms, ions, and/or molecules chosen from molecules of AlH, AsH, BaH, BiH, CdH, ClH, CoH, GeH, InH, NaH, NbH, OH, RhH, RuH, SH, SbH, SeH, SiH, SnH, SrH, TlH, C₂, N₂, O₂, CO₂, NO₂, and NO₃ and atoms or ions of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, Kr, 2K⁺, He⁺, Ti²⁺, Na⁺, Rb⁺, Sr⁺, Fe³⁺, Mo²⁺, Mo⁴⁺, In³⁺, He⁺, Ar⁺, Xe⁺, Ar²⁺ and H⁺, and Ne⁺ and H⁺.

In other embodiments, MH⁻ type hydrogen catalysts to produce hydrinos provided by the transfer of an electron to an acceptor A, the breakage of the M-H bond plus the ionization of t electrons from the atom M each to a continuum energy level such that the sum of the electron transfer energy comprising the difference of electron affinity (EA) of MH and A, M-H bond energy, and ionization energies of the t electrons from M is approximately m·27.2 eV where m is an integer. MH⁻ type hydrogen catalysts capable of providing a net enthalpy of reaction of approximately m·27.2 eV are OH⁻, SiH⁻, CoH⁻, NiH⁺, and SeH⁻

In other embodiments, MH⁺ type hydrogen catalysts to produce hydrinos are provided by the transfer of an electron from a donor A which may be negatively charged, the breakage of the M-H bond, and the ionization of t electrons from the atom M each to a continuum energy level such that the sum of the electron transfer energy comprising the difference of ionization energies of MH and A, bond M-H energy, and ionization energies of the t electrons from M is approximately m·27.2 eV where m is an integer.

In an embodiment, at least one of a molecule or positively or negatively charged molecular ion serves as a catalyst that accepts about m·27.2 eV from atomic H with a decrease in the magnitude of the potential energy of the molecule or positively or negatively charged molecular ion by about m·27.2 eV. Exemplary catalysts are H₂O, OH, amide group NH₂, and H₂S.

O₂ may serve as a catalyst or a source of a catalyst. The bond energy of the oxygen molecule is 5.165 eV, and the first, second, and third ionization energies of an oxygen atom are 1161806 eV, 35.11730 eV, and 54.9355 eV, respectively. The reactions O₂→O+O²⁺, O₂→O+O³⁺, and 2O→2O⁺ provide a net enthalpy of about 2, 4, and 1 times E_{ℏ}, respectively, and comprise catalyst reactions to form hydrino by accepting these energies from H to cause the formation of hydrinos.

II. Hydrinos

A hydrogen atom having a binding energy given by

$${E}_{B} = \frac{13.6 eV}{{( 1 / p )}^{2}}$$

where p is an integer greater than 1, preferably from 2 to 137, is the product of the H catalysis reaction of the present disclosure. The binding energy of an atom, ion, or molecule, also known as the ionization energy, is the energy required to remove one electron from the atom, ion or molecule. A hydrogen atom having the binding energy given in Eqs. (10) and (12) is hereafter referred to as a “hydrino atom” or “hydrino.” The designation for a hydrino of radius

$$\frac{{a}_{H}}{p} ,$$

where a_{H} is the radius of an ordinary hydrogen atom and p is an integer, is

$$H [ \frac{{a}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

According to the present disclosure, a hydrino hydride ion (H⁻) having a binding energy according to Eq. (19) that is greater than the binding of ordinary hydride ion (about 0.75 eV) for p=2 up to 23, and less for p=24 (H⁻) is provided. For p=2 to p=24 of Eq. (19), the hydride ion binding energies are respectively 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV. Exemplary compositions comprising the novel hydride ion are also provided herein.

Exemplary compounds are also provided comprising one or more hydrino hydride ions and one or more other elements. Such a compound is referred to as a “hydrino hydride compound.”

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule, 15.3 eV (“ordinary hydrogen molecule”); (d) hydrogen molecular ion, 16.3 eV (“ordinary hydrogen molecular ion”); and (e) H₃⁺, 22.6 eV (“ordinary trihydrogen molecular ion”). Herein, with reference to forms of hydrogen, “normal” and “ordinary” are synonymous.

According to a further embodiment of the present disclosure, a compound is provided comprising at least one increased binding energy hydrogen species such as (a) a hydrogen atom having a binding energy of about

$$\frac{13.6 eV}{{( \frac{1}{p} )}^{2}} ,$$

such as within a range of about 0.9 to 1.1 times

$$\frac{13.6 eV}{{( \frac{1}{p} )}^{2}}$$

where p is an integer from 2 to 137; (b) a hydride ion (H⁻) having a binding energy of about

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) ,$$

such as within a range of about 0.9 to 1.1 times

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$

where p is an integer from 2 to 24; (c) H₄⁺(1/p); (d) a trihydrino molecular ion, H₃⁺(1/p), having a binding energy of about

$$\frac{22.6}{{( \frac{1}{p} )}^{2}} eV$$

such as within a range of about 0.9 to 1.1 times

$$\frac{22.6}{{( \frac{1}{p} )}^{2}} eV$$

where p is an integer from 2 to 137; (e) a dihydrino having a binding energy of about

$$\frac{15.3}{{( \frac{1}{p} )}^{2}} eV$$

such as within a range of about 0.9 to 1.1 times

$$\frac{15.3}{{( \frac{1}{p} )}^{2}} eV$$

where p is an integer from 2 to 137; (f) a dihydrino molecular ion with a binding energy of about

$$\frac{16.3}{{( \frac{1}{p} )}^{2}} eV$$

such as within a range of about 0.9 to 1.1 times

$$\frac{15.3}{{( \frac{1}{p} )}^{2}} eV$$

where p is an integer, preferably an integer from 2 to 137.

According to a further embodiment of the present disclosure, a compound is provided comprising at least one increased binding energy hydrogen species such as (a) a dihydrino molecular ion having a total energy of about

$${E}_{T} = - {p}^{2} \{ \frac{{e}^{2}}{8 {πε}_{o} {a}_{H}} ( 4 ln 3 - 1 - 2 ln 3 ) [ 1 + p \sqrt{\frac{2 ℏ \sqrt{\frac{\frac{2 {e}^{2}}{4 {{πε}_{o} ( 2 {a}_{H} )}^{3}}}{{m}_{e}}}}{{m}_{e} {c}^{2}}} ] - \frac{1}{2} ℏ \sqrt{\frac{\frac{{pe}^{2}}{4 {{πε}_{o} ( \frac{2 {a}_{H}}{p} )}^{3}} - \frac{{pe}^{2}}{8 {{πε}_{o} ( \frac{3 {a}_{H}}{p} )}^{3}}}{μ}} \} = - {p}^{2} 16.13392 eV - {p}^{3} 0.118755 eV$$

such as within a range of about 0.9 to 1.1 times

$${E}_{T} = - {p}^{2} \{ \frac{{e}^{2}}{8 {πε}_{o} {a}_{H}} ( 4 ln 3 - 1 - 2 ln 3 ) [ 1 + p \sqrt{\frac{2 ℏ \sqrt{\frac{\frac{2 {e}^{2}}{4 {{πε}_{o} ( 2 {a}_{H} )}^{3}}}{{m}_{e}}}}{{m}_{e} {c}^{2}}} ] - \frac{1}{2} ℏ \sqrt{\frac{\frac{{pe}^{2}}{4 {{πε}_{o} ( \frac{2 {a}_{H}}{p} )}^{3}} - \frac{{pe}^{2}}{8 {{πε}_{o} ( \frac{3 {a}_{H}}{p} )}^{3}}}{μ}} \} = - {p}^{2} 16.13392 eV - {p}^{3} 0.118755 eV$$

where p is an integer, ℏ is Planck's constant bar, mₑ is the mass of the electron, c is the speed of light in vacuum, and μ is the reduced nuclear mass, and (b) a dihydrino molecule having a total energy of about

$${E}_{T} = - {p}^{2} \{ \frac{{e}^{2}}{8 {πε}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] [ 1 + p \sqrt{\frac{2 ℏ \sqrt{\frac{\frac{2 {e}^{2}}{4 {{πε}_{o} ( 2 {a}_{H} )}^{3}}}{{m}_{e}}}}{{m}_{e} {c}^{2}}} ] - \frac{1}{2} ℏ \sqrt{\frac{\frac{{pe}^{2}}{8 {{πε}_{o} ( \frac{{a}_{0}}{p} )}^{3}} - \frac{{pe}^{2}}{8 {{πε}_{o} ( \frac{( 1 + \frac{1}{\sqrt{2}} ) {a}_{0}}{p} )}^{3}}}{μ}} \} = - {p}^{2} 31.351 eV - {p}^{3} 0.326469 eV$$

such as within a range of about 0.9 to 1.1 times

$${E}_{T} = - {p}^{2} \{ \frac{{e}^{2}}{8 {πε}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] [ 1 + p \sqrt{\frac{2 ℏ \sqrt{\frac{\frac{2 {e}^{2}}{4 {{πε}_{o} ( 2 {a}_{H} )}^{3}}}{{m}_{e}}}}{{m}_{e} {c}^{2}}} ] - \frac{1}{2} ℏ \sqrt{\frac{\frac{{pe}^{2}}{8 {{πε}_{o} ( \frac{{a}_{0}}{p} )}^{3}} - \frac{{pe}^{2}}{8 {{πε}_{o} ( \frac{( 1 + \frac{1}{\sqrt{2}} ) {a}_{0}}{p} )}^{3}}}{μ}} \} \\ where p is an = - {p}^{2} 31.351 eV - {p}^{3} 0.326469 eV$$

integer and aₒ is the Bohr radius.

According to one embodiment of the present disclosure wherein the compound comprises a negatively charged increased binding energy hydrogen species, the compound further comprises one or more cations, such as a proton, ordinary H₂⁺, or ordinary H₃⁺.

A method is provided herein for preparing compounds comprising at least one hydrino hydride ion. Such compounds are hereinafter referred to as “hydrino hydride compounds.” The method comprises reacting atomic hydrogen with a catalyst having a net enthalpy of reaction of about

$$\frac{m}{2} \cdot 27 e V ,$$

where m is an integer greater than 1, preferably an integer less than 400, to produce an increased binding energy hydrogen atom having a binding energy of about

$$\frac{13.6 eV}{{( \frac{1}{p} )}^{2}}$$

where p is an integer, preferably an integer from 2 to 137. A further product of the catalysis is energy. The increased binding energy hydrogen atom can be reacted with an electron source, to produce an increased binding energy hydride ion. The increased binding energy hydride ion can be reacted with one or more cations to produce a compound comprising at least one increased binding energy hydride ion.

In an embodiment, at least one of very high power and energy may be achieved by the hydrogen undergoing transitions to hydrinos of high p values in Eq. (18) in a process herein referred to as disproportionation as given in Mills GUTCP Chp. 5 which is incorporated by reference. Hydrogen atoms H(1/p) p=1, 2, 3, . . . 137 can undergo further transitions to lower-energy states given by Eqs. (10) and (12) wherein the transition of one atom is catalyzed by a second that resonantly and nonradiatively accepts m·27.2 eV with a concomitant opposite change in its potential energy. The overall general equation for the transition of H(1/p) to H(1/(p+m)) induced by a resonance transfer of m·27.2 eV to H(1/p′) given by Eq. (32) is represented by

H(1/p′)+H(1/p)→H+H(1/(p+m))+[2 pm+m²−p′²+1]·13.6 eV (32)

The EUV light from the hydrino process may dissociate the dihydrino molecules and the resulting hydrino atoms may serve as catalysts to transition to lower energy states. An exemplary reaction comprises the catalysis H to H(1/17) by H(1/4) wherein H(1/4) may be a reaction product of the catalysis of another H by HOH. Disproportionation reactions of hydrinos are predicted to given rise to features in the X-ray region. As shown by Eqs. (5-8) the reaction product of HOH catalyst is

$$H [ \frac{{a}_{H}}{4} ] .$$

Consider a likely transition reaction in hydrogen clouds containing H₂O gas wherein the first hydrogen-type atom

$$H [ \frac{{a}_{H}}{p} ]$$

is an H atom and the second acceptor hydrogen-type atom

$$H [ \frac{{a}_{H}}{{p}^{′}} ]$$

serving as a catalyst is

$$H [ \frac{{a}_{H}}{4} ] .$$

Since the potential energy of

$$H [ \frac{{a}_{H}}{4} ]$$

is 4²·27.2 eV=16·27.2 eV=435.2 eV, the transition reaction is represented by

$$16 \cdot 27.2 eV + H [ \frac{{a}_{H}}{4} ] + H [ \frac{{a}_{H}}{1} ] \to {H}_{fast}^{+} + {e}^{-} + H * [ \frac{{a}_{H}}{17} ] + 16 \cdot 27.2 eV \qquad ( 33 )$$

$$H * [ \frac{{a}_{H}}{17} ] \to H [ \frac{{a}_{H}}{17} ] + 3481.6 eV \qquad ( 34 )$$

$${H}_{fast}^{+} + {e}^{-} \to H [ \frac{{a}_{H}}{1} ] + 231.2 eV \qquad ( 35 )$$

And, the overall reaction is

$$H [ \frac{{a}_{H}}{4} ] + H [ \frac{{a}_{H}}{1} ] \to H [ \frac{{a}_{H}}{1} ] + H [ \frac{{a}_{H}}{17} ] + 3712.8 eV \qquad ( 36 )$$

The extreme-ultraviolet continuum radiation band due to the

$$H * [ \frac{{a}_{H}}{p + m} ]$$

intermediate (e.g. Eq. (16) and Eq. (34)) is predicted to have a short wavelength cutoff and energy

$${E}_{{( H \to H [ \frac{{a}_{H}}{p + m} ] )}^{}}$$

given by

$$\begin{matrix}{E}_{( H \to H [ \frac{{a}_{H}}{p + m} ] )} = [ {( p + m )}^{2} - {p}^{2} ] \cdot 13.6 eV - m \cdot 27.2 eV \\ {λ}_{( H \to H [ \frac{{a}_{H}}{p + m} ] )} = \frac{91.2}{[ {( p + m )}^{2} - {p}^{2} ] \cdot 13.6 eV - m \cdot 27.2 eV} nm\end{matrix} \qquad ( 37 )$$

and extending to longer wavelengths than the corresponding cutoff. Here the extreme-ultraviolet continuum radiation band due to the decay of the

$$H * [ \frac{{a}_{H}}{17} ]$$

intermediate is predicted to have a short wavelength cutoff at E=3481.6 eV; 0.35625 nm and extending to longer wavelengths. A broad X-ray peak with a 3.48 keV cutoff was observed in the Perseus Cluster by NASA's Chandra X-ray Observatory and by the XMM-Newton [E. Bulbul, M. Markevitch, A. Foster, R. K. Smith, M. Loewenstein, S. W. Randall, “Detection of an unidentified emission line in the stacked X-Ray spectrum of galaxy clusters,” The Astrophysical Journal, Volume 789, Number 1, (2014); A. Boyarsky, O. Ruchayskiy, D. Iakubovskyi, J. Franse, “An unidentified line in X-ray spectra of the Andromeda galaxy and Perseus galaxy cluster,” (2014), arXiv:1402.4119 [astro-ph.CO]] that has no match to any known atomic transition. The 3.48 keV feature assigned to dark matter of unknown identity by BulBul et al. matches the

$$H [ \frac{{a}_{H}}{4} ] + H [ \frac{{a}_{H}}{1} ] \to H [ \frac{{a}_{H}}{17} ]$$

transition and further confirms hydrinos as the identity of dark matter.

The novel hydrogen compositions of matter can comprise:

(a) at least one neutral, positive, or negative hydrogen species (hereinafter “increased binding energy hydrogen species”) having a binding energy

(i) greater than the binding energy of the corresponding ordinary hydrogen species, or

(ii) greater than the binding energy of any hydrogen species for which the corresponding ordinary hydrogen species is unstable or is not observed because the ordinary hydrogen species' binding energy is less than thermal energies at ambient conditions (standard temperature and pressure, STP), or is negative; and

(b) at least one other element. Typically, the hydrogen products described herein are increased binding energy hydrogen species.

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged such that the other element provides the balancing charge to form a neutral compound. The former group of compounds is characterized by molecular and coordinate bonding; the latter group is characterized by ionic bonding.

Also provided are novel compounds and molecular ions comprising

(a) at least one neutral, positive, or negative hydrogen species (hereinafter “increased binding energy hydrogen species”) having a total energy

(i) greater than the total energy of the corresponding ordinary hydrogen species, or

(ii) greater than the total energy of any hydrogen species for which the corresponding ordinary hydrogen species is unstable or is not observed because the ordinary hydrogen species' total energy is less than thermal energies at ambient conditions, or is negative; and

(b) at least one other element.

The total energy of the hydrogen species is the sum of the energies to remove all of the electrons from the hydrogen species. The hydrogen species according to the present disclosure has a total energy greater than the total energy of the corresponding ordinary hydrogen species. The hydrogen species having an increased total energy according to the present disclosure is also referred to as an “increased binding energy hydrogen species” even though some embodiments of the hydrogen species having an increased total energy may have a first electron binding energy less that the first electron binding energy of the corresponding ordinary hydrogen species. For example, the hydride ion of Eq. (19) for p=24 has a first binding energy that is less than the first binding energy of ordinary hydride ion, while the total energy of the hydride ion of Eq. (19) for p=24 is much greater than the total energy of the corresponding ordinary hydride ion.

Also provided herein are novel compounds and molecular ions comprising

(a) a plurality of neutral, positive, or negative hydrogen species (hereinafter “increased binding energy hydrogen species”) having a binding energy

(i) greater than the binding energy of the corresponding ordinary hydrogen species, or

(ii) greater than the binding energy of any hydrogen species for which the corresponding ordinary hydrogen species is unstable or is not observed because the ordinary hydrogen species' binding energy is less than thermal energies at ambient conditions or is negative; and

(b) optionally one other element. The compounds of the present disclosure are hereinafter referred to as “increased binding energy hydrogen compounds.”

The increased binding energy hydrogen species can be formed by reacting one or more hydrino atoms with one or more of an electron, hydrino atom, a compound containing at least one of said increased binding energy hydrogen species, and at least one other atom, molecule, or ion other than an increased binding energy hydrogen species.

Also provided are novel compounds and molecular ions comprising

(a) a plurality of neutral, positive, or negative hydrogen species (hereinafter “increased binding energy hydrogen species”) having a total energy

(i) greater than the total energy of ordinary molecular hydrogen, or

(ii) greater than the total energy of any hydrogen species for which the corresponding ordinary hydrogen species is unstable or is not observed because the ordinary hydrogen species' total energy is less than thermal energies at ambient conditions or is negative; and

(b) optionally one other element. The compounds of the present disclosure are hereinafter referred to as “increased binding energy hydrogen compounds.”

In an embodiment, a compound is provided comprising at least one increased binding energy hydrogen species chosen from (a) hydride ion having a binding energy according to Eq. (19) that is greater than the binding of ordinary hydride ion (about 0.8 eV) for p=2 up to 23, and less for p=24 (“increased binding energy hydride ion” or “hydrino hydride ion”); (b) hydrogen atom having a binding energy greater than the binding energy of ordinary hydrogen atom (about 13.6 eV) (“increased binding energy hydrogen atom” or “hydrino”); (c) hydrogen molecule having a first binding energy greater than about 15.3 eV (“increased binding energy hydrogen molecule” or “dihydrino”); and (d) molecular hydrogen ion having a binding energy greater than about 16.3 eV (“increased binding energy molecular hydrogen ion” or “dihydrino molecular ion”). In the disclosure, increased binding energy hydrogen species and compounds is also referred to as lower-energy hydrogen species and compounds. Hydrinos comprise an increased binding energy hydrogen species or equivalently a lower-energy hydrogen species.

III. Chemical Reactor

The present disclosure is also directed to other reactors for producing increased binding energy hydrogen species and compounds of the present disclosure, such as dihydrino molecules and hydrino hydride compounds. Further products of the catalysis are power and optionally plasma and light depending on the cell type. Such a reactor is hereinafter referred to as a “hydrogen reactor” or “hydrogen cell.” The hydrogen reactor comprises a cell for making hydrinos. The cell for making hydrinos may take the form of a chemical reactor or gas fuel cell such as a gas discharge cell, a plasma torch cell, or microwave power cell, and an electrochemical cell. In an embodiment, the catalyst is HOH and the source of at least one of the HOH and H is ice. The ice may have a high surface area to increase at least one of the rates of the formation of HOH catalyst and H from ice and the hydrino reaction rate. The ice may be in the form of fine chips to increase the surface area. In an embodiment, the cell comprises an arc discharge cell and that comprises ice at least one electrode such that the discharge involves at least a portion of the ice.

In an embodiment, the arc discharge cell comprises a vessel, two electrodes, a high voltage power source such as one capable of a voltage in the range of about 100 V to 1 MV and a current in the range of about 1 A to 100 kA, and a source of water such as a reservoir and a means to form and supply H₂O droplets. The droplets may travel between the electrodes. In an embodiment, the droplets initiate the ignition of the arc plasma. In an embodiment, the water arc plasma comprises H and HOH that may react to form hydrinos. The ignition rate and the corresponding power rate may be controlled by controlling the size of the droplets and the rate at which they are supplied to the electrodes. The source of high voltage may comprise at least one high voltage capacitor that may be charged by a high voltage power source. In an embodiment, the arc discharge cell further comprises a means such as a power converter such as one of the present invention such as at least one of a PV converter and a heat engine to convert the power from the hydrino process such as light and heat to electricity.

Exemplary embodiments of the cell for making hydrinos may take the form of a liquid-fuel cell, a solid-fuel cell, a heterogeneous-fuel cell, a CIHT cell, and an SF-CIHT or SunCell® cell. Each of these cells comprises: (i) reactants including a source of atomic hydrogen; (ii) at least one catalyst chosen from a solid catalyst, a molten catalyst, a liquid catalyst, a gaseous catalyst, or mixtures thereof for making hydrinos; and (iii) a vessel for reacting hydrogen and the catalyst for making hydrinos. As used herein and as contemplated by the present disclosure, the term “hydrogen,” unless specified otherwise, includes not only proteum (¹H), but also deuterium (²H) and tritium (³H). Exemplary chemical reaction mixtures and reactors may comprise SF-CIHT, CIHT, or thermal cell embodiments of the present disclosure. Additional exemplary embodiments are given in this Chemical Reactor section. Examples of reaction mixtures having H₂O as catalyst formed during the reaction of the mixture are given in the present disclosure. Other catalysts may serve to form increased binding energy hydrogen species and compounds. The reactions and conditions may be adjusted from these exemplary cases in the parameters such as the reactants, reactant wt %'s, H₂ pressure, and reaction temperature. Suitable reactants, conditions, and parameter ranges are those of the present disclosure. Hydrinos and molecular hydrino are shown to be products of the reactors of the present disclosure by predicted continuum radiation bands of an integer times 13.6 eV, otherwise unexplainable extraordinarily high H kinetic energies measured by Doppler line broadening of H lines, inversion of H lines, formation of plasma without a breakdown fields, and anomalously plasma afterglow duration as reported in Mills Prior Publications. The data such as that regarding the CIHT cell and solid fuels has been validated independently, off site by other researchers. The formation of hydrinos by cells of the present disclosure was also confirmed by electrical energies that were continuously output over long-duration, that were multiples of the electrical input that in most cases exceed the input by a factor of greater than 10 with no alternative source. The predicted molecular hydrino H₂(1/4) was identified as a product of CIHT cells and solid fuels by MAS H NMR that showed a predicted upfield shifted matrix peak of about −4.4 ppm, ToF-SIMS and ESI-ToFMS that showed H₂(1/4) complexed to a getter matrix as m/e=M+n2 peaks wherein M is the mass of a parent ion and n is an integer, electron-beam excitation emission spectroscopy and photoluminescence emission spectroscopy that showed the predicted rotational and vibration spectrum of H₂(1/4) having 16 or quantum number p=4 squared times the energies of H₂, Raman and FTIR spectroscopy that showed the rotational energy of H₂(1/4) of 1950 cm⁻¹, being 16 or quantum number p=4 squared times the rotational energy of H₂, XPS that showed the predicted total binding energy of H₂(1/4) of 500 eV, and a ToF-SIMS peak with an arrival time before the m/e=1 peak that corresponded to H with a kinetic energy of about 204 eV that matched the predicted energy release for H to H(1/4) with the energy transferred to a third body H as reported in Mills Prior Publications and in R. Mills X Yu, Y. Lu, G Chu, J. He, J. Lotoski, “Catalyst Induced Hydrino Transition (CIHT) Electrochemical Cell”, International Journal of Energy Research, (2013) and R. Mills, J. Lotoski, J. Kong, G Chu, J. He, J. Trevey, “High-Power-Density Catalyst Induced Hydrino Transition (CIHT) Electrochemical Cell” (2014) which are herein incorporated by reference in their entirety.

Using both a water flow calorimeter and a Setaram DSC 131 differential scanning calorimeter (DSC), the formation of hydrinos by cells of the present disclosure such as ones comprising a solid fuel to generate thermal power was confirmed by the observation of thermal energy from hydrino-forming solid fuels that exceed the maximum theoretical energy by a factor of 60 times. The MAS H NMR showed a predicted H₂(1/4) upfield matrix shift of about −4.4 ppm. A Raman peak starting at 1950 cm⁻¹ matched the free space rotational energy of H₂(1/4) (0.2414 eV). These results are reported in Mills Prior Publications and in R. Mills, J. Lotoski, W. Good, J. He, “Solid Fuels that Form HOH Catalyst”, (2014) which is herein incorporated by reference in its entirety.

IV. SunCell and Power Converter

Power systems (also referred to herein as “SunCell”) that generate at least one of electrical energy and thermal energy may comprise:

a vessel capable of a maintaining a pressure below atmospheric;

reactants capable of undergoing a reaction that produces enough energy to form a plasma in the vessel comprising:
a) a mixture of hydrogen gas and oxygen gas, and/or water vapor, and/or
   a mixture of hydrogen gas and water vapor;
b) a molten metal;

a mass flow controller to control the flow rate of at least one reactant into the vessel;

a vacuum pump to maintain the pressure in the vessel below atmospheric pressure when one or more reactants are flowing into the vessel;

a molten metal injector system comprising at least one reservoir that contains some of the molten metal, a molten metal pump system (e.g., one or more electromagnetic pumps) configured to deliver the molten metal in the reservoir and through an injector tube to provide a molten metal stream, and at least one non-injector molten metal reservoir for receiving the molten metal stream;

at least one ignition system comprising a source of electrical power or ignition current to supply electrical power to the at least one stream of molten metal to ignite the reaction when the hydrogen gas and/or oxygen gas and/or water vapor are flowing into the vessel;

a reactant supply system to replenish reactants that are consumed in the reaction; and

a power converter or output system to convert a portion of the energy produced from the reaction (e.g., light and/or thermal output from the plasma) to electrical power and/or thermal power. In some embodiments, the effluence comprises (or consists of) nascent water and atomic hydrogen. In some embodiments, the effluence comprises (or consists of) nascent water, and molecular hydrogen. In some embodiments, the effluence comprises (or consists of) nascent water, atomic hydrogen, and molecular hydrogen. In some embodiments, the effluence further comprises a noble gas.

In some embodiments, the power system may comprise an optical rectenna such as the one reported by A. Sharma, V. Singh, T. L. Bougher, B. A. Cola, “A carbon nanotube optical rectenna”, Nature Nanotechnology, Vol. 10, (2015), pp. 1027-1032, doi:10.1038/nnano.2015.220 which is incorporated by reference in its entirety, and at least one thermal to electric power converter. In a further embodiment, the vessel is capable of a pressure of at least one of atmospheric, above atmospheric, and below atmospheric. In another embodiment, the at least one direct plasma to electricity converter can comprise at least one of the group of plasmadynamic power converter, \vec{E}×\vec{B} direct converter, magnetohydrodynamic power converter, magnetic mirror magnetohydrodynamic power converter, charge drift converter, Post or Venetian Blind power converter, gyrotron, photon bunching microwave power converter, and photoelectric converter. In a further embodiment, the at least one thermal to electricity converter can comprise at least one of the group of a heat engine, a steam engine, a steam turbine and generator, a gas turbine and generator, a Rankine-cycle engine, a Brayton-cycle engine, a Stirling engine, a thermionic power converter, and a thermoelectric power converter. Exemplary thermal to electric systems that may comprise closed coolant systems or open systems that reject heat to the ambient atmosphere are supercritical CO₂, organic Rankine, or external combustor gas turbine systems.

In addition to UV photovoltaic and thermal photovoltaic of the current disclosure, the SunCell® may comprise other electric conversion means known in the art such as thermionic, magnetohydrodynamic, turbine, microturbine, Rankine or Brayton cycle turbine, chemical, and electrochemical power conversion systems. The Rankine cycle turbine may comprise supercritical CO₂, an organic such as hydrofluorocarbon or fluorocarbon, or steam working fluid. In a Rankine or Brayton cycle turbine, the SunCell® may provide thermal power to at least one of the preheater, recuperator, boiler, and external combustor-type heat exchanger stage of a turbine system. In an embodiment, the Brayton cycle turbine comprises a SunCell® turbine heater integrated into the combustion section of the turbine. The SunCell® turbine heater may comprise ducts that receive airflow from at least one of the compressor and recuperator wherein the air is heated and the ducts direct the heated compressed flow to the inlet of the turbine to perform pressure-volume work. The SunCell® turbine heater may replace or supplement the combustion chamber of the gas turbine. The Rankine or Brayton cycle may be closed wherein the power converter further comprises at least one of a condenser and a cooler.

The converter may be one given in Mills Prior Publications and Mills Prior Applications. The hydrino reactants such as H sources and HOH sources and SunCell® systems may comprise those of the present disclosure or in prior US patent applications such as Hydrogen Catalyst Reactor, PCT/US08/61455, filed PCT Apr. 24, 2008; Heterogeneous Hydrogen Catalyst Reactor, PCT/US09/052072, filed PCT Jul. 29, 2009; Heterogeneous Hydrogen Catalyst Power System, PCT/US10/27828, PCT filed Mar. 18, 2010; Electrochemical Hydrogen Catalyst Power System, PCT/US11/28889, filed PCT Mar. 17, 2011; H₂O-Based Electrochemical Hydrogen-Catalyst Power System, PCT/US12/31369 filed Mar. 30, 2012; CIHT Power System, PCT/US13/041938 filed May 21, 2013; Power Generation Systems and Methods Regarding Same, PCT/IB2014/058177 filed PCT Jan. 10, 2014; Photovoltaic Power Generation Systems and Methods Regarding Same, PCT/US14/32584 filed PCT Apr. 1, 2014; Electrical Power Generation Systems and Methods Regarding Same, PCT/US2015/033165 filed PCT May 29, 2015; Ultraviolet Electrical Generation System Methods Regarding Same, PCT/US2015/065826 filed PCT Dec. 15, 2015; Thermophotovoltaic Electrical Power Generator, PCT/US16/12620 filed PCT Jan. 8, 2016; Thermophotovoltaic Electrical Power Generator Network, PCT/US2017/035025 filed PCT Dec. 7, 2017; Thermophotovoltaic Electrical Power Generator, PCT/US2017/013972 filed PCT Jan. 18, 2017; Extreme and Deep Ultraviolet Photovoltaic Cell, PCT/US2018/012635 filed PCT Jan. 5, 2018; Magnetohydrodynamic Electric Power Generator, PCT/US18/17765 filed PCT Feb. 12, 2018; Magnetohydrodynamic Electric Power Generator, PCT/US2018/034842 filed PCT May 29, 2018; Magnetohydrodynamic Electric Power Generator, PCT/IB2018/059646 filed PCT Dec. 5, 2018; and Magnetohydrodynamic Electric Power Generator, PCT/IB2020/050360 filed PCT Jan. 16, 2020 (“Mills Prior Applications”) herein incorporated by reference in their entirety.

In an embodiment, H₂O is ignited to form hydrinos with a high release of energy in the form of at least one of thermal, plasma, and electromagnetic (light) power. (“Ignition” in the present disclosure denotes a very high reaction rate of H to hydrinos that may be manifest as a burst, pulse or other form of high-power release.) H₂O may comprise the fuel that may be ignited with the application a high current such as one in the range of about 10 A to 100,000 A. This may be achieved by the application of a high voltage such as about 5,000 to 100,000 V to first form highly conducive plasma such as an arc. Alternatively, a high current may be passed through a conductive matrix such as a molten metal such as silver further comprising the hydrino reactants such as H and HOH, or a compound or mixture comprising H₂O wherein the conductivity of the resulting fuel such as a solid fuel is high. (In the present disclosure a solid fuel is used to denote a reaction mixture that forms a catalyst such as HOH and H that further reacts to form hydrinos. The plasma volatge may be low such as in the range of about 1 V to 100V. However, the reaction mixture may comprise other physical states than solid. In embodiments, the reaction mixture may be at least one state of gaseous, liquid, molten matrix such as molten conductive matrix such a molten metal such as at least one of molten silver, silver-copper alloy, and copper, solid, slurry, sol gel, solution, mixture, gaseous suspension, pneumatic flow, and other states known to those skilled in the art.) In an embodiment, the solid fuel having a very low resistance comprises a reaction mixture comprising H₂O. The low resistance may be due to a conductor component of the reaction mixture. In embodiments, the resistance of the solid fuel is at least one of in the range of about 10⁻⁹ ohm to 100 ohms, 10⁻⁸ ohm to 10 ohms, 10⁻³ ohm to 1 ohm, 10⁻⁴ ohm to 10⁻¹ ohm, and 10⁻⁴ ohm to 10⁻² ohm. In another embodiment, the fuel having a high resistance comprises H₂O comprising a trace or minor mole percentage of an added compound or material. In the latter case, high current may be flowed through the fuel to achieve ignition by causing breakdown to form a highly conducting state such as an arc or arc plasma.

In an embodiment, the reactants can comprise a source of H₂O and a conductive matrix to form at least one of the source of catalyst, the catalyst, the source of atomic hydrogen, and the atomic hydrogen. In a further embodiment, the reactants comprising a source of H₂O can comprise at least one of bulk H₂O, a state other than bulk H₂O, a compound or compounds that undergo at least one of react to form H₂O and release bound H₂O. Additionally, the bound H₂O can comprise a compound that interacts with H₂O wherein the H₂O is in a state of at least one of absorbed H₂O, bound H₂O, physisorbed H₂O, and waters of hydration. In embodiments, the reactants can comprise a conductor and one or more compounds or materials that undergo at least one of release of bulk H₂O, absorbed H₂O, bound H₂O, physisorbed H₂O, and waters of hydration, and have H₂O as a reaction product. In other embodiments, the at least one of the source of nascent H₂O catalyst and the source of atomic hydrogen can comprise at least one of: (a) at least one source of H₂O; (b) at least one source of oxygen, and (c) at least one source of hydrogen.

In an embodiment, the hydrino reaction rate is dependent on the application or development of a high current. In an embodiment of a SunCell®, the reactants to form hydrinos are subject to a low voltage, high current, high power pulse that causes a very rapid reaction rate and energy release. In an exemplary embodiment, a 60 Hz voltage is less than 15 V peak, the current ranges from 100 A/cm² and 50,000 A/cm² peak, and the power ranges from 1000 W/cm² and 750,000 W/cm². Other frequencies, voltages, currents, and powers in ranges of about 1/100 times to 100 times these parameters are suitable. In an embodiment, the hydrino reaction rate is dependent on the application or development of a high current. In an embodiment, the voltage is selected to cause a high AC, DC, or an AC-DC mixture of current that is in the range of at least one of 100 A to 1,000,000 A, 1 kA to 100,000 A, 10 kA to 50 kA. The DC or peak AC current density may be in the range of at least one of 100 A/cm² to 1,000,000 A/cm², 1000 A/cm² to 100,000 A/cm², and 2000 A/cm² to 50,000 A/cm². The DC or peak AC voltage may be in at least one range chosen from about 0.1 V to 1000 V, 0.1 V to 100 V, 0.1 V to 15 V, and 1 V to 15 V. The AC frequency may be in the range of about 0.1 Hz to 10 GHz, 1 Hz to 1 MHz, 10 Hz to 100 kHz, and 100 Hz to 10 kHz. The pulse time may be in at least one range chosen from about 10⁻⁶ s to 10 s, 10⁻⁵ s to 1 s, 10⁻⁴ s to 0.1 s, and 10⁻³ s to 0.01 s.

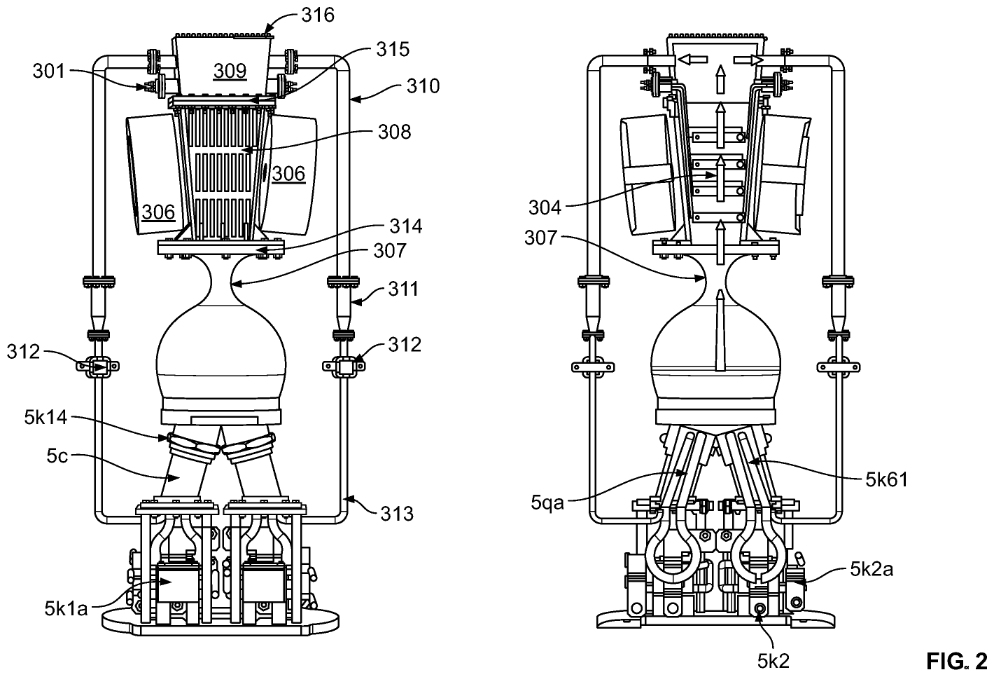

In an embodiment comprising AC or time-variable ignition current and further comprising at least one DC EM pump comprising permanent magnets, the magnets may be shielded from the AC magnetic field of the AC ignition current. The shields may comprise Mu-metal, Amumetal, Amunickel, Cryoperm 10, and other magnetic shielding materials known in the art. The magnetic shielding may prevent the permanent magnets from demagnetizing. In an exemplary embodiment, each shield may comprise a heavy iron bar such as one of thickness in the range of about 5 mm to 50 mm that is positioned on top of and longitudinally covers the corresponding EM pump permanent magnet. Such power generation systems are illustrated in FIGS. 2-3, 25, and 31A-C.

In an embodiment, at least one electrically conductive SunCell® component such as the reaction cell chamber 5b31 or EM pump tube 5k6 may comprise, be lined, or coated with an electrical insulator such as a ceramic to avoid eddy currents that cause the EM pump magnets to demagnetize. In an exemplary embodiment, a SunCell® comprising a stainless-steel reaction cell chamber comprises a BN, SiC, or quartz liner or a ceramic coating such as one of the disclosure.

In an embodiment wherein the ignition power is time dependent such as AC power such as 60 Hz power, each EM magnet of a DC EM pump may comprise at least one of a magnetic yolk between opposing EM pump magnets and a magnetic shield such as a mu-metal shield to prevent EM pump magnet demagnetization by the time varying ignition power.

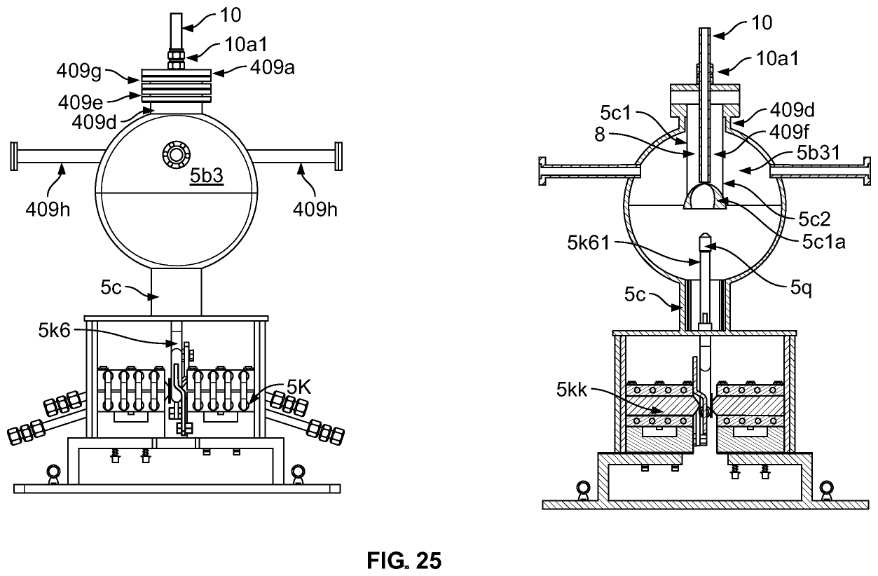

In an embodiment, the EM pump magnets 5k4 are oriented along the same axis as the injected molten metal stream that connects two electrodes that may be opposed along the same axis as shown in FIGS. 25-31E. The magnets may be located on opposite sides of the EM pump tube 5k6 with one positioned in the opposite direction as the other along the injection axis. The EM pump bus bars 5k2 may each be oriented perpendicular to the injection axis and oriented in the direction away from the side of the closest magnet. The EM pump magnets may each further comprise and L-shaped yoke to direct magnetic flux from the corresponding vertically oriented magnet in the transverse direction relative to the EM pump tube 5k6 and perpendicular to both the direction of the molten metal flow in the tube and the direction on the EM pump current. The ignition system may comprise one that has a time varying waveform comprising voltage and current such as an AC waveform such as a 60 Hz waveform. The vertical orientation of the magnets may protect them from being demagnetized by the time-varying ignition current.

In an embodiment, the transfer of energy from atomic hydrogen catalyzed to a hydrino state results in the ionization of the catalyst. The electrons ionized from the catalyst may accumulate in the reaction mixture and vessel and result in space charge build up. The space charge may change the energy levels for subsequent energy transfer from the atomic hydrogen to the catalyst with a reduction in reaction rate. In an embodiment, the application of the high current removes the space charge to cause an increase in hydrino reaction rate. In another embodiment, the high current such as an arc current causes the reactant such as water that may serve as a source of H and HOH catalyst to be extremely elevated in temperature. The high temperature may give rise to the thermolysis of the water to at least one of H and HOH catalyst. In an embodiment, the reaction mixture of the SunCell® comprises a source of H and a source of catalyst such as at least one of nH (n is an integer) and HOH. The at least one of nH and HOH may be formed by the thermolysis or thermal decomposition of at least one physical phase of water such as at least one of solid, liquid, and gaseous water. The thermolysis may occur at high temperature such as a temperature in at least one range of about 500K to 10,000K, 1000K to 7000K, and 1000K to 5000K. In an exemplary embodiment, the reaction temperature is about 3500 to 4000K such that the mole fraction of atomic H is high as shown by J. Lede, F. Lapicque, and J Villermaux [J. Lédé, F. Lapicque, J. Villermaux, “Production of hydrogen by direct thermal decomposition of water”, International Journal of Hydrogen Energy, 1983, V8, 1983, pp. 675-679; H. H. G. Jellinek, H. Kachi, “The catalytic thermal decomposition of water and the production of hydrogen”, International Journal of Hydrogen Energy, 1984, V9, pp. 677-688; S. Z. Baykara, “Hydrogen production by direct solar thermal decomposition of water, possibilities for improvement of process efficiency”, International Journal of Hydrogen Energy, 2004, V29, pp. 1451-1458; S. Z. Baykara, “Experimental solar water thermolysis”, International Journal of Hydrogen Energy, 2004, V29, pp. 1459-1469 which are herein incorporated by reference]. The thermolysis may be assisted by a solid surface such as one of the cell compoments. The solid surface may be heated to an elevated temperature by the input power and by the plasma maintained by the hydrino reaction. The thermolysis gases such as those down stream of the ignition region may be cooled to prevent recombination or the back reaction of the products into the starting water. The reaction mixture may comprise a cooling agent such as at least one of a solid, liquid, or gaseous phase that is at a lower temperature than the temperature of the product gases. The cooling of the thermolysis reaction product gases may be achieved by contacting the products with the cooling agent. The cooling agent may comprise at least one of lower temperature steam, water, and ice.

In an embodiment, the fuel or reactants may comprise at least one of a source of H, H₂, a source of catalyst, a source of H₂O, and H₂O. Suitable reactants may comprise a conductive metal matrix and a hydrate such as at least one of an alkali hydrate, an alkaline earth hydrate, and a transition metal hydrate. The hydrate may comprise at least one of MgCl₂.6H₂O, BaI₂.2H₂O, and ZnCl₂.4H₂O. Alternatively, the reactants may comprise at least one of silver, copper, hydrogen, oxygen, and water.

In an embodiment, the reaction cell chamber 5b31, which is where the reactants may undergo the plasma forming reaction, may be operated under low pressure to achieve high gas temperature. Then the pressure may be increased by a reaction mixture gas source and controller to increase reaction rate wherein the high temperature maintains nascent HOH and atomic H by thermolysis of at least one of H bonds of water dimers and H₂ covalent bonds. An exemplary threshold gas temperature to achieve thermolysis is about 3300° C. A plasma having a higher temperature than about 3300° C. may break H₂O dimer bonds to form nascent HOH to serve as the hydrino catalyst. At least one of the reaction cell chamber H₂O vapor pressure, H₂ pressure, and O₂ pressure may be in at least one range of about 0.01 Torr to 100 atm, 0.1 Torr to 10 atm, and 0.5 Torr to 1 atm. The EM pumping rate may be in at least one range of about 0.01 ml/s to 10,000 ml/s, 0.1 ml/s to 1000 ml/s, and 0.1 ml/s to 100 ml/s. In embodiment, at least one of a high ignition power and a low pressure may be maintained initially to heat the plasma and the cell to achieve thermolysis. The initial power may comprise at least one of high frequency pulses, pulses with a high duty cycle, higher voltage, and higher current, and continuous current. In an embodiment, at least one of the ignition power may be reduced, and the pressure may be increased following heating of the plasma and cell to achieve thermolysis. In another embodiment, the SunCell® may comprise an additional plasma source such as a plasma torch, glow discharge, microwave, or RF plasma source for heating of the hydrino reaction plasma and cell to achieve thermolysis.

In an embodiment, the ignition power may be at an initial power level and waveform of the disclosure and may be switched to a second power level and waveform when the reaction cell chamber achieves a desired temperature. In an embodiment, the second power level may be less than the initial. The second power level may be about zero. The condition to switch at least one of the power level and waveform is the achievement of a reaction cell chamber temperature above a threshold wherein the hydrino reaction kinetics may be maintained within 20% to 100% of the initial rates while operating at the second power level. In an embodiment, the temperature threshold may be in at least one range of about 800° C. to 3000° C., 900° C. to 2500° C., and 1000° C. to 2000° C.

In an embodiment, the reaction cell chamber is heated to a temperature that will sustain the hydrino reaction in the absence of ignition power. In an embodiment, the EM pumping may or may not be maintained following termination of the ignition power wherein the suppling of hydrino reactants such as at least one of H₂, O₂, and H₂O is maintained during the ignition-off operation of the SunCell®. In an exemplary embodiment, the SunCell® shown in FIG. 25 was well insulated with silica-alumina fiber insulation, 2500 sccm H2 and 250 sccm O₂ gases were flowed over Pt/Al₂O₃ beads, and the SunCell® was heated to a temperature in the range of 900° C. to 1400° C. With continued maintenance of the H₂ and O₂ flow and EM pumping, the hydrino reaction self-sustained in the absence of ignition power as evidenced by an increase in the temperature over time in the absence of the input ignition power.

### Ignition System

In an embodiment, the ignition system comprises a switch to at least one of initiate the current and interrupt the current once ignition is achieved. The flow of current may be initiated by the contact of the molten metal streams. The switching may be performed electronically by means such as at least one of an insulated gate bipolar transistor (IGBT), a silicon-controlled rectifier (SCR), and at least one metal oxide semiconductor field effect transistor (MOSFET). Alternatively, ignition may be switched mechanically. The current may be interrupted following ignition in order to optimize the output hydrino generated energy relative to the input ignition energy. The ignition system may comprise a switch to allow controllable amounts of energy to flow into the fuel to cause detonation and turn off the power during the phase wherein plasma is generated. In an embodiment, the source of electrical power to deliver a short burst of high-current electrical energy comprises at least one of the following:

a voltage selected to cause a high AC, DC, or an AC-DC mixture of current that is in the range of at least one of 100 A to 1,000,000 A, 1 kA to 100,000 A, 10 kA to 50 kA;

a DC or peak AC current density in the range of at least one of 1 A/cm² to 1,000,000 A/cm², 1000 A/cm² to 100,000 A/cm², and 2000 A/cm² to 50,000 A/cm²;

wherein the voltage is determined by the conductivity of the solid fuel wherein the voltage is given by the desired current times the resistance of the solid fuel sample;

the DC or peak AC voltage is in the range of at least one of 0.1 V to 500 kV, 0.1 V to 100 kV, and 1 V to 50 kV, and

the AC frequency is in range of at least one of 0.1 Hz to 10 GHz, 1 Hz to 1 MHz, 10 Hz to 100 kHz, and 100 Hz to 10 kHz.

The system further comprises a startup power/energy source such as a battery such as a lithium ion battery. Alternatively, external power such as grid power may be provided for startup through a connection from an external power source to the generator. The connection may comprise the power output bus bar. The startup power energy source may at least one of supply power to the heater to maintain the molten metal conductive matrix, power the injection system, and power the ignition system.

The SunCell® may comprise a high-pressure water electrolyzer such as one comprising a proton exchange membrane (PEM) electrolyzer having water under high pressure to provide high-pressure hydrogen. Each of the H₂ and O₂ chambers may comprise a recombiner to eliminate contaminant O₂ and H₂, respectively. The PEM may serve as at least one of the separator and salt bridge of the anode and cathode compartments to allow for hydrogen to be produced at the cathode and oxygen at the anode as separate gases. The cathode may comprise a dichalcogenide hydrogen evolution catalyst such as one comprising at least one of niobium and tantalum that may further comprise sulfur. The cathode may comprise one known in the art such as Pt or Ni. The hydrogen may be produced at high pressure and may be supplied to the reaction cell chamber 5b31 directly or by permeation through a hydrogen permeable membrane. The SunCell® may comprise an oxygen gas line from the anode compartment to the point of delivery of the oxygen gas to a storage vessel or a vent. In an embodiment, the SunCell® comprises sensors, a processor, and an electrolysis current controller.

In another embodiment, hydrogen fuel may be obtained from electrolysis of water, reforming natural gas, at least one of the syngas reaction and the water-gas shift reaction by reaction of steam with carbon to form H₂ and CO and CO₂, and other methods of hydrogen production known by those skilled in the art.

In another embodiment, the hydrogen may be produced by thermolysis using supplied water and the heat generated by the SunCell®. The thermolysis cycle may comprise one of the disclosure or one known in the art such as one that is based on a metal and its oxide such as at least one of SnO/Sn and ZnO/Zn. In an embodiment wherein the inductively coupled heater, EM pump, and ignition systems only consume power during startup, the hydrogen may be produced by thermolysis such that the parasitic electrical power requirement is very low. The SunCell® may comprise batteries such as lithium ion batteries to provide power to run systems such as the gas sensors and control systems such as those for the reaction plasma gases.

### Magnetohydrodynamic (MHD) Converter

Charge separation based on the formation of a mass flow of ions or an electrically conductive medium in a crossed magnetic field is well known art as magnetohydrodynamic (MHD) power conversion. The positive and negative ions undergo Lorentzian direction in opposite directions and are received at corresponding MHD electrode to affect a voltage between them. The typical MHD method to form a mass flow of ions is to expand a high-pressure gas seeded with ions through a nozzle to create high-speed flow through the crossed magnetic field with a set of MHD electrodes crossed with respect to the deflecting field to receive the deflected ions. In an embodiment, the pressure is typically greater than atmospheric, and the directional mass flow may be achieved by hydrino reaction to form plasma and highly conductive, high-pressure-and-temperature molten metal vapor that is expanded to create high-velocity flow through a cross magnetic field section of the MHD converter. The flow may be through an MHD converter may be axial or radial. Further directional flow may be achieved with confining magnets such as those of Helmholtz coils or a magnetic bottle.

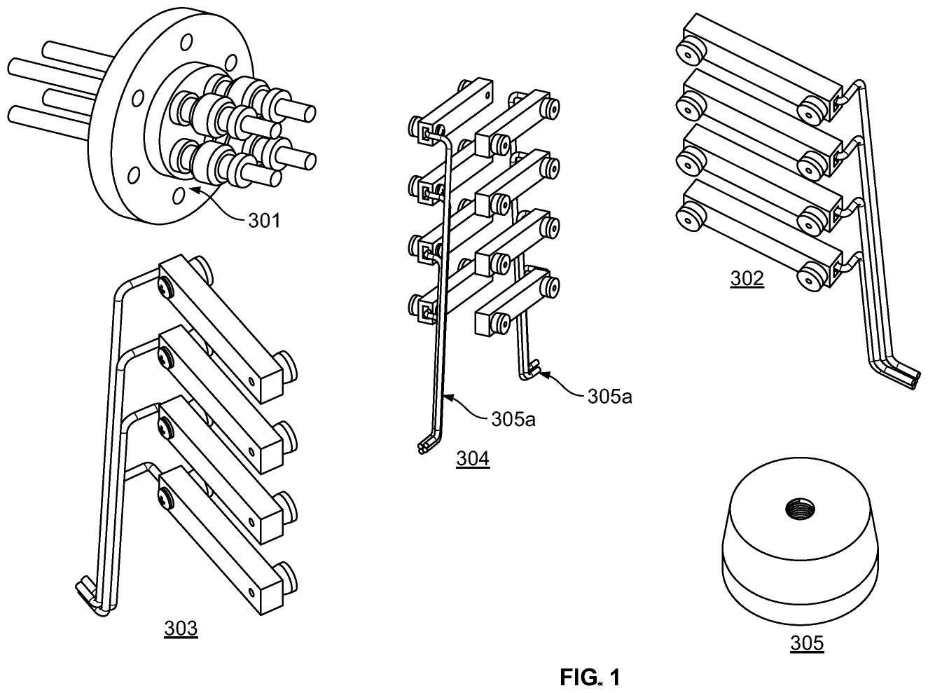

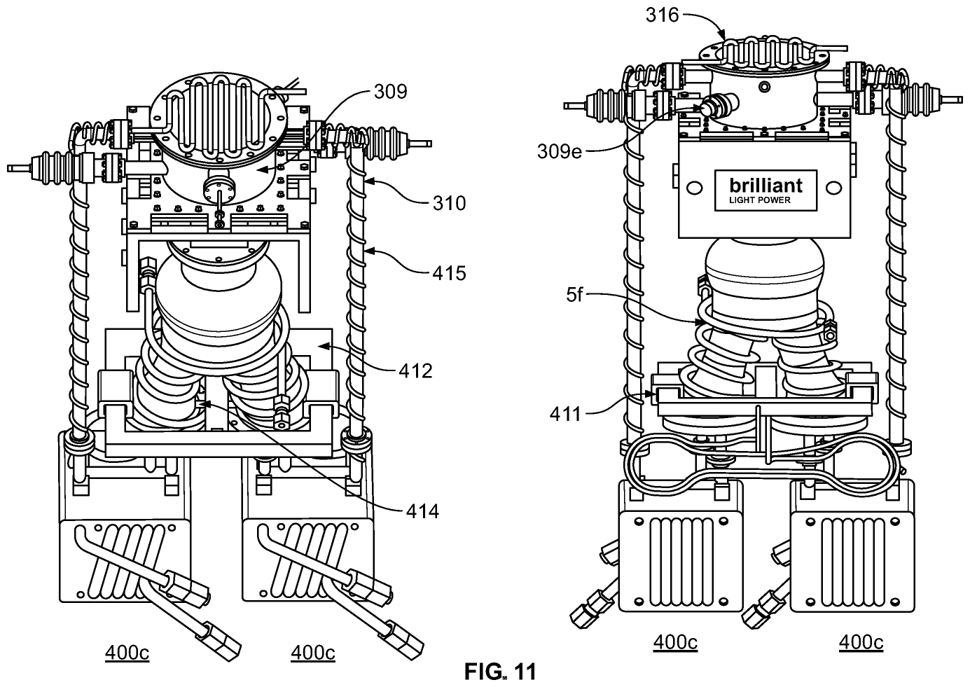

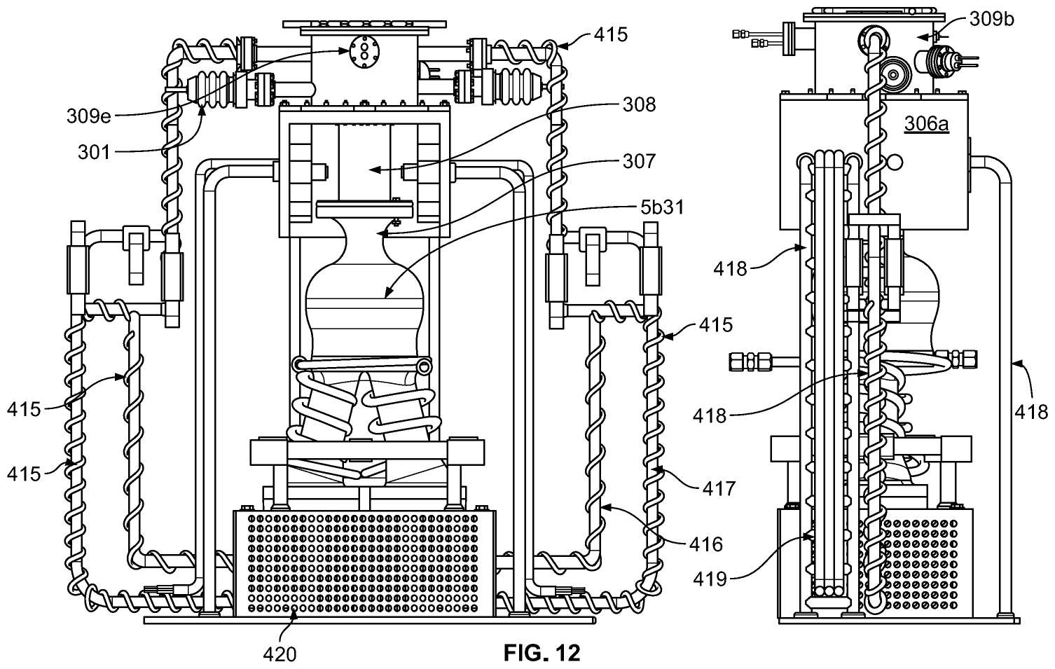

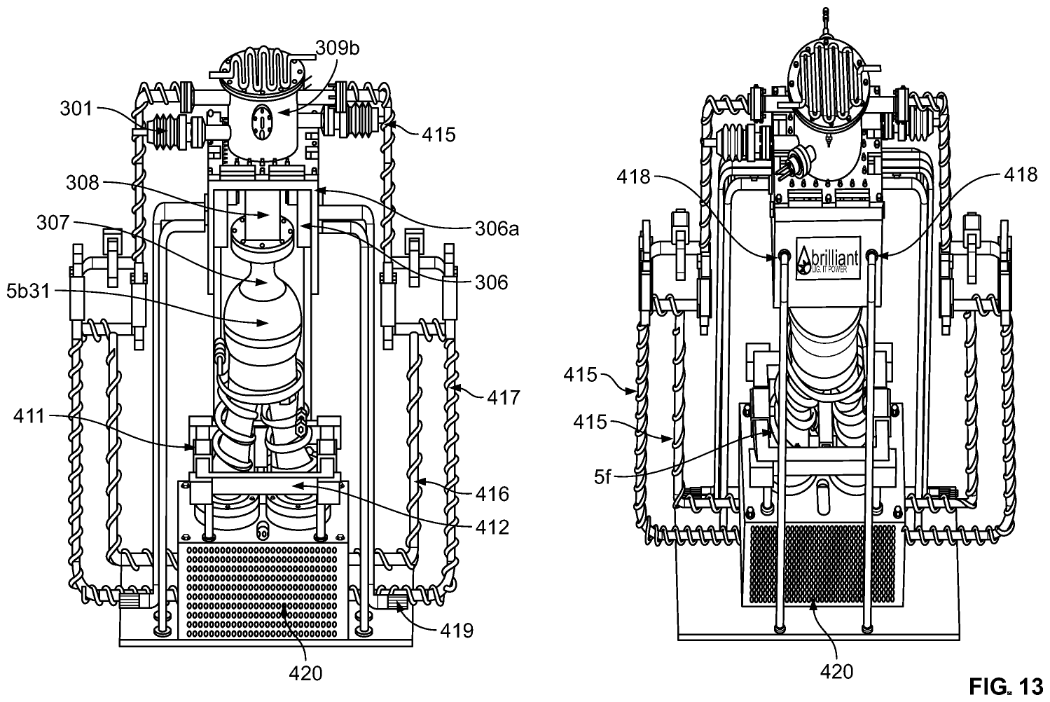

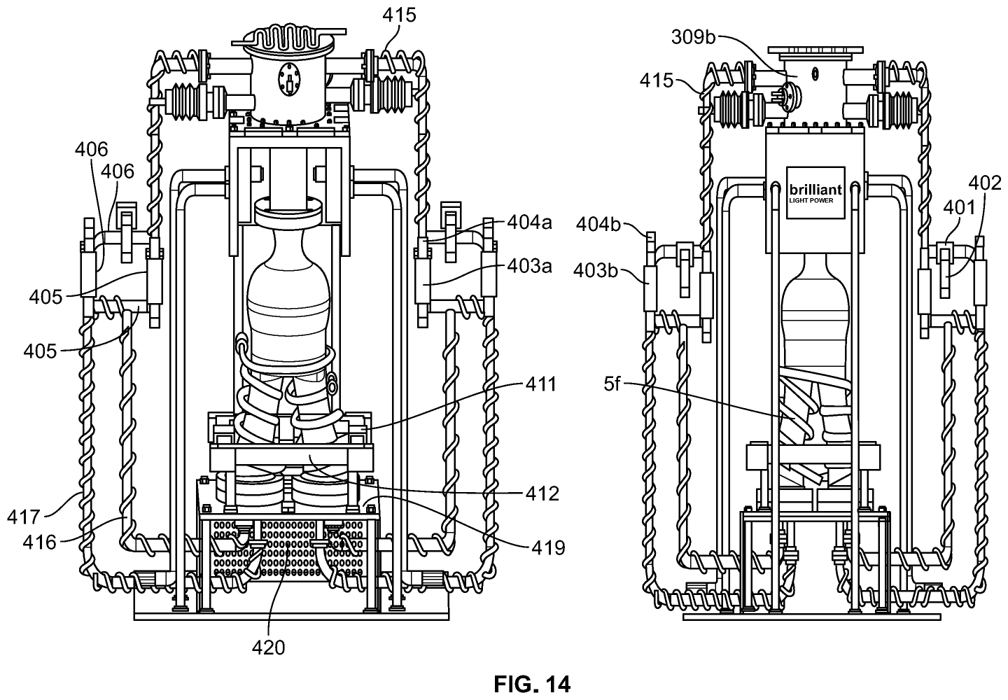

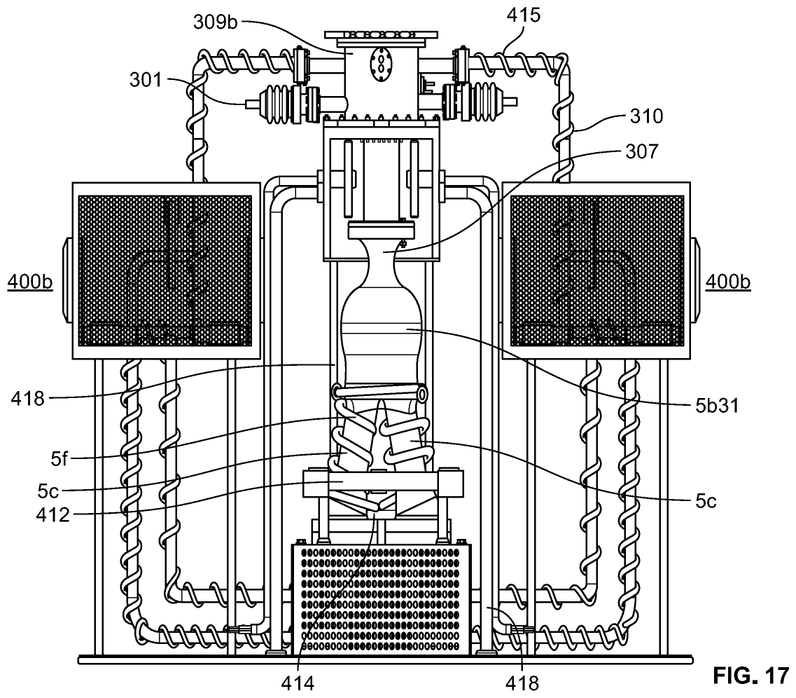

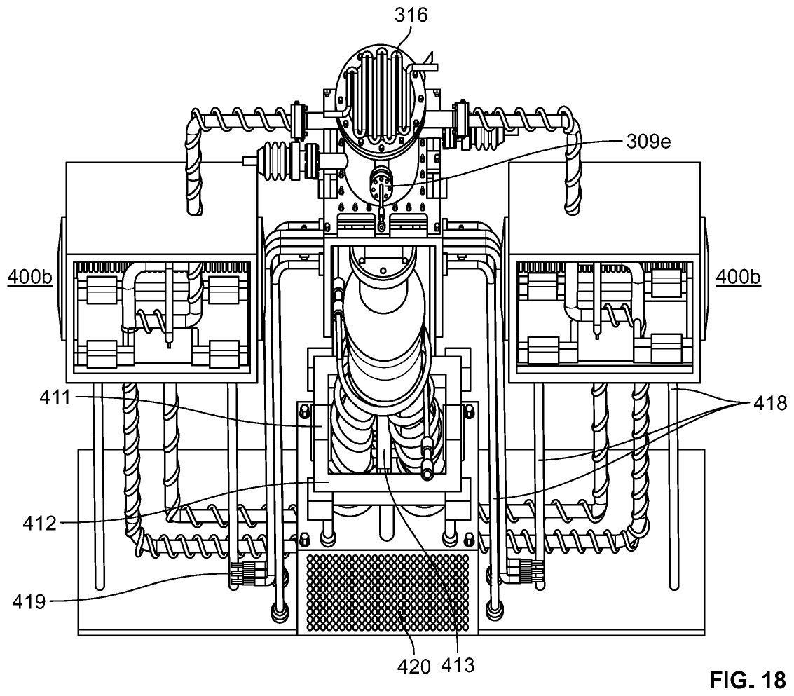

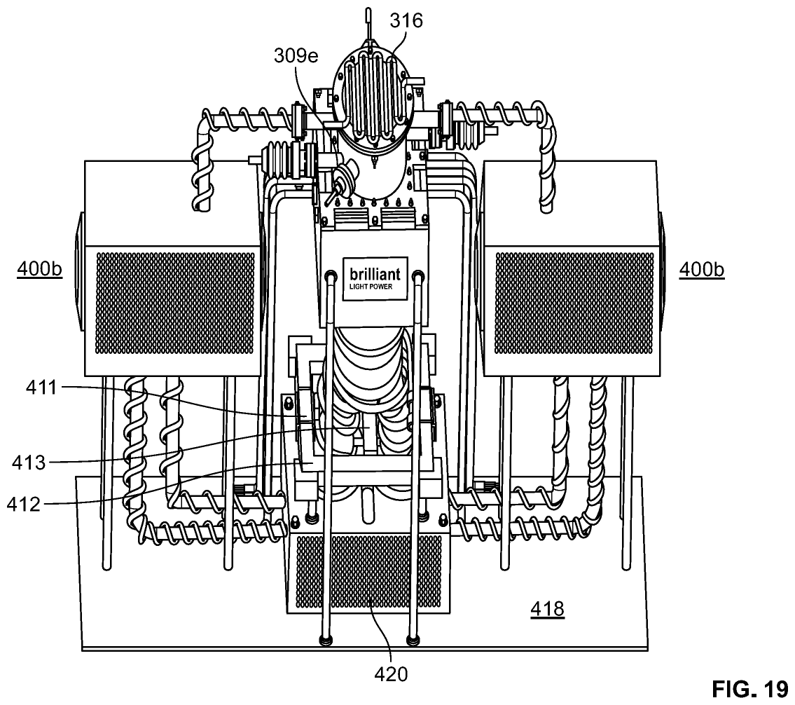

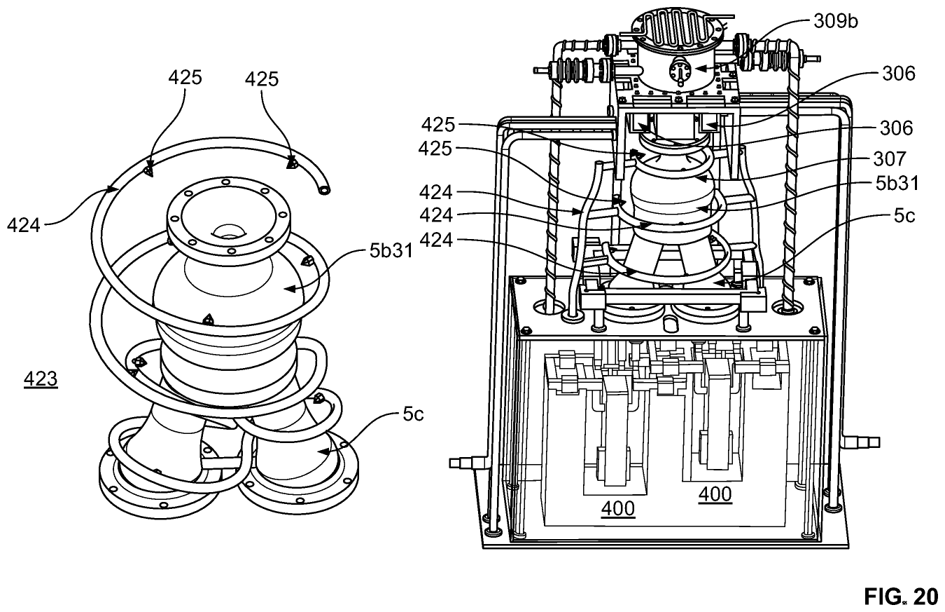

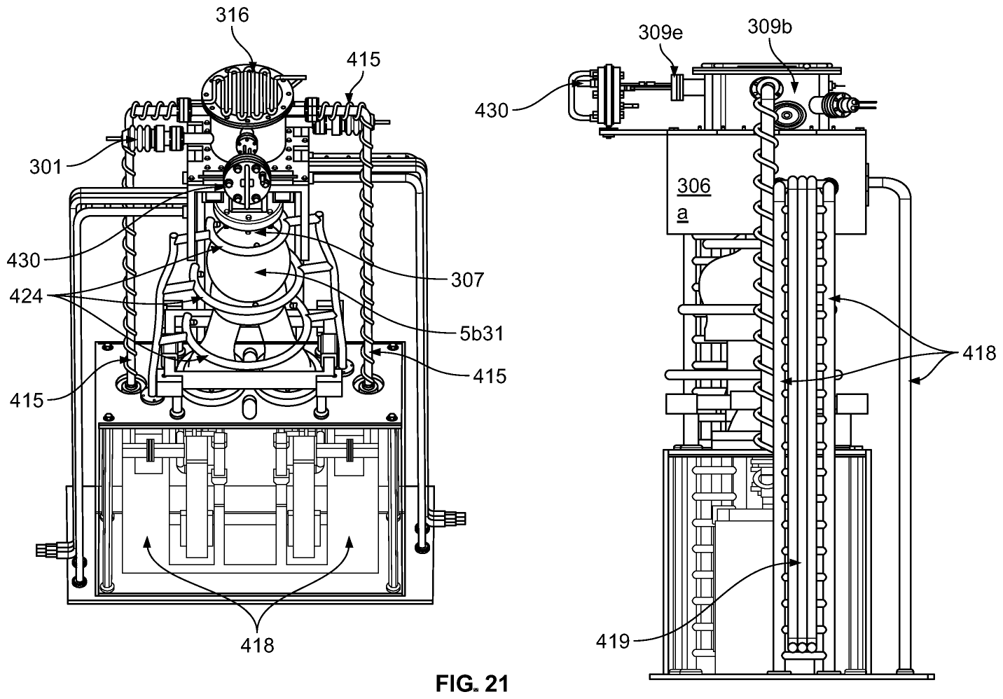

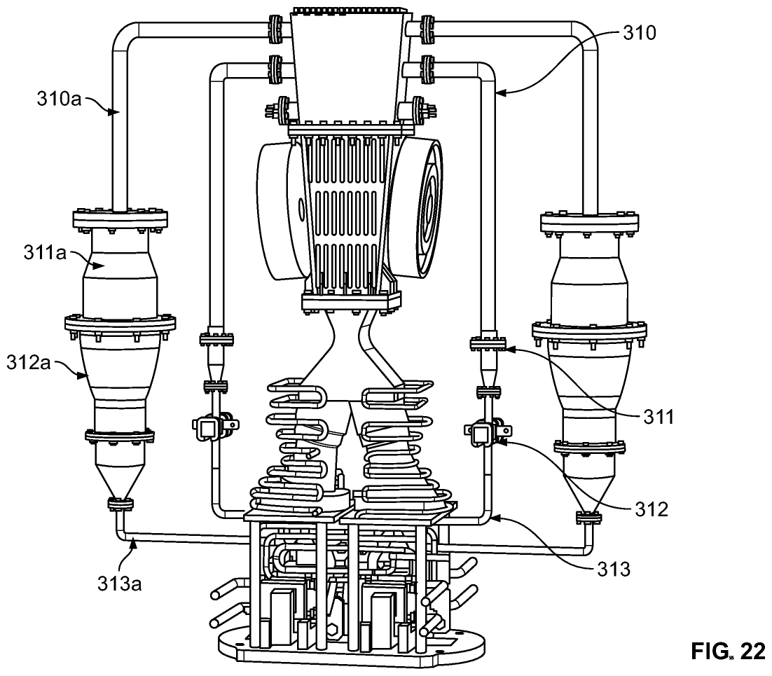

Specifically, the MHD electric power system shown in FIGS. 1-22 may comprise a hydrino reaction plasma source of the disclosure such as one comprising an EM pump 5ka, at least one reservoir 5c, at least two electrodes such as ones comprising dual molten metal injectors 5k61, a source of hydrino reactants such as a source of HOH catalyst and H, an ignition system comprising a source of electrical power 2 to apply voltage and current to the electrodes to form a plasma from the hydrino reactants, and a MHD electric power converter. In an embodiment, the ignition system may comprise a source of voltage and current such as a DC power supply and a bank of capacitor to deliver pulsed ignition with the capacity for high current pulses. In a dual molten metal injector embodiment, current flows through the injected molten metal streams to ignite plasma when the streams connect. The components of the MHD power system comprising a hydrino reaction plasma source and an MHD converter may be comprised of at least one of oxidation resistant materials such as oxidation resistant metals, metals comprising oxidation resistant coatings, and ceramics such that the system may be operated in air.

The power converter or output system may comprise a magnetohydrodynamic (MHD) converter comprising a nozzle connected to the vessel, a magnetohydrodynamic channel, electrodes, magnets, a metal collection system, a metal recirculation system, a heat exchanger, and optionally a gas recirculation system. In some embodiments, the molten metal may comprise silver. In embodiments with a magnetohydrodyanamic converter, the magnetohydrodynamic converter may be delivered oxygen gas to form silver particles nanoparticles (e.g., of size in the molecular regime such as less than about 10 nm or less than about 1 nm) upon interaction with the silver in the molten metal stream, wherein the silver nanoparticles are accelerated through the magnetohydrodynamic nozzle to impart a kinetic energy inventory of the power produced from the reaction. The reactant supply system may supply and control delivery of the oxygen gas to the converter. In various implementations, at least a portion of the kinetic energy inventory of the silver nanoparticles is converted to electrical energy in a magnetohydrodynamic channel. Such version of electrical energy may result in coalescence of the nanoparticles. The nanoparticles may coalesce as molten metal which at least partially absorbs the oxygen in a condensation section of the magnetohydrodynamic converter (also referred to herein as an MHD condensation section) and the molten metal comprising absorbed oxygen is returned to the injector reservoir by a metal recirculation system. In some embodiments, the oxygen may be released from the metal by the plasma in the vessel. In some embodiments, the plasma is maintained in the magnetohydrodynamic channel and metal collection system to enhance the absorption of the oxygen by the molten metal.

To avoid MHD electrode electrical shorting by the molten metal vapor, the electrodes 304 (FIG. 1) may comprise conductors, each mounted on an electrical-insulator-covered conducting post 305 that serves as a standoff for lead 305a and may further serve as a spacer of the electrode from the wall of the generator channel 308. The electrodes 304 may be segmented and may comprise a cathode 302 and anode 303. Except for the standoffs 305, the electrodes may be freely suspended in the generator channel 308. The electrode spacing along the vertical axis may be sufficient to prevent molten metal shorting. The electrodes may comprise a refractory conductor such as W, Ta, Re, or Mo. The leads 305a may be connected to wires that may be insulated with a refractory insulator such as BN. The wires may join in a harness that penetrates the channel at a MHD bus bar feed through flange 301 that may comprise a metal. Outside of the MHD converter, the harness may connect to a power consolidator and inverter. In an embodiment, the MHD electrodes 304 comprise liquid electrodes such as liquid silver electrodes. In an embodiment, the ignition system may comprise liquid electrodes. The ignition system may be DC or AC. The reactor may comprise a ceramic such as quartz, alumina, zirconia, hafnia, or Pyrex. The liquid electrodes may comprise a ceramic frit that may further comprise micro-holes that are loaded with the molten metal such as silver.

### Molten Metal Stream Generation

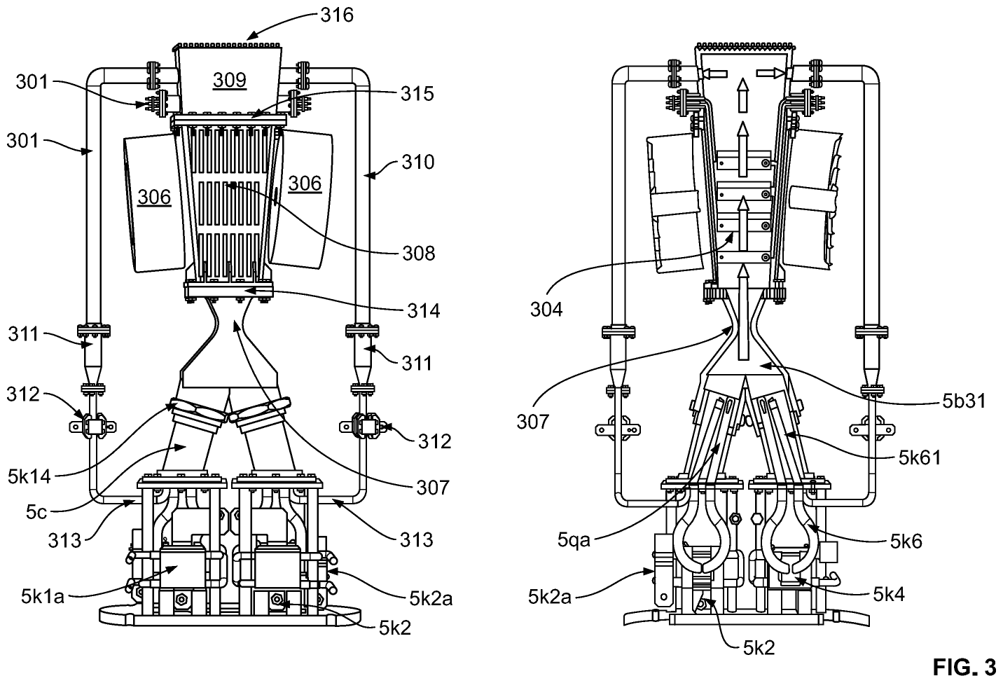

In an embodiment, such as one shown in FIGS. 2 and 3, the SunCell® comprises a two reservoirs 5c, each comprising an electromagnetic (EM) pump such as a DC, AC, or another EM pump of the disclosure and injector that also serves as the ignition electrode and a reservoir inlet riser for leveling the molten metal level in the reservoir. The molten metal may comprise silver, silver-copper alloy, gallium, Galinstan, or another of the disclosure. The SunCell® may further comprise a reaction cell chamber 5b31, electrically isolating flanges between the reservoirs and the reaction cell chamber such as electrically isolating Conflat flanges, and a drip edge at the top of each reservoir to electrically isolate the reservoirs and EM pumps from each other wherein the ignition current flows with contact of intersecting molten metal streams of the two EM pump injectors. In an embodiment, at least one of each reservoir 5c, the reaction cell chamber 5b31, and the inside of the EM pump tube 5k6 are coated with a ceramic or comprise a ceramic liner such as such as one of BN, quartz, titania, alumina, yttria, hafnia, zirconia, silicon carbide, or mixtures such as TiO₂—Yr₂O₃—Al₂O₃, or another of the disclosure. In an embodiment, the SunCell® further comprises an external resistive heater such as heating coils such as Kanthal wire wrapped on the outer surface of at least one SunCell® component. In an embodiment, the outer surface of at least one component of the SunCell such as the reaction cell 5b3, reservoir 5c, and EM pump tube 5k6 is coated with a ceramic to electrically isolate the resistive heater coil such as Kanthal wire wrapped on the surface. In an embodiment, the SunCell® may further comprise at least one of a heat exchanger and thermal insulation that may be wrapped on the surface of at least one SunCell® component. At least one of the heat exchanger and heater may be encased in the thermal insulation.

In an embodiment, the resistive heater may comprise a support for the heating element such as a heating wire. The support may comprise carbon that is hermetically sealed. The sealant may comprise a ceramic such as SiC. The SiC may be formed by reaction of Si with carbon at high temperature in the vacuum furnace.

The SunCell® heater 415 may be a resistive heater or an inductively coupled heater. An exemplary SunCell® heater 415 comprises Kanthal A-1 (Kanthal) resistive heating wire, a ferritic-chromium-aluminum alloy (FeCrAl alloy) capable of operating temperatures up to 1400° C. and having high resistivity and good oxidation resistance. Additional FeCrAl alloys for suitable heating elements are at least one of Kanthal APM, Kanthal A F, Kanthal D, and Alkrothal. The heating element such as a resistive wire element may comprise a NiCr alloy that may operate in the 1100° C. to 1200° C. range such as at least one of Nikrothal 80, Nikrothal 70, Nikrothal 60, and Nikrothal 40. Alternatively, the heater 415 may comprise molybdenum disilicide (MoSi₂) such as at least one of Kanthal Super 1700, Kanthal Super 1800, Kanthal Super 1900, Kanthal Super RA, Kanthal Super ER, Kanthal Super HT, and Kanthal Super NC that is capable of operating in the 1500° C. to 1800° C. range in an oxidizing atmosphere. The heating element may comprise molybdenum disilicide (MoSi₂) alloyed with Alumina. The heating element may have an oxidation resistant coating such as an Alumina coating. The heating element of the resistive heater 415 may comprise SiC that may be capable of operating at a temperature of up to 1625° C.

In an embodiment, the SunCell® may further comprise a molten metal overflow system such as one comprising an overflow tank, at least one pump, a cell molten metal inventory sensor, a molten metal inventory controller, a heater, a temperature control system, and a molten metal inventory to store and supply molten metal as required to the SunCell® as may be determined by at least one sensor and controller. A molten metal inventory controller of the overflow system may comprise a molten metal level controller of the disclosure such as an inlet riser tube and an EM pump. The overflow system may comprise at least one of the MUD return conduit 310, return reservoir 311, return EM pump 312, and return EM pump tube 313.

The electromagnetic pumps may each comprise one of two main types of electromagnetic pumps for liquid metals: an AC or DC conduction pump in which an AC or DC magnetic field is established across a tube containing liquid metal, and an AC or DC current is fed to the liquid through electrodes connected to the tube walls, respectively; and induction pumps, in which a travelling field induces the required current, as in an induction motor wherein the current may be crossed with an applied AC electromagnetic field. The induction pump may comprise three main forms: annular linear, flat linear, and spiral. The pumps may comprise others know in the art such as mechanical and thermoelectric pumps. The mechanical pump may comprise a centrifugal pump with a motor driven impeller. The power to the electromagnetic pump may be constant or pulsed to cause a corresponding constant or pulsed injection of the molten metal, respectively. The pulsed injection may be driven by a program or function generator. The pulsed injection may maintain pulsed plasma in the reaction cell chamber.

In an embodiment, the EM pump tube 5k6 comprises a flow chopper to cause intermittent or pulsed molten metal injection. The chopper may comprise a valve such as an electronically controlled valve that further comprises a controller. The valve may comprise a solenoid valve. Alternatively, the chopper may comprise a rotating disc with at least one passage that rotates periodically to intersect the flow of molten metal to allow the molten metal to flow through the passage wherein the flow in blocked by sections of the rotating disc that do not comprise a passage.

The molten metal pump may comprise a moving magnet pump (MMP). An exemplary commercial AC EM pump is the CMI Novacast CA15 wherein the heating and cooling systems may be modified to support pumping molten silver.

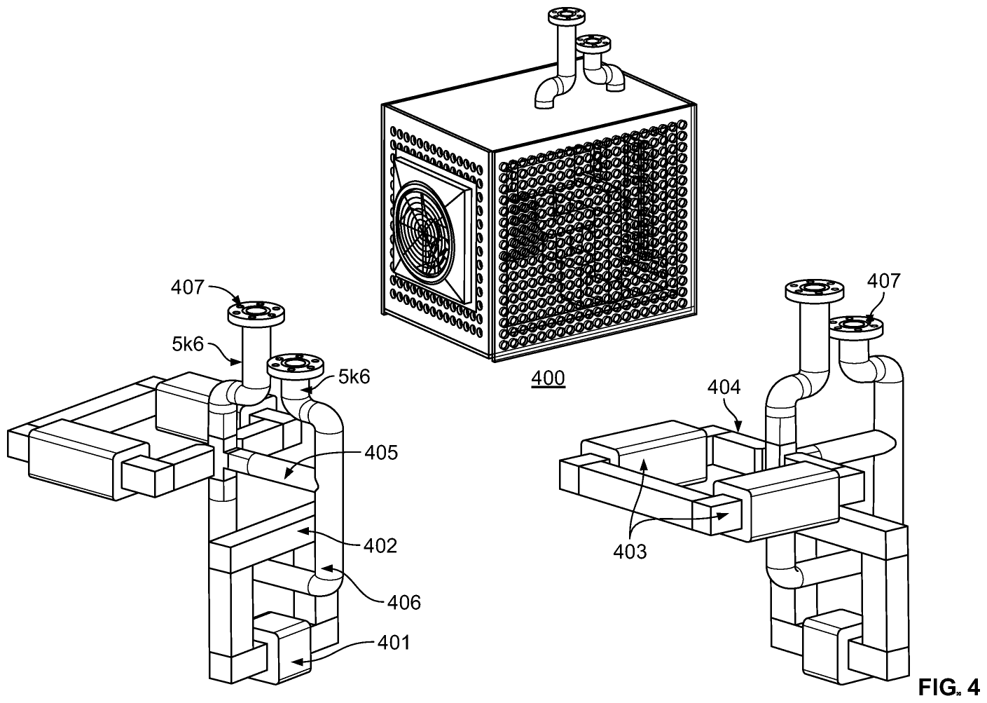

In an embodiment (FIGS. 4-22), the EM pump 400 may comprise an AC, inductive type wherein the Lorentz force on the silver is produced by a time-varying electric current through the silver and a crossed synchronized time-varying magnetic field. The time-varying electric current through the silver may be created by Faraday induction of a first time-varying magnetic field produced by an EM pump transformer winding circuit 401a. The source of the first time-varying magnetic field may comprise a primary transformer winding 401, and the silver may serve as a secondary transformer winding such as a single turn shorted winding comprising an EM pump tube section of a current loop 405 and a EM pump current loop return section 406. The primary winding 401 may comprise an AC electromagnet wherein the first time-varying magnetic field is conducted through the circumferential loop of silver 405 and 406, the induction current loop, by a magnetic circuit or EM pump transformer yoke 402. The silver may be contained in a vessel such as a ceramic vessel 405 and 406 such as one comprising a ceramic of the disclosure such as silicon nitride (MP 1900° C.), quartz, alumina, zirconia, magnesia, or hafnia. A protective SiO₂ layer may be formed on silicon nitrite by controlled passive oxidation. The vessel may comprise channels 405 and 406 that enclose the magnetic circuit or EM pump transformer yoke 402. The vessel may comprise a flattened section 405 to cause the induced current to have a component of flow in a perpendicular direction to the synchronized time-varying magnetic field and the desired direction of pump flow according to the corresponding Lorentz force. The crossed synchronized time-varying magnetic field may be created by an EM pump electromagnetic circuit or assembly 403c comprising AC electromagnets 403 and EM pump electromagnetic yoke 404. The magnetic yoke 404 may have a gap at the flattened section of the vessel 405 containing the silver. The electromagnet 401 of the EM pump transformer winding circuit 401a and the electromagnet 403 of the EM pump electromagnetic assembly 403c may be powered by a single-phase AC power source or other suitable power source known in the art. The magnet may be located close to the loop bend such that the desired current vector component is present. The phase of the AC current powering the transformer winding 401 and electromagnet winding 403 may be synchronized to maintain the desired direction of the Lorentz pumping force. The power supply for the transformer winding 401 and electromagnet winding 403 may be the same or separate power supplies. The synchronization of the induced current and B field may be through analog means such as delay line components or by digital means that are both known in the art. In an embodiment, the EM pump may comprise a single transformer with a plurality of yokes to provide induction of both the current in the closed current loop 405 and 406 and serve as the electromagnet and yoke 403 and 404. Due to the use of a single transformer, the corresponding inducted current and the AC magnetic field may be in phase.

In an embodiment (FIGS. 2-22), the induction current loop may comprise the inlet EM pump tube 5k6, the EM pump tube section of the current loop 405, the outlet EM pump tube 5k6, and the path through the silver in the reservoir 5c that may comprise the walls of the inlet riser 5qa and the injector 561 in embodiments that comprise these components. The EM pump may comprise monitoring and control systems such as ones for the current and voltage of the primary winding and feedback control of SunCell power production with pumping parameters. Exemplary measured feedback parameters may be temperature at the reaction cell chamber 5b31 and electricity at MHD converter. The monitoring and control system may comprise corresponding sensors, controllers, and a computer. In an embodiment, the SunCell® may be at least one of monitored and controlled by a wireless device such as a cell phone. The SunCell® may comprise an antenna to send and receive data and control signals.

In an embodiment wherein the molten metal injector comprising at least one EM pump comprising a current source and magnets to cause a Lorentz pumping force, the EM pump magnets 5k4 may comprise permanent or electromagnets such as DC or AC electromagnets. In the case that the magnets are permanent magnets or DC electromagnets, the EM pump current source comprises a DC power source. In the case that the magnets 5k4 comprise AC electromagnets, the EM pump current source for the EM bus bars 5k2 comprises an AC power source that provides current that is in phase with AC EM pump electromagnet field applied to the EM pump tube 5k6 to produce a Lorentz pumping force. In an embodiment wherein the magnet such as an electromagnet is immersed in a coolant that is corrosive such as a water bath, the magnet such as an electromagnet may be hermetically sealed in a sealant such as a thermoplastic, a coating, or a housing that may be non-magnetic such as a stainless-steel housing.

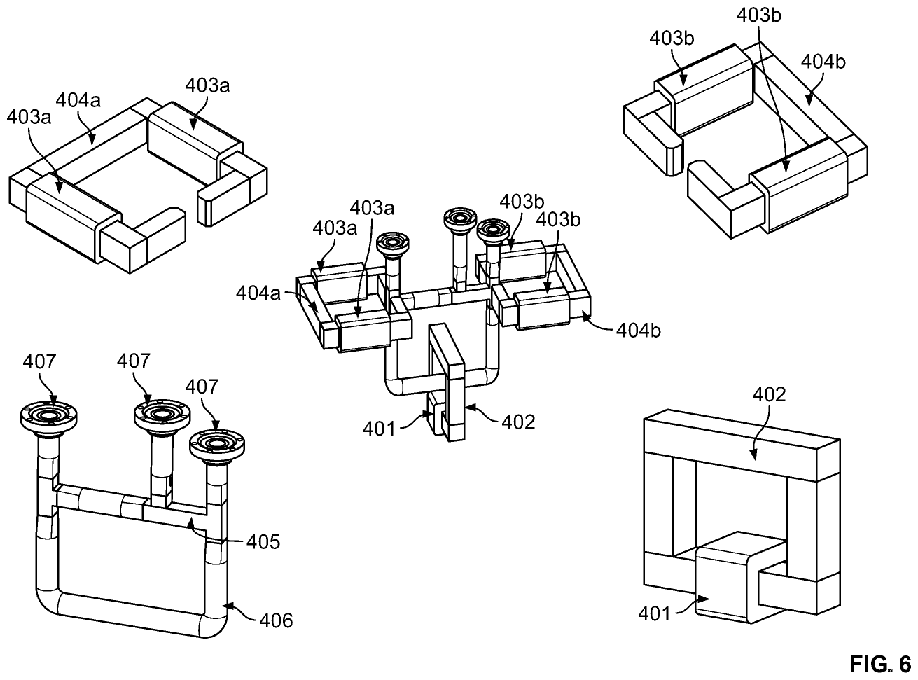

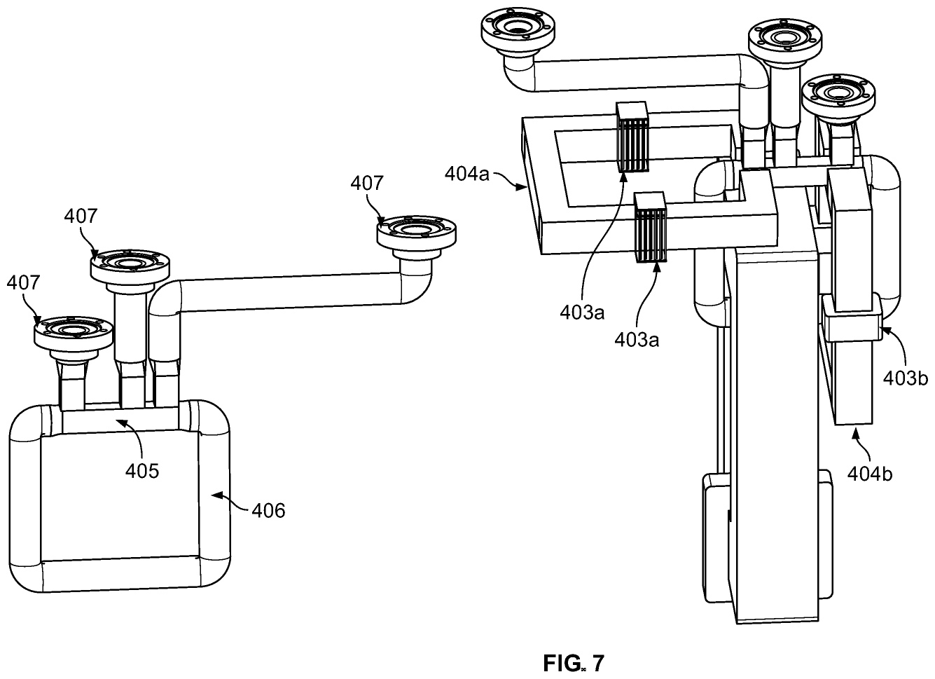

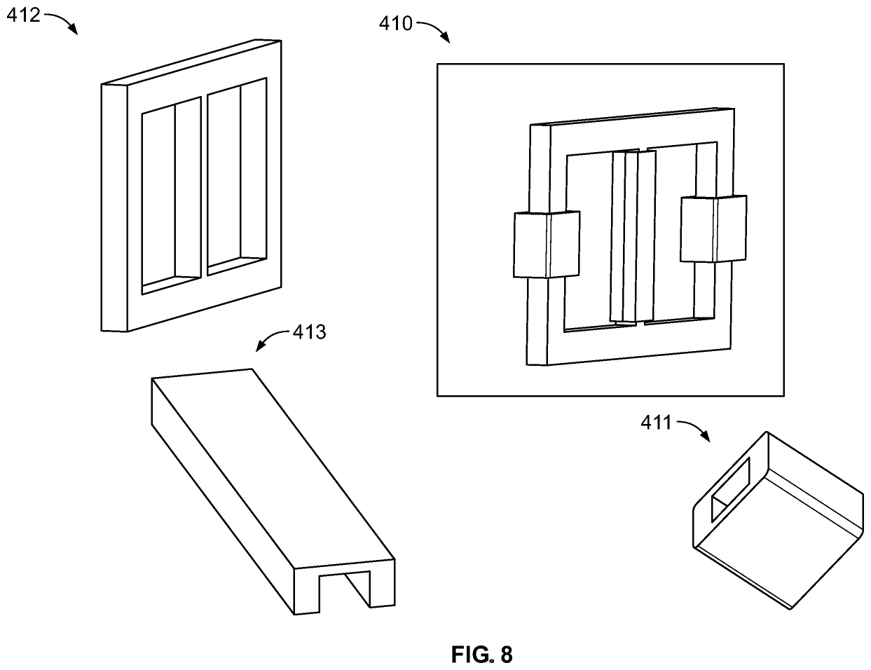

The EM pump may comprise a multistage pump (FIGS. 6-21). The multistage EM pump may receive the input metal flows such as that from the MHD return conduit 310 and that from the base of the reservoir 5c at different pump stages that each correspond to a pressure that permits essentially only forward molten metal flow out the EM pump outlet and injector 5k61. In an embodiment, the multistage EM pump assembly 400a (FIG. 6) comprises at least one EM pump transformer winding circuit 401a comprising a transformer winding 401 and transformer yoke 402 through an induction current loop 405 and 406 and further comprises at least one AC EM pump electromagnetic circuit 403c comprising an AC electromagnet 403 and an EM pump electromagnetic yoke 404. The induction current loop may comprise an EM pump tube section 405 and an EM pump current loop return section 406. The electromagnetic yoke 404 may have a gap at the flattened section of the vessel or EM pump tube section of a current loop 405 containing the pumped molten metal such as silver. In an embodiment shown in FIG. 7, the induction current loop comprising EM pump tube section 405 may have inlets and outlets located offset from the bends for return flow in section 406 such that the induction current may be more transverse to the magnetic flux of the electromagnets 403a and 403b to optimize the Lorentz pumping force that is transverse to both the current and the magnetic flux. The pumped metal may be molten in section 405 and solid in the EM pump current loop return section 406.

In an embodiment, the multistage EM pump may comprise a plurality of AC EM pump electromagnetic circuits 403c that supply magnetic flux perpendicular to both the current and metal flow. The multistage EM pump may receive inlets along the EM pump tube section of a current loop 405 at locations wherein the inlet pressure is suitable for the local pump pressure to achieve forward pump flow wherein the pressure increases at the next AC EM pump electromagnetic circuit 403c stage. In an exemplary embodiment, the MHD return conduit 310 enters the current loop such the EM pump tube section of a current loop 405 at an inlet before a first AC electromagnet circuit 403c comprising AC electromagnets 403a and EM pump electromagnetic yoke 404a. The inlet flow from the reservoir 5c may enter after the first and before a second AC electromagnet circuit 403c comprising AC electromagnets 403b and EM pump electromagnetic yoke 404b wherein the pumps maintain a molten metal pressure in the current loop 405 that maintains a desired flow from each inlet to the next pump stage or to the pump outlet and the injector 5k61. The pressure of each pump stage may be controlled by controlling the current of the corresponding AC electromagnet of the AC electromagnet circuit. An exemplary transformer comprises a silicon steel laminated transformer core 402, and exemplary EM pump electromagnetic yokes 404a and 404b each comprise a laminated silicon steel (grain-oriented steel) sheet stack.

In an embodiment, the EM pump current loop return section 406 such as a ceramic channel may comprise a molten metal flow restrictor or may be filled with a solid electrical conductor such that the current of the current loop is complete while preventing molten metal back flow from a higher pressure to a lower pressure section of the EM pump tube. The solid may comprise a metal such as a stainless steel of the disclosure such as Haynes 230, Pyromet® alloy 625, Carpenter L-605 alloy, BioDur® Carpenter CCM® alloy, Haynes 230, 310 SS, or 625 SS. The solid may comprise a refractory metal. The solid may comprise a metal that is oxidation resistant. The solid may comprise a metal or conductive cap layer or coating such as iridium to avoid oxidation of the solid conductor.

In an embodiment, the solid conductor in the conduit 406 that provides a return current path but prevents silver black flow comprises solid molten metal such as solid silver. The solid silver may be maintained by maintaining a temperature at one or more locations along the path of the conduit 406 that is below the melting point of silver such that it maintains a solid state in at least a portion of the conduit 406 to prevent silver flow in the 406 conduit. The conduit 406 may comprise at least one of a heat exchanger such as a coolant loop, that absence of trace heating or insulation, and a section distanced from hot section 405 such that the temperature of at least one portion of the conduit 406 may be maintained below the melting point of the molten metal.

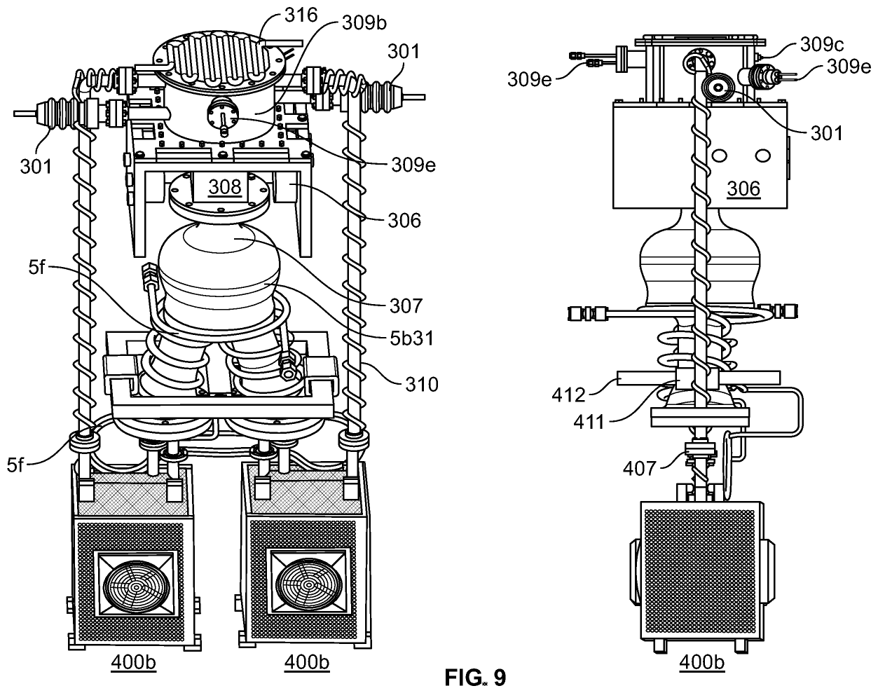

At least one line (FIGS. 9-21) such as at least one of the MHD return conduit 310, EM pump reservoir line 416, and EM pump injection line 417 may be heated by a heater such as a resistive or inductively coupled heater. The SunCell may further comprise structural supports 418 that secure components such as the MHD magnet housing 306a, the MHD nozzle 307, and MHD channel 308, electrical output, sensor, and control lines 419 that may be mounted on the structural supports 418, and heat shielding such as 420 about the EM pump reservoir line 416, and EM pump injection line 417.

In another embodiment, the ignition system comprises an induction system (FIGS. 8-21) wherein the source of electricity applied to the conductive molten metal to cause ignition of the hydrino reaction provides an induction current, voltage, and power. The ignition system may comprise an electrode-less system wherein the ignition current is applied by induction by an induction ignition transformer assembly 410. The induction current may flow through the intersecting molten metal streams from the plurality of injectors maintained by the pumps such as the EM pumps 400. In an embodiment, the reservoirs 5c may further comprise a ceramic cross connecting channel 414 such as a channel between the bases of the reservoirs 5c. The induction ignition transformer assembly 410 may comprise an induction ignition transformer winding 411 and an induction ignition transformer yoke 412 that may extend through the induction current loop formed by the reservoirs 5c, the intersecting molten metal streams from the plurality of molten metal injectors, and the cross-connecting channel 414. The induction ignition transformer assembly 410 may be similar to that of the EM pump transformer winding circuit 401a.

In an embodiment, the ignition current source may comprise an AC, inductive type wherein the current in the molten metal such as silver is produced by Faraday induction of a time-varying magnetic field through the silver. The source of the time-varying magnetic field may comprise a primary transformer winding, an induction ignition transformer winding 411, and the silver may at least partially serve as a secondary transformer winding such as a single turn shorted winding. The primary winding 411 may comprise an AC electromagnet wherein an induction ignition transformer yoke 412 conducts the time-varying magnetic field through a circumferential conducting loop or circuit comprising the molten silver. In an embodiment, the induction ignition system may comprise a plurality of closed magnetic loop yokes 412 that maintain time varying flux through the secondary comprising the molten silver circuit. At least one yoke and corresponding magnetic circuit may comprise a winding 411 wherein the additive flux of a plurality of yokes 412 each with a winding 411 may create induction current and voltage in parallel. The primary winding turn number of each yoke 412 winding 411 may be selected to achieve a desired secondary voltage from that applied to each winding, and a desired secondary current may be achieved by selecting the number of closed loop yokes 412 with corresponding windings 411 wherein the voltage is independent of the number of yokes and windings, and the parallel currents are additive.

In an embodiment, the heater 415 may comprise a resistive heater such as one comprising wire such as Kanthal or other of the disclosure. The resistive heater may comprise a refractory resistive filament or wire that may be wrapped around the components to be heated. Exemplary resistive heater elements and components may comprise high temperature conductors such as carbon, Nichrome, 300 series stainless steels, Incoloy 800 and Inconel 600, 601, 718, 625, Haynes 230, 188, 214, Nickel, Hastelloy C, titanium, tantalum, molybdenum, TZM, rhenium, niobium, and tungsten. The filament or wire may be potted in a potting compound to protect it from oxidation. The heating element as filament, wire, or mesh may be operated in vacuum to protect it from oxidation. An exemplary heater comprises Kanthal A-1 (Kanthal) resistive heating wire, a ferritic-chromium-aluminum alloy (FeCrAl alloy) capable of operating temperatures up to 1400° C. and having high resistivity and good oxidation resistance. Another exemplary filament is Kanthal APM that forms a non-scaling oxide coating that is resistant to oxidizing and carburizing environments and can be operated to 1475° C. The heat loss rate at 1375 K and an emissivity of 1 is 200 kW/m² or 0.2 W/cm². Commercially available resistive heaters that operate to 1475 K have a power of 4.6 W/cm². The heating may be increased using insulation external to the heating element.

An exemplary heater 415 comprises Kanthal A-1 (Kanthal) resistive heating wire, a ferritic-chromium-aluminum alloy (FeCrAl alloy) capable of operating temperatures up to 1400° C. and having high resistivity and good oxidation resistance. Additional FeCrAl alloys for suitable heating elements are at least one of Kanthal APM, Kanthal AF, Kanthal D, and Alkrothal. The heating element such as a resistive wire element may comprise a NiCr alloy that may operate in the 1100° C. to 1200° C. range such as at least one of Nikrothal 80, Nikrothal 70, Nikrothal 60, and Nikrothal 40. Alternatively, the heater 415 may comprise molybdenum disilicide (MoSi₂) such as at least one of Kanthal Super 1700, Kanthal Super 1800, Kanthal Super 1900, Kanthal Super RA, Kanthal Super ER, Kanthal Super HT, and Kanthal Super NC that is capable of operating in the 1500° C. to 1800° C. range in an oxidizing atmosphere. The heating element may comprise molybdenum disilicide (MoSi₂) alloyed with Alumina. The heating element may have an oxidation resistant coating such as an Alumina coating. The heating element of the resistive heater 415 may comprise SiC that may be capable of operating at a temperature of up to 1625° C. The heater may comprise insulation to increase at least one of its efficiency and effectiveness. The insulation may comprise a ceramic such as one known by those skilled in the art such as an insulation comprising alumina-silicate. The insulation may be at least one of removable or reversible. The insulation may be removed following startup to more effectively transfer heat to a desired receiver such as ambient surroundings or a heat exchanger. The insulation may be mechanically removed. The insulation may comprise a vacuum-capable chamber and a pump, wherein the insulation is applied by pulling a vacuum, and the insulation is reversed by adding a heat transfer gas such as a noble gas such as helium. A vacuum chamber with a heat transfer gas such as helium that can be added or pumped off may serve as adjustable insulation.

The ignition current may be time varying such as about 60 Hz AC, but may have other characteristics and waveforms such as a waveform having a frequency in at least one range of 1 Hz to 1 MHz, 10 Hz to 10 kHz, 10 Hz to 1 kHz, and 10 Hz to 100 Hz, a peak current in at least one range of about 1 A to 100 MA, 10 A to 10 MA, 100 A to 1 MA, 100 A to 100 kA, and 1 kA to 100 kA, and a peak voltage in at least one range of about 1 V to 1 MV, 2 V to 100 kV, 3 V to 10 kV, 3 V to 1 kV, 2 V to 100 V, and 3 V to 30 V wherein the waveform may comprise a sinusoid, a square wave, a triangle, or other desired waveform that may comprise a duty cycle such as one in at least one range of 1% to 99%, 5% to 75%, and 10% to 50%. To minimize the skin effect at high frequency, the windings such as 411 of the ignition system may comprise at least one of braided, multiple-stranded, and Litz wire.

In an exemplary MHD thermodynamic cycle: (i) silver nanoparticles form in the reaction cell chamber wherein the nanoparticles may be transported by at least one of thermophoresis and thermal gradients that select for ones in the molecular regime; (ii) the hydrino plasma reaction in the presence of the released O forms high temperature and pressure 25 mole % O and 70 mole % silver nanoparticle gas that flows into the nozzle entrance; (iii) 25 mole % O and 75 mole % silver nanoparticle gas undergoes nozzle expansion, (iv) the resulting kinetic energy of the jet is converted to electricity in the MHD channel; (v) the nanoparticles increase in size in the MHD channel and coalesce to silver liquid at the end of the MHD channel, (vi) liquid silver absorbs 25 mole % O, and (vii) EM pumps pump the liquid mixture back to the reaction cell chamber.

For a gaseous mixture of oxygen and silver nanoparticles, the temperature of oxygen and silver nanoparticles in the free molecular regime is the same such that the ideal gas equations apply to estimate the acceleration of the gas mixture in nozzle expansion wherein the mixture of O₂ and nanoparticles have a common kinetic energy at the common temperature. The acceleration of the gas mixture comprising molten metal nanoparticles such as silver nanoparticles in a converging-diverging nozzle may be treated as the isentropic expansion of ideal gas/vapor in the converging-diverging nozzle. Given stagnation temperature T₀; stagnation pressure p₀; gas constant Rᵥ; and specific heat ratio k, the thermodynamic parameters may be calculated using the equations of Liepmann and Roshko [Liepmann, H. W. and A. Roshko Elements of Gas Dynamics, Wiley (1957)]. The stagnation sonic velocity C₀ and density ρ₀ are given by

$$\begin{matrix}{c}_{0} = \sqrt{k {R}_{v} {T}_{0}} , & {ρ}_{0} = \frac{{p}_{0}}{{R}_{v} {T}_{0}}\end{matrix} \qquad ( 57 )$$

The nozzle throat conditions (Mach number Ma*=1) are given by:

$$\begin{matrix}{T}^{*} = \frac{{T}_{0}}{1 + \frac{( k - 1 )}{2}} , & {p}^{*} = \frac{{p}_{0}}{{[ 1 + \frac{( k - 1 )}{2} ]}^{k / ( k - 1 )}} , & {ρ}^{*} = \frac{{p}^{*}}{{R}_{v} {T}^{*}}\end{matrix} \qquad ( 58 )$$

$$\begin{matrix}{c}^{*} = \sqrt{k {R}_{v} {T}^{*}} , & {u}^{*} = {c}^{*} , & {A}^{*} = \frac{m}{{ρ}^{*} {u}^{*}}\end{matrix}$$

where u is the velocity, m is the mass flow, and A is the nozzle cross sectional area. The nozzle exit conditions (exit Mach number=Ma) are given by:

$$T = \frac{{T}_{0}}{1 + \frac{( k - 1 )}{2} M {a}^{2}} , \\ p = \frac{{p}_{0}}{{[ 1 + \frac{( k - 1 )}{2} M {a}^{2} ]}^{k / ( k - 1 )}} , \\ ρ = \frac{p}{{R}_{v} T} c = \sqrt{k {R}_{v} T} , \\ u = c M a , \\ A = \frac{m}{ρ u} \qquad ( 59 )$$

Due to the high molecular weight of the nanoparticles, the MHD conversion parameters are similar to those of LMMHD wherein the MHD working medium is dense and travels at low velocity relative to gaseous expansion.

### Power System and Configuration

In an exemplary embodiment, the SunCell® having a pedestal electrode shown in FIG. 25 comprises (i) an injector reservoir 5c, EM pump tube 5k6 and nozzle 5q, a reservoir base plate 409a, and a spherical reaction cell chamber 5b31 dome, (ii) a non-injector reservoir comprising a sleeve reservoir 409d that may comprise SS welded to the lower hemisphere 5b41 with a sleeve reservoir flange 409e at the end of the sleeve reservoir 409d, (iii) an electrical insulator insert reservoir 409f comprising a pedestal 5c1 at the top and an insert reservoir flange 409g at the bottom that mates to the sleeve reservoir flange 409e wherein the insert reservoir 409f, pedestal 5c that may further comprise a drip edge 5c1a, and insert reservoir flange 409g may comprise a ceramic such as boron nitride, stabilized BN such as BN—CaO or BN—ZrO₂, silicon carbide, alumina, zirconia, hafnia, or quartz, or a refractory material such as a refractory metal, carbon, or ceramic with a protective coating such as SiC or ZrB₂ such as one comprising SiC or ZrB₂ carbon and (iv) a reservoir base plate 409a such as one comprising SS having a penetration for the ignition bus bar 10a1 and an ignition bus bar 10 wherein the baseplate bolts to the sleeve reservoir flange 409e to sandwich the insert reservoir flange 409g. In an embodiment the SunCell® may comprise a vacuum housing enclosing and hermetically sealing the joint comprising the sleeve reservoir flange 409e, the insert reservoir flange 409g, and the reservoir baseplate 409a wherein the housing is electrically isolated at the electrode bus bar 10. In an embodiment the nozzle 5q may be threaded onto a nozzle section of the electromagnetic pump tube 5k61. The nozzle may comprise a refractory metal such as W, Ta, Re, or Mo. The nozzle may be submerged.

In an embodiment shown in FIG. 25, an inverted pedestal 5c2 and ignition bus bar and electrode 10 are at least one of oriented in about the center of the cell 5b3 and aligned on the negative z-axis wherein at least one counter injector electrode 5k61 injects molten metal from its reservoir 5c in the positive z-direction against gravity where applicable. The injected molten stream may maintain a coating or pool of liquid metal in the pedestal 5c2 against gravity where applicable. The pool or coating may at least partially cover the electrode 10. The pool or coating may protect the electrode from damage such as corrosion or melting. In the latter case, the EM pumping rate may be increased to increase the electrode cooling by the flowing injected molten metal. The electrode area and thickness may also be increased to dissipate local hot spots to prevent melting. The pedestal may be positively biased and the injector electrode may be negatively biased. In another embodiment, the pedestal may be negatively biased and the injector electrode may be positively biased wherein the injector electrode may be submerged in the molten metal. The molten metal such as gallium may fill a portion of the lower portion of the reaction cell chamber 5b31. In addition to the coating or pool of injected molten metal, the electrode 10 such as a W electrode may be stabilized from corrosion by the applied negative bias. In an embodiment, the electrode 10 may comprise a coating such as an inert conductive coating such as a rhenium coating to protect the electrode from corrosion. In an embodiment the electrode may be cooled. The cooling of the electrode may reduce at least one of the electrode corrosion rate and the rate of alloy formation with the molten metal (e.g., as compared to operation without electrode cooling). The cooling may be achieved by means such as centerline water cooling. In an embodiment, the surface area of the inverted electrode is increased by increasing the size of the surface in contact with at least one of the plasma and the molten metal stream from the injector electrode. In an exemplary embodiment, a large plate or cup is attached to the end of the electrode 10. In another embodiment, the injector electrode may be submerged to increase the area of the counter electrode. FIG. 25 shows an exemplary spherical reaction cell chamber. Other geometries such a rectangular, cubic, cylindrical, and conical are within the scope of the disclosure. In an embodiment, the base of the reaction cell chamber where it connects to the top of the reservoir may be sloped such as conical. Such configurations may facilitate mixing of the molten metal as it enters the inlet of the EM pump. In an embodiment, at least a portion of the external surface of the reaction cell chamber may be clad in a material with a high heat transfer coefficient such as copper to avoid hot spots on the reaction cell chamber wall. In an embodiment, the SunCell® comprises a plurality of pumps such as EM pumps to inject molten metal on the reaction cell chamber walls to maintain molten metal walls to prevent the plasma in the reaction cell chamber from melting the walls. In another embodiment, the reaction cell chamber wall comprises a liner 5b31a such as a BN, fused silica, or quartz liner to avoid hot spots. An exemplary reaction cell chamber comprises a cubic upper section lined with quartz plates and lower spherical section comprising an EM pump at the bottom wherein the spherical section promotes molten metal mixing.

In an embodiment, the sleeve reservoir 409d may comprise a tight-fitting electrical insulator of the ignition bus bar and electrode 10 such that molten metal is contained about exclusively in a cup or drip edge 5c1a at the end of the inverted pedestal 5c2. The insert reservoir 409f having insert reservoir flange 409g may be mounted to the cell chamber 5b3 by reservoir baseplate 409a, sleeve reservoir 409d, and sleeve reservoir flange 409e. The electrode may penetrate the reservoir baseplate 409a through electrode penetration 10al. The electrode may penetrate the reservoir baseplate 409a through electrode penetration 10a1. In an embodiment, the insert reservoir 409f may comprise a coating on the electrode bus bar 10. In an embodiment at least one SunCell® component such as the insert reservoir 409f, a reaction cell chamber liner or coating, and a bus bar liner or coating may comprise a ceramic such as BN, quartz, titania, alumina, yttria, hafnia, zirconia, silicon carbide, Mullite, or mixtures such as ZrO₂—TiO₂—Y₂O₃, TiO₂-Yr₂O₃—Al₂O₃, or another of the disclosure, or one comprising at least one of SiO₂, Al₂O₃, ZrO₂, HfO₂, TiO₂, MgO, BN, BN—ZrO₂, BN—B₂O₃, and a ceramic that serves to bind to the metal of the component and then to BN or another ceramic. Exemplary composite coatings comprising BN by Oerlikon are Ni 13Cr 8Fe 3.5Al 6.5BN, ZrO₂ 9.5 Dy₂O₃ 0.7 BN, ZrO₂ 7.5 Y₂O₃ 0.7 BN, and Co 25Cr 5Al 0.27Y 1.75Si 15hBN. In an embodiment, a suitable metal, ceramic, or carbon coated with BN may serve as the liner or coating. A suitable metal or ceramic is capable of operating at the temperature of the SunCell® with the adherence of the BN coating. In an embodiment, binder in a SunCell® component such as the sleeve reservoir 409d, a reaction cell chamber liner or coating, or a bus bar liner or coating may be baked out by at least one of heating and running under a vacuum. Alternatively, a passivated coating may be formed or applied to the ceramic. In an exemplary embodiment, BN is oxidized to form a B₂O₃ passivation coating.

The EM pump tube 5k6 may comprise a material, liner, or coating that is resistant to forming an alloy with gallium such as at least one of W, Ta, Re, Mo, BN, Alumina, Mullite, silica, quartz, zirconia, hafnia, titania, or another of the disclosure. In an embodiment, the pump tube, liner or coating comprises carbon. The carbon may be applied by a suspension means such as a spray or liquid coating that is cured and degassed. In an exemplary embodiment, carbon suspension is poured into the pump tube to fill it, the carbon suspension is cured, and a channel is then machined through the tube to form a carbon liner on the walls. In an embodiment, the carbon coated metal such as Ni may be resistant to forming a carbide at high temperature. In an embodiment, the EM pump tube 5k6 may comprise a metallic tube that is filled with a liner or coating material such as BN that is bored out to form the pump tube. The EM pump tube may comprise an assembly comprising a plurality of parts. The parts may comprise a material or a liner or coating that is resistant to forming an alloy with gallium. In an embodiment, the parts may be separately coated and assembled. The assembly may comprise at least one of a housing that contains two opposing bus bars 5k2, a liquid metal inlet, and a liquid metal outlet, and a means to seal the housing such as Swageloks. In an embodiment, the EM pump bus bars 5k2 may comprise a conductive portion in contact with the gallium inside of the EM pump tube that is resistant to forming an alloy with gallium. The conductive portion may comprise an alloy-resistant material such as Ta, W, Re, Ir, or Mo, or an alloy-resistant cladding or coating on another metal such as SS such as one comprising Ta, W, Re, Ir, or Mo.

In an embodiment, the SunCell® comprises an inlet riser tube 5qa to prevent hot gallium flow to the reservoir base 5kk1 and suppress gallium alloy formation. The reservoir base 5kk1 may comprise a liner, cladding, or coating to suppress gallium alloy formation.

In an embodiment to permit good electrical contact between the EM pump bus bars 5k2 and the molten metal in the EM pump tube 5k6, the coating is applied before the EM pump bus bars are attached by means such as welding. Alternatively, any coating may be removed from the bus bars penetrating into the molten metal before operation by means known in the art such as abrasion, ablation, or etching.

In another embodiment, the insert reservoir flange 409g may be replaced with a feedthrough mounted in the reservoir baseplate 409a that electrically isolates the bus bar 10 of the feedthrough and pedestal 5c1 or insert reservoir 409f from the reservoir baseplate 409a. The feedthrough may be welded to the reservoir baseplate. An exemplary feedthrough comprising the bus bar 10 is Solid Sealing Technology, Inc. #FA10775. The bus bar 10 may be joined to the electrode 8 or the bus bar 10 and electrode 8 may comprise a single piece. The reservoir baseplate may be directly joined to the sleeve reservoir flange. The union may comprise Conflat flanges that are bolted together with an intervening gasket. The flanges may comprise knife edges to seal a soft metallic gasket such as a copper gasket. The ceramic pedestal 5c1 comprising the insert reservoir 409f may be counter sunk into a counter bored reservoir baseplate 409a wherein the union between the pedestal and the reservoir baseplate may be sealed with a gasket such as a carbon gasket or another of the disclosure. The electrode 8 and bus bar 10 may comprise an endplate at the end where plasma discharge occurs. Pressure may be applied to the gasket to seal the union between the pedestal and the reservoir baseplate by pushing on the disc that in turn applies pressure to the gasket. The discs may be threaded on to the end of the electrode 8 such that turning the disc applies pressure to the gasket. The feedthrough may comprise an annular collar that connects to the bus bar and to the electrode. The annular collar may comprise a threshed set screw that when tightened locks the electrode into position. The position may be locked with the gasket under tension applied by the end disc pulling the pedestal upwards. The pedestal 5c1 may comprise a shaft for access to the set screw. The shaft may be threaded so that it can be sealed on the outer surface of the pedestal with a nonconductive set screw such a ceramic one such as a BN one wherein the pedestal may comprise BN such as BN—ZrO₂. In another embodiment, the bus bar 10 and electrode 8 may comprise rods that may butt-end connect. In an embodiment, the pedestal 5c1 may comprise two or more threaded metal shafts each with a set screw that tightens against the bus bar 10 or electrode 8 to lock them in place under tension. The tension may provide at least one of connection of the bus bar 10 and electrode 8 and pressure on the gasket. Alternatively, the counter electrode comprises a shortened insulating pedestal 5c1 wherein at least one of the electrode 8 and bus bar 10 comprise male threads, a washer and a matching female nut such that the nut and washer tighten against the shortened insulating pedestal 5c1. Alternatively, the electrode 8 may comprise male threads on an end that threads into matching female threads at an end of the bus bar 10, and the electrode 8 further comprises a fixed washer that tightens the shortened insulating pedestal 5c1 against the pedestal washer and the reservoir baseplate 409a that may be counter sunk. The counter electrode may comprise other means of fasting the pedestal, bus bar, and electrode that are known to those skilled the art.

In another embodiment, at least one seal such as (i) one between the insert reservoir flange 409g and the sleeve reservoir flange 409e, and (ii) one between the reservoir baseplate 409a and the sleeve reservoir flange 409e may comprise a wet seal (FIG. 25). In the latter case, the insert reservoir flange 409g may be replaced with a feedthrough mounted in the reservoir baseplate 409a that electrically isolates the bus bar 10 of the feedthrough and pedestal 5c1 from the reservoir baseplate 409a, and the wet seal may comprise one between the reservoir baseplate 409a and the feedthrough. Since gallium forms an oxide with a melting point of 1900° C., the wet seal may comprise solid gallium oxide.

In an embodiment, hydrogen may be supplied to the cell through a hydrogen permeable membrane such as a structurally reinforced Pd—Ag or niobium membrane. The hydrogen permeation rate through the hydrogen permeable membrane may be increased by maintaining plasma on the outer surface of the permeable membrane. The SunCell® may comprise a semipermeable membrane that may comprise an electrode of a plasma cell such as a cathode of a plasma cell (e.g., a glow discharge cell). The SunCell® such as one shown in FIG. 25 may further comprise an outer sealed plasma chamber comprising an outer wall surrounding a portion of the wall of cell 5b3 wherein a portion of the metal wall of the cell 5b3 comprises an electrode of the plasma cell. The sealed plasma chamber may comprise a chamber around the cell 5b3 such as a housing wherein the wall of cell 5b3 may comprise a plasma cell electrode and the housing or an independent electrode in the chamber may comprise the counter electrode. The SunCell® may further comprise a plasma power source, and plasma control system, a gas source such as a hydrogen gas supply tank, a hydrogen supply monitor and regular, and a vacuum pump.

The system may operate via the production of two plasmas. An initial reaction mixture such as a non-stoichiometric H₂/O₂ mixture (e.g., an H₂/O₂ having less than 20% or less than 10% or less than 5% or less than 3% O₂ by mole percentage of the mixture) may pass through a plasma cell such as a glow discharge to create a reaction mixture capable of undergoing the catalytic reactions with sufficient exothermicity to produce a plasma as described herein. For example, a non-stoichiometric H₂/O₂ mixture may pass through a glow discharge to produce an effluence of atomic hydrogen and nascent H₂O (e.g., a mixture having water at a concentration and with an internal energy sufficient to prevent formation of hydrogen bonds). The glow discharge effluence may be directed into the reaction chamber where a current is supplied between two electrodes (e.g., with a molten metal passed therebetween). Upon interaction of the effluence with the biased molten metal (e.g., gallium), the catalytic reaction between the nascent water and the atomic hydrogen is induced, for example, upon the formation of arc current. The power system may comprise:

a) a plasma cell (e.g., glow discharge cell);

b) a set of electrodes in electrical contact with one another via a molten metal flowing therebetween such that an electrical bias may be applied molten metal;

c) a molten metal injection system which flows the molten metal between the electrodes;

wherein the effluence of the plasma cell is oriented towards the biased molten metal (e.g., the positive electrode or anode).

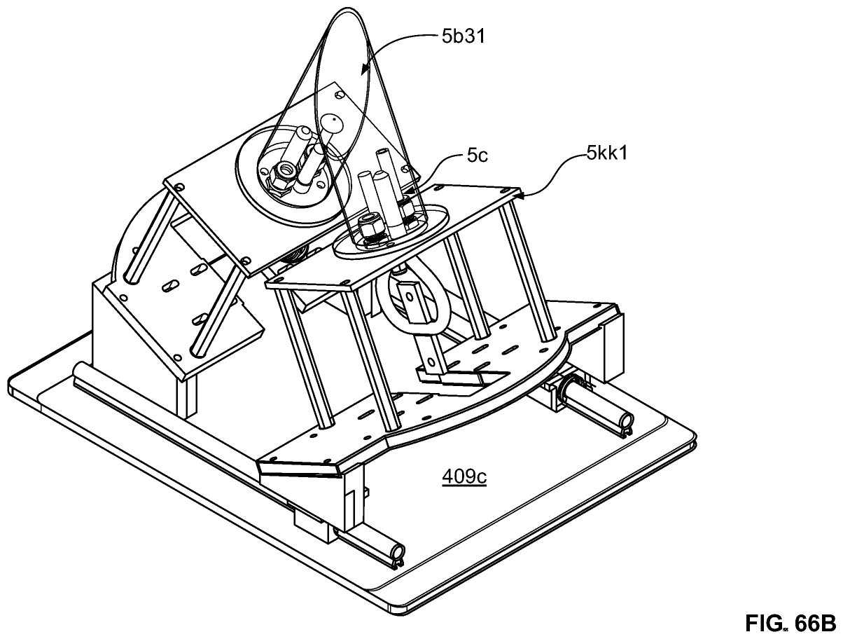

In an embodiment, the SunCell® comprises at least one a ceramic reservoir 5c and reaction cell chamber 5b31 such as one comprising quartz. The SunCell® may comprise two cylindrical reaction cell chambers 5b31 each comprising a reservoir at a bottom section wherein the reaction cell chambers are fused at the top along a seam where the two intersect as shown in FIGS. 66A-B. In an embodiment, the apex formed by the intersection of the reaction cell chambers 5b31 may comprise a gasketed seal such as two flanges that bolt together with an intervening gasket such as a graphite gasket to absorb thermal expansion and other stresses. Each reservoir may comprise a means such as an inlet riser 5qa to maintain a time-averaged level of molten metal in the reservoir. The bottom of the reservoirs may each comprise a reservoir flange 5k17 that may be sealed to a baseplate 5kk1 comprising an EM pump assembly 5kk comprising an EM pump 5ka with inlet and injection tube 5k61 penetrations and further comprising the EM magnets 5k4 and EM pump tube 5k6 under each baseplate. In an embodiment, permanent EM pump magnets 5k4 (FIGS. 66A-B) may be replaced with electromagnets such as DC or AC electromagnets. In the case that the magnets 5k4 comprise AC electromagnets, the EM pump current source for the EM bus bars 5k2 comprises an AC power source that provides current that is in phase with AC EM pump electromagnet field applied to the EM pump tube 5k6 to produce a Lorentz pumping force. Each EM pump assembly 5kk may attach to the reservoir flange at the same angle as the corresponding reservoir 5c such that the reservoir flange may be perpendicular to the slanted reservoir. The EM pump assembly 5kk may be mounted to a slide table 409c (FIG. 66B) with supports to mount and align the corresponding slanted EM pump assemblies 5kk and reservoirs 5c. The baseplate may seal to the reservoir by a wet seal. The baseplate may further comprise penetrations each with a tube for evacuating or supplying gases to the reaction cell chamber 5b31 comprising the region wherein the reservoirs are fused. The reservoir may further comprise at least one of a gas injection tube 710 and a reservoir vacuum tube 711 wherein at least one tube may extend above the molten metal level. At least one of the gas injection line 710 and the vacuum line 711 may comprise a cap such as a carbon cap or a cover such as a carbon cover with side openings to allow gas flow while at least partially blocking molten metal entry into the tube. In another design, the fused reservoir section may be horizontally cutaway and a vertical cylinder may be attached at the cutaway section. The cylinder may further comprise a sealing top plate such as a quartz plate or may join to a converging diverging nozzle of the MHD converter. The top plate may comprise at least one penetration for lines such as vacuum and gas supply lines. In an embodiment, the quartz may be housed in a tight-fitting casing that provides support against outward deformation of the quartz due to operation at high temperature and pressure. The casing may comprise at least one of carbon, and ceramic, and a metal that has a high melting point and resists deformation at high temperature. Exemplary casings comprise at least one of stainless steel, C, W, Re, Ta, Mo, Nb, Ir, Ru, Hf, Tc, Rh, V, Cr, Zr, Pa, Pt, Th, Lu, Ti, Pd, Tm, Sc, Fe, Y, Er, Co, Ho, Ni, and Dy. At least one seal to a SunCell component such as one to the reservoirs 5c, the reaction cell chamber 5b31, the converging-diverging nozzle or MHD nozzle section 307, the MHD expansion or generation section 308, the MHD condensation section 309, MHD electrode penetrations, the electromagnetic pump bus bar 5k2, and an ignition reservoir bus bar 5k2a1 that supplies ignition power to the molten metal of the reservoir may comprise a wet seal. In an exemplary embodiment, the reservoir flange 5k17 comprises a wet seal with the baseplate 5kk1 wherein the outer perimeter of the flange may be cooled by a cooling loop 5k18 such as a water-cooling loop. In another exemplary embodiment, the EM pump tube comprises a liner such as a BN liner and at least one of the electromagnetic pump bus bar 5k2 and the ignition reservoir bus bar 5k2a1 comprises a wet seal.

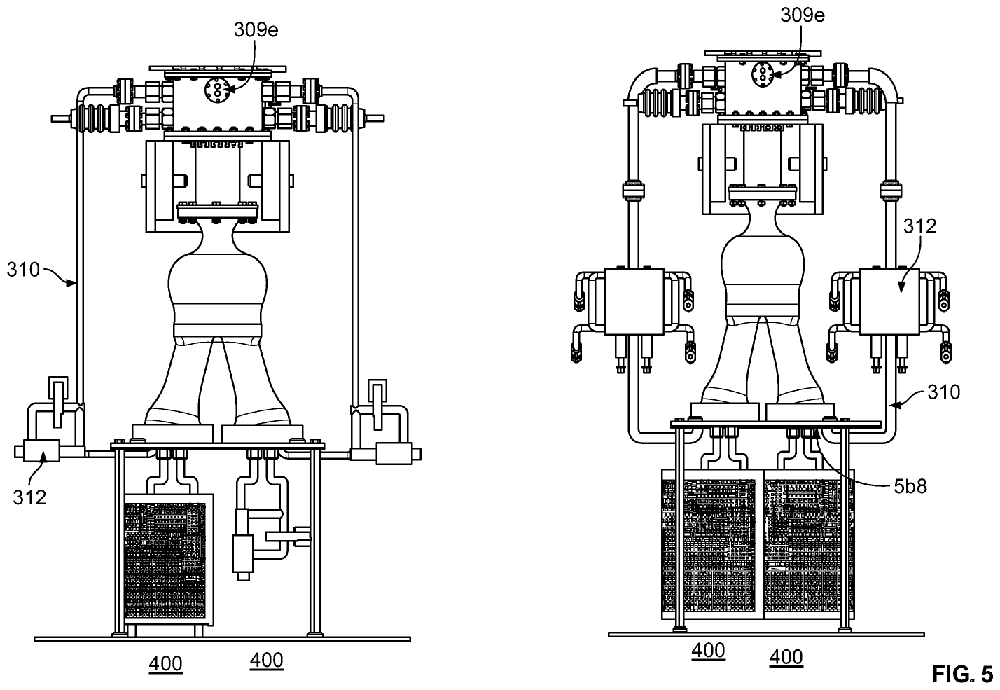

In an embodiment, a ceramic SunCell® such as a quartz one is mounted on a metal baseplate 5kk1 (FIG. 66B) wherein a wet seal comprises a penetration into the reservoir 5c that allows molten metal such a silver in the reservoir to contact solidified molten metal on the baseplate 5kk1 of each EM pump assembly to form the wet seal. Each baseplate may be connected to a terminal of the ignition power source such as a DC or AC power source such that the wet seal may also serve as a bus bar for the ignition power. The EM pump may comprise an induction AC type such as one shown in FIGS. 4 and 5. The ceramic SunCell® may comprise a plurality of components such as the EM pumps, reservoirs, reaction cell chamber, and MHD components that are sealed with flanged gasketed unions that may be bolted together. The gasket may comprise carbon or a ceramic such as Thermiculite.

Rhenium (MP 3185° C.) is resistant to attack from gallium, Galinstan, silver, and copper and is resistant to oxidation by oxygen and water and the hydrino reaction mixture such as one comprising oxygen and water; thus, it may serve as a coating for metal components such as those of the EM pump assembly 5kk such as the baseplate 5kk1, EM pump tube 5k6, EM pump bus bars 5k2, EM pump injectors 5k61, EM pump nozzle 5q, inlet risers 5qa, gas lines 710, and vacuum line 711. The component may be coated with rhenium by electroplating, vacuum deposition, chemical deposition, and other methods known in the art. In an embodiment, a bus bar or electrical connection at a penetration such the EM pump bus bars 5k2 or the penetrations for MHD electrodes in the MHD generator channel 308 may comprise solid rhenium sealed by a wet seal at the penetration.

In an embodiment (FIGS. 66A-B), the heater to melt the metal to form the molten metal comprises a resistive heater such as a Kanthal wire heater around the reservoirs 5c and reaction cell chamber 5b31 such as ones comprising quartz. The EM pump 5kk may comprise heat transfer blocks to transfer heat from the reservoirs 5c to the EM pump tube 5k6. In an exemplary embodiment, the heater comprises a Kanthal wire coil wrapped about the reservoirs and reaction cell chamber wherein graphite heat transfer blocks with ceramic heat transfer paste attached to the EM pump tubes 5k6 transfer heat to the tubes to melt the metal therein. Larger diameter EM pump tubes may be used to better transfer heat to the EM pump tube to cause melting in EM pump tube. The components containing molten metal may be well thermally insulated with an insulation such as ceramic fiber or other high temperature insulation known in the art. The components may be heated slowly to avoid thermal shock.

In an embodiment, the SunCell® comprises a heater such as a resistive heater. The heater may comprise a kiln or furnace that is positioned over at least one of the reaction cell chambers, the reservoirs, and the EM pump tubes. In the embodiment wherein the EM pump tubes are inside of the kiln, the EM pump magnets and the wet seal may be selectively thermally insulated and cooled by a cooling system such as a water-cooling system. In an embodiment, each reservoir may comprise a thermal insulator at the baseplate at the base of the molten metal such as a ceramic insulator. The insulator may comprise BN or a moldable ceramic such as one comprising alumina, magnesia, silica, zirconia, or hafnia. The ceramic insulator at the base of the molten metal may comprise penetrations for the EM pump inlet and injector, gas and vacuum lines, thermocouple, and ignition bus bar that makes direct contact with the molten metal. In an embodiment, the thermal insulator permits the molten metal to melt at the base of the reservoir by reducing heat loss to the baseplate and wet seal cooling. The diameter of the EM pump inlet penetration may be enlarged to increase the heat transfer from molten metal in the reservoir to that in the EM pump tube. The EM pump tube may comprise heat transfer blocks to transfer heat from the inlet penetration to the EM pump tube.

In an embodiment, the baseplate 5kk1 may comprise a refractory material or metal such as stainless steel, C, W, Re, Ta, Mo, Nb, Ir, Ru, Hf, Tc, Rh, V, Cr, Zr, Pa, Pt, Th, Lu, Ti, Pd, Tm, Sc, Fe, Y, Er, Co, Ho, Ni, and Dy that may be coated with a liner or coating such as one of the disclosure that is resistant to at least one of corrosion with at least one of O₂ and H₂O and alloy formation with the molten metal such as gallium or silver. In an embodiment, the EM pump tube may be lined or coated with a material that prevents corrosion or alloy formation. The EM bus bars may comprise a conductor that is resistant to at least one of corrosion or alloy formation. Exemplary EM pump bus bars wherein the molten metal is gallium are Ta, W, Re, and Ir. Exemplary EM pump bus bars wherein the molten metal is silver are W, Ta, Re, Ni, Co, and Cr. In an embodiment, the EM bus bars may comprise carbon or a metal with a high melting point that may be coated with an electrically conductive coating that resists alloy formation with the molten metal such as at least one of gallium and silver. Exemplary coatings comprise a carbide or diboride such as those of titanium, zirconium, and hafnium.

In an embodiment wherein the molten metal such as copper or gallium may form an alloy with the baseplate such as one comprising stainless steel, the baseplate comprises a liner or is coated with an material that does not form an alloy such as Ta, W, Re, or a ceramic such as BN, Mullite, or zirconia-titania-yttria.

In an embodiment of the SunCell® shown in FIGS. 66A-B, the molten metal comprises gallium or Galinstan, the seals at the baseplate 5kk1 comprise gaskets such as Viton O rings or carbon (Graphoil) gaskets, and the diameter of the inlet riser tubes 5qa is sufficiently large such that the levels of the molten metal in the reservoirs 5c are maintained about even with a near steady stream of injected molten metal from both reservoirs. The diameter of each inlet riser tube be larger than that of the silver molten metal embodiment, to overcome the higher viscosity of gallium and Galinstan. The inlet riser tube diameter may be in the range of about 3 mm to 2 cm. The baseplate 5kk1 may be stainless steel maintained below about 500° C. or may be ceramic coated to prevent gallium alloy formation.

### Exemplary Baseplate Coatings are Mullite and ZTY.

In an embodiment, the wet seal of a penetration may comprise a nipple through which the molten silver partially extends to be continuous with a solidified silver electrode. In an exemplary embodiment, the EM pump bus bars 5k2 comprise a wet seal comprising an inside ceramic coated EM pump tube 5k6 having opposing nipples through which the molten silver passes to contact a solidified section that comprises the EM pump power connector, and at least one bus bar may optionally further comprise a connector to one lead of the ignition power supply.

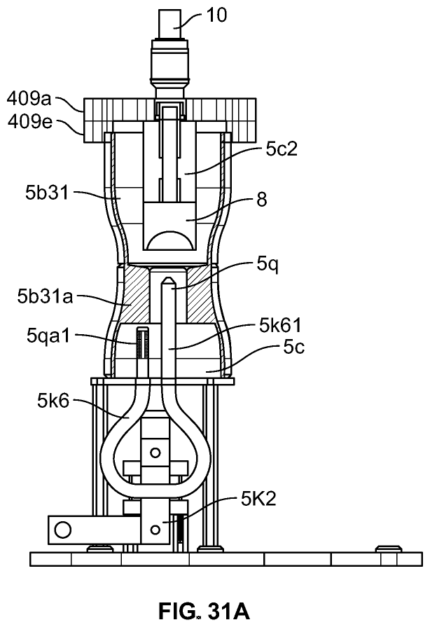

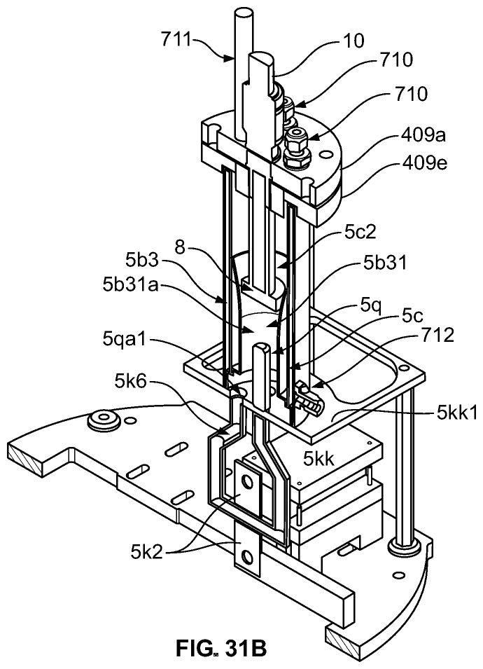

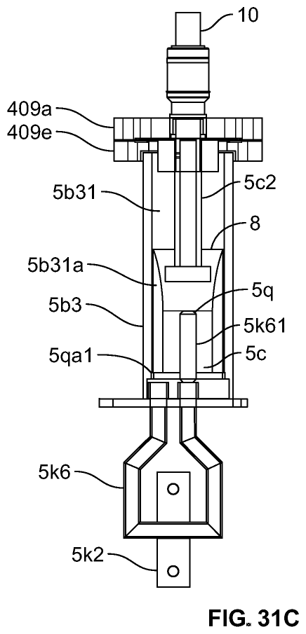

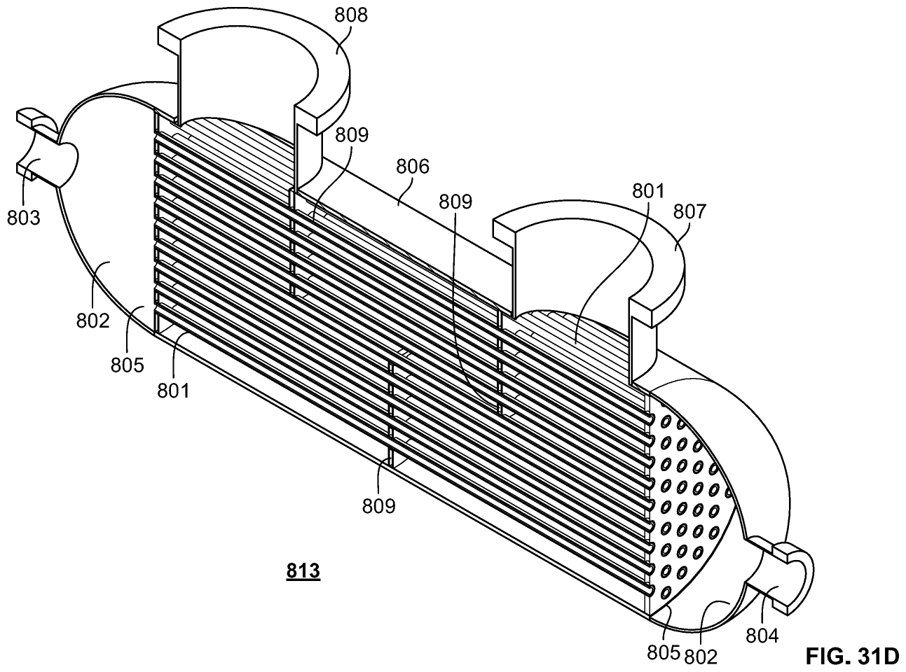

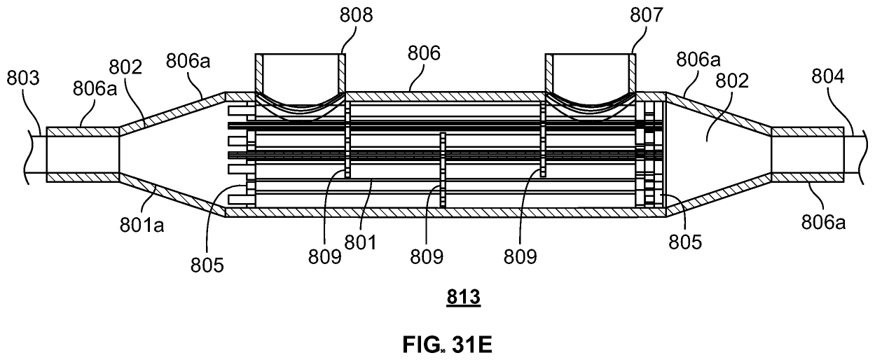

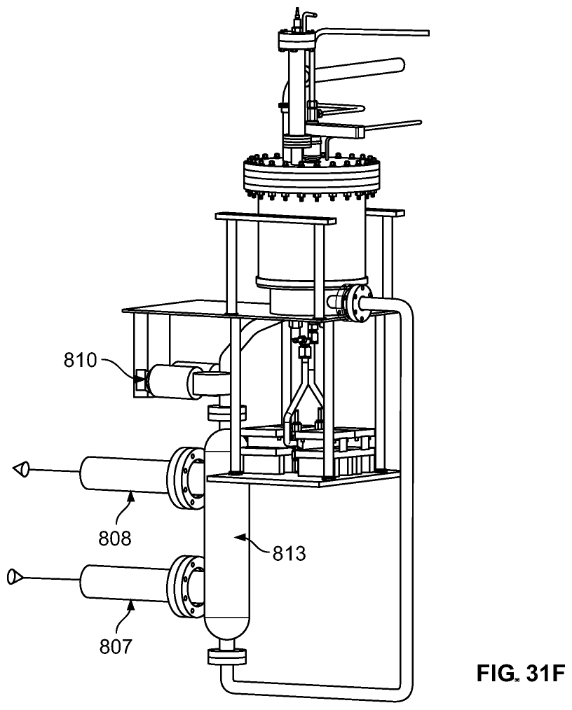

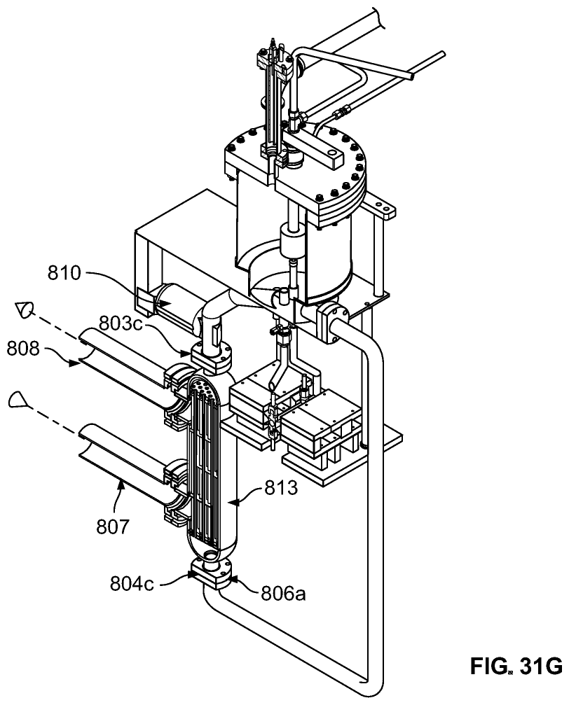

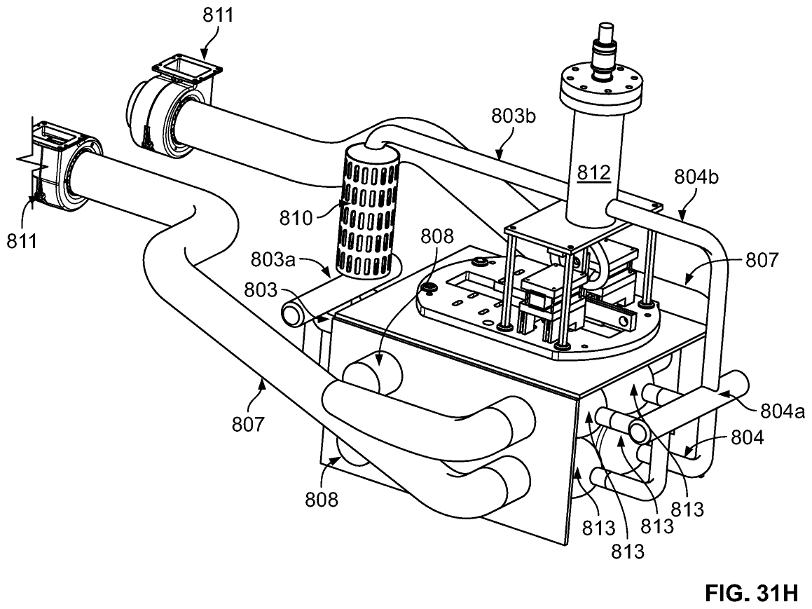

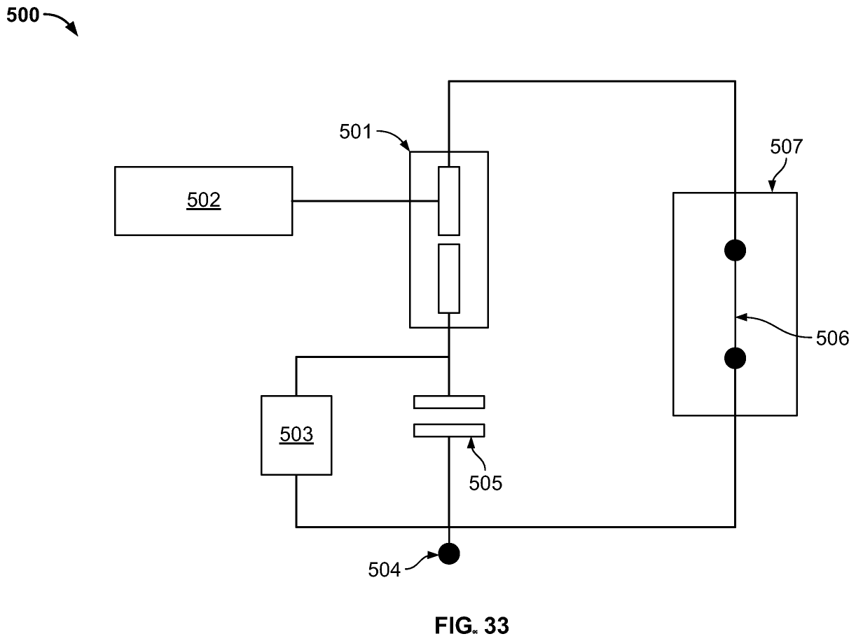

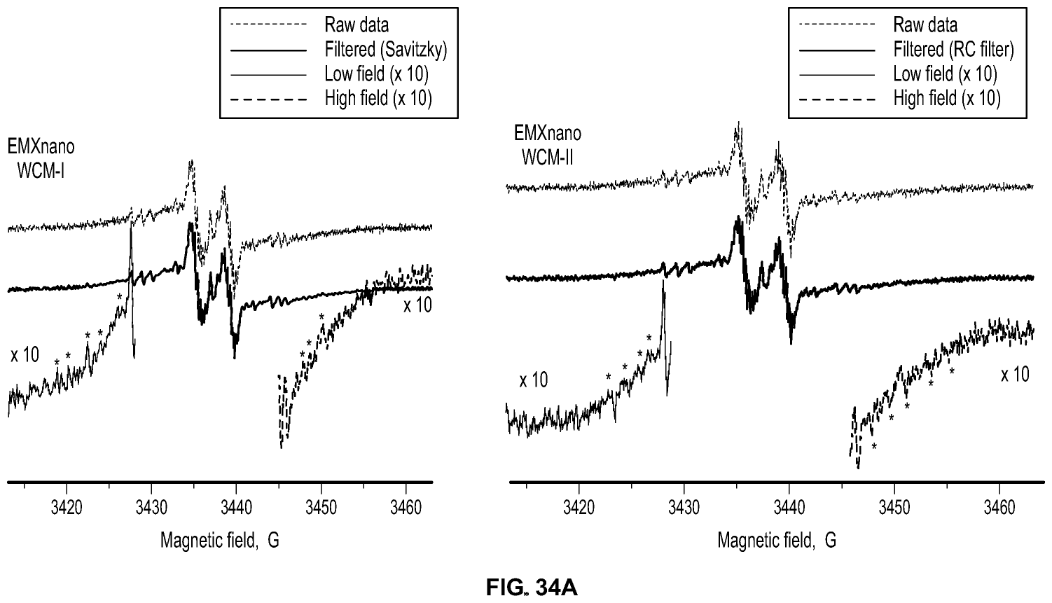

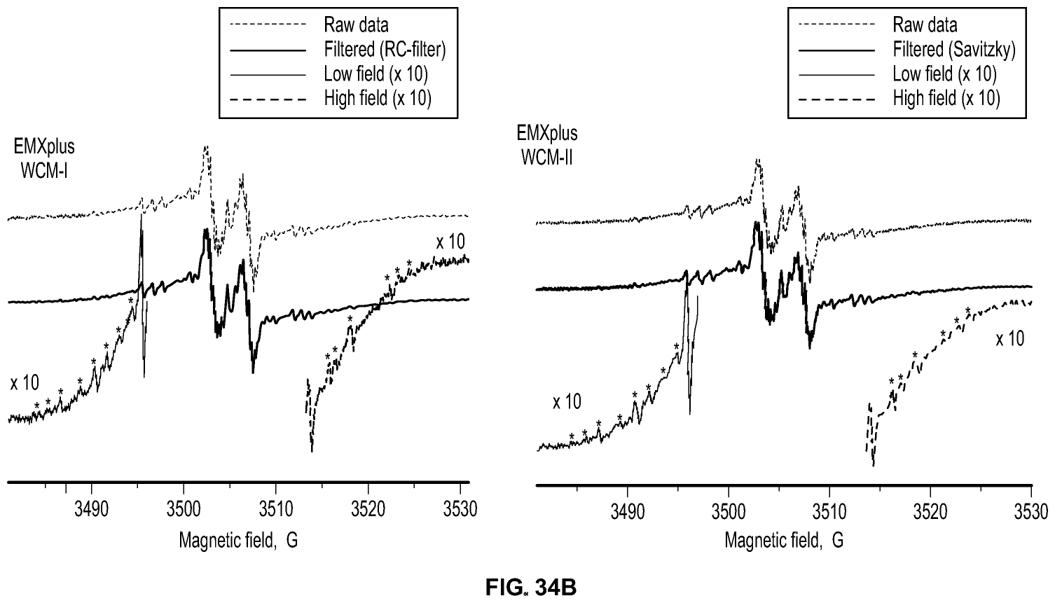

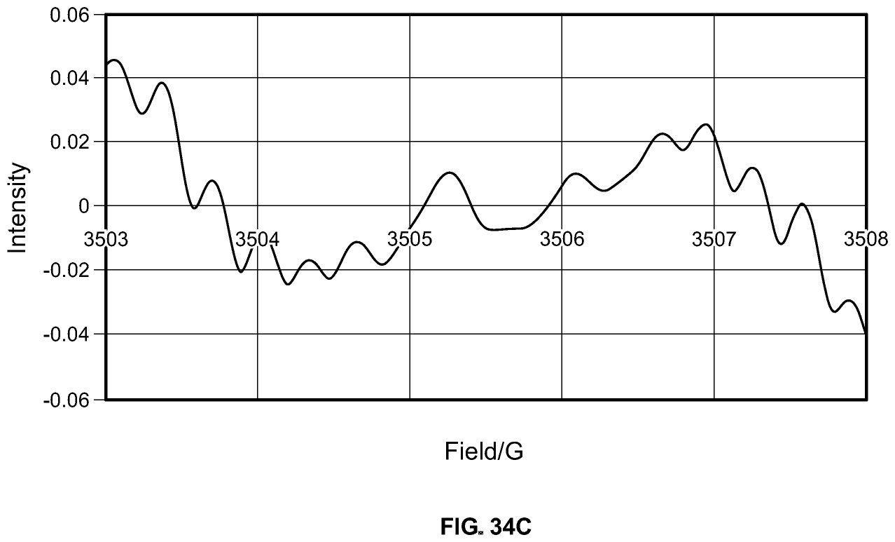

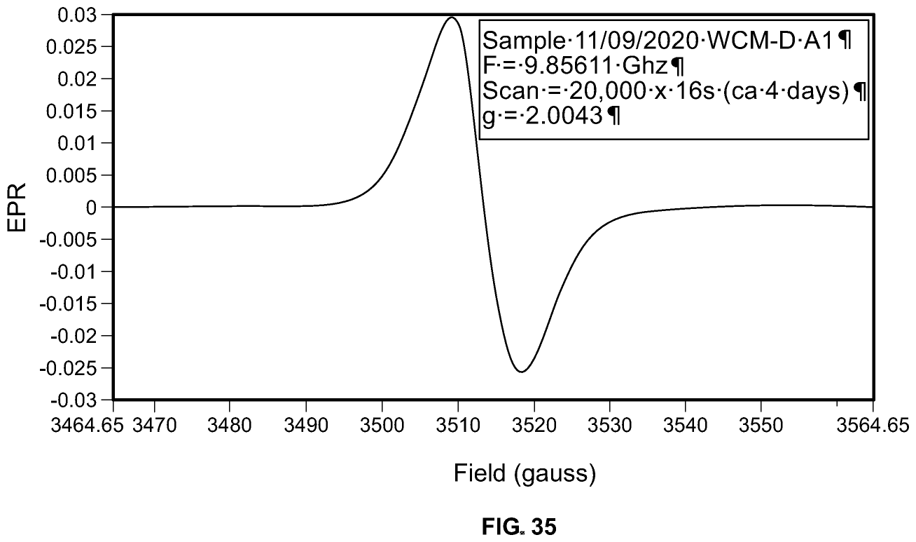

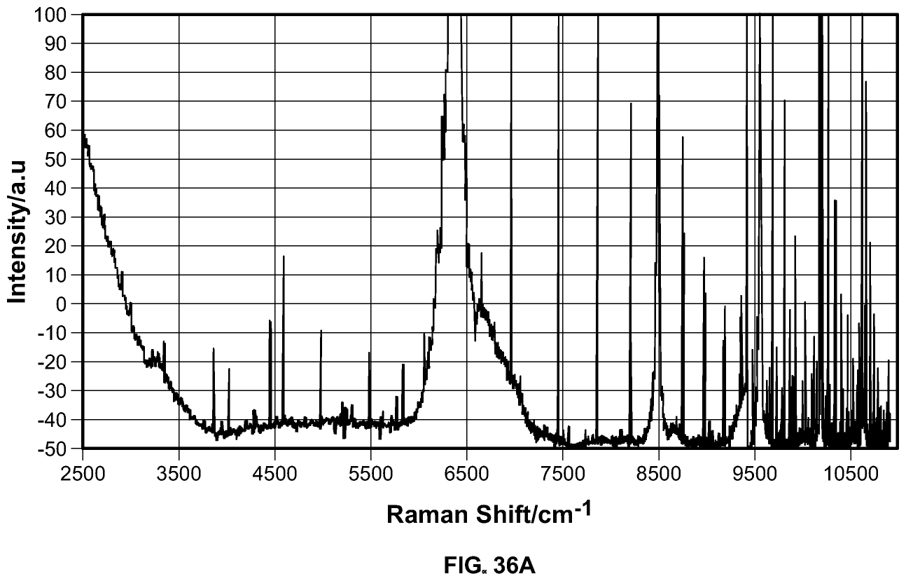

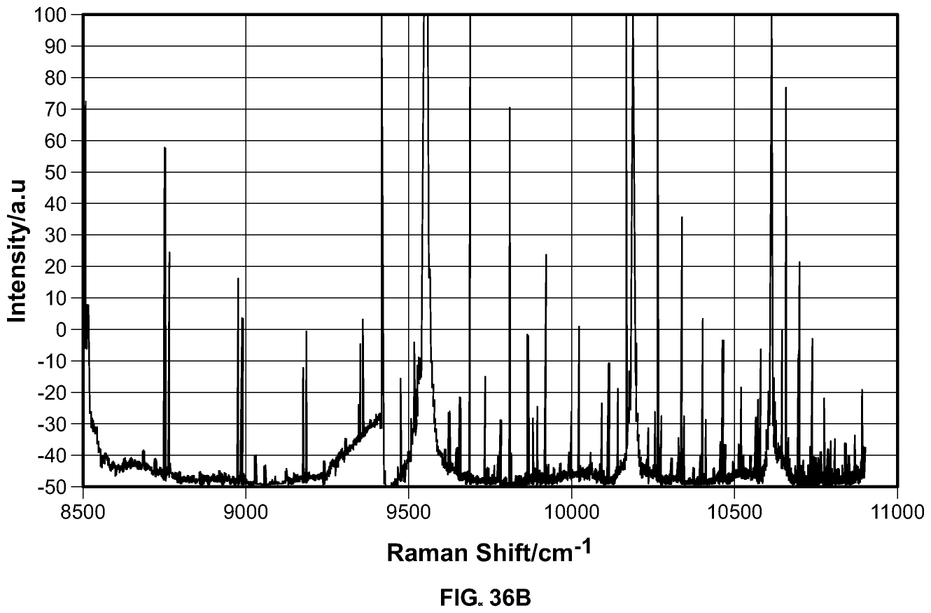

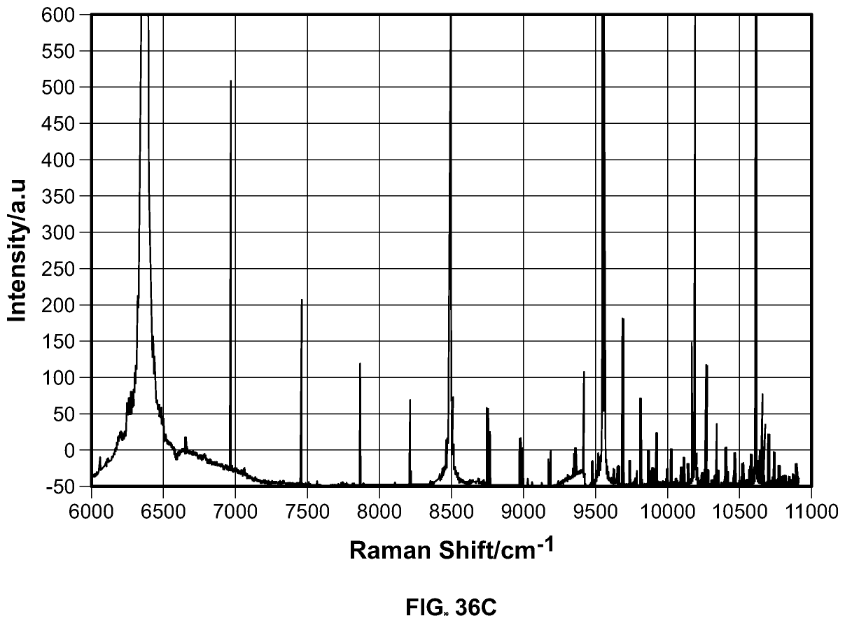

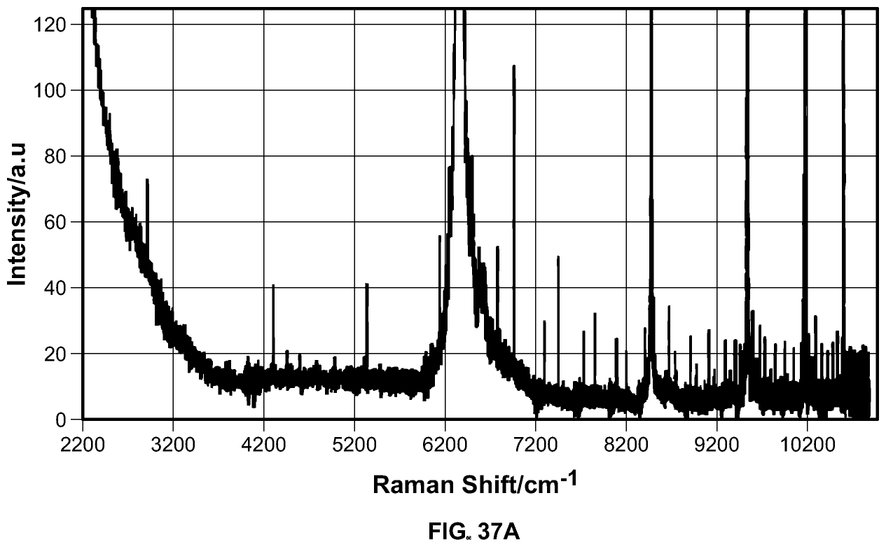

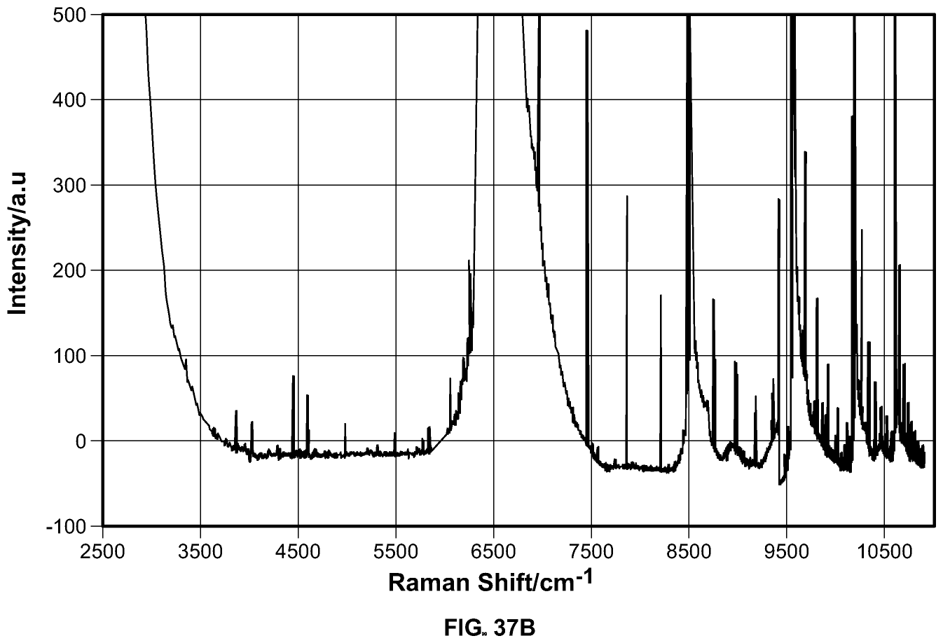

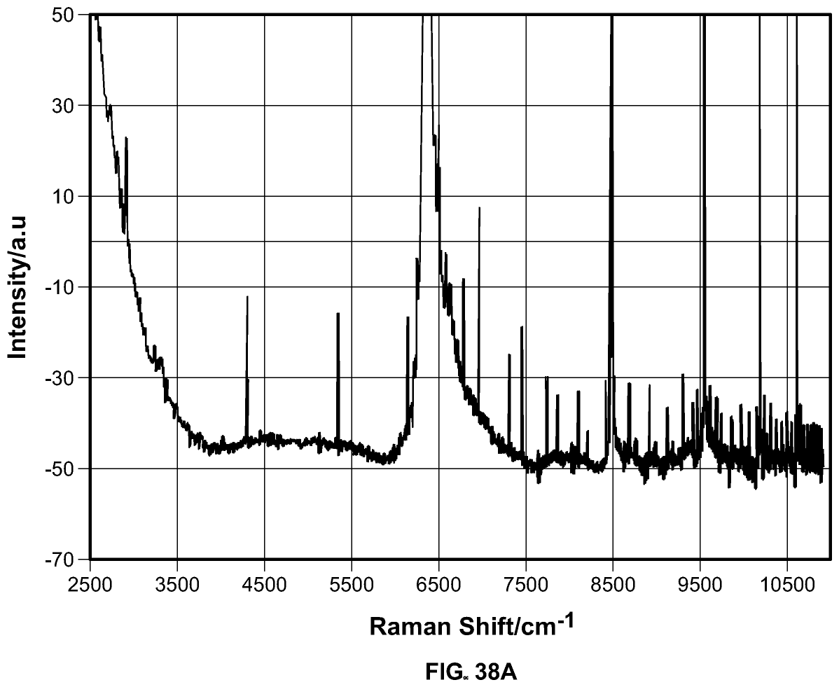

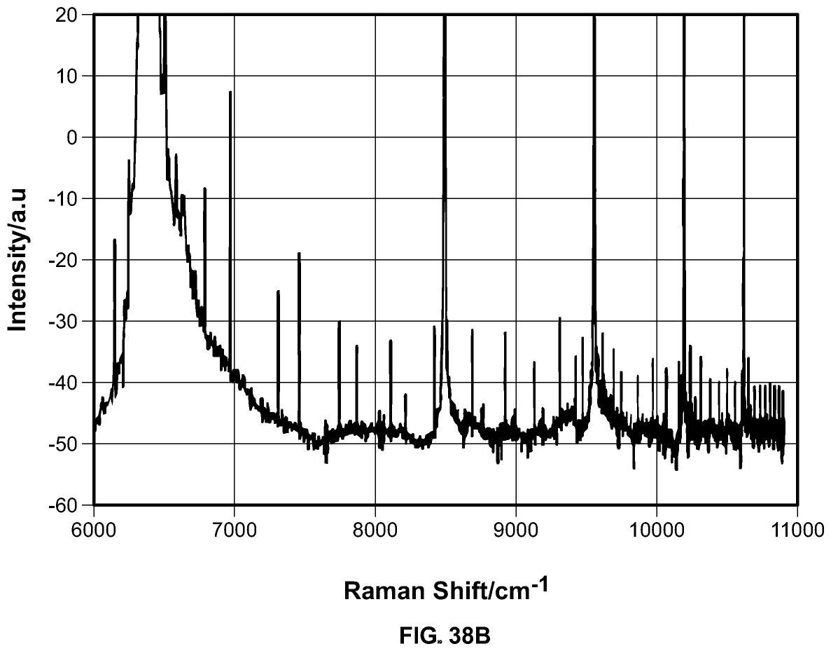

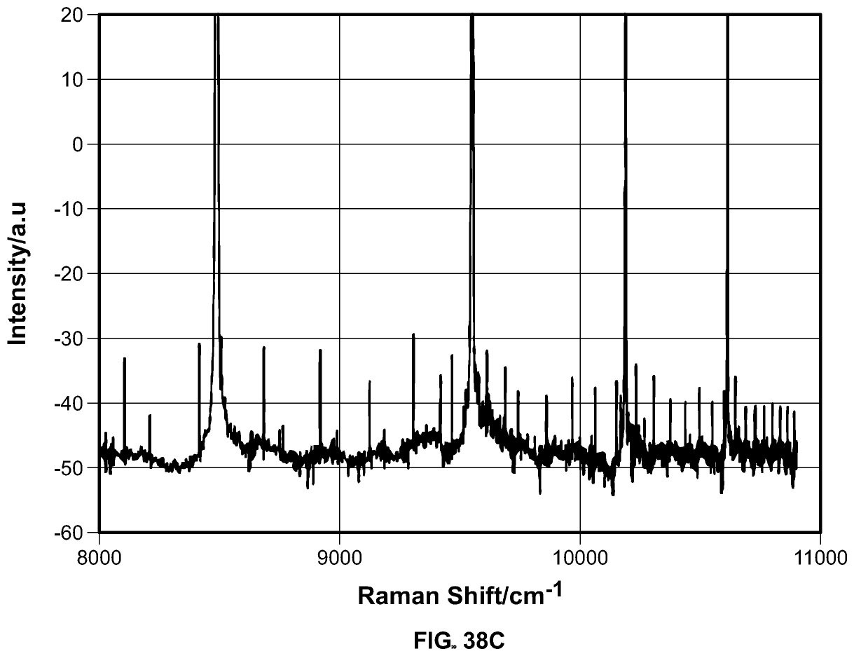

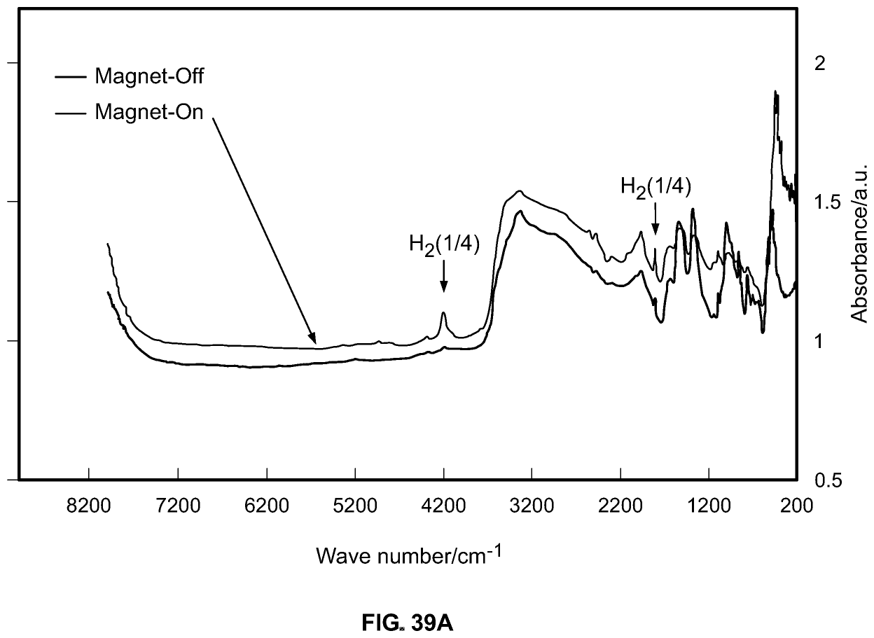

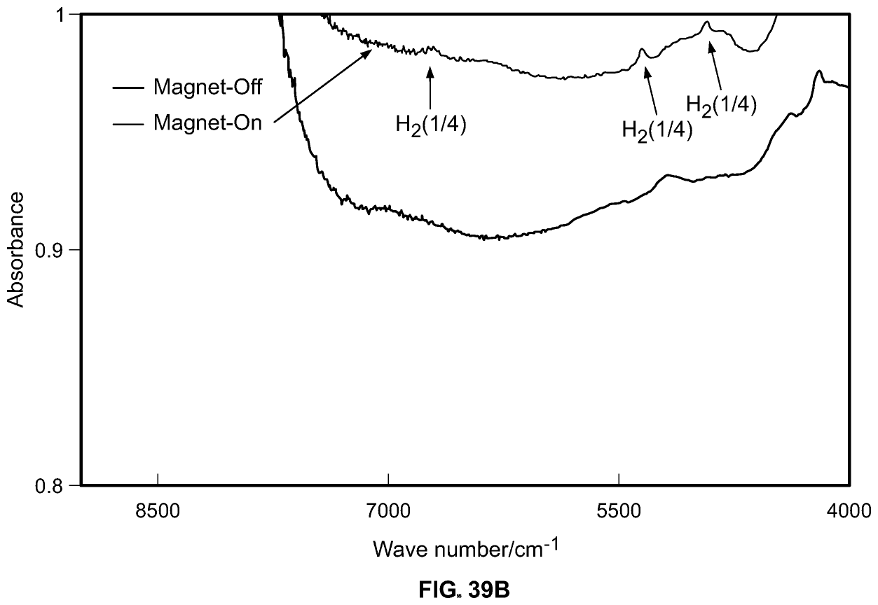

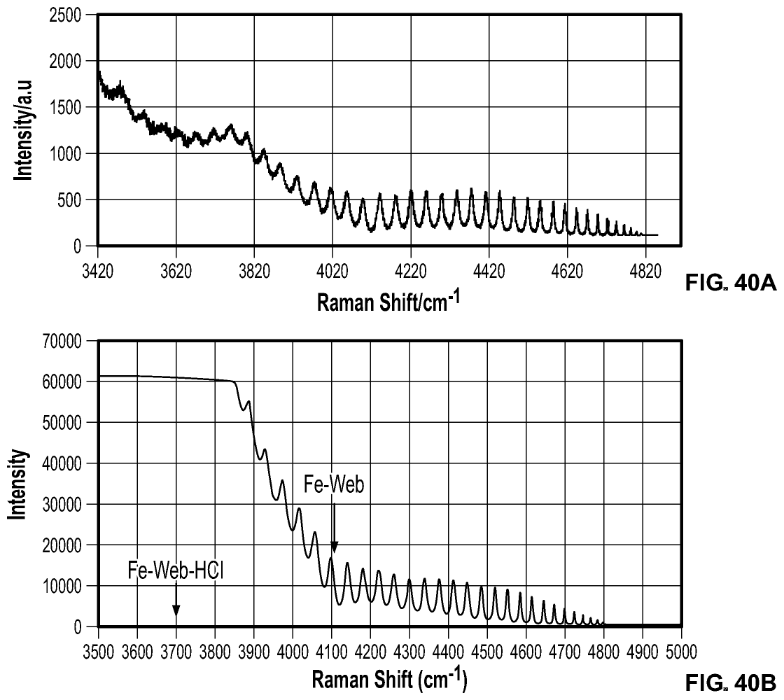

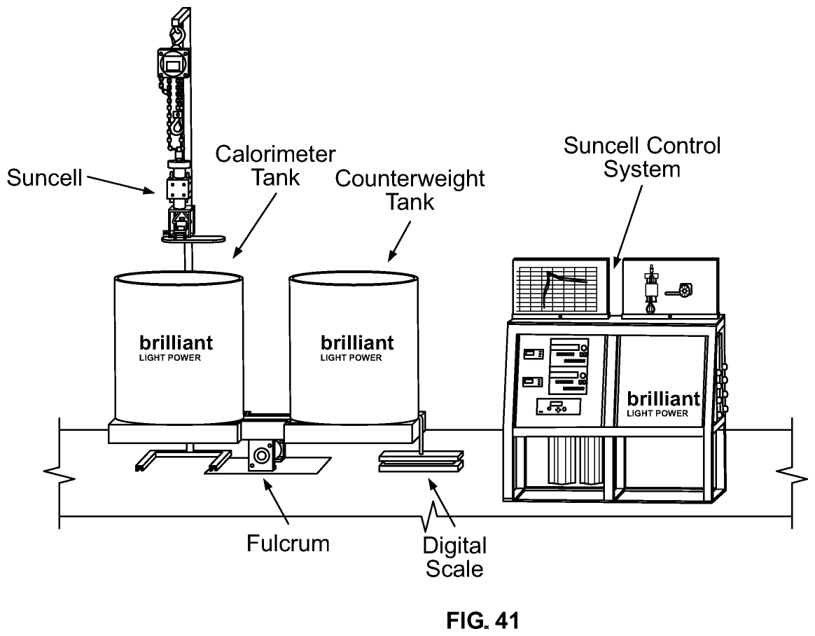

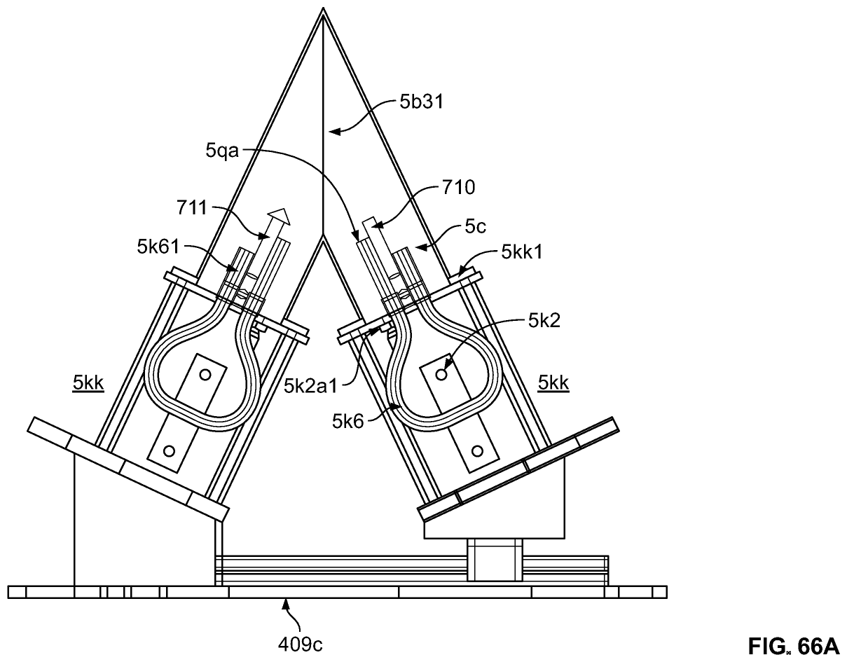

The EM pump tube 5k6 may comprise a material, liner, or coating that is resistant to forming an alloy with gallium or silver such as at least one of W, Ta, Re, Ir, Mo, BN, Alumina, Mullite, silica, quartz, zirconia, hafnia, titania, or another of the disclosure. In an embodiment, the pump tube, liner or coating comprises carbon. The carbon may be applied by a suspension means such as a spray or liquid coating that is cured and degassed. In an embodiment, the carbon-coated metal such as Ni may be resistant to forming a carbide at high temperature. In an embodiment, the EM pump tube 5k6 may comprise a metallic tube that is filled with a liner or coating material such as BN that is bored out to form the pump tube. The EM pump tube may be segmented or comprise an assembly comprising a plurality of parts (FIG. 31C). The parts may comprise a material such as Ta or a liner or coating that is resistant to forming an alloy with gallium. In an embodiment, the parts may be separately coated and assembled. The assembly may comprise at least one of a housing that contains two opposing bus bars 5k2, a liquid metal inlet, and a liquid metal outlet, and a means to seal the housing such as Swageloks. In an embodiment, the EM pump bus bars 5k2 may comprise a conductive portion in contact with the gallium inside of the EM pump tube that is resistant to forming an alloy with gallium. The conductive portion may comprise an alloy-resistant material such as Ta, W, Re, or Mo, or an alloy-resistant cladding or coating on another metal such as SS such as one comprising Ta, W, Re, Ir, or Mo. In an embodiment, the exterior or the EM pump tube such as one comprising Ta or W may be coated or clad with a coating of cladding of the disclosure to protect the exterior from oxidation. In exemplary embodiments, a Ta EM pump tube may be coated with Re, ZTY, or Mullite or clad with stainless steel (SS) wherein the cladding to the exterior of the Ta EM pump tube may comprise SS pieces adhered together using welds or an extreme-temperature-rated SS glue such as J-B Weld 37901.

An embodiment, the liner may comprise a thin-wall, flexible metal that is resistant to alloying with gallium such as a W, Ta, Re, Ir, Mo, or Ta tube liner that may be inserted into an EM pump tube 5k6 comprising another metal such as stainless steel. The liner may be inserted in a preformed EM pump tube or a straight tube that is then bent. The EM pump bus bars 5k2 may be attached by means such as welding after the liner is installed in the formed EM pump tube. The EM pump tube liner may form a tight seal with the EM pump bus bars 5k2 by a compression fitting or sealing material such as carbon or a ceramic sealant.

In an embodiment wherein at least one of the molten metal and any alloy formed from the molten metal may off gas to produce a gas boundary layer that interferes with EM pumping by at least partially blocking the Lorentz current, the EM pump tube 5k6 at the position of the magnets 5k4 may be vertical to break up the gas boundary layer.

In an embodiment, the SunCell® comprises an interference eliminator comprising a means to mitigate or eliminate any interference between the source of electrical power to the ignition circuit and the source of electrical power to the EM pump 5kk. The interference eliminator may comprise at least one of, one or more circuit elements and one or more controllers to regulate the relative voltage, current, polarity, waveform, and duty cycle of the ignition and EM pump currents to prevent interference between the two corresponding supplies.

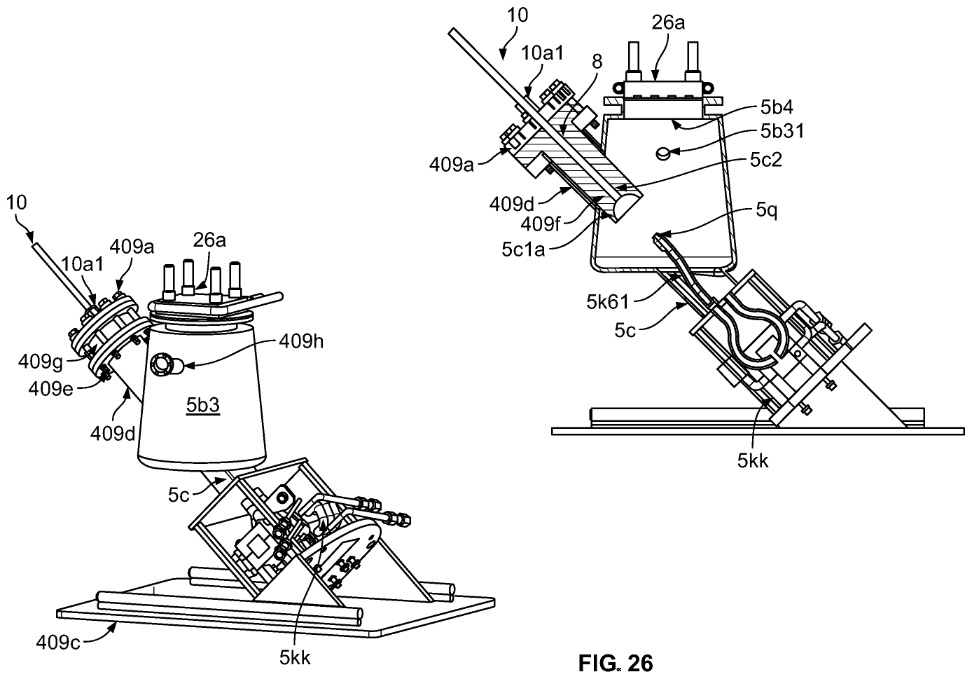

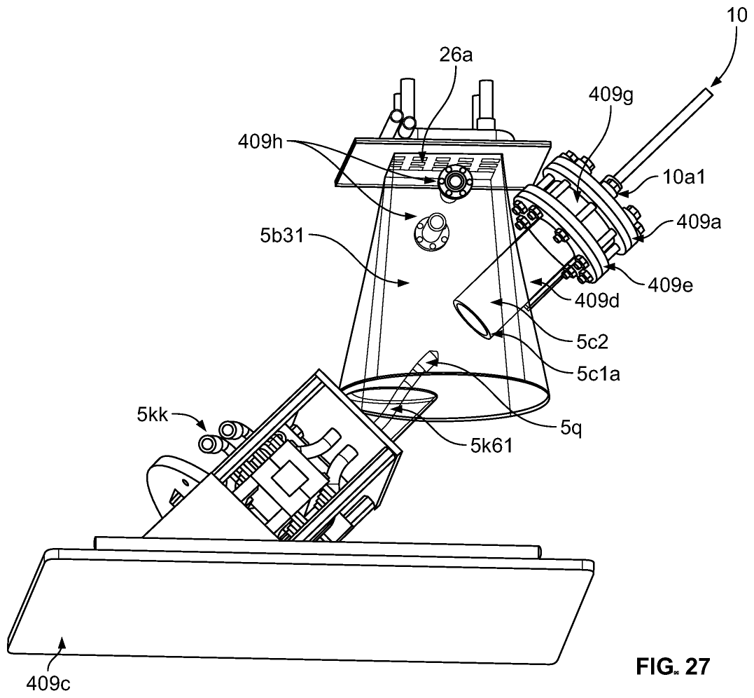

The SunCell® may further comprise a photovoltaic (PV) converter and a window to transmit light to the PV converter. In an embodiment shown in FIGS. 26-27, the SunCell® comprises a reaction cell chamber 5b31 with a tapering cross section along the vertical axis and a PV window 5b4 at the apex of the taper. The window with a mating taper may comprise any desired geometry that accommodates the PV array 26a such as circular (FIG. 26) or square or rectangular (FIG. 27). The taper may suppress metallization of the PV window 5b4 to permit efficient light to electricity conversion by the photovoltaic (PV) converter 26a. The PV converter 26a may comprise a dense receiver array of concentrator PV cells such as PV cells of the disclosure and may further comprise a cooling system such as one comprising microchannel plates. The PV window 5b4 may comprise a coating that suppresses metallization. The PV window may be cooled to prevent thermal degradation of the PV window coating. The SunCell® may comprise at least one partially inverted pedestal 5c2 having a cup or drip edge 5c1a at the end of the inverted pedestal 5c2 similar to one shown in FIG. 25 except that the vertical axis of each pedestal and electrode 10 may be oriented at an angle with respect to the vertical or z-axis. The angle may be in the range of 1° to 90°. In an embodiment, at least one counter injector electrode 5k61 injects molten metal from its reservoir 5c obliquely in the positive z-direction against gravity where applicable. The injection pumping may be provided by EM pump assembly 5kk mounted on EM pump assembly slide table 409c. In exemplary embodiments, the partially inverted pedestal 5c2 and the counter injector electrode 5k61 are aligned on an axis at 135° to the horizontal or x-axis as shown in FIG. 26 or aligned on an axis at 45° to the horizontal or x-axis as shown in FIG. 27. The insert reservoir 409f having insert reservoir flange 409g may be mounted to the cell chamber 5b3 by reservoir baseplate 409a, sleeve reservoir 409d, and sleeve reservoir flange 409e. The electrode may penetrate the reservoir baseplate 409a through electrode penetration 10a1. The nozzle 5q of the injector electrode may be submerged in the liquid metal such as liquid gallium contained in the bottom of the reaction cell chamber 5b31 and reservoir 5c. Gases may be supplied to the reaction cell chamber 5b31, or the chamber may be evacuated through gas ports such as 409h.

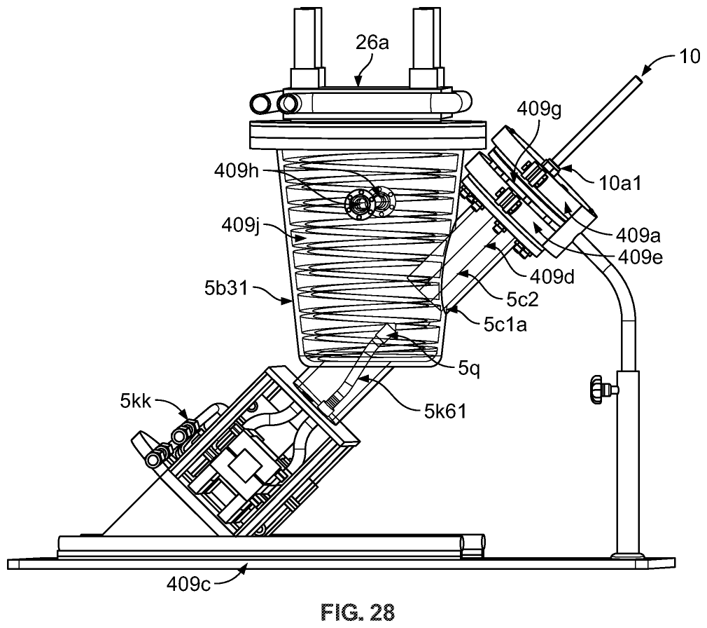

In an alternative embodiment shown in FIG. 28, the SunCell® comprises a reaction cell chamber 5b31 with a tapering cross section along the negative vertical axis and a PV window 5b4 at the larger diameter-end of the taper comprising the top of the reaction cell chamber 5b31, the opposite taper of the embodiment shown in FIGS. 26-27. In an embodiment, the SunCell® comprises a reaction cell chamber 5b31 comprising a right cylinder geometry. The injector nozzle and the pedestal counter electrode may be aligned on the vertical axis at opposite ends of the cylinder or along a line at a slant to the vertical axis.

In an embodiment shown in FIGS. 26 and 27, the electrode 10 and PV panel 26a may interchange locations and orientations such that the molten metal injector 5k6 and nozzle 5q inject molten metal vertically to the counter electrode 10, and the PV panel 26a receives light from the plasma side-on.

The SunCell may comprise a transparent window to serve as a light source of wavelengths transparent to the window. The SunCell may comprise a blackbody radiator 5b4 that may serve as a blackbody light source. In an embodiment, the SunCell® comprises a light source (e.g., the plasma from the reaction) wherein the hydrino plasma light emitted through the window is utilized in a desired lighting application such as room, street, commercial, or industrial lighting or for heating or processing such as chemical treatment or lithography.

In an embodiment the top electrode comprises the positive electrode. The SunCell may comprise an optical window and a photovoltaic (PV) panel behind the positive electrode. The positive electrode may serve as a blackbody radiator to provide at least one of heat, light, and illumination of a PV panel. In the latter case, the illumination of the PV panel generates electricity from the incident light. In an embodiment, the optical window may comprise a vacuum-tight outer window and an inner spinning window to prevent molten metal from adhering to the inner window and opacifying the window. In an embodiment, the positive electrode may heat a blackbody radiator which emits light through the PV window to the PV panel. The blackbody radiator may connect to the positive electrode to receive heat from it by conduction as well as radiation. The blackbody radiation may comprise a refractory metal such as a refractory metal such as tungsten (M.P.=3422° C.) or tantalum (M.P.=3020° C.), or a ceramic such as one of the disclosure such as one or more of the group of graphite (sublimation point=3642° C.), borides, carbides, nitrides, and oxides such as a metal oxide such as alumina, zirconia, yttria stabilized zirconia, magnesia, hafnia, or thorium dioxide (ThO₂); transition metals diborides such as hafnium boride (HfB₂), zirconium diboride (ZrB₂), or niobium boride (NbB₂); a metal nitride such as hafnium nitride (HfN), zirconium nitride (ZrN), titanium nitride (TiN), and a carbide such as titanium carbide (TiC), zirconium carbide, or tantalum carbide (TaC) and their associated composites. Exemplary ceramics having a desired high melting point are magnesium oxide (MgO) (M.P.=2852° C.), zirconium oxide (ZrO) (M.P.=2715° C.), boron nitride (BN) (M.P.=2973° C.), zirconium dioxide (ZrO₂) (M.P.=2715° C.), hafnium boride (HfB₂) (M.P.=3380° C.), hafnium carbide (HfC) (M.P.=3900° C.), Ta₄HfC₅ (M.P.=4000° C.), Ta₄HfC₅TaX₄HfCX₅ (4215° C.), hafnium nitride (HfN) (M.P.=3385° C.), zirconium diboride (ZrB₂) (M.P.=3246° C.), zirconium carbide (ZrC) (M.P.=3400° C.), zirconium nitride (ZrN) (M.P.=2950° C.), titanium boride (TiB₂) (M.P.=3225° C.), titanium carbide (TiC) (M.P.=3100° C.), titanium nitride (TiN) (M.P.=2950° C.), silicon carbide (SiC) (M.P.=2820° C.), tantalum boride (TaB₂) (M.P.=3040° C.), tantalum carbide (TaC) (M.P.=3800° C.), tantalum nitride (TaN) (M.P.=2700° C.), niobium carbide (NbC) (M.P.=3490° C.), niobium nitride (NbN) (M.P.=2573° C.), vanadium carbide (VC) (M.P.=2810° C.), and vanadium nitride (VN) (M.P.=2050° C.).

In an embodiment, the SunCell® comprises an induction ignition system with a cross connecting channel of reservoirs 414, a pump such as an induction EM pump, a conduction EM pump, or a mechanical pump in an injector reservoir, and a non-injector reservoir that serves as the counter electrode. The cross-connecting channel of reservoirs 414 may comprise restricted flow means such that the non-injector reservoir may be maintained about filled. In an embodiment, the cross-connecting channel of reservoirs 414 may contain a conductor that does not flow such as a solid conductor such as solid silver.

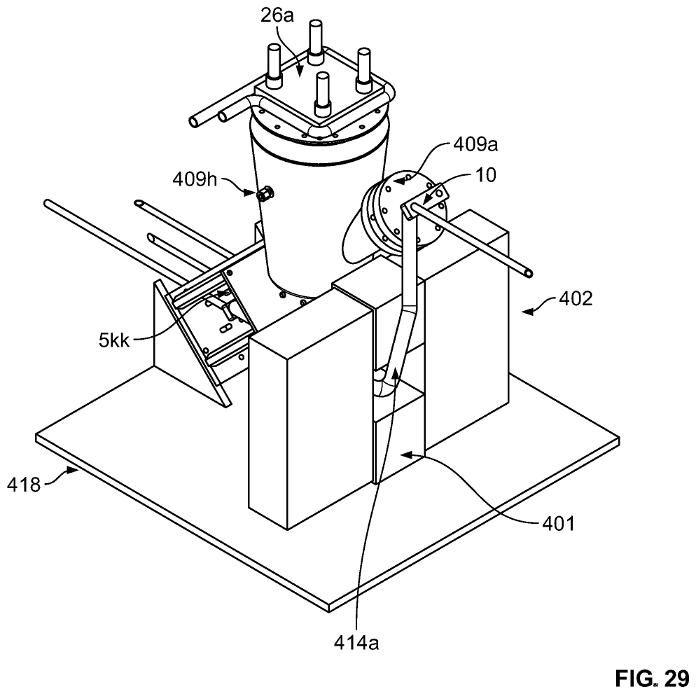

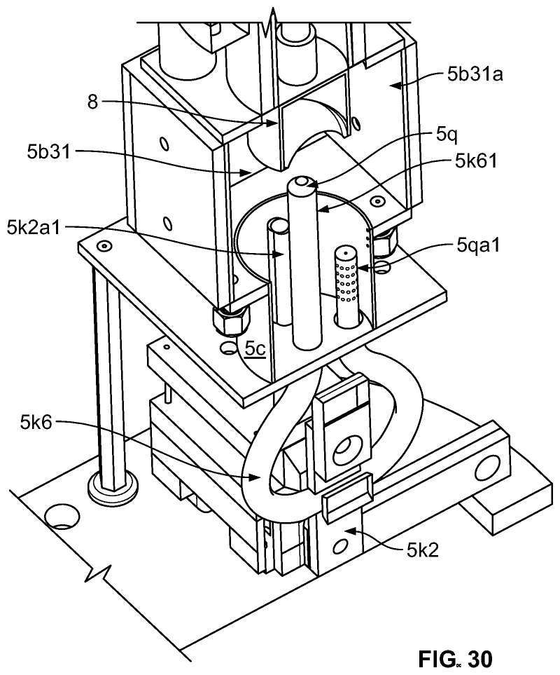

In an embodiment (FIG. 29), the SunCell® comprises a current connector or reservoir jumper cable 414a between the cathode and anode bus bars or current connectors. The cell body 5b3 may comprise a non-conductor, or the cell body 5b3 may comprise a conductor such as stainless steel wherein at least one electrode is electrically isolated from the cell body 5b3 such that induction current is forced to flow between the electrodes. The current connector or jumper cable may connect at least one of the pedestal electrode 8 and at least one of the electrical connectors to the EM pump and the bus bar in contact with the metal in the reservoir 5c of the EM pump. The cathode and anode of the SunCell® such as ones shown in FIGS. 25-28 comprising a pedestal electrode such as an inverted pedestal 5c2 or a pedestal 5c2 at an angle to the z-axis may comprise an electrical connector between the anode and cathode that form a closed current loop by the molten metal stream injected by the at least one EM pump 5kk. The metal stream may close an electrically conductive loop by contacting at least one of the molten metal EM pump injector 5k61 and 5q or metal in the reservoir 5c and the electrode of the pedestal. The SunCell® may further comprise an ignition transformer 401 having its yoke 402 in the closed conductive loop to induce a current in the molten metal of the loop that serves as a single loop shorted secondary. The transformer 401 and 402 may induce an ignition current in the closed current loop. In an exemplary embodiment, the primary may operate in at least one frequency range of 1 Hz to 100 kHz, 10 Hz to 10 kHz, and 60 Hz to 2000 Hz, the input voltage may operate in at least one range of about 10 V to 10 MV, 50 V to 1 MV, 50 V to 100 kV, 50 V to 10 kV, 50 V to 1 kV, and 100 V to 480 V, the input current may operate in at least one range of about 1 A to 1 MA, 10 A to 100 kA, 10 A to 10 kA, 10 A to 1 kA, and 30 A to 200 A, the ignition voltage may operate in at least one range of about 0.1 V to 100 kV, 1 V to 10 kV, 1 V to 1 kV, and 1 V to 50 V, and the ignition current may be in the range of about 10 A to 1 MA, 100 A to 100 kA, 100 A to 10 kA, and 100 A to 5 kA. In an embodiment, the plasma gas may comprise any gas such as at least one of a noble gas, hydrogen, water vapor, carbon dioxide, nitrogen, oxygen and air. The gas pressure may be in at least one range of about 1 microTorr to 100 atm, 1 milliTorr to 10 atm, 100 milliTorr to 5 atm, and 1 Torr to 1 atm.

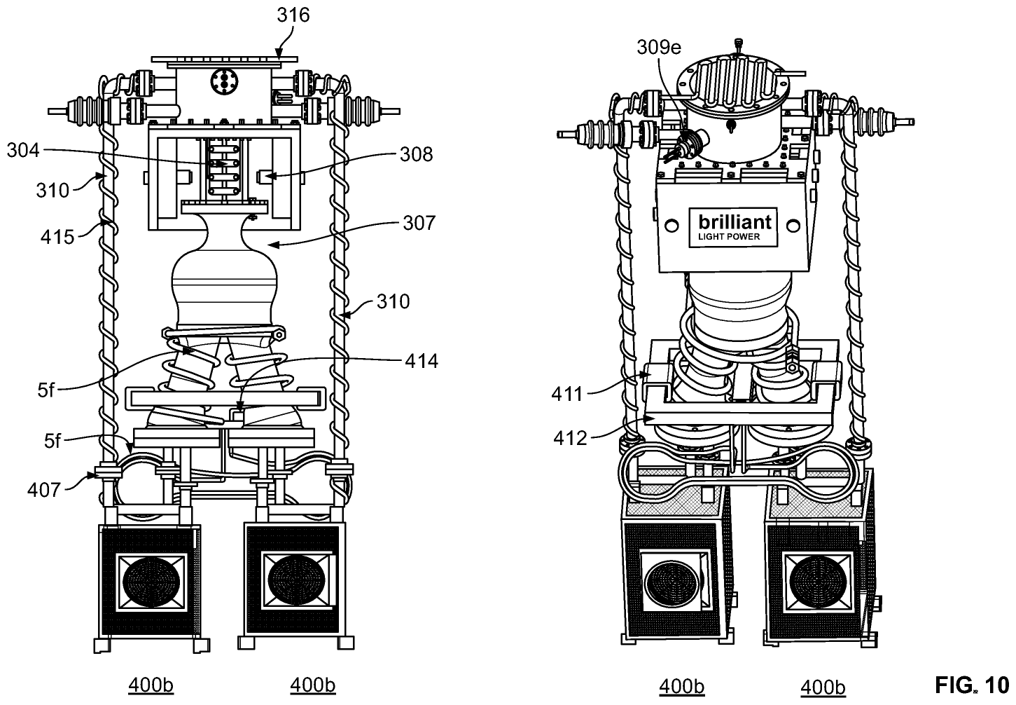

An exemplary tested embodiment comprised a quartz SunCell® with two crossed EM pump injectors such as the SunCell® shown in FIG. 10. Two molten metal injectors, each comprising an induction-type electromagnetic pump comprising an exemplary Fe based amorphous core, pumped Galinstan streams such that they intersected to create a triangular current loop that linked a 1000 Hz transformer primary. The current loop comprised the streams, two Galinstan reservoirs, and a cross channel at the base of the reservoirs. The loop served as a shorted secondary to the 1000 Hz transformer primary. The induced current in the secondary maintained a plasma in atmospheric air at low power consumption. The induction system is enabling of a silver-based-working-fluid-SunCell®-magnetohydrodynamic power generator of the disclosure wherein hydrino reactants are supplied to the reaction cell chamber according to the disclosure. Specifically, (i) the primary loop of the ignition transformer operated at 1000 Hz, (ii) the input voltage was 100 V to 150 V, and (iii) the input current was 25 A. The 60 Hz voltage and current of the EM pump current transformer were 300 V and 6.6 A, respectively. The electromagnet of each EM pump was powered at 60 Hz, 15-20 A through a series 299 μF capacitor to match the phase of the resulting magnetic field with the Lorentz cross current of the EM pump current transformer.

The transformer was powered by a 1000 Hz AC power supply. In an embodiment, the ignition transformer may be powered by a variable frequency drive such as a single-phase variable frequency drive (VFD). In an embodiment, the VFD input power is matched to provide the output voltage and current that further provides the desired ignition voltage and current wherein the number of turns and wire gauge are selected for the corresponding output voltage and current of the VFD. The induction ignition current may be in at least one range of about 10 A to 100 kA, 100 A to 10 kA, and 100 A to 5 kA. The induction ignition voltage may be in at least one range of 0.5 V to 1 kV, 1 V to 100 V, and 1 V to 10 V. The frequency may be in at least one range of about 1 Hz to 100 kHz, 10 Hz to 10 kHz, and 10 Hz to 1 kHz. An exemplary VFD is the ATO 7.5 kW, 220 V to 240 V output single phase 500 Hz VFD.

Another exemplary tested embodiment comprised a Pyrex SunCell® with one EM pump injector electrode and a pedestal counter electrode with a connecting jumper cable 414a between them such as the SunCell® shown in FIG. 29. The molten metal injector comprising an DC-type electromagnetic pump, pumped a Galinstan stream that connected with the pedestal counter electrode to close a current loop comprising the stream, the EM pump reservoir, and the jumper cable connected at each end to the corresponding electrode bus bar and passing through a 60 Hz transformer primary. The loop served as a shorted secondary to the 60 Hz transformer primary. The induced current in the secondary maintained a plasma in atmospheric air at low power consumption. The induction ignition system is enabling of a silver-or-gallium-based-molten-metal SunCell® power generator of the disclosure wherein hydrino reactants are supplied to the reaction cell chamber according to the disclosure. Specifically, (i) the primary loop of the ignition transformer operated at 60 Hz, (ii) the input voltage was 300 V peak, and (iii) the input current was 29 A peak. The maximum induction plasma ignition current was 1.38 kA.

In an embodiment, the source of electrical power or ignition power source comprises a non-direct current (DC) source such as a time dependent current source such as a pulsed or alternating current (AC) source. The peak current may be in at least one range such as 10 A to 100 MA, 100 A to 10 MA, 100 A to 1 MA, 100 A to 100 kA, 100 A to 10 kA, and 100 A to 1 kA. The peak voltage may be in at least one range of 0.5 V to 1 kV, 1 V to 100 V, and 1 V to 10 V. In an embodiment, the EM pump power source and AC ignition system may be selected to avoid inference that would result in at least one of ineffective EM pumping and distortion of the desired ignition waveform.

In an embodiment, the source of electrical power to supply the ignition current or ignition power source may comprise at least one of a DC, AC, and DC and AC power supply such as one that is powered by at least one of AC, DC, and DC and AC electricity such as a switching power supply, a variable frequency drive (VFD), an AC to AC converter, a DC to DC converter, and AC to DC converter, a DC to AC converter, a rectifier, a full wave rectifier, an inverter, a photovoltaic array generator, magnetohydrodynamic generator, and a conventional power generator such as a Rankine or Brayton-cycle-powered generator, a thermionic generator, and a thermoelectric generator. The ignition power source may comprise at least one circuit element such as a transition, IGBT, inductor, transformer, capacitor, rectifier, bridge such as an H-bridge, resistor, operation amplifier, or another circuit element or power conditioning device known in the art to produce the desired ignition current. In an exemplary embodiment, the ignition power source may comprise a full wave rectified high frequency source such as one that supplies positive square wave pulses at about 50% duty cycle or greater. The frequency may be in the range of about 60 Hz to 100 kHz. An exemplary supply provides about 30-40 V and 3000-5000 A at a frequency of in the range of about 10 kHz to 40 kHz. In an embodiment, the electrical power to supply the ignition current may comprise a capacitor bank charged to an initial offset voltage such as one in the range of 1 V to 100 V that may be in series with an AC transformer or power supply wherein the resulting voltage may comprise DC voltage with AC modulation. The DC component may decay at a rate dependent on its normal discharge time constant, or the discharge time may be increased or eliminated wherein the ignition power source further comprises a DC power supply that recharges the capacitor bank. The DV voltage component may assist to initiate the plasma wherein the plasma may thereafter be maintained with a lower voltage. The ignition power supply such as a capacitor bank may comprise a fast switch such as one controlled by a servomotor or solenoid to connect and disconnect ignition power to electrodes.

In an embodiment, at least one of the hydrino plasma and ignition current may comprise an arc current. An arc current may have the characteristic that the higher the current, the lower the voltage. In an embodiment, at least one of the reaction cell chamber walls and the electrodes are selected to form and support at least one of a hydrino plasma current and an ignition current that comprises an arc current, one with a very low voltage at very high current. The current density may be in at least one range of about 1 A/cm² to 100 MA/cm², 10 A/cm² to 10 MA/cm², 100 A/cm² to 10 MA/cm², and 1 kA/cm² to 1 MA/cm².

In an embodiment, the ignition system may apply a high starting power to the plasma and then decrease the ignition power after the resistance drops. The resistance may drop due to at least one of an increase in conductivity due to reduction of any oxide in the ignition circuit such as on the electrodes or the molten metal stream, and formation of a plasma. In an exemplary embodiment, the ignition system comprises a capacitor bank in series with AC to produce AC modulation of high-power DC wherein the DC voltage decays with discharge of the capacitors and only lower AC power remains.

In an embodiment the molten metal may be selected to form gaseous nanoparticles, to be more volatile, or to comprise more volatile components to increase the conductivity of the plasma. For example, the molten metal may be more volatile or comprise more volatile components than silver (e.g., the molten metal may have a boiling point less than the boiling point of silver). In an exemplary embodiment, the molten metal may comprise Galinstan which has an increased volatility compared to gallium at a given temperature since Galinstan boils at about 1300° C. compared the boiling point of gallium of 2400° C. In another exemplary embodiment, silver may fume at its melting point in the presence of trace oxygen. Zinc is another exemplary metal that exhibits nanoparticle fuming. Zinc forms an oxide that is not volatile (B. P.=1974° C.), and ZnO may be reduced by hydrogen. ZnO may be reduced by the hydrogen of the hydrino reaction mixture. In an embodiment, the molten metal may comprise a mixture or alloy of zinc metal and gallium or Galinstan. The ratio of each metal may be selected to achieve the desired nanoparticle formation and enhancement of at least one of power production and MHD power conversion. The increase in ion-recombination rate due to the higher plasma conductivity may maintain the hydrino reaction and plasma with reduced ignition current or in the absence of ignition current. In an embodiment, the SunCell® comprises a condenser to cause the vaporized metal or aerosolized nanoparticle metal such as Galinstan to reflux. In an embodiment, the refluxing metal in the gas phases maintains the hydrino reaction with low to the absence of ignition power. In an exemplary embodiment, the cell is operated at about the boiling point of Galinstan such that refluxing Galinstan metal maintains the hydrino reaction with low to no ignition power, and in another exemplary embodiment, refluxing silver nanoparticles maintain the hydrino reaction with low to no ignition power.

In an embodiment, one or more properties of a metal of a low-boiling point or low heat of vaporization relative to other candidates, and the ability to form nanoparticle fumes at a temperature less than its boiling point makes it suitable as a working gas of the MHD system wherein the working gas forms a gaseous phase upon sufficient heating and provides pressure-volume or kinetic energy work against the MHD conversion system to produce electricity.

In an embodiment, the pedestal electrode 8 may be recessed in the insert reservoir 409f wherein the pumped molten metal fills a pocket such as 5c1a to dynamically form a pool of molten metal in contact with the pedestal electrode 8. The pedestal electrode 8 may comprise a conductor that does not form an alloy with the molten metal such as gallium at the operating temperature of the SunCell®. An exemplary pedestal electrode 8 comprises tungsten, tantalum, stainless steel, or molybdenum wherein Mo does not form an alloy such as Mo₃Ga with gallium below an operating temperature of 600° C. In an embodiment, the inlet of the EM pump may comprise a filter 5ga1 such as a screen or mesh that blocks alloy particles while permitting gallium to enter. To increase the surface area, the filter may extend at least one of vertically and horizontally and connect to the inlet. The filter may comprise a material that resists forming an alloy with gallium such as stainless steel (SS), tantalum, or tungsten. An exemplary inlet filter comprises a SS cylinder having a diameter equal to that of the inlet but vertically elevated. The filter many be cleaned periodically as part of routine maintenance.

In an embodiment, the non-injector elector electrode may be intermittently submerged in the molten metal in order to cool it. In an embodiment, the SunCell® comprises an injector EM pump and its reservoir 5c and at least one additional EM pump and may comprise another reservoir for the additional EM pump. Using the additional reservoir, the additional EM pump may at least one of (i) reversibly pump molten metal into the reaction cell chamber to intermittently submerge the non-injector electrode in order to cool it and (ii) pump molten metal onto the non-injector electrode in order to cool it. The SunCell® may comprise a coolant tank with coolant, a coolant pump to circulate coolant through the non-injector electrode, and a heat exchanger to reject heat from the coolant. In an embodiment, the non-injector electrode may comprise at a channel or cannula for coolant such as water, molten salt, molten metal, or another coolant known in the art to cool the non-injector electrode.

In an inverted embodiment shown in FIG. 25, the SunCell® is rotated by 180° such that the non-injector electrode is at the bottom of the cell and the injector electrode is at the top of the reaction cell chamber such that the molten metal injection is along the negative z-axis. At least one of the noninjector electrode and injector electrode may be mounted in a corresponding plate and may be connected to the reaction cell chamber by a corresponding flange seal. The seal may comprise a gasket that comprises a material that does not form an alloy with gallium such as Ta, W, or a ceramic such as one of the disclosure or known in the art. The reaction cell chamber section at the bottom may serve as the reservoir, the former reservoir may be eliminated, and the EM pump may comprise an inlet riser in the new bottom reservoir that may penetrate the bottom base plate, connect to an EM pump tube, and provide molten metal flow to the EM pump wherein an outlet portion of the EM pump tube penetrates the top plate and connects to the nozzle inside of the reaction cell chamber. During operation, the EM pump may pump molten metal from the bottom reservoir and inject it into the non-injector electrode 8 at the bottom of the reaction cell chamber. The inverted SunCell® may be cooled by a high flow of gallium injected by the injector electrode for the top of the cell. The non-injector electrode 8 may comprise a concave cavity to pool the gallium to better cool the electrode. In an embodiment, the non-injector electrode may serve as the positive electrode; however, the opposite polarity is also an embodiment of the disclosure.

In an embodiment, the electrode 8 may be cooled by emitting radiation. To increase the heat transfer, the radiative surface area may be increased. In an embodiment, the bus bar 10 may comprise attached radiators such as vane radiators such as planar plates. The plates may be attached by fasting the face of an edge along the axis of the bus bar 10. The vanes may comprise a paddle wheel pattern. The vanes may be heated by conductive heat transfer from the bus bar 10 that may be heated by at least one of resistively by the ignition current and heated by the hydrino reaction. The radiators such as vanes may comprise a refractory metal such as Ta, Re, or W.

In an embodiment, the PV window may comprise an electrostatic precipitator (ESP) in front of the PV window to block oxide particles such as Ga₂O. The ESP may comprise a tube with a central coronal discharge electrode such as a central wire, and a high voltage power supply to cause a discharge such as a coronal discharge at the wire. The discharge may charge the oxide particles which may be attracted by and migrate to the wall of the ESP tube where they may be at least one of collected and removed. The ESP tube wall may be highly polished to reflect light from the reaction cell chamber to the PV window and a PV converter such as a dense receiver array of concentrator PV cells.

In an embodiment, a PV window system comprises at least one of a transparent rotating baffle in front of a stationary sealed window, both in the xy-plane for light propagating along the z-axis and a window that may rotate in the xy-plane for light propagating along the z-axis. An exemplary embodiment comprises a spinning transparent disc such as a clear view screen https://en.wikipedia.org/wiki/Clear_view_screen) that may comprise at least one of the baffle and the window. In an embodiment, the SunCell® comprises a corona discharge system comprising a negative electrode, a counter electrode, and a discharge power source. In an exemplary embodiment, the negative electrode may comprise a pin, needle, or wire that may be in proximity of the PV baffle or widow such as a spinning one. The cell body may comprise the counter electrode. A coronal discharge may be maintained near the PV window to charge at least one of particles formed during power generation operation such as Ga₂O and the PV baffle or window negatively such that the particles are repelled by the PV baffle or window.

In an embodiment, the molten metal stream injected by the EM pump may become misaligned or deviate from a trajectory to impact the counter electrode center. The EM pump may further comprise a controller that senses the misalignment and alters the EM pump current to re-establish proper stream alignment and then may reestablish the initial EM pumping rate. The controller may comprise a sensor such as at least one thermocouple to sense the misalignment wherein the temperature of at least one component that is monitored increases when the misalignment occurs. In an exemplary embodiment, the controller controls the EM pump current to maintain injection stability using sensors such as thermocouples and software.

In an embodiment, the injector nozzle 5q and the counter electrode 8 are axially aligned to ensure that the molten metal stream impacts the center of the counter electrode. Fabrication methods known the art such as laser alignment and others such as drilling a hole in the nozzle 5q after insertion of the injector pump tube 5k61 to achieve alignment may be implemented. In another embodiment, a concave counter electrode may reduce any adverse effects of misalignment by containing the injected molten metal within the concavity.

### Maintaining Plasma Generation

In an embodiment, the SunCell® comprises a vacuum system comprising an inlet to a vacuum line, a vacuum line, a trap, and a vacuum pump. The vacuum pump may comprise one with a high pumping speed such as a root pump, scroll, or multi-lobe pump and may further comprise a trap for water vapor that may be in series or parallel connection with the vacuum pump such as in series connection preceding the vacuum pump. In an embodiment, the vacuum pump such as a multi-lobe pump, or a scroll or root pump comprising stainless steel pumping components may be resistant to damage by gallium alloy formation. The water trap may comprise a water absorbing material such as a solid desiccant or a cryotrap. In an embodiment, the pump may comprise at least one of a cryopump, cryofilter, or cooler to at least one of cool the gases before entering the pump and condense at least one gas such as water vapor. To increase the pumping capacity and rate, the pumping system may comprise a plurality of vacuum lines connected to the reaction cell chamber and a vacuum manifold connected to the vacuum lines wherein the manifold is connected to the vacuum pump. In an embodiment, the inlet to vacuum line comprises a shield for stopping molten metal particles in the reaction cell chamber from entering the vacuum line. An exemplary shield may comprise a metal plate or dome over the inlet but raised from the surface of the inlet to provide a selective gap for gas flow from the reaction cell chamber into the vacuum line. The vacuum system that may further comprise a particle flow restrictor to the vacuum line inlet such as a set of baffles to allow gas flow while blocking particle flow.

The vacuum system may be capable of at least one of ultrahigh vacuum and maintaining a reaction cell chamber operating pressure in at least one low range such as about 0.01 Torr to 500 Torr, 0.1 Torr to 50 Torr, 1 Torr to 10 Torr, and 1 Torr to 5 Torr. The pressure may be maintained low in the case of at least one of (i) H₂ addition with trace HOH catalyst supplied as trace water or as O₂ that reacts with H₂ to form HOH and (ii) H₂O addition. In the case that noble gas such as argon is also supplied to the reaction mixture, the pressure may be maintained in at least one high operating pressure range such as about 100 Torr to 100 atm, 500 Torr to 10 atm, and 1 atm to 10 atm wherein the argon may be in excess compared to other reaction cell chamber gases. The argon pressure may increase the lifetime of at least one of HOH catalyst and atomic H and may prevent the plasma formed at the electrodes from rapidly dispersing so that the plasma intensity is increased.

In an embodiment, the reaction cell chamber comprises a means to control the reaction cell chamber pressure within a desired range by changing the volume in response to pressure changes in the reaction cell chamber. The means may comprise a pressure sensor, a mechanical expandable section, an actuator to expand and contract the expandable section, and a controller to control the differential volume created by the expansion and contraction of the expandable section. The expandable section may comprise a bellows. The actuator may comprise a mechanical, pneumatic, electromagnetic, piezoelectric, hydraulic, and other actuators known in the art.

In an embodiment, the SunCell® may comprise a (i) gas recirculation system with a gas inlet and an outlet, (ii) a gas separation system such as one capable of separating at least two gases of a mixture of at least two of a noble gas such as argon, O₂, H₂, H₂O, a volatile species of the reaction mixture such as GaX₃ (X=halide) or NₓO_{y} (x, y=integers), and hydrino gas, (iii) at least one noble gas, O₂, H₂, and H₂O partial pressure sensors, (iv) flow controllers, (v) at least one injector such as a microinjector such as one that injects water, (vi) at least one valve, (vii) a pump, (viii) an exhaust gas pressure and flow controller, and (ix) a computer to maintain at least one of the noble gas, argon, O₂, H₂, H₂O, and hydrino gas pressures. The recirculation system may comprise a semipermeable membrane to allow at least one gas such as molecular hydrino gas to be removed from the recirculated gases. In an embodiment, at least one gas such as the noble gas may be selectively recirculated while at least one gas of the reaction mixture may flow out of the outlet and may be exhausted through an exhaust. The noble gas may at least one of increase the hydrino reaction rate and increase the rate of the transport of at least one species in the reaction cell chamber out the exhaust. The noble gas may increase the rate of exhaust of excess water to maintain a desired pressure. The noble gas may increase the rate that hydrinos are exhausted. In an embodiment, a noble gas such as argon may be replaced by a noble-like gas that is at least one of readily available from the ambient atmosphere and readily exhausted into the ambient atmosphere. The noble-like gas may have a low reactivity with the reaction mixture. The noble-like gas may be acquired from the atmosphere and exhausted rather than be recirculated by the recirculation system. The noble-like gas may be formed from a gas that is readily available from the atmosphere and may be exhausted to the atmosphere. The noble gas may comprise nitrogen that may be separated from oxygen before being flowed into the reaction cell chamber. Alternatively, air may be used as a source of noble gas wherein oxygen may be reacted with carbon from a source to form carbon dioxide. At least one of the nitrogen and carbon dioxide may serve as the noble-like gas. Alternatively, the oxygen may be removed by reaction with the molten metal such as gallium. The resulting gallium oxide may be regenerated in a gallium regeneration system such as one that forms sodium gallate by reaction of aqueous sodium hydroxide with gallium oxide and electrolyzes sodium gallate to gallium metal and oxygen that is exhausted.

In an embodiment, the SunCell® may be operated prominently closed with addition of at least one of the reactants H₂, O₂, and H₂O wherein the reaction cell chamber atmosphere comprises the reactants as well as a noble gas such as argon. The noble gas may be maintained at an elevated pressure such as in the range of 10 Torr to 100 atm. The atmosphere may be at least one of continuously and periodically or intermittently exhausted or recirculated by the recirculation system. The exhausting may remove excess oxygen. The addition of reactant O₂ with H₂ may be such that O₂ is a minor species and essentially forms HOH catalyst as it is injected into the reaction cell chamber with excess H₂. A torch may inject the H₂ and O₂ mixture that immediately reacts to form HOH catalyst and excess H₂ reactant. In an embodiment, the excess oxygen may be at least partially released from gallium oxide by at least one of hydrogen reduction, electrolytic reduction, thermal decomposition, and at least one of vaporization and sublimation due to the volatility of Ga₂O. In an embodiment, at least one of the oxygen inventory may be controlled and the oxygen inventory may be at least partially permitted to form HOH catalyst by intermittently flowing oxygen into the reaction cell chamber in the presence of hydrogen. In an embodiment, the oxygen inventory may be recirculated as H₂O by reaction with the added H₂. In another embodiment, excess oxygen inventor may be removed as Ga₂O₃ and regenerated by means of the disclosure such as by at least one of the skimmer and electrolysis system of the disclosure. The source of the excess oxygen may be at least one of O₂ addition and H₂O addition.

In an embodiment, the gas pressure in the reaction cell chamber may be at least partially controlled by controlling at least one of the pumping rate and the recirculation rate. At least one of these rates may be controlled by a valve controlled by a pressure sensor and a controller. Exemplary valves to control gas flow are solenoid valves that are opened and closed in response to an upper and a lower target pressure and variable flow restriction vales such as butterfly and throttle valves that are controlled by a pressure sensor and a controller to maintain a desired gas pressure range.

In an embodiment, the SunCell® comprises a means to vent or remove molecular hydrino gas from the reaction cell chamber 5b31. In an embodiment, at least one of the reaction cell liner and walls of the reaction cell chamber have a high permeation rate for molecular hydrino such as H₂(1/4). To increase the permeation rate, at least one of the wall thickness may be minimized and the wall operating temperature maximized. In an embodiment, the thickness of at least one of the reservoir 5c wall and the reaction cell chamber 5b31 wall may be in the range of 0.05 mm to 5 mm thick. In an embodiment, the reaction cell chamber wall is thinner in at least one region relative to another region to increase the diffusion or permeation rate of molecular hydrino product from the reaction cell chamber 5b31. In an embodiment, the upper side wall section of the reaction cell chamber wall such as the one just below the sleeve reservoir flange 409e of FIG. 31 is thinned. The thinning may also be desirable to decrease heat conduction to the sleeve reservoir flange 409e. The degree of thinning relative to other wall regions may be in the range of 5% to 90% (e.g., the thinned area has a cross sectional width that is from 5% to 90% of the cross sectional width of non-thinned sections such as the lower side wall section of the reaction chamber proximal to and below electrode 8).

The SunCell® may comprise temperature sensors, a temperature controller, and a heat exchanger such as water jets to controllably maintain the reaction cell chamber walls at a desired temperature such as in the range of 300° C. to 1000° C. to provide a desired high molecular hydrino permeation rate.

At least one of the wall and liner material may be selected to increase the permeation rate. In an embodiment, the reaction cell chamber 5b31 may comprise a plurality of materials such as one or more that contact gallium and one or more that is separated from gallium by a liner, coating, or cladding such as a liner, coating, or cladding of the disclosure. At least one of the separated or protected materials may comprise one that has increased permeability to molecular hydrino relative to a material that is not separated or protected from gallium contact. In an exemplary embodiment, the reaction cell chamber material may comprise one or more of stainless steel such as 347 SS such as 4130 alloy SS or Cr—Mo SS, nickel, Ti, niobium, vanadium, iron, W, Re, Ta, Mo, niobium, and Nb(94.33 wt %)-Mo(4.86 wt %)-Zr(0.81 wt %). Crystalline material such as SiC may be more permeable to hydrinos than amorphous materials such as Sialon or quartz such that crystalline material are exemplary liners.

A different reaction cell chamber wall such as one that is highly permeable to hydrinos may replace the reaction cell chamber wall of a SunCell® (FIG. 31B) comprising another metal that is less permeable such one comprising 347 or 304 SS. The wall section may be a tubular one. The replacement section may be welded, soldered, or brazed to the balance of the SunCell® by methods known in the art such as ones involving the use of metals of different coefficients of thermal expansion to match expansion rates of joined materials. In an embodiment, the replacement section comprising a refractory metal such as Ta, W, Nb, or Mo may be bonded to a different metal such as stainless steel by an adhesive such as one by Coltronics such as Resbond or Durabond 954. In an embodiment, the union between the different metals may comprise a lamination material such as a ceramic lamination between the bonded metals wherein each metal is bonded to one face of the lamination. The ceramic may comprise one of the disclosure such as BN, quartz, alumina, hafnia, or zirconia. An exemplary union is Ta/Durabond 954/BN/Durabond 954/SS. In an embodiment, the flange 409e and baseplate 409a may be sealed with a gasket or welded.

In an embodiment, the reaction cell chamber comprising a carbon liner comprises at least one of walls that have a high heat transfer capability, a large diameter, and a highly capable cooling system wherein the heat transfer capability, the large diameter, and the cooling system are sufficient to maintain the temperature of the carbon liner below a temperature at which it would react with at least one component of the hydrino reaction mixture such as water or hydrogen. An exemplary heat transfer capability may be in the range of about 10 W/cm² to 10 kW/cm² wall area; an exemplary diameter may be in the range of about 2 cm to 100 cm, an exemplary cooling system is an external water bath; an exemplary desired liner temperature may be about below 700-750° C. The reaction cell chamber wall may further be highly permeable to molecular hydrino. The liner may be in contact with the wall to improve heat transfer from the liner to the cooling system to maintain the desired temperature.

In an embodiment, the SunCell® comprises a gap between the liner and at least one reaction cell chamber wall and a vacuum pump wherein the gap comprises a chamber that is evacuated by the vacuum pump to remove molecular hydrino. The liner may be porous. In an exemplary embodiment, the liner comprises porous ceramic such as porous BN, SiC-coated carbon, or quartz to increase the permeation rate. In an embodiment, the SunCell® may comprise insulation. The insulation may be highly permeable for hydrino. In another embodiment, the SunCell® comprises a molecular hydrino getter such as iron nanoparticles at least one internal and external to the reaction cell chamber wherein the getter binds molecular hydrino to remove it from the reaction cell chamber. In an embodiment, the molecular hydrino gas may be pumped out of the reaction cell chamber. The reaction mixture gas such as one comprising H₂O and hydrogen or another of the disclosure may comprise a flushing gas such as a noble gas to assist in removing molecular hydrino gas by evacuation. The flushing gas may be vented to atmosphere or circulated by a recirculator of the disclosure.

In an embodiment, the liner may comprise a hydrogen dissociator such as niobium. The liner may comprise a plurality of materials such as a material the resists gallium alloy formation in the hottest zones of the reaction cell chamber and another material such as a hydrogen dissociator in at least one zone that operates at a temperature below the gallium alloy formation temperature of the another material.

In an embodiment, gallium oxide such as Ga₂O may be removed from the reaction cell chamber by at least one of vaporization and sublimation due to the volatility of Ga₂O. The removal may be achieved by at least one method of flowing gas through the reaction cell chamber and maintaining a low pressure such as one below atmospheric. The gas flow may be maintained by the recirculator of the disclosure. The low pressure may be maintained by the vacuum pumping system of the disclosure. The gallium oxide may be condensed in the condenser of the disclosure and returned to the reaction cell chamber. Alternatively, the gallium oxide may be trapped in a filter or trap such as a cryotrap from which it may be removed and regenerated by systems and methods of the disclosure. The trap may be in at least one gas line of the recirculator. In an embodiment, the Ga₂O may be trapped in the trap of the vacuum system wherein the trap may comprise at least one of a filter, a cryotrap, and an electrostatic precipitator. The electrostatic precipitator may comprise high voltage electrodes to maintain a plasma to electrostatically charge Ga₂O particles and to trap the charged particles. In an exemplary embodiment, each set of at least one set of electrodes may comprise a wire that may produce a coronal discharge that negatively electrostatically charges the Ga₂O particles and a positively charged collection electrode such as a plate or tube electrode that precipitates the charged particles from the gas stream from the reaction cell chamber. The Ga₂O particles may be removed from each collector electrode by a means known in the art such as mechanically, and the Ga₂O may be converted to gallium and recycled. The gallium may be regenerated from the Ga₂O by systems and methods of the such as by electrolysis in NaOH solution.

The electrostatic precipitator (ESP) may further comprise a means to precipitate at least one desired species from the gas stream from the reaction cell chamber and return it to the reaction cell chamber. The precipitator may comprise a transport mean such as an auger, conveyor belt, pneumatic, electromechanical, or other transport means of the disclosure or known in the art to transport particles collected by the precipitator back to the reaction cell chamber. The precipitator may be mounted in a portion of the vacuum line that comprises a refluxer that returns desired particles to the reaction cell chamber by gravity flow wherein the particles may be precipitated and flow back to the reaction cell chamber by gravity flow such as flow in the vacuum line. The vacuum line may be oriented vertically in at least one portion that allows the desired particles to undergo gravity return flow.

In an exemplary tested embodiment, the reaction cell chamber was maintained at a pressure range of about 1 to 2 atm with 4 ml/min H₂O injection. The DC voltage was about 30 V and the DC current was about 1.5 kA. The reaction cell chamber was a 6-inch diameter stainless steel sphere such as one shown in FIG. 25 that contained 3.6 kg of molten gallium.

The electrodes comprised a 1-inch submerged SS nozzle of a DC EM pump and a counter electrode comprising a 4 cm diameter, 1 cm thick W disc with a 1 cm diameter lead covered by a BN pedestal. The EM pump rate was about 30-40 ml/s. The gallium was polarized positive with a submerged nozzle, and the W pedestal electrode was polarized negative. The gallium was well mixed by the EM pump injector. The SunCell® output power was about 85 kW measured using the product of the mass, specific heat, and temperature rise of the gallium and SS reactor.

In another tested embodiment, 2500 sccm of H2 and 25 sccm O₂ was flowed through about 2 g of 10% Pt/Al₂O₃ beads held in an external chamber in line with the H₂ and O₂ gas inlets and the reaction cell chamber. Additionally, argon was flowed into the reaction cell chamber at a rate to maintain 50 Torr chamber pressure while applying active vacuum pumping. The DC voltage was about 20 V and the DC current was about 1.25 kA. The SunCell® output power was about 120 kW measured using the product of the mass, specific heat, and temperature rise of the gallium and SS reactor.

In an embodiment, the recirculation system or recirculator such as the noble gas recirculatory system capable of operating at one or more of under atmospheric pressure, at atmospheric pressure, and above atmospheric pressure may comprise (i) a gas mover such as at least one of a vacuum pump, a compressor, and a blower to recirculate at least one gas from the reaction cell chamber, (ii) recirculation gas lines, (iii) a separation system to remove exhaust gases such as hydrino and oxygen, and (iv) a reactant supply system. In an embodiment, the gas mover is capable of pumping gas from the reaction cell chamber, pushing it through the separation system to remove exhaust gases, and returning the regenerated gas to the reaction cell chamber. The gas mover may comprise at least two of the pump, the compressor, and the blower as the same unit. In an embodiment, the pump, compressor, blower or combination thereof may comprise at least one of a cryopump, cryofilter, or cooler to at least one of cool the gases before entering the gas mover and condense at least one gas such as water vapor. The recirculation gas lines may comprise a line from the vacuum pump to the gas mover, a line from the gas mover to the separation system to remove exhaust gases, and line from the separation system to remove exhaust gases to the reaction cell chamber that may connect with the reactant supply system. An exemplary reactant supply system comprises at least one union with the line to the reaction cell chamber with at least one reaction mixture gas makeup line for at least one of the noble gas such as argon, oxygen, hydrogen, and water. The addition of reactant O₂ with H₂ may be such that O₂ is a minor species and essentially forms HOH catalyst as it is injected into the reaction cell chamber with excess H₂. A torch may inject the H₂ and O₂ mixture that immediately reacts to form HOH catalyst and excess H₂ reactant. The reactant supply system may comprise a gas manifold connected to the reaction mixture gas supply lines and an outflow line to the reaction cell chamber.

The separation system to remove exhaust gases may comprise a cryofilter or cryotrap. The separation system to remove hydrino product gas from the recirculating gas may comprise a semipermeable membrane to selectively exhaust hydrino by diffusion across the membrane from the recirculating gas to atmosphere or to an exhaust chamber or stream. The separation system of the recirculator may comprise an oxygen scrubber system that removes oxygen from the recirculating gas. The scrubber system may comprise at least one of a vessel and a getter or absorbent in the vessel that reacts with oxygen such as a metal such as an alkali metal, an alkaline earth metal, or iron. Alternatively, the absorbent such as activated charcoal or another oxygen absorber known in the art may absorb oxygen. The charcoal absorbent may comprise a charcoal filter that may be sealed in a gas permeable cartridge such as one that is commercially available. The cartridge may be removable. The oxygen absorbent of the scrubber system may be periodically replaced or regenerated by methods known in the art. A scrubber regeneration system of the recirculation system may comprise at least one of one or more absorbent heaters and one or more vacuum pumps. In an exemplary embodiment, the charcoal absorbent is at least one of heated by the heater and subjected to an applied vacuum by the vacuum pump to release oxygen that is exhausted or collected, and the resulting regenerated charcoal is reused. The heat from the SunCell® may be used to regenerate the absorbent. In an embodiment, the SunCell® comprises at least one heat exchanger, a coolant pump, and a coolant flow loop that serves as a scrubber heater to regenerate the absorbent such as charcoal. The scrubber may comprise a large volume and area to effectively scrub while not significantly increasing the gas flow resistance. The flow may be maintained by the gas mover that is connected to the recirculation lines. The charcoal may be cooled to more effectively absorb species to be scrubbed from the recirculating gas such as a mixture comprising the noble gas such as argon. The oxygen absorbent such as charcoal may also scrub or absorb hydrino gas. The separation system may comprise a plurality of scrubber systems each comprising (i) a chamber capable of maintaining a gas seal, (ii) an absorbent to remove exhaust gases such as oxygen, (iii) inlet and outlet valves that may isolate the chamber from the recirculation gas lines and isolate the recirculation gas lines from the chamber, (iv) a means such as a robotic mechanism controlled by a controller to connect and disconnect the chamber from the recirculation lines, (v) a means to regenerate the absorbent such as a heater and a vacuum pump wherein the heater and vacuum pump may be common to regenerate at least one other scrubber system during its regeneration, (v) a controller to control the disconnection of the nth scrubber system, connection of the n+1th scrubber system, and regeneration of the nth scrubber system while the n+1th scrubber system serves as an active scrubber system wherein at least one of the plurality of scrubber systems may be regenerated while at least one other may be actively scrubbing or absorbing the desired gases. The scrubber system may permit the SunCell® to be operated under closed exhaust conditions with periodic controlled exhaust or gas recovery. In an exemplary embodiment, hydrogen and oxygen may be separately collected from the absorbent such as activated carbon by heating to different temperatures at which the corresponding gases are about separately released.

In an embodiment comprising a reaction cell chamber gas mixture of a noble gas, hydrogen, and oxygen wherein the partial pressure of the noble gas of the reaction cell chamber gas exceeds that of hydrogen, the oxygen partial pressure may be increased to compensate for the reduced reaction rate between hydrogen and oxygen to form HOH catalyst due to the reactant concentration dilution effect of the noble gas such as argon. In an embodiment, the HOH catalyst may be formed in advance of combining with the noble gas such as argon. The hydrogen and oxygen may be caused to react by a recombiner or combustor such as a recombiner catalyst, a plasma source, or a hot surface such as a filament. The recombiner catalyst may comprise a noble metal supported on a ceramic support such as Pt, Pd, or Ir on alumina, zirconia, hafnia, silica, or zeolite power or beads, another supported recombiner catalyst of the disclosure, or a dissociator such as Raney Ni, Ni, niobium, titanium, or other dissociator metal of the disclosure or one known in the art in a form to provide a high surface area such as powder, mat, weave, or cloth. An exemplary recombiner comprises 10 wt % Pt on Al₂O₃ beads. The plasma source may comprise a glow discharge, microwave plasma, plasma torch, inductively or capacitively coupled RF discharge, dielectric barrier discharge, piezoelectric direct discharge, acoustic discharge, or another discharge cell of the disclosure or known in the art. The hot filament may comprise a hot tungsten filament, a Pt or Pd black on Pt filament, or another catalytic filament known in the art.

The inlet flow of reaction mixture species such as at least one of water, hydrogen, oxygen, and a noble gas may be continuous or intermittent. The inlet flow rates and an exhaust or vacuum flow rate may be controlled to achieve a desired pressure range. The inlet flow may be intermittent wherein the flow may be stopped at the maximum pressure of a desired range and commenced at a minimum of the desire range. In a case that reaction mixture gases comprises high pressure noble gas such as argon, the reaction cell chamber may be evacuated, filled with the reaction mixture, and run under about static exhaust flow conditions wherein the inlet flows of reactants such as at least one of water, hydrogen, and oxygen are maintained under continuous or intermittent flow conditions to maintain the pressure in the desired range. Additionally, the noble gas may be flowed at an economically practical flow rate with a corresponding exhaust pumping rate, or the noble gas may be regenerated or scrubbed and recirculated by the recirculation system or recirculator. In an embodiment, the reaction mixture gases may be forced into the cell by an impeller or by a gas jet to increase the reactant flow rate through the cell while maintaining the reaction cell pressure in a desired range.

The reaction cell chamber 5b31 gases may comprise at least one of H₂, a noble gas such as argon, O₂, and H₂O, and oxide such as CO₂. In an embodiment, the pressure in the reaction cell chamber 5b31 may be below atmospheric. The pressure may be in a least one range of about 1 milliTorr to 750 Torr, 10 milliTorr to 100 Torr, 100 milliTorr to 10 Torr, and 250 milliTorr to 1 Torr. The SunCell® may comprise a water vapor supply system comprising a water reservoir with heater and a temperature controller, a channel or conduit, and a value. In an embodiment, the reaction cell chamber gas may comprise H₂O vapor. The water vapor may be supplied by the external water reservoir in connection with the reaction cell chamber through the channel by controlling the temperature of the water reservoir wherein the water reservoir may be the coldest component of the water vapor supply system. The temperature of the water reservoir may control the water vapor pressure based on the partial pressure of water as a function of temperature. The water reservoir may further comprise a chiller to lower the vapor pressure. The water may comprise an additive such as a dissolved compound such as a salt such as NaCl or other alkali or alkaline earth halide, an absorbent such as zeolite, a material or compound that forms a hydrate, or another material or compound known to those skilled in the art that reduces the vapor pressure. Exemplary mechanisms to lower the vapor pressure are by colligative effects or bonding interaction. In an embodiment, the source of water vapor pressure may comprise ice that may be housed in a reservoir and supplied to the reaction cell chamber 5b31 through a conduit. The ice may have a high surface area to increase at least one of the rate of the formation of HOH catalyst and H from ice and the hydrino reaction rate. The ice may be in the form of fine chips to increase the surface area. The ice may be maintained at a desired temperature below 0° C. to control the water vapor pressure. A carrier gas such as at least one of H₂ and argon may be flowed through the ice reservoir and into the reaction cell chamber. The water vapor pressure may also be controlled by controlling the carrier gas flow rate.

The molarity equivalent of H₂ in liquid H₂O is 55 moles/liter wherein H₂ gas at STP occupies 22.4 liters. In an embodiment, H₂ is supplied to the reaction cell chamber 5b31 as a reactant to form hydrino in a form that comprises at least one of liquid water and steam. The SunCell® may comprise at least one injector of the at least one of liquid water and steam. The injector may comprise at least one of water and steam jets. The injector orifice into the reaction cell chamber may be small to prevent backflow. The injector may comprise an oxidation resistant, refractory material such as a ceramic or another or the disclosure. The SunCell® may comprise a source of at least one of water and steam and a pressure and flow control system. In an embodiment, the SunCell® may further comprise a sonicator, atomizer, aerosolizer, or nebulizer to produce small water droplets that may be entrained in a carrier gas stream and flowed into the reaction cell chamber. The sonicator may comprise at least one of a vibrator and a piezoelectric device. The vapor pressure of water in a carrier gas flow may be controlled by controlling the temperature of the water vapor source or that of a flow conduit from the source to the reaction cell chamber. In an embodiment, the SunCell® may further comprise a source of hydrogen and a hydrogen recombiner such as a CuO recombiner to add water to the reaction cell chamber 5b31 by flowing hydrogen through the recombiner such as a heated copper oxide recombiner such that the produced water vapor flows into the reaction cell chamber. In another embodiment, the SunCell® may further comprise a steam injector. The steam injector may comprise at least one of a control valve and a controller to control the flow of at least one of steam and cell gas into the steam injector, a gas inlet to a converging nozzle, a converging-diverging nozzle, a combining cone that may be in connection with a water source and an overflow outlet, a water source, an overflow outlet, a delivery cone, and a check valve. The control value may comprise an electronic solenoid or other computer-controlled value that may be controlled by a timer, sensor such as a cell pressure or water sensor, or a manual activator. In an embodiment, the SunCell® may further comprise a pump to inject water. The water may be delivered through a narrow cross section conduit such as a thin hypodermic needle so that heat from the SunCell® does not boil the water in the pump. The pump may comprise a syringe pump, peristaltic pump, metering pump, or other known in the art. The syringe pump may comprise a plurality of syringes such that at least one may be refilling as another is injecting. The syringe pump may amplify the force of the water in the conduit due to the much smaller cross-section of the conduit relative to the plunger of the syringe. The conduit may be at least one of heat sunk and cooled to prevent the water in the pump from boiling.

In an embodiment, the reaction cell chamber reaction cell mixture is controlled by controlling the reaction cell chamber pressure by at least one means of controlling the injection rate of the reactants and controlling the rate that excess reactants of the reaction mixture and products are exhausted from the reaction cell chamber 5b31. In an embodiment, the SunCell® comprises a pressure sensor, a vacuum pump, a vacuum line, a valve controller, and a valve such as a pressure-activated valve such as a solenoid valve or a throttle valve that opens and closes to the vacuum line from the reaction cell chamber to the vacuum pump in response to the controller that processes the pressure measured by the sensor. The valve may control the pressure of the reaction cell chamber gas. The valve may remain closed until the cell pressure reaches a first high setpoint, then the value may be activated to be open until the pressure is dropped by the vacuum pump to a second low setpoint which may cause the activation of the valve to close. In an embodiment, the controller may control at least one reaction parameter such as the reaction cell chamber pressure, reactant injection rate, voltage, current, and molten metal injection rate to maintain a non-pulsing or about steady or continuous plasma.

In an embodiment, the SunCell® comprises a pressure sensor, a source of at least one reactant or species of the reaction mixture such as a source of H₂O, H₂, O₂, and noble gas such a argon, a reactant line, a valve controller, and a valve such as a pressure-activated valve such as a solenoid valve or a throttle valve that opens and closes to the reactant line from the source of at least one reactant or species of the reaction mixture and the reaction cell chamber in response to the controller that processes the pressure measured by the sensor. The valve may control the pressure of the reaction cell chamber gas. The valve may remain open until the cell pressure reaches a first high setpoint, then the value may be activated to be close until the pressure is dropped by the vacuum pump to a second low setpoint which may cause the activation of the valve to open.

In an embodiment, the SunCell® may comprise an injector such as a micropump. The micropump may comprise a mechanical or non-mechanical device. Exemplary mechanical devices comprise moving parts which may comprise actuation and microvalve membranes and flaps. The driving force of the micropump mat be generated by utilizing at least one effect form the group of piezoelectric, electrostatic, thermos-pneumatic, pneumatic, and magnetic effects. Non-mechanical pumps may be unction with at least one of electro-hydrodynamic, electro-osmotic, electrochemical, ultrasonic, capillary, chemical, and another flow generation mechanism known in the art. The micropump may comprise at least one of a piezoelectric, electroosmotic, diaphragm, peristaltic, syringe, and valveless micropump and a capillary and a chemically powered pump, and another micropump known in the art. The injector such as a micropump may continuously supply reactants such as water, or it may supply reactants intermittently such as in a pulsed mode. In an embodiment, a water injector comprises at least one of a pump such as a micropump, at least one valve, and a water reservoir, and may further comprise a cooler or an extension conduit to remove the water reservoir and valve for the reaction cell chamber by a sufficient distance, either to avoid over heating or boiling of the preinjected water.

The SunCell® may comprise an injection controller and at least one sensor such as one that records pressure, temperature, plasma conductivity, or other reaction gas or plasma parameter. The injection sequence may be controlled by the controller that uses input from the at least one sensor to deliver the desired power while avoiding damage to the SunCell® due to overpowering. In an embodiment, the SunCell® comprises a plurality of injectors such as water injectors to inject into different regions within the reaction cell chamber wherein the injectors are activated by the controller to alternate the location of plasma hot spots in time to avoid damage to the SunCell®. The injection may be intermittent, periodic intermittent, continuous, or comprise any other injection pattern that achieves the desired power, gain, and performance optimization.

The SunCell® may comprise valves such as pump inlet and outlet valves that open and close in response to injection and filling of the pump wherein the inlet and outlet valve state of opening or closing may be 180° out of phase from each other. The pump may develop a higher pressure than the reaction cell chamber pressure to achieve injection. In the event that the pump injection is prone to influence by the reaction cell chamber pressure, the SunCell® may comprise a gas connection between the reaction cell chamber and the reservoir that supplies the water to the pump to dynamically match the head pressure of the pump to that of the reaction cell chamber.

In an embodiment wherein the reaction cell chamber pressure is lower than the pump pressure, the pump may comprise at least one valve to achieve stoppage of flow to the reaction cell chamber when the pump is idle. The pump may comprise the at least one valve. In an exemplary embodiment, a peristaltic micropump comprises at least three microvalves in series. These three valves are opened and closed sequentially in order to pull fluid from the inlet to the outlet in a process known as peristalsis. In an embodiment, the valve may be active such as a solenoidal or piezoelectric check valve, or it may act passively whereby the valve is closed by backpressure such as a check valve such as a ball, swing, diagram, or duckbill check valve.

In an embodiment wherein a pressure gradient exists between the source of water to be injected into the reaction cell chamber and the reaction cell chamber, the pump may comprise two valves, a reservoir valve and a reaction cell chamber valve, that may open and close periodically 180° out of phase. The valves may be separated by a pump chamber having a desired injection volume. With the reaction cell chamber valve closing, the reservoir valve may be opening to the water reservoir to fill the pump chamber. With the reservoir valve closing, the reaction cell chamber valve may be opening to cause the injection of the desired volume of water into the reaction cell chamber. The flow into and out of the pump chamber may be driven by the pressure gradient. The water flow rate may be controlled by controlling the volume of the pump chamber and the period of the synchronized valve openings and closings. In an embodiment, the water microinjector may comprise two valves, an inlet and outlet valve to a microchamber or about 10 ul to 15 ul volume, each mechanically linked and 180° out of phase with respect to opening and closing. The valves may be mechanically driven by a cam.

In another embodiment, another species of the reaction cell mixture such as at least one of H₂, O₂, a noble gas, and water may replace water or be in addition to water. In the case that the species that is flowed into the reaction cell chamber is a gas at room temperature, the SunCell® may comprise a mass flow controller to control the input flow of the gas.

In an embodiment, an additive is added to the reaction cell chamber 5b31 to increase the hydrino reaction rate by providing a source of at least one of H and HOH in the molten metal. A suitable additive may reversibly form a hydrate wherein the hydrate forms at about a SunCell® operating temperature and is released at a higher temperature such as one within the hydrino reaction plasma. In an embodiment, the SunCell® operating temperature may be in the range of about 100° C. to 3000° C., and the corresponding temperature range of the hydrino reaction plasma may be in the range of about 50° C. to 2000° C. higher than the operating temperature of the SunCell®. In an exemplary embodiment, the additive such as lithium vanadate or bismuth oxide may be added to the molten metal wherein the additive may bind water molecules and release them in the plasma to provide the at least one of the H and HOH catalyst. A source of water may be supplied continuously to the reaction cell chamber wherein at least some of the water may bind to the additive. The additive may increase the hydrino reaction rate by binding water as waters of hydration and transport the bound water into the plasma where the corresponding additive-hydrate may dehydrate to provide at least one of H and HOH catalyst to the hydrino reaction. The source of water may comprise at least one of liquid and gaseous water, hydrogen, and oxygen. The SunCell® may comprise at least one of a water injector of the disclosure and a hydrogen and oxygen recombiner of the disclosure such as a noble metal supported on a ceramic such as alumina. A mixture of hydrogen and oxygen may be supplied to the recombiner that recombines the hydrogen and oxygen to water that then flows into the reaction cell chamber.

In another embodiment wherein a pressure gradient exists between the source of water to be injected into the reaction cell chamber and the reaction cell chamber, the inlet flow of water may be continuously supplied through a flow rate controller or restrictor such as at least one of (i) a needle valve, (ii) a narrow or small ID tube, (iii) a hygroscopic material such as cellulose, cotton, polyethene glycol, or another hygroscopic materials known in the art, and (iv) a semipermeable membrane such as ceramic membrane, a frit, or another semipermeable membrane known in the art. The hygroscopic material such as cotton may comprise a packing and may serve to restrict flow in addition to another restrictor such as a needle valve. The SunCell® may comprise a holder for the hygroscopic material or semipermeable membrane. The flow rate of the flow restrictor may be calibrated, and the vacuum pump and the pressure-controlled exhaust valve may further maintain a desired dynamic chamber pressure and water flow rate. In another embodiment, another species of the reaction cell mixture such as at least one of H₂, O₂, a noble gas, and water may replace water or be in addition to water. In the case that the species that is flowed into the reaction cell chamber is a gas at room temperature, the SunCell® may comprise a mass flow controller to control the input flow of the gas.

In an embodiment, the injector operated under a reaction cell chamber vacuum, may comprise a flow restrictor such as a needle valve or narrow tube wherein the length and diameter are controlled to control the water flow rate. An exemplary small diameter tube injector comprises one similar to one used for ESI-ToF injection systems such as one having an ID in the range of about 25 um to 300 um. The flow restrictor may be combined with at least one other injector element such as a value or a pump. In an exemplary embodiment, the water head pressure of the small diameter tube is controlled with a pump such as a syringe pump. The injection rate may further be controlled with a valve from the tube to the reaction cell chamber. The head pressure may be applied by pressurizing a gas over the water surface wherein gas is compressible and water is incompressible. The gas pressurization may be applied by a pump. The water injection rate may be controlled by at least one of the tube diameter, length, head pressure, and valve opening and closing frequency and duty cycle. The tube diameter may be in the range of about 10 um to 10 mm, the length may be in the range of about 1 cm to 1 m, the head pressure may be in the range of about 1 Torr to 100 atm, the valve opening and closing frequency may in the range of about 0.1 Hz to 1 kHz, and the duty cycle may be in the range of about 0.01 to 0.99.

In an embodiment, the SunCell® comprises a source of hydrogen such as hydrogen gas and a source of oxygen such as oxygen gas. The source of at least one of hydrogen and oxygen sources comprises at least one or more gas tanks, flow regulators, pressure gauges, valves, and gas lines to the reaction cell chamber. In an embodiment, the HOH catalyst is generated from combustion of hydrogen and oxygen. The hydrogen and oxygen gases may be flowed into the reaction cell chamber. The inlet flow of reactants such as at least one of hydrogen and oxygen may be continuous or intermittent. The flow rates and an exhaust or vacuum flow rate may be controlled to achieve a desired pressure. The inlet flow may be intermittent wherein the flow may be stopped at the maximum pressure of a desired range and commenced at a minimum of the desire range. At least one of the H₂ pressure and flow rate and O₂ pressure and flow rate may be controlled to maintain at least one of the HOH and H₂ concentrations or partial pressures in a desired range to control and optimize the power from the hydrino reaction. In an embodiment, at least one of the hydrogen inventory and flow many be significantly greater than the oxygen inventory and flow. The ratio of at least one of the partial pressure of H₂ to O₂ and the flow rate of H₂ to O₂ may be in at least one range of about 1.1 to 10,000, 1.5 to 1000, 1.5 to 500, 1.5 to 100, 2 to 50 and 2 to 10. In an embodiment, the total pressure may be maintained in a range that supports a high concentration of nascent HOH and atomic H such as in at least one pressure range of about 1 mTorr to 500 Torr, 10 mTorr to 100 Torr, 100 mTorr to 50 Torr, and 1 Torr to 100 Torr. In an embodiment, at least one of the reservoir and reaction cell chamber may be maintained at an operating temperature that is greater than the decomposition temperature of at least one of gallium oxyhydroxide and gallium hydroxide. The operating temperature may be in at least one range of about 200° C. to 2000° C., 200° C. to 1000° C., and 200° C. to 700° C. The water inventory may be controlled in the gaseous state in the case that gallium oxyhydroxide and gallium hydroxide formation is suppressed.

In an embodiment, the SunCell® comprises a gas mixer to mix at least two gases such as hydrogen and oxygen that are flowed into the reaction cell chamber. In an embodiment, the micro-injector for water comprises the mixer that mixes hydrogen and oxygen wherein the mixture forms HOH as it enters the reaction cell chamber. The mixer may further comprise at least one mass flow controller, such as one for each gas or a gas mixture such as a premixed gas. The premixed gas may comprise each gas in its desired molar ratio such as a mixture comprising hydrogen and oxygen. The H2 molar percent of a H₂—O₂ mixture may be in significant excess such as in a molar ratio range of about 1.5 to 1000 times the molar percent of O₂. The mass flow controller may control the hydrogen and oxygen flow and subsequent combustion to form HOH catalyst such that the resulting gas flow into the reaction cell chamber comprises hydrogen in excess and HOH catalyst. In an exemplary embodiment, the H2 molar percentage is in the range of about 1.5 to 1000 times the molar percent of HOH. The mixer may comprise a hydrogen-oxygen torch. The torch may comprise a design known in the art such as a commercial hydrogen-oxygen torch. In exemplary embodiments, O₂ with H₂ are mixed by the torch injector to cause O₂ to react to form HOH within the H₂ stream to avoid oxygen reacting with the gallium cell components or the electrolyte to dissolve gallium oxide to facilitate its regeneration to gallium by in situ electrolysis such as NaI electrolyte or another of the disclosure. Alternatively, a H₂—O₂ mixture comprising hydrogen in at least ten times molar excess is flowed into the reaction cell chamber by a single flow controller versus two supplying the torch.

The supply of hydrogen to the reaction cell chamber as H₂ gas rather than water as the source of H₂ by reaction of H₂O with gallium to form H₂ and Ga₂O₃ may reduce the amount of Ga₂O₃ formed. The water micro-injector comprising a gas mixer may have a favorable characteristic of allowing the capability of injecting precise amounts of water at very low flow rates due to the ability to more precisely control gas flow over liquid flow. Moreover, the reaction of the O₂ with excess H₂ may form about 100% nascent water as an initial product compared to bulk water and steam that comprise a plurality of hydrogen-bonded water molecules. In an embodiment, the gallium is maintained at a temperature of less than 100° C. such that the gallium may have a low reactivity to consume the HOH catalyst by forming gallium oxide. The gallium may be maintained at low temperature by a cooling system such as one comprising a heat exchanger or a water bath for at least one of the reservoir and reaction cell chamber. In an exemplary embodiment, the SunCell® is operated under the conditions of high flow rate H₂ with trace O₂ flow such as 99% H₂/1% O₂ wherein the reaction cell chamber pressure may be maintained low such as in the pressure range of about 1 to 30 Torr, and the flow rate may be controlled to produce the desired power wherein the theoretical maximum power by forming H₂(1/4) may be about 1 kW/30 sccm. Any resulting gallium oxide may be reduced by in situ hydrogen plasma and electrolytically reduction. In an exemplary embodiment capable of generating a maximum excess power of 75 kW wherein the vacuum system is capable of achieving ultrahigh vacuum, the operating condition are about oxide free gallium surface, low operating pressure such as about 1-5 Torr, and high H₂ flow such as about 2000 sccm with trace HOH catalyst supplied as about 10-20 sccm oxygen through a torch injector.

In an embodiment, the SunCell® components or surfaces of components that contact gallium such as at least one of the reaction cell chamber walls, the top of the reaction cell chamber, inside walls of the reservoir, and inside walls of the EM pump tube may be coated with a coating that does not form an alloy readily with gallium such as a ceramic such as Mullite, BN, or another of the disclosure, or a metal such as W, Ta, Re, Nb, Zr, Mo, TZM, or another of the disclosure. In another embodiment, the surfaces may be clad with a material that does not readily form an alloy with gallium such as carbon, a ceramic such as BN, alumina, zirconia, quartz, or another of the disclosure, or a metal such as W, Ta, Re, or another of the disclosure. In an embodiment, at least one of the reaction cell chamber, reservoir, and EM pump tube may comprise Nb, Zr, W, Ta, Re, Mo, or TZM. In an embodiment, SunCell® components or portions of the components such as the reaction cell chamber, reservoir, and EM pump tube may comprise a material that does not form an alloy except when the temperature of contacting gallium exceeds an extreme such as at least one extreme of over about 400° C., 500° C., 600° C., 700° C., 800° C., 900° C., and 1000° C. The SunCell® may be operated at a temperature wherein portions of components do not reach a temperature at which gallium alloy formation occurs. The SunCell® operating temperature may be controlled with cooling by cooling means such as a heat exchanger or water bath. The water bath may comprise impinging water jets such as jets off of a water manifold wherein at least one of the number of j ets incident on the reaction chamber and the flow rate or each jet are controlled by a controller to maintain the reaction chamber within a desired operating temperature range. In an embodiment such as one comprising water jet cooling of at least one surface, the exterior surface of at least one component of the SunCell® may be clad with insulation such as carbon to maintain an elevated internal temperature while permitting operational cooling. In an embodiment wherein the SunCell® is cooled by means such as at least one of suspension in a coolant such as water or subjected to impinging coolant jets, the EM pump tube is thermally insulated to prevent the injection of cold liquid metal into the plasma to avoid decreasing the hydrino reaction rate. In an exemplary thermal insulation embodiment, the EM pump tube 5k6 may be cast in cement-type material that is a very good thermal insulator (e.g., the cement-type material may have a thermal conductivity of less than 1 W/mK or less than 0.5 W/mK or less than 0.1 W/mK). The surfaces that form a gallium alloy above a temperature extreme achieved during SunCell® operation may be selectively coated or clad with a material that does not readily form an alloy with gallium. The portions of the SunCell® components that both contact gallium and exceed the alloy temperature for the component's material such as stainless steel may be clad with the material that does not readily form an alloy with gallium. In an exemplary embodiment, the reaction cell chamber walls may be clad with W, Ta, Re, Mo, TZM, niobium, vanadium, or zirconium plate, or a ceramic such as quartz, especially at the region near the electrodes wherein the reaction cell chamber temperature is the greatest. The cladding may comprise a reaction cell chamber liner 5b31a. The liner may comprise a gasket or other gallium impervious material such as a ceramic paste positioned between the liner and the walls of the reaction cell chamber to prevent gallium from seeping behind the liner. The liner may be attached to the wall by at least one of welds, bolts, or another fastener or adhesive known in the art.

In an embodiment, the bus has such as at least one of 10, 5k2, and the corresponding electrical leads from the bus bars to at least one of the ignition and EM pump power supplies may serve as a means to remove heat from the reaction cell chamber 5b31 for applications. The SunCell® may comprise a heat exchanger to remove heat from at least one of the bus bars and corresponding leads. In a SunCell® embodiment comprising a MHD converter, heat lost on the bus bars and their leads may be returned to the reaction cell chamber by a heat exchanger that transfers heat from the bus bars to the molten silver that is returned to the reaction cell chamber from the MHD converter by the EM pump.

In an embodiment, the side walls of the reaction cell chamber such as the four vertical sides of a cubic reaction cell chamber or walls of a cylindrical cell may be coated or clad in a refractory metal such as W, Ta, or Re, or covered by a refractory metal such as W, Ta, or Re liner. The metal may be resistant to alloy formation with gallium. The top of the reaction cell chamber may be clad or coated with an electrical insulator or comprise an electrically insulating liner such as a ceramic. Exemplary cladding, coating, and liner materials are at least one of BN, gorilla glass (e.g., alkali-aluminosilicate sheet glass available from Corning), quartz, titania, alumina, yttria, hafnia, zirconia, silicon carbide, graphite such as pyrolytic graphite, silicon carbide coated graphite, or mixtures such as TiO₂-Yr₂O₃—Al₂O₃. The top liner may have a penetration for the pedestal 5c1 (FIG. 25). The top liner may prevent the top electrode 8 from electrically shorting to the top of the reaction cell chamber. In an embodiment, the top flange 409a (FIGS. 31A-C) may comprise a liner such as one of the disclosure or coating such as a ceramic coating such as Mullite, ZTY, Resbond, or another of the disclosure or a paint such as VHT Flameproof™.

In an embodiment, the SunCell® comprises a baseplate 409a heat sensor, an ignition power source controller, an ignition power source, and a shut off switch which may be connected, directly, or indirectly to at least one of the ignition power source controller and the ignition power source to terminate ignition when a short occurs at the baseplate 409a and it overheats. In an embodiment, the ceramic liner comprises a plurality of sections wherein the sections provide at least one of expansion gaps or joints between sections and limit heat gradients along the length of the plurality of the sections of the liner. In an embodiment, the liner may be suspended above the liquid metal level to avoid a steep thermal gradient formed in the case that a portion of the liner is submerged in the gallium. The liner sections may comprise different combinations of materials for different regions or zones having different temperature ranges during operation. In an exemplary embodiment of a liner comprising a plurality of ceramic sections of at least two types of ceramic, the section in the hottest zone such as the zone in proximity to the positive electrode may comprise SiC or BN, and at least one other section may comprise quartz.

In an embodiment, the reaction cell chamber 5b31 comprises internal thermal insulation (also referred to herein as a liner) such as at least one ceramic or carbon liner, such as a quartz, BN, alumina, zirconia, hafnia, or another liner of the disclosure. In some embodiments, the reaction cell chamber does not comprise a liner such as a ceramic liner. In some embodiments, the reaction cell chamber walls may comprise a metal that is maintained at a temperature below that for which alloy with the molten metal occurs such as below about 400° C. to 500° C. in the case of stainless steel such as 347 SS such as 4130 alloy SS or Cr—Mo SS or W, Ta, Mo, Nb, Nb(94.33 wt %)-Mo(4.86 wt %)-Zr(0.81 wt %), Os, Ru, Hf, Re, or silicide coated Mo. In an embodiment such as one wherein the reaction cell chamber is immersed in a coolant such as water, the reaction cell chamber 5b31 wall thickness may be thin such that the internal wall temperature is below the temperature at which the wall material such as 347 SS such as 4130 alloy SS, Cr—Mo SS, or Nb—Mo(5 wt %)-Zr(1 wt %) forms an alloy with the molten metal such as gallium. The reaction cell chamber wall thickness may be at least one of about less than 5 mm, less than 4 mm, less than 3 mm, less than 2 mm, and less than 1 mm. The temperature inside of the liner may be much higher such as in at least one range of about 500° C. to 3400° C., 500° C. to 2500° C., 500° C. to 1000° C., and 500° C. to 1500° C. In an exemplary embodiment, the reaction cell chamber and reservoir comprise a plurality of liners such as a BN inner most liner that may comprise a W, Ta, or Re inlay and may be segmented, and one or more concentric outer quartz liners. The baseplate liner may comprise an inner BN plate and at least one other ceramic plate, each with perforations for penetrations. In an embodiment, penetrations may be sealed with a cement such as a ceramic one such as Resbond or a refractory powder that is resistant to molten metal alloy formation such as W powder in the case of molten gallium. An exemplary baseplate liner is a moldable ceramic insulation disc. In an embodiment, the liner may comprise a refractory or ceramic inlay such as a W or Ta inlay. The ceramic inlay may comprise ceramic tiles such as ones comprising small-height semicircular rings stacked into a cylinder. Exemplary ceramics are zirconia, yttria-stabilized-zirconia, hafnia, alumina, and magnesia. The height of the rings may be in the range of about 1 mm to 5 cm. In another embodiment, the inlay may comprise tiles or beads that may be held in place by a high temperature binding material or cement. Alternatively, the tiles or beads may be embedded in a refractory matrix such as carbon, a refractory metal such as W, Ta, or Mo, or a refractory diboride or carbide such as those of Ta, W, Re, Ti, Zr, or Hf such as ZrB₂, TaC, HfC, and WC or another of the disclosure.

In an exemplary embodiment, the liner may comprise segmented rings with quartz at the gallium surface level, and the balance of the rings may comprise SiC. The quartz segment may comprise beveled quartz plates that form a ring such as a hexagonal or octagonal ring. In another exemplary embodiment, the reaction cell chamber wall may be painted, carbon coated, or ceramic coated, and the liner may comprise carbon with an inner refractory metal liner such as one comprising Nb, Mo, Ta, or W. A further inner liner may comprise a refractory metal ring such as a hexagonal or octagonal ring at the gallium surface such as one comprising beveled refractory metal plates such as one comprising Nb, Mo, Ta, or W plates.

Thermal insulation may comprise a vacuum gap. The vacuum gap may comprise a space between a liner with smaller diameter than that of the reservoir and reaction cell chamber wall wherein reaction cell chamber pressure is low such as about below 50 Torr. To prevent plasma from contacting the reaction cell chamber wall, the reaction cell chamber may comprise a cap or lid such as a ceramic plug such as a BN plug. The hydrino reaction mixture gas lines may supply the reaction cell chamber, and a vacuum line may provide gas evacuation. The vacuum gap may be evacuated by a separate vacuum line connection or by a connection to the vacuum provided by the reaction cell chamber or its vacuum line. To prevent hot gallium from contacting the reservoir wall the reservoir wall may comprise a liner such as at least one quartz liner that has a height from the base of the reservoir to just above the gallium level wherein the liner displaces the molten gallium to provide thermal insulation from contact of hot gallium with the wall.

The cell wall may be thin to enhance the permeation of molecular hydrino product to avoid product inhibition. The liner may comprise a porous material such as BN, porous quartz, porous SiC, or a gas gap to facilitate the diffusion and permeation of the hydrino product from the reaction cell chamber. The reaction cell chamber wall may comprise a material that is highly permeable to molecular hydrino such as Cr—Mo SS such as 4130 alloy SS.

In an embodiment, at least one SunCell® component such as the walls the reaction cell chamber 5b31, the walls of the reservoir 5c, the walls of the EM pump tube 5k6, the baseplate 5kk1, and the top flange 409a may be coated with a coating such one of the disclosure such as a ceramic that at least one of resists alloy formation with the molten metal and resists corrosion with at least one of O₂ and H₂O. The thermal expansion coefficient of the coating and the coated component may be about matched such as in at least one range of a factor of about 0.1 to 10, 0.1 to 5, and 0.1 to 2. In the case of a ceramic coating that has a low thermal expansion coefficient, a coated metal such as Kovar or Invar having a similar thermal expansion coefficient is selected for the coated component.

In an embodiment, the EM pump tube 5k6 and EM bus bars 5k2 that are attached to the EM pump tube 5k6 have about a match in thermal coefficient of expansion. In an exemplary embodiment, the EM pump tube sections connected to the EM pump bus bars 5k2 comprise Invar or Kovar to match the low coefficient of thermal expansion of W bus bars.

In an embodiment, at least one component comprising a liner may be cooled by a cooling system. The cooling system may maintain a component temperature below that at which an alloy forms with the molten metal such as gallium. The cooling system may comprise a water bath into which the component is immersed. The cooling system may further comprise water jets that impinge on the cooled component. In an exemplary embodiment, the component comprises the EM pump tube, and the water bath immersion and water jet cooling of the EM pump tube can be implemented with minimum cooling of the hot gallium pumped by the EM pump by using an EM pump tube liner having a very low thermal conductivity such as one comprising quartz.

### Formation of Nascent Water and Atomic Hydrogen

In an embodiment, the reaction cell chamber further comprises a dissociator chamber that houses a hydrogen dissociator such as Pt, Pd, Ir, Re, or other dissociator metal on a support such as carbon, or ceramic beads such as Al₂O₃, silica, or zeolite beads, Raney Ni, or Ni, niobium, titanium, or other dissociator metal of the disclosure in a form to provide a high surface area such as powder, mat, weave, or cloth. In an embodiment the SunCell® comprises a recombiner to catalytically react supplied H₂ and O₂ to HOH and H that flow into the reaction cell chamber 5b31. The recombiner may further comprise a controller comprising at least one of a temperature sensor, a heater, and a cooling system such a as heat exchanger that senses the recombiner temperature and controls at least one of the cooling system such as a water jet and the heater to maintain the recombiner catalyst in a desire operating temperature range such as one in the range of about 60° C. to 600° C. The upper temperature is limited by that at which the recombiner catalyst sinters and loses effective catalyst surface area.

The H₂O yield of the H₂/O₂ recombination reaction may not be 100%, especially under flow conditions. Removing the oxygen to prevent an oxide coat from forming may permit the reduction of the ignition power by a range of about 10% to 100%. The recombiner may comprise a means to remove about all of the oxygen that flows into the cell by converting it to H₂O. The recombiner may further serve as a dissociator to form H atoms and HOH catalyst that flow through a gas line to the reaction cell chamber. A longer flow path of the gas in the recombiner may increase the dwell time in the recombiner and allow the O₂ to H₂ reaction to go more to completion. However, the longer path in the recombiner and the gas line may allow more undesirable H recombination and HOH dimerization. So, a balance of the competing effects of flow path length is optimized in the recombiner, and the length of the gas line from the recombiner/dissociator to the reaction cell chamber may be minimized.

In an embodiment, the supply of a source of oxygen such as O₂ or H₂O to the reaction cell chamber results in the increase in the oxygen inventory of the reaction cell chamber. In the case that gallium is the molten metal, the oxygen inventory may comprise at least one of gallium oxide, H₂O, and O₂. The oxygen inventory may be essential for the formation of the HOH catalyst for the hydrino reaction. However, an oxide coat on the molten metal such as gallium oxide on liquid gallium may result in the suppression of the hydrino reaction and the increase in the ignition voltage at a fixed ignition current. In an embodiment, the oxygen inventory is optimized. The optimization may be achieved by flowing oxygen intermittently with a controller. Alternatively, oxygen may be flowed at a high rate until an optimal inventory is accumulated, and then the flow rate may be decreased to maintain the desired optimal inventory at a lower flow rate that balances the rate that the oxygen inventory is depleted by removal from the reaction cell chamber and reservoir by means such as evacuation by a vacuum pump. In an exemplary embodiment, the gas flow rates are about 2500 sccm H₂/250 sccm O₂ for about 1 minute to load an about 100-cc reaction cell chamber and an about 1 kg gallium reservoir inventory, then and about 2500 sccm H₂/5 sccm O₂ thereafter. An indication that an oxide layer is not forming or is being consumed is a decrease in ignition voltage with time at constant ignition current wherein the voltage may be monitored by a voltage sensor, and the oxygen flow rate may be controlled by a controller.

In an embodiment, the SunCell® comprises an ignition power parameter sensor and an oxygen source flow rate controller that senses at least one of the ignition voltage at a fixed current, the ignition current at a fixed voltage, and the ignition power and changes the oxygen source flow rate in response to the power parameter. The oxygen source may comprise at least one of oxygen and water. In an exemplary embodiment, the oxygen source controller may control the oxygen flow into the reaction cell chamber based on the ignition voltage wherein the oxygen inventory in the reaction cell chamber is increased in response to the voltage sensed by the ignition power parameter sensor below a threshold voltage and decreased in response to the voltage sensed above a threshold voltage.

To increase the recombiner yield, the recombiner dwell time, surface area, and catalytic activity may be increased. A catalyst with higher kinetics may be selected. The operating temperature may be increased.

In another embodiment, the recombiner comprise as hot filament such as a noble metal-black coated Pt filament such as Pt-black-Pt filament. The filament may be maintained at a sufficiently elevated temperature to maintain the desired rate of recombination by resistive heating maintained by a power supply, temperature sensor, and controller.

In an embodiment, the H₂/O₂ recombiner comprises a plasma source such as a glow discharge, microwave, radio frequency (RF), inductively or capacitively-coupled RF plasma. The discharge cell to sever as the recombiner may be high vacuum capable. An exemplary discharge cell 900 shown in FIGS. 16.19A-C comprises a stainless-steel vessel or glow discharge plasma chamber 901 with a Conflat flange 902 on the top with a mating top plate 903 sealed with a silver-plated copper gasket. The top plate may have a high voltage feed through 904 to an inner tungsten rod electrode 905. The cell body may be grounded to serve as the counter electrode. The top flange may further comprise at least one gas inlet 906 for H₂, O₂, and a mixture. The bottom plate 907 of the stainless-steel vessel may comprise a gas outlet to the reaction cell chamber. The glow discharge cell further comprises a power source such as a DC power source with a voltage in the range of about 10 V to 5 kV and a current in the range of about 0.01 A to 100 A. The glow discharge breakdown and maintenance voltages for a desired gas pressure, electrode separation, and discharge current may be selected according to Paschen's law. The glow discharge cell may further comprise a means such as a spark plug ignition system to cause gas breakdown to start the discharge plasma wherein the glow discharge plasma power operates at a lower maintenance voltage which sustains the glow discharge. The breakdown voltage may be in the range of about 50 V to 5 kV, and the maintenance voltage may be in the range of about 10 V to 1 kV. The glow discharge cell may be electrically isolated from the other SunCell® components such as the reaction cell chamber 5b31 and the reservoir 5c to prevent shorting of the ignition power. Pressure waves may cause glow discharge instabilities that create variations in the reactants flowing into the reaction cell chamber 5b31 and may damage the glow discharge power supply. To prevent back pressure waves due to the hydrino reaction from propagating into the glow discharge plasma chamber, the reaction cell chamber 5b31 may comprise a baffle such as one threaded into a BN sleeve on the electrode bus bar where the gas line from the glow discharge cell enters the reaction cell chamber. The glow discharge power supply may comprise at least one surge protector element such as a capacitor. The length of the discharge cell and the reaction cell chamber height may be minimized to reduce the distance from the glow discharge plasma to the positive surface of the gallium, to increase the concentration of atomic hydrogen and HOH catalyst by reducing the distance for possible recombination.

In an embodiment, the area of the connection between the plasma cell and reaction cell chamber 5b31 may be minimized to avoid atomic H wall recombination and HOH dimerization. The plasma cell such as the glow discharge cell may connect directly to an electrical isolator such as a ceramic one such as one from Solid Seal Technologies, Inc. that connects directly to the top flange 409a of the reaction cell chamber. The electrical isolator may be connected to the discharge cell and the flange by welds, flange joints, or other fasteners known in the art. The inner diameter of the electrical isolator may be large such as about the diameter of the discharge cell chamber such as in the range of about 0.05 cm to 15 cm. In another embodiment wherein the SunCell® and the body of the discharge cell are maintained at the same voltage such as at ground level, the discharge cell may be directly connected to the reaction cell chamber such as at top flange 409a of the reaction cell chamber. The connection may comprise a weld, flange joint, or other fastener known in the art. The inner diameter of the connection may be large such as about the diameter of the discharge cell chamber such as in the range of about 0.05 cm to 15 cm.

The output power level can be controlled by the hydrogen and oxygen flow rate, the discharge current, the ignition current and voltage, and the EM pump current, and the molten metal temperature. The SunCell® may comprise corresponding sensors and controllers for each of these and other parameters to control the output power. The molten metal such as gallium may be maintained in the temperature range of about 200° C. to 2200° C. In an exemplary embodiment comprising an 8 inch diameter 4130 Cr—Mo SS cell with a Mo liner along the reaction cell chamber wall, a glow discharge hydrogen dissociator and recombiner connected directly the flange 409a of the reaction cell chamber by a 0.75 inch OD set of Conflat flanges, the glow discharge voltage was 260 V; the glow discharge current was 2 A; the hydrogen flow rate was 2000 sccm; the oxygen flow rate was 1 sccm; the operating pressure was 5.9 Torr; the gallium temperature was maintained at 400° C. with water bath cooling; the ignition current and voltage were 1300 A and 26-27V; the EM pump rate was 100 g/s, and the output power was over 300 kW for an input ignition power of 29 kW corresponding to a gain of at least 10 times.

In an embodiment, the recombiner such as a glow discharge cell recombiner may be cooled by a coolant such as water. In an exemplary embodiment, the electrical feedthrough of the recombiner may be water cooled. The recombiner may be submerged in an agitated water bath for cooling. The recombiner may comprise a safety kill switch that senses a stray voltage and terminates the plasma power supply when the voltage goes above a threshold such as one in the range of about 0V to 20V (e.g., 0.1V to 20V).

In an embodiment, the SunCell® comprises as a driven plasma cell such as a discharge cell such as a glow discharge, microwave discharge, or inductively or capacitively coupled discharge cell wherein the hydrino reaction mixture comprises the hydrino reaction mixture of the disclosure such as hydrogen in excess of oxygen relative to a stoichiometric mixture of H₂ (66.6%) to O₂ (33.3%) mole percent. The driven plasma cell may comprise a vessel capable of vacuum, a reaction mixture supply, a vacuum pump, a pressure gauge, a flow meter, a plasma generator, a plasma power supply, and a controller. Plasma sources to maintain the hydrino reaction are given in Mills Prior Applications which are incorporated by reference. The plasma source may maintain a plasma in a hydrino reaction mixture comprising a mixture of hydrogen and oxygen having a deficit of oxygen compared to a stoichiometric mixture of H₂ (66.6%) to O₂ (33.3%) mole percent. The oxygen deficit of the hydrogen-oxygen mixture may be in the range of about 5% to 99% from that of a stoichiometric mixture. The mixture may comprise mole percentages of about 99.66% to 68.33% H₂ and about 0.333% to 31.66% O₂. These mixtures may produce a reaction mixture upon passage through the plasma cell such as the glow discharge sufficient to induce the catalytic reaction as described herein upon interaction with a biased molten metal in the reaction cell chamber.

In an embodiment, the reaction mixture gases formed at the outflow of the plasma cell may be forced into the reaction cell by velocity gas stream means such as an impeller or by a gas jet to increase the reactant flow rate through the cell while maintaining the reaction cell pressure in a desired range. High velocity gas may pass through the recombiner plasma source before being injected into the reaction cell chamber.

In an embodiment, the plasma recombiner/dissociator maintains a high concentration of at least one of atomic H and HOH catalyst in the reaction cell chamber by direct injection of the atomic H and HOH catalyst into the reaction cell chamber from the external plasma recombiner/dissociator. The corresponding reaction conditions may be similar to those produced by very high temperature in the reaction cell chamber that produce very high kinetic and power effects. An exemplary high temperature range is about 2000° C.-3400° C. In an embodiment, the SunCell® comprises a plurality of recombiner/dissociators such as plasma discharge cell recombiner/dissociators that inject at least one of atomic H and HOH catalyst wherein the injection into the reaction cell chamber may be by flow.

In another embodiment, the hydrogen source such as a H₂ tank may be connected to a manifold that may be connected to at least two mass flow controllers (MFC). The first MFC may supply H₂ gas to a second manifold that accepts the H2 line and a noble gas line from a noble gas source such as an argon tank. The second manifold may output to a line connected to a dissociator such as a catalyst such as Pt/Al₂O₃, Pt/C, or another of the disclosure in a housing wherein the output of the dissociator may be a line to the reaction cell chamber. The second MFC may supply H₂ gas to a third manifold that accepts the H₂ line and an oxygen line from an oxygen source such as an O₂ tank. The third manifold may output to a line to a recombiner such as a catalyst such as Pt/Al₂O₃, Pt/C, or another of the disclosure in a housing wherein the output of the recombiner may be a line to the reaction cell chamber.

Alternatively, the second MFC may be connected to the second manifold supplied by the first MFC. In another embodiment, the first MFC may flow the hydrogen directly to the recombiner or to the recombiner and the second MFC. Argon may be supplied by a third MFC that receives gas from a supply such as an argon tank and outputs the argon directly into the reaction cell chamber.

In another embodiment, H₂ may flow from its supply such as a H₂ tank to a first MFC that outputs to a first manifold. O₂ may flow from its supply such as an O₂ tank to a second MFC that outputs to the first manifold. The first manifold may output to recombiner/dissociator that outputs to a second manifold. A noble gas such as argon may flow from its supply such as an argon tank to the second manifold that outputs to the reaction cell chamber. Other flow schemes are within the scope of the disclosure wherein the flows deliver the reactant gases in the possible ordered permutations by gas supplies, MFCs, manifolds, and connections known in the art.

In an embodiment, the SunCell® comprises at least one of a source of hydrogen such as water or hydrogen gas such as a hydrogen tank, a means to control the flow from the source such as a hydrogen mass flow controller, a pressure regulator, a line such as a hydrogen gas line from the hydrogen source to at least one of the reservoir or reaction cell chamber below the molten metal level in the chamber, and a controller. A source of hydrogen or hydrogen gas may be introduced directly into the molten metal wherein the concentration or pressure may be greater than that achieved by introduction outside of the metal. The higher concentration or pressure may increase the solubility of hydrogen in the molten metal. The hydrogen may dissolve as atomic hydrogen wherein the molten metal such as gallium or Galinstan may serve as a dissociator. In another embodiment, the hydrogen gas line may comprise a hydrogen dissociator such as a noble metal on a support such as Pt on Al₂O₃ support. The atomic hydrogen may be released from the surface of the molten metal in the reaction cell chamber to support the hydrino reaction. The gas line may have an inlet from the hydrogen source that is at a higher elevation than the outlet into the molten metal to prevent the molten metal from back flowing into the mass flow controller. The hydrogen gas line may extend into the molten metal and may further comprise a hydrogen diffuser at the end to distribute the hydrogen gas. The line such as the hydrogen gas line may comprise a U section or trap. The line may enter the reaction cell chamber above the molten metal and comprise a section that bends below the molten metal surface. At least one of the hydrogen source such as a hydrogen tank, the regulator, and the mass flow controller may provide sufficient pressure of the source of hydrogen or hydrogen to overcome the head pressure of the molten metal at the outlet of the line such as a hydrogen gas line to permit the desired source of hydrogen or hydrogen gas flow.

In an embodiment, the SunCell® comprises a source of hydrogen such as a tank, a valve, a regulator, a pressure gauge, a vacuum pump, and a controller, and may further comprise at least one means to form atomic hydrogen from the source of hydrogen such as at least one of a hydrogen dissociator such as one of the disclosure such as Re/C or Pt/C and a source of plasma such as the hydrino reaction plasma, a high voltage power source that may be applied to the SunCell® electrodes to maintain a glow discharge plasma, an RF plasma source, a microwave plasma source, or another plasma source of the disclosure to maintain a hydrogen plasma in the reaction cell chamber. The source of hydrogen may supply pressurized hydrogen. The source of pressurized hydrogen may at least one of reversibly and intermittently pressurize the reaction cell chamber with hydrogen. The pressurized hydrogen may dissolve into the molten metal such as gallium. The means to form atomic hydrogen may increase the solubility of hydrogen in the molten metal. The reaction cell chamber hydrogen pressure may be in at least one range of about 0.01 atm to 1000 atm, 0.1 atm to 500 atm, and 0.1 atm to 100 atm. The hydrogen may be removed by evacuation after a dwell time that allows for absorption. The dwell time may be in at least one range of about 0.1 s to 60 minutes, 1 s to 30 minutes, and 1 s to 1 minute. The SunCell® may comprise a plurality of reaction cell chambers and a controller that may be at least one of intermittently supplied with atomic hydrogen and pressured and depressurized with hydrogen in a coordinated manner wherein each reaction cell chamber may be absorbing hydrogen while another is being pressurized or supplied atomic hydrogen, evacuated, or in operation maintaining a hydrino reaction. Exemplary systems and conditions for causing hydrogen to absorb into molten gallium are given by Carreon [M. L. Carreon, “Synergistic interactions of H₂ and N₂ with molten gallium in the presence of plasma”, Journal of Vacuum Science & Technology A, Vol. 36, Issue 2, (2018), 021303 pp. 1-8; https://doi.org/10.1116/1.5004540] which is herein incorporated by reference. In an exemplary embodiment, the SunCell® is operated at high hydrogen pressure such as 0.5 to 10 atm wherein the plasma displays pulsed behavior with much lower input power than with continuous plasma and ignition current. Then, the pressure is maintained at about 1 Torr to 5 Torr with 1500 sccm H₂+15 sccm O₂ flow through 1 g of Pt/Al₂O₃ at greater than 90° C. and then into the reaction cell chamber wherein high output power develops with additional H₂ outgassing from the gallium with increasing gallium temperature. The corresponding H₂ loading (gallium absorption) and unloading (H₂ off gassing from gallium) or may be repeated.

In an embodiment, the source of hydrogen or hydrogen gas may be injected directly into molten metal in a direction that propels the molten metal to the opposing electrode of a pair of electrodes wherein the molten metal bath serves as an electrode. The gas line may serve as an injector wherein the source of hydrogen or hydrogen injection such as H₂ gas injection may at least partially serve as a molten metal injector. An EM pump injector may serve as an additional molten metal injector of the ignition system comprising at least two electrodes and a source of electrical power.

In an embodiment, the SunCell® comprises a molecular hydrogen dissociator. The dissociator may be housed in the reaction cell chamber or in a separate chamber in gaseous communication with the reaction cell chamber. The separate housing may prevent the dissociator from failing due to being exposed to the molten metal such as gallium. The dissociator may comprise a dissociating material such as supported Pt such as Pt on alumina beads or another of the disclosure or known in the art. Alternatively, the dissociator may comprise a hot filament or plasma discharge source such as a glow discharge, microwave plasma, plasma torch, inductively or capacitively coupled RF discharge, dielectric barrier discharge, piezoelectric direct discharge, acoustic discharge, or another discharge cell of the disclosure or known in the art. The hot filament may be heated resistively by a power source that flows current through electrically isolated feed through the penetrate the reaction cell chamber wall and then through the filament.

In another embodiment, the ignition current may be increased to increase at least one of the hydrogen dissociation rate and the plasma ion-electron recombination rate. In an embodiment, the ignition waveform may comprise a DC offset such as one in the voltage range of about 1 V to 100 V with a superimposed AC voltage in the range of about 1 V to 100 V. The DC voltage may increase the AC voltage sufficiently to form a plasma in the hydrino reaction mixture, and the AC component may comprise a high current in the presence of plasma such as in a range of about 100 A to 100,000 A. The DC current with the AC modulation may cause the ignition current to be pulsed at the corresponding AC frequency such as one in at least one range of about 1 Hz to 1 MHz, 1 Hz to 1 kHz, and 1 Hz to 100 Hz. In an embodiment, the EM pumping is increased to decrease the resistance and increase the current and the stability of the ignition power.

In an embodiment, a high-pressure glow discharge may be maintained by means of a microhollow cathode discharge. The microhollow cathode discharge may be sustained between two closely spaced electrodes with openings of approximately 100 micron diameter. Exemplary direct current discharges may be maintained up to about atmospheric pressure. In an embodiment, large volume plasmas at high gas pressure may be maintained through superposition of individual glow discharges operating in parallel. The plasma current may be at least one of DC or AC.

In an embodiment, the atomic hydrogen concentration is increased by supplying a source of hydrogen that is easier to dissociate than H₂O or H₂. Exemplary sources are those having at least one of lower enthalpies and lower free energies of formation per H atom such as methane, a hydrocarbon, methanol, an alcohol, another organic molecule comprising H.

In an embodiment, the dissociator may comprise the electrode 8 such as the one shown in FIG. 25. The electrode 8 may comprise a dissociator capable of operating at high temperature such as one up to 3200° C. and may further comprise a material that is resistant to alloy formation with the molten metal such as gallium. Exemplary electrodes comprise at least one of W and Ta. In an embodiment, the bus bar 10 may comprise attached dissociators such as vane dissociators such as planar plates. The plates may be attached by fasting the face of an edge along the axis of the bus bar 10. The vanes may comprise a paddle wheel pattern. The vanes may be heated by conductive heat transfer from the bus bar 10 which may be heated by at least one of resistively by the ignition current and heated by the hydrino reaction. The dissociators such as vanes may comprise a refractory metal such as Hf, Ta, W, Nb, or Ti.

In an embodiment, the SunCell® comprises a source of about monochromatic light (e.g., light having a spectral bandwidth of less than 50 nm or less than 25 nm or less than 10 nm or less than 5 nm) and a window for the about monochromatic light. The light may be incident on hydrogen gas such as hydrogen gas in the reaction cell chamber. The fundamental vibration frequency of H₂ is 4161 cm⁻¹. At least one frequency of a potential plurality of frequencies may be about resonant with the vibrational energy of H₂. The about resonant irradiation may be absorbed by H₂ to cause selective H₂ bond dissociation. In another embodiment, the frequency of the light may be about resonant with at least one of (i) the vibrational energy of the OH bond of H₂O such as 3756 cm⁻¹ and others known by those skilled in the art such as those given by Lemus [R. Lemus, “Vibrational excitations in H₂O in the framework of a local model,” J. Mol. Spectrosc., Vol. 225, (2004), pp. 73-92] which is incorporated by reference, (ii) the vibrational energy of the hydrogen bond such between hydrogen bonded H₂O molecules, and (iii) the hydrogen bond energy between hydrogen bonded H₂O molecules wherein the absorption of the light causes H₂O dimers and other H₂O multimers to dissociate into nascent water molecules. In an embodiment, the hydrino reaction gas mixture may comprise an additional gas such as ammonia from a source that is capable of H-bonding with H₂O molecules to increase the concentration of nascent HOH by competing with water dimer H bonding. The nascent HOH may serve as the hydrino catalyst.

In an embodiment, the hydrino reaction creates at least one reaction signature from the group of power, thermal power, plasma, light, pressure, an electromagnetic pulse, and a shock wave. In an embodiment, the SunCell® comprises at least one sensor and at least one control system to monitor the reaction signature and control the reaction parameters such as reaction mixture composition and conditions such as pressure and temperature to control the hydrino reaction rate. The reaction mixture may comprise at least one of, or a source of H₂O, H₂, O₂, a noble gas such as argon, and GaX₃ (X=halide). In an exemplary embodiment, the intensity and the frequency of electromagnetic pulses (EMPs) are sensed, and the reaction parameters are controlled to increase the intensity and frequency of the EMPs to increase the reaction rate and vice versa. In another exemplary embodiment, at least one of shock wave frequencies, intensities, and propagation velocities such as those between two acoustic probes are sensed, and the reaction parameters are controlled to increase at least one of the shock wave frequencies, intensities, and propagation velocities to increase the reaction rate and vice versa.

### Molten Metal

The H₂O may react with the molten metal such as gallium to form H₂(g) and the corresponding oxide such as Ga₂O₃ and Ga₂O, oxyhydroxide such as GaO(OH), and hydroxide such as Ga(OH)₃. The gallium temperature may be controlled to control the reaction with H₂O. In an exemplary embodiment, the gallium temperature may be maintained below 100° C. to at least one of prevent the H₂O from reacting with gallium and cause the H₂O-gallium reaction to occur with a slow kinetics.

In another exemplary embodiment, the gallium temperature may be maintained above about 100° C. to cause the H₂O-gallium reaction to occur with a fast kinetics. The reaction of H₂O with gallium in the reaction cell chamber 5b31 may facilitate the formation of at least one hydrino reactant such as H or HOH catalyst. In an embodiment, water may be injected into the reaction cell chamber 5b31 and may react with gallium that may be maintained at a temperature over 100° C. to at least one of (i) form H₂ to serve as a source of H, (ii) cause H₂O dimers to form HOH monomers or nascent HOH to serve as the catalyst, and (iii) reduce the water vapor pressure.

In an embodiment, GaOOH may serve as a solid fuel hydrino reactant to form at least one of HOH catalyst and H to serve as reactants to form hydrinos. In an embodiment, at least one of oxide such as Ga₂O₃ or Ga₂O, hydroxide such as Ga(OH)₃, and oxyhydroxide such as such as GaOOH, AlOOH, or FeOOH may serve as a matrix to bind hydrino such as H₂(1/4). In an embodiment, at least one of GaOOH and metal oxides such as those of stainless steel and stainless steel-gallium alloys are added to the reaction cell chamber to serve as getters for hydrinos. The getter may be heated to a high temperature such as one in the range of about 100° C. to 1200° C. to release molecular hydrino gas such as H₂(1/4).

In an embodiment, an alloy formation reaction at least one of traps and absorbs molecular hydrino in the alloy product that serves as a getter. A solid metal piece such as a stainless steel (SS) one immersed in liquid gallium may react with gallium to form metal-gallium alloy that serves as a molecular hydrino getter. In an exemplary embodiment, at least one of stainless-steel reaction cell chamber and reservoir walls may serve as a reaction surface that is consumed to form at least one stainless-steel alloy such as at least one of Ga₃Fe, Ga₃Ni, and Ga₃Cr to that absorb or trap molecular hydrino. The molecular hydrino gas may accumulate at the wall due to the permeation barrier. The increased local concentration of hydrino reaction products typically increases the molecular hydrino gas concentration captured in the alloy. Following absorption of reaction products in the getter, the getter may be a source of molecular hydrino gas that may be released by means such as heating the getter. In an embodiment, the getter comprises at least one of a gallium oxide, GaOOH, and at least one stainless steel alloy. The getter may be dissolved in aqueous base such as NaOH or KOH to form molecular hydrino such as H₂(1/4) trapped in GaOOH matrix.

In an embodiment, a solid fuel of the disclosure such as FeOOH, an alkali halide-hydroxide mixture, and transition metal halide-hydroxide mixture such as Cu(OH)₂+FeBr₂ may be activated to react to form hydrinos by at least one of application of heat and application of mechanical power. The latter may be achieved by ball milling the solid fuel.

In an alternative embodiment, the SunCell® comprises a coolant flow heat exchanger comprising the pumping system whereby the reaction cell chamber is cooled by a flowing coolant wherein the flow rate may be varied to control the reaction cell chamber to operate within a desired temperature range. The heat exchanger may comprise plates with channels such as microchannel plates. In an embodiment, the SunCell® comprises a cell comprising the reaction cell chamber 531, reservoir 5c, pedestal 5c1, and all components in contact with the hydrino reaction plasma wherein one or more components may comprise a cell zone. In an embodiment, the heat exchanger such as one comprising a flowing coolant may comprise a plurality of heat exchangers organized in cell zones to maintain the corresponding cell zone at an independent desired temperature.

In an embodiment such as one shown in FIG. 30, the SunCell® comprises thermal insulation or a liner 5b31a fastened on the inside of the reaction cell chamber 5b31 at the molten gallium level to prevent the hot gallium from directly contacting the chamber wall. The thermal insulation may comprise at least one of a thermal insulator, an electrical insulator, and a material that is resistant to wetting by the molten metal such as gallium. The insulation may at least one of allow the surface temperature of the gallium to increase and reduce the formation of localized hot spots on the wall of the reaction cell chamber that may melt the wall. In addition, a hydrogen dissociator such as one of the disclosure may be clad on the surface of the liner. In another embodiment, at least one of the wall thickness is increased and heat diffusers such a copper blocks are clad on the external surface of the wall to spread the thermal power within the wall to prevent localized wall melting. The thermal insulation may comprise a ceramic such as BN, SiC, carbon, Mullite, quartz, fused silica, alumina, zirconia, hafnia, others of the disclosure, and ones known to those skilled in the art. The thickness of the insulation may be selected to achieve a desired area of the molten metal and gallium oxide surface coating wherein a smaller area may increase temperature by concentration of the hydrino reaction plasma. Since a smaller area may reduce the electron-ion recombination rate, the area may be optimized to favor elimination of the gallium oxide film while optimizing the hydrino reaction power. In an exemplary embodiment comprising a rectangular reaction cell chamber, rectangular BN blocks are bolted onto to threaded studs that are welded to the inside walls of the reaction cell chamber at the level of the surface of the molten gallium. The BN blocks form a continuous raised surface at this position on the inside of the reaction cell chamber.

In an embodiment (FIG. 25 and FIG. 30), the SunCell® comprises a bus bar 5k2ka1 through a baseplate of the EM pump at the bottom of the reservoir 5c. The bus bar may be connected to the ignition current power supply. The bus bar may extend above the molten metal level. The bus bar may serve as the positive electrode in addition to the molten metal such as gallium. The molten metal may heat sink the bus bar to cool it. The bus bar may comprise a refractory metal that does not form an alloy with the molten metal such as W, Ta, or Re in the case that the molten metal comprises gallium. The bus bar such as a W rod protruding from the gallium surface may concentrate the plasma at the gallium surface. The injector nozzle such as one comprising W may be submerged in the molten metal in the reservoir to protect it from thermal damage.

In an embodiment (FIG. 25), such as one wherein the molten metal serves as an electrode, the cross-sectional area that serves as the molten electrode may be minimized to increase the current density. The molten metal electrode may comprise the injector electrode. The injection nozzle may be submerged. The molten metal electrode may be positive polarity. The area of the molten metal electrode may be about the area of the counter electrode. The area of the molten metal surface may be minimized to serve as an electrode with high current density. The area may be in at least one range of about 1 cm² to 100 cm², 1 cm² to 50 cm², and 1 cm² to 20 cm². At least one of the reaction cell chamber and reservoir may be tapered to a smaller cross section area at the molten metal level. At least a portion of at least one of the reaction cell chamber and the reservoir may comprise a refractory material such as tungsten, tantalum, or a ceramic such as BN at the level of the molten metal. In an exemplary embodiment, the area of at least one of the reaction cell chamber and reservoir at the molten metal level may be minimized to serve as the positive electrode with high current density. In an exemplary embodiment, the reaction cell chamber may be cylindrical and may further comprise a reducer, conical section, or transition to the reservoir wherein the molten metal such as gallium fills the reservoir to a level such that the gallium cross sectional area at the corresponding molten metal surface is small to concentrate the current and increase the current density. In an exemplary embodiment (FIG. 31A), at least one of the reaction cell chamber and the reservoir may comprise an hourglass shape or a hyperboloid of one sheet wherein the molten metal level is at about the level of the smallest cross-sectional area. This area may comprise a refectory material or comprise a liner 5b31a of a refractory material such as carbon, a refractory metal such as W, Ta, or Re, or a ceramic such as BN, SiC, or quartz. In exemplary embodiment, the reaction cell chamber may comprise stainless steel such as 347 SS such as 4130 alloy SS and liner may comprise W or BN. In an embodiment, the reaction cell chamber comprises at least one plasma confinement structure such as an annular ring centered on the axis between the electrodes to confine plasma inside of the ring. The rings may be at least one of shorted with the molten metal and walls of the reaction cell chamber and electrically isolated by at least one electrically insulating support.

### Reaction Cell or Chamber Configurations

In an embodiment, the reaction cell chamber may comprise a tube reactor (FIGS. 31B-C) such as one comprising a stainless-steel tube vessel 5b3 that is vacuum or high-pressure capable. The pressure and reaction mixture inside if the vessel may be controlled by flowing gases through gas inlet 710 and evacuating gases through vacuum line 711. The reaction cell chamber 5b31 may comprise a liner 5b31a such as a refractory liner such as a ceramic liner such as one comprising BN, quartz, pyrolytic carbon, or SiC that may electrically isolate the reaction cell chamber 5b31 from the vessel 5b3 wall and may further prevent gallium alloy formation. Alternatively, a refractory metal liner such as W, Ta, or Re may reduce gallium alloy formation. The EM bus bars 5k2 may comprise a material, coating, or cladding that is electrically conductive and resists formation of a gallium alloy. Exemplary materials are Ta, Re, Mo, W, and Ir. Each bus bar 5k2 may be fastened to the EM pump tube by a weld or fastener such as a Swagelok that may comprise a coating comprising a ceramic or a gallium alloy-resistant metal such as at least one of Ta, Re, Mo, W, and Ir.

In an embodiment, the liner (e.g., the liner of the EM pump, the reaction cell liner) comprises a hybrid of a plurality of materials such as a plurality of ceramics or a ceramic and a refractory metal. The ceramic may be one of the disclosure such as BN, quartz, alumina, zirconia, hafnia, or a diboride or carbide such as those of Ta, W, Re, Ti, Zr, or Hf such as ZrB₂, TaC, HfC, and WC. The refractory metal may be one of the disclosure such as W, Ta, Re, Ir, or Mo. In an exemplary embodiment of a tubular cell (FIGS. 31B-C), the liner comprises a BN tube with a recessed band at the region where the plasma is most intense wherein a W tube section with a slightly larger diameter than the diameter of the BN tube liner is held in the recessed band of the BN liner. In an exemplary embodiment, the liner of a refractory metal tube-shaped reaction cell chamber 5b31 such as one comprising niobium or vanadium and coated with a ceramic such as zirconia-titania-yttria (ZTY) to prevent oxidation comprises an inner BN tube with at least one refractory metal or ceramic inlay such as a W inlay at a desired position such as at the position of where the plasma due to the hydrino reaction is most intense.

In an embodiment, the ceramic liner, coating, or cladding of at least one SunCell® component such as the reservoir, reaction cell chamber, and EM pump tube may comprise at least one of a metal oxide, alumina, zirconia, yttria stabilized zirconia, magnesia, hafnia, silicon carbide, zirconium carbide, zirconium diboride, silicon nitride (Si₃N₄), a glass ceramic such as Li₂O×Al₂O₃×nSiO₂ system (LAS system), the MgO×Al₂O₃×nSiO₂ system (MAS system), the ZnO×Al₂O₃×nSiO₂ system (ZAS system). At least one SunCell® component such as the reservoir, reaction cell chamber, EM pump tube, liner, cladding, or coating may comprise a refractory material such as at least one of graphite (sublimation point=3642° C.), a refractory metal such as tungsten (M.P.=3422° C.) or tantalum (M.P.=3020° C.), niobium, niobium alloy, vanadium, a ceramic, a ultra-high-temperature ceramic, and a ceramic matrix composite such as at least one of borides, carbides, nitrides, and oxides such as those of early transition metals such as hafnium boride (HfB₂), zirconium diboride (ZrB₂), hafnium nitride (HfN), zirconium nitride (ZrN), titanium carbide (TiC), titanium nitride (TiN), thorium dioxide (ThO₂), niobium boride (NbB₂), and tantalum carbide (TaC) and their associated composites. Exemplary ceramics having a desired high melting point are magnesium oxide (MgO) (M.P.=2852° C.), zirconium oxide (ZrO) (M.P.=2715° C.), boron nitride (BN) (M.P.=2973° C.), zirconium dioxide (ZrO₂) (M.P.=2715° C.), hafnium boride (HfB₂) (M.P.=3380° C.), hafnium carbide (HfC) (M.P.=3900° C.), Ta₄HfC₅ (M.P.=4000° C.), Ta₄HfC₅TaX₄HfCX₅ (4215° C.), hafnium nitride (HfN) (M.P.=3385° C.), zirconium diboride (ZrB₂) (M.P.=3246° C.), zirconium carbide (ZrC) (M.P.=3400° C.), zirconium nitride (ZrN) (M.P.=2950° C.), titanium boride (TiB₂) (M.P.=3225° C.), titanium carbide (TiC) (M.P.=3100° C.), titanium nitride (TiN) (M.P.=2950° C.), silicon carbide (SiC) (M.P.=2820° C.), tantalum boride (TaB₂) (M.P.=3040° C.), tantalum carbide (TaC) (M.P.=3800° C.), tantalum nitride (TaN) (M.P.=2700° C.), niobium carbide (NbC) (M.P.=3490° C.), niobium nitride (NbN) (M.P.=2573° C.), vanadium carbide (VC) (M.P.=2810° C.), and vanadium nitride (VN) (M.P.=2050° C.), and a turbine blade material such as one or more from the group of a superalloy, nickel-based superalloy comprising chromium, cobalt, and rhenium, one comprising ceramic matrix composites, U-500, Rene 77, Rene N5, Rene N6, PWA 1484, CMSX-4, CMSX-10, Inconel, IN-738, GTD-111, EPM-102, and PWA 1497. The ceramic such as MgO and ZrO may be resistant to reaction with H₂.

In an embodiment, at least one of each reservoir 5c, the reaction cell chamber 5b31, and the inside of the EM pump tube 5k6 are coated with a ceramic or comprise a ceramic liner such as such as one of BN, quartz, carbon, pyrolytic carbon, silicon carbide, titania, alumina, yttria, hafnia, zirconia, or mixtures such as TiO₂-Yr₂O₃—Al₂O₃, or another of the disclosure. An exemplary carbon coating comprises Aremco Products Graphitic Bond 551RN and an exemplary alumina coating comprises Cotronics Resbond 989. In an embodiment, the liner comprises at least two concentric clam shells such as two BN clam shell liners. The vertical seams of the clam shell (parallel with the reservoir) may be offset or staggered by a relative rotational angle to avoid a direct electrical path from the plasma or molten metal inside of the reaction cell chamber to the reaction cell chamber walls. In an exemplary embodiment, the offset is 90° at the vertical seams wherein the two sections of the clam shell permit the liners to thermally expand without cracking, and the overlapping inner and outer liners block plasma from electrically shorting to the reaction chamber wall due to relative offset of the sets of seams of the concentric clam shell liners. Another exemplary embodiment comprises a clam shell inner liner and a full outer liner such as a BN clam shell inner and a carbon or ceramic tube outer liner. In a further embodiment of the plurality of concentric liners, at least the inner liner comprises vertically stack sections. The horizontal seams of the inner liner may be covered by the outer liner wherein the seams of the inner liner are at different vertical heights from those of the outer, in the case that the outer liner also comprises vertically stacked sections. The resulting offsetting of the seams prevents electrical shorting between at least one of the molten metal and plasma inside of the reaction cell chamber and the reaction cell chamber walls.

The liner comprises an electrical insulator that is capable of high temperature operation and has good thermal shock resistance. Machinability, the ability to provide thermal insulation, and resistance to reactivity with the hydrino reactants and the molten metal are also desirable. Exemplary liner materials are at least one of BN, AlN, Sialon, and Shapal. Silicon nitride (Si₃N₄), silicon carbide, Sialon, Mullite, and Macor may serve a thermal insulation circumferential to the BN inner liner. The liner may comprise a porous type of the liner material such as porous Sialon. Further exemplary liners comprise at least one of SiC-carbon glazed graphite with a Ta or W inlay or inner BN liner to protect it from the hydrino plasma, pyrolytic-coated carbon, SiC—C composite, silicon nitride bonded silicon carbide, yttria stabilized zirconia, SiC with a Ta or W inlay. The liner may be at least one of horizontally and vertically segmented to reduce thermal shock. The lined component such as at least one of the reaction cell chamber 5b31 and reservoir 5c may be ramped in temperature at a rate that avoids liner thermal shock (e.g. the shock produced by the plasma heating too rapidly to produce thermal gradients and differential expansion-based stresses in the liner that leads to failure) of the liner such as a SiC liner. The temperature ramp rate may be in the range of about 1° C./minute to 200° C./s. The segmented sections may interlock by a structural feature on juxtaposed sections such as ship lapping or tongue and groove. In an embodiment, the interlocking of the segments, each comprising an electrical insulator, prevents the plasma from electrically shorting to reaction cell chamber wall 5b31. In another embodiment, the liner may comprise a porous ceramic such a sporous SiC, MgO, fire brick, ZrO₂, HfO₂, and Al₂O₃ to avoid thermal shock. The liner may comprise a plurality or stack of concentric liner materials which in combination provide the desired properties of the liner. The inner most layer may possess chemical inertness at high temperature, high thermal shock resistance and high temperature operational capability. The outer layers may provide electrical and thermal insulation and resistance to reactivity at their operating temperature. In an exemplary embodiment, quartz is operated below about 700° C. to avoid reaction with gallium to gallium oxide. Exemplary concentric liner stacks to test are from inside to outside: BN—SiC—Si3N4 wherein quartz, SiC, SiC-coated graphite, or SiC—C composite may replace Si3N4 and AlN, Sialon, or Shapal may replace BN or SiC.

In an embodiment, the liner may comprise a housing that is circumferential to the reaction cell chamber 5b31. The walls of the housing may comprise a ceramic or coated or clad metal of the disclosure. The housing may be filled with a thermally stable thermal insulator. In an exemplary embodiment, the housing comprises a double-walled BN tube liner comprising an inner and outer BN tube with a gap between the two tubes and BN end-plate seals at the top and bottom of the gap to form a cavity wherein the cavity may be filled with silica gel or other high-temperature-capable thermal insulator such as an inner quartz tube.

In an embodiment comprising a plurality of concentric liners, at least one outer concentric liner may at least one of (i) serve as a heat sink and (ii) remove heat from the juxtaposed inner liner. The outer liner may comprise a material with a high heat transfer coefficient such as BN or SiC. In an exemplary embodiment, the inner most liner may comprise BN that may be segmented and the corresponding outer liner may comprise SiC that may be segmented and stacked such that the seams of the inner most and outer liner segments are offset or staggered.

In an embodiment, the reaction cell chamber plasma may short to the reaction cell chamber wall rather then connect to the reservoir gallium surface due to gallium boiling that increases the total pressure between the reservoir gallium and the electrode 8 to a point that a plasma cannot form. The ignition voltage may increase as the pressure increases until the resistance is lower through the lower-pressure bulk gas to the reaction chamber wall. In an embodiment, the gallium vaporization can be sensed by a rise in ignition voltage at constant ignition current. A controller can reduce the ignition power, change the gas pressure, decrease the recombiner plasma power, or increase the EM pumping and gallium mixing in response to the voltage rise to decrease the vaporization. In another embodiment, the controller may at least one of apply the ignition current intermittently to suppress the gallium boiling wherein the hydrino reaction plasma may sustain during a portion of the duty cycle with the ignition off and cause argon to flow into the reaction cell chamber from a source to suppress gallium boiling by increasing the pressure while avoiding reduction in H atom concentration. In an embodiment such as that shown in FIGS. 16.19A-B, the EM pump 5kk comprises a plurality of stages or pumps to increase the molten metal agitation to prevent the formation of a local hot spot that could boil. In an embodiment shown in FIG. 16.19C, the SunCell® may comprise a plurality of EM pump assemblies 5kk with a plurality of molten metal injectors 5k61, each with a corresponding counter electrode 8. In an embodiment, an EM pump may inject molten gallium to at least one counter electrode 8 through a plurality of injection electrodes 5k61. The plurality of electrode pairs may increase the current while reducing the plasma resistance to increase the hydrino reaction power and gain. Elevated pressure due to gallium boiling from excessive local gallium surface heating may also be reduced.

The vacuum line 711 may comprise a section containing a material such as metal wool such as SS wool or a ceramic fiber such as one comprising at least one of Alumina, silicate, zirconia, magnesia, and hafnia that has a large surface area; yet is highly diffusible for gases. The condensation material may condense gallium and gallium oxide which may be refluxed back into the reaction cell chamber while allowing gases such as H₂, O₂, argon, and H₂O to be removed by evacuation. The vacuum line 711 may comprise a vertical section to enhance the reflux of gallium and gallium products to the reaction cell chamber 5b31. In an embodiment, a gallium additive such as at least one other metal, element, compound or material may be added to the gallium to prevent boiling. The gallium additive may comprise silver which may further form nanoparticles in the reaction cell chamber 5b31 to reduce the plasma resistance and increase the hydrino power gain.

Experimentally, the hydrino reaction power was increased with a SunCell® comprising a smaller diameter reaction cell chamber due to the increase in the plasma current density, plasma density, and corresponding plasma heating effect. With the innovation of the glow discharge recombiner, plasma concentration is not necessary since the discharge plasma produces the effect of high temperature including preparing an amount of nascent water which may be characterized as water having an internal energy sufficient to prevent the formation of hydrogen bonds. In an embodiment comprising a plasma recombiner such as a glow discharge recombiner, damage to the liner such as a BN liner is avoided by distancing the liner from the hydrino plasma. To achieve the distancing, the liner may comprise a larger diameter compared to the SunCell that generates similar power. In an embodiment, the liner such as a BN liner contacts the reaction cell chamber wall to improve heat transfer to an external water bath to prevent the BN from cracking. In an embodiment, the liner may be segmented and comprise a plurality of materials such as BN in the most intense plasma zone such as the zone between the molten metal surface and the counter electrode 8 and further comprise segments of at least one different ceramic such as SiC in other zones. Moreover, certain liners, such as BN may provide increased passivity of reaction products such as the hydrino to afford more efficient power generation.

At least one segment of the inner most liner such as a BN liner may comprise a desired thickness such as 0.1 mm to 10 cm thick to transfer heat at least radially from the molten metal such as gallium to an external heat sink such as water coolant. In an embodiment, the liner such as a BN liner may make good thermal contact with at least one of the reservoir wall and reaction chamber wall. The diameter of the inner liner may be selected to remove it sufficiently from the center of the reaction cell chamber to reduce plasma damage to a desired extent. The diameter may be in the range of 0.5 cm to 100 cm. The liner may a refractory metal inlay such as a W inlay in the region where the plasma is the most intense. In an exemplary embodiment, an 8 cm diameter BN liner is in contact with circumferential reaction cell chamber and reservoir walls wherein the liner portion that is submerged in molten metal comprises perforations to permit molten metal to contact the reservoir wall to increase heat transfer to the reservoir wall and an external coolant such as a water or air coolant. In another exemplary embodiment, an inner but-end stacked BN segmented liner comprises perforations below the molten metal level and an outer concentric liner comprises a single piece SiC cylinder with notches cut in the bottom to allow radial molten metal flow and heat transfer.

In an embodiment, at least one of the inner or outer liners comprise a refractory metal such as W or Ta, and another comprises an electrical insulator such as a ceramic such as BN wherein the refractory metal liner may dissipate local hot spots by at least one of thermal conduction and heat sinking. In addition to removing thermal stress on the inner most liner that is exposed to the hydrino reaction plasma by transferring heat away from the inner most liner surface, the hydrino permeation rate may be higher in liner and reaction cell chamber materials with high heat transfer coefficients such as Cr—Mo SS versus 304 SS, or BN versus Sialon which may increase the hydrino reaction rate by reducing hydrino product inhibition. An exemplary SunCell® embodiment comprising concentric liner and reaction cell chamber wall components to facilitate hydrino product permeation and heat transfer to an external coolant such as a water bath comprises a BN inner most liner, a corresponding SiC outer liner, and a concentric Cr—Mo SS reaction cell chamber wall with good thermal contact between concentric components. In an embodiment wherein it is desired that heat be retained in the reaction cell chamber such as one comprising a heat exchanger such as a molten gallium to air heat exchanger, the reaction cell chamber may comprise additional outer concentric thermal insulating liners such as quartz ones, and may further comprise a thermally insulating base such as one comprising a bottom quartz liner.

In an embodiment, the liner may comprise a refractory metal such as at least one of W, Ta, Mo, or Nb that is resistant to forming an alloy with gallium. The metal liner may be in contact with the cell wall to increase the heat transfer to an external coolant such as water. In an embodiment, the horizontal distance from the circumferential edge of the electrode 8 to the reaction cell chamber 5b31 wall is greater than the vertical separation between the molten metal in the reservoir and the electrode 8 wherein at least one of the reaction cell chamber and the reservoir may optionally comprise a liner. In an exemplary embodiment, a centered W electrode 8 has a diameter of about 1 to 1.5 inches in a reaction cell chamber with a diameter in the range of about 6 to 8 inches wherein a W, Ta, Mo, or Nb liner is in contact with the reaction cell chamber wall. The reaction cell chamber with a diameter sufficient to avoid the formation of a discharge between the wall and electrode 8 may comprise no liner to improve at least one of heat transfer across the wall and hydrino diffusion through the wall to avoid hydrino product inhibition. In an embodiment such as one shown in FIGS. 16.19A-B, at least one of a portion of the reservoir and reaction cell chamber walls may be replaced with a material such as a metal such as Nb, Mo, Ta, or W that is resistant to gallium alloy formation. The joints 911 with the other components of the cell such as the remaining portions of the reaction cell chamber 5b31 wall and reservoir wall may be bonded with a weld, braze, or adhesive such as a glue. The bond may be at a lip that overlaps the replacement section.

In an embodiment, the inner most liner may comprise at least one of a refractory material such as one comprising W or Ta and a molten metal cooling system. The molten metal cooling system may comprise an EM pump nozzle that directs at least a portion of the injected molten metal such as gallium onto the liner to cool it. The molten metal cooling system may comprise a plurality of nozzles that inject molten metal to the counter electrode and further inject molten metal onto the walls of the liner to cool it. In an exemplary embodiment, the molten metal cooling system comprises an injector nozzle positioned in the central region of the reservoir such as the center of the reservoir or proximal thereto that may be submerged in the molten metal contained in the reservoir and an annular ring injector inside of the liner that comprises a series of apertures or nozzle to inject an annular spray onto the inner surface of the liner. The central injector and annular ring injector may be supplied by the same EM pump or independent EM pumps. The liner such as a BN or SiC liner may have a high heat transfer coefficient. The liner may be in close contact with the reaction cell chamber wall 5b31 that may be cooled to cool the liner. In exemplary embodiments, the reaction cell chamber wall 5b31 may be water or air cooled.

In an embodiment, the liner such as quartz liner is cooled by the molten metal such as gallium. In an embodiment, the SunCell® comprises a multiple-nozzle molten metal injector or multiple molten metal injectors to spread the heat released by the hydrino reaction by agitation and distribution of the reaction on the molten metal surface. The multiple nozzles may distribute the power of the reaction to avoid localized excessive vaporization of the molten metal.

In an embodiment, a Ta, Re, or W liner may comprise a Ta, Re, or W vessel comprising walls such as a Ta, Re, or W cylindrical tube, a welded Ta, Re, or W baseplate and at least one fastened penetrating component such as at least one of a welded-in Ta, Re, or W EM pump tube inlet, and injector outlet, ignition bus bar, and thermocouple well. In another embodiment, the vessel may comprise a ceramic such as SiC, BN, quartz, or another ceramic of the disclosure wherein the vessel may comprise at least one boss that transitions to a penetrating component wherein the fastener may comprise a gasketed union such as one comprising a graphite gasket or another or the disclosure or a glue such as a ceramic to metal glue such as Resbond or Durabond of the disclosure. The vessel may have an open top. The vessel may be housed in a metal shell such as a stainless-steel shell. Penetrations such as the ignition bus bar may be vacuum sealed to the stainless-steel shell by seals such as a Swageloks or housings such as ones formed with flanges and a gaskets. The shell may be sealed at the top. The seal may comprise a Conflat flange 409e and baseplate 409a (FIGS. 31A-C). The flange may be sealed with bolts that may comprise spring loaded blots, disc spring washers, or lock washers. The vessel liner may further comprise an inner liner such as a ceramic liner such as at least one concentric BN or quartz liner. Components of the disclosure that comprise Re may comprise other metals that are coated with Re.

In an embodiment, the liner 5b31a may cover all of the walls of the reaction cell chamber 5b31 and the reservoir 5c. At least one of the reactant gas supply line 710 and vacuum line 711 may be mounted on the top flange 409a (FIGS. 31B-C). The vacuum line may be mounted vertically to further serve as a condenser and refluxer of metal vapor or another condensate that is desired to be refluxed. The SunCell® may comprise a trap such as one on the vacuum line. An exemplary trap may comprise at least one elbow on the vacuum line to condense and reflux vaporized gallium. The trap may be cooled by a coolant such as water. The liner may comprise components such as a base plate, a top or flange plate, and a tube body section or a plurality of stacked body sections. The components may comprise a carbon or a ceramic such as BN, quartz, alumina, magnesia, hafnia, or another ceramic of the disclosure. The components may be glued together or joined with gasketed unions. In an exemplary embodiment, the components comprise quartz that are glued together. Alternatively, the components comprise BN that comprise graphite gasketed unions.

In an embodiment, the temperature of the molten metal such as gallium may be monitored by a thermocouple such as a high temperature thermocouple that may further be resistant to forming an alloy with the molten metal such as gallium. The thermocouple may comprise W, Re, or Ta or may comprise a protective sheath such as a W, Re, Ta, or ceramic one. In an embodiment, the baseplate may comprise a thermocouple well for the thermocouple that protrudes into the molten metal and protects the thermocouple wherein heat transfer paste may be used to make good thermal contact between the thermocouple and the well. In an exemplary embodiment, a Ta, Re, or W thermocouple or a Ta, Re, or W tube thermowell is connected by a Swagelok to the baseplate of the reservoir. Alternatively, the thermocouple may be inserted in the EM pump tube, inlet side.

The top of the tube reactor (FIGS. 31A-C) may comprise a pedestal electrode 8 with feed through and bus bar 10 covered with an electrically insulating sheath 5c2 wherein the feed through is mounted in a baseplate 409a that is connected to the vessel 5b3 by flange 409e. The bottom of the vessel may comprise a molten metal reservoir 5c with at least one thermocouple port 712 to monitor the molten metal temperature and an injector electrode such as an EM pump injector electrode 5k61 with nozzle Sq. The inlet to the EM pump 5kk may be covered by an inlet screen 5qa1. The EM pump tube 5k6 may be segmented or comprise a plurality of sections fastened together by means such as welding wherein the segmented EM pump tube comprise a material or is lined, coated, or clad with a material such as Ta, W, Re, Ir, Mo, or a ceramic that is resistant to gallium alloy formation or oxidation. In an embodiment, the feed through to the top electrode 8 may be cooled such as water cooled. An ignition electrode water cooling system (FIGS. 16.19A-B) may comprise inlet 909 and outlet water 910 cooling lines. In another embodiment, the baseplate 409a may comprise a standoff to move the feed through further from the reaction cell chamber 5b31 in order to cool it during operation.

In an embodiment, the liner may comprise a thinner upper section and a thicker lower section with a taper in between sections such that liner has a relatively larger cross-sectional area at one or more regions such as the region the houses the upper electrode 8 and a smaller cross-sectional area at the level of the gallium to increase the current density at the gallium surface. The relative ratio of the cross-sectional area at the top versus bottom section may be in the range of 1.01 to 100 times.

In an embodiment, the SunCell® may be cooled by a medium such as a gas such as air or a liquid such as water. The SunCell® may comprise a heat exchanger that may transfer heat (e.g., heat of the reaction cell chamber) to a gas such as air or a liquid such as water. In an embodiment, the heat exchanger comprises a closed vessel such as a tube that houses the SunCell® or a hot portion thereof such as the reaction cell chamber 5b31. The heat exchanger may further comprise a pump that causes water to flow through the tube. The flow may be pressurized such that steam production may be suppressed to increase the heat transfer rate. The resulting superheated water may flow to a steam generator to form steam, and the steam may power a steam turbine. Or, the steam may be used for heating.

In an embodiment of an air-cooled heat exchanger, the SunCell® heat exchanger may comprise high surface area heat fins on the hot outer surfaces and a blower or compressor to flow air over the fins to remove heat from the SunCell® for heating and electricity production applications. In another air-cooled heat exchanger embodiment, the molten metal such a gallium is pumped outside of the reservoir 5c by an EM pump such as 5ka and through a heat exchanger and then pumped back to the reservoir 5c in a closed loop.

In an embodiment wherein the heat transfer across the reaction cell chamber wall is at least partially by a conductive mechanism, the heat transfer across the wall to a coolant such as air or water is increased by at least one of increasing the wall area, decreasing the wall thickness, and selecting a reaction cell chamber wall comprising a material such as nickel or a stainless steel such as chromium molybdenum steel that has a higher thermal conductivity than alternatives such as 316 stainless steel.

In an embodiment (FIGS. 31A-D), the heat exchanger may comprise the SunCell® reservoir 5c, EM pump assembly 5kk, and EM pump tube 5k6 wherein the EM pump tube section between its inlet and the section comprising the EM pump tube bus bars 5k2 is extended to achieve a desired area of at least one loop or coil conduit in a coolant bath such as a water bath, molten metal bath, or molten salt bath. Multiple loops or coil may be fed from at least one supply manifold, and the molten metal flow may be collected to return to the EM pump by at least one collector manifold. The loop or coil conduits and manifolds may comprise material resistant to alloy formation with the molten metal such as gallium and possess a high heat transfer coefficient. Exemplary conduit materials are Cr—Mo SS, tantalum, niobium, molybdenum, and tungsten. The conduit may be coated or painted to prevent corrosion. In an exemplary embodiment, the EM pump tube and heat exchanger conduit comprises Ta that is coated with a CrN, a ceramic such as Mullite or ZTY, or a paint such as VHT Flameproof™ to prevent corrosion with water, and the EM pump bus bars 5k2 comprise Ta. In another exemplary embodiment, the EM pump tube and heat exchanger conduit comprises Nb that is coated with a CrN, a ceramic such as Mullite or ZTY, or a paint such as VHT Flameproof™ to prevent corrosion with water, and the EM pump bus bars 5k2 comprise Nb.

In an embodiment, the SunCell® comprises at least one component such as the reaction cell chamber and the reservoir comprising a wall metal such as 4130 CrMo SS, Nb, Ta, W, or Mo with a high heat transfer coefficient, a sufficiently thin wall, and a sufficiently large area to provide sufficient heat loss to a thermal sink such as a water bath to maintain a desired molten metal temperature during the production of a desired amount of power. An external heat exchanger may not be necessary. The wall thickness may be in the range of about 0.05 mm to 5 mm. The wall area and thickness may be calculated from the conduction heat transfer equation using the bath and desire molten metal temperature as the thermal gradient. The external surfaces of the SunCell® may be coated with a paint such as VHT Flameproof™, a ceramic such as Mullite, or an electroplated corrosion-resistant metal such as SS, Ni, or chrome to prevent corrosion with a coolant of the thermal sink such as water of the water bath.

The flow in the conduit may be controlled by controlling the EM pump current. The ignition voltage to maintain the plasma within a desired adjustable range of molten metal flow rate through both the heat exchanger and reaction chamber injector may be controlled by controlling the separation distance of the nozzle 5q and the counter electrode 8. The separation distance may be in the range of about 1 mm to 10 cm. The heat exchanger may further comprise controllable conduit cooling jets and at least one of (i) one or more thermal sensors, (ii) one or more molten metal and coolant flow sensors, and (iii) a controller. The heat transfer of the single loop heat exchanger to the coolant bath may be further controlled by controlling the jets cooling the conduit.

In another embodiment, the heat exchanger may comprise at least one conduit loop or coil and at least one pump such as an EM pump or a mechanical molten metal pump that are independent of the EM pump injection assembly 5kk. In an embodiment, the pump may be positioned on the cold side of the molten metal recirculating flow path to avoid exceeding the pump's maximum operational temperature. In an embodiment, the EM pump for at least one of the molten metal injection and the heat exchanger recirculation may comprise an AC EM pump. The AC EM pump may comprise an AC power supply that is common for supplying direct AC current to the EM bus bars or to the induction current coil, as well as to the electromagnets of the AC EM pump so that the current and magnetic field are in phase to produce the Lorentz pumping force in one direction with high efficiency.

The molten metal temperature such as molten gallium may be maintained at a desired temperature such as an elevated temperature less than the temperature that alloy forms. Control of the gallium temperature can be achieved by controlling at least one of the EM pump current which changes the heat exchanger flow rate, jets on the heat exchanger, water coolant temperature, degree of reaction cell chamber thermal insulation, degree of reaction cell chamber submersion in water, reactant H₂ flow rate, reactant O₂ flow rate, recombiner plasma voltage and current parameters, and ignition power.

In an embodiment, the nozzle 5q may be replaced with a plurality of nozzles, or the nozzle may have a plurality of openings such as those of a shower head to disperse the injected gallium from multiple orifices toward the counter electrode. Such configurations may facilitate the formation of a plasma at higher molten metal injection rates such as those required to maintain a high flow rate in the single loop conduit of the heat exchanger that is in series with the EM pump injection system comprising the EM pump tube, and its inlet and injection outlet.

### Heat Exchanger

In an embodiment, the SunCell® comprises a heat source for a turbine system such as one comprising an external combustor-type wherein heat from the heat exchanger heats air from a turbine compressor and replaces the heat from combustion. The heat exchanger may be positioned inside of a gas turbine to receive air from the compressor, or it may be external to the turbine wherein air is ducted from the compressor across the heat exchanger and back into the combustion section of the gas turbine. The heat exchanger may comprise an EM pump tubing embedded in fins over which air is forced to flow. The tubing may have a serpentine or zigzagged winding pattern.

In an embodiment, the SunCell® comprises a heat exchanger such as an air-cooled or water-cooled heat exchanger. In an embodiment, the heater exchanger may comprise a tube-in-shell design (FIGS. 31D-E). The heater exchanger may comprise a plurality of tubes 801 through which molten metal such as molten silver or molten gallium from the SunCell® 812 is circulated. The heat exchanger may comprise (i) a molten metal reservoir such as the reservoir 5c comprising a molten metal such as molten gallium or molten silver that receives thermal power from the reaction cell chamber 5b31, (ii) at least one circulating electromagnetic pump 810 that pumps the molten metal from the SunCell®, through the heat exchanger, and back to the SunCell®, (iv) a shell 806 with an inlet 807 and an outlet 808 for forced flow of an external coolant such as air or water wherein baffles 809 may direct the flow of the external coolant through the shell wherein the air flow may be countercurrent to the molten gallium flow in the conduits, (v) a least one channel or conduit 801 inside of the shell 806 for the flow of the molten metal inside wherein the external coolant flows through the shell 806 and over the conduits 801 to transfer heat from the molten metal to the external coolant, (v) a heat exchanger inlet line 803 and a heat exchanger outlet line 804 wherein the circulating pump is connected in the loop formed by the molten metal reservoir 5c, the heat exchanger, and the inlet and outlet lines, (vi) a coolant pump or blower, and (vii) a sensor and control system to control the flows of the molten metal and the coolant. The heat exchanger may further comprise at least one heat exchanger manifold 802 and a distributor 805. An inlet manifold 802 may receive hot molten metal from the circulating EM pump 810 and distribute it to a plurality of channels or conduits 801. A molten metal outlet manifold 802 may receive the molten metal through a distributor 805, combine the distributed flow from the plurality of conduits, and direct the molten metal flow to the heat exchanger outlet line 804 connecting back to the cell reservoir 5c. The circulating EM pump may pump hot gallium through a heat exchanger inlet line 803 to the heat exchanger and back to the cell reservoir 5c through the outlet line 804. The heat exchanger may further comprise an external coolant inlet 807 and outlet 808 and may further comprise baffles 809 to direct the flow of the external coolant over the molten metal conduits 801. The flow may be created by an external coolant blower or pump 811 such as an air blower or compressor or a water pump. In response to input from at least one sensor such as a thermocouple and flow rate meter, the flow of the SunCell® molten metal and the external coolant through the heat exchanger may be controlled by at least one controller and a computer that controls the pumping or blower speed of the corresponding pump or blower.

Other external coolants are within the scope the disclosure such as a molten metal, molten salt, or another gas or liquid than air and water, respectively, that are known in the art. In an embodiment comprising a water boiler heat exchanger having a water coolant, the tubes 801 may comprise carbon. Water may enter the inlet 807 and steam may exit the outlet 808. In a steam boiler embodiment, the reservoir contains a height of gallium and the gallium is recirculated from the bottom of the reservoir to maintain a desired temperature gradient from the top to the bottom such that the gallium temperature in the tubes of a steam boiler is maintained below one which results in film boiling on the surface of the tubes. In addition, the injection of lower temperature gallium from the bottom of the reservoir may suppress gallium boiling in the reaction cell chamber to prevent an undesired pressure increase.

An exemplary heat exchanger, including those which may exchange heat between an external coolant and the molten metal is illustrated in FIG. 31D. The heat exchanger may comprise Ta components such as at least one of Ta conduits 801, manifolds 802, distributors 805, heat exchanger inlet line 803, and heat exchanger outlet line 804. Molten metal may enter through inlet line 803, collect in the entrance manifold 802, pass through the distributors 805 and conduits 801 to the exit manifold 802, with final exit through outlet line 804. The exemplary heat exchanger further comprises a stainless-steel shell 806, external coolant inlet 807, external coolant outlet 808, and baffles 809. Coolant may enter the inlet 807 and pass over the external surface of the conduits 801 towards outlet 808. Contact between the coolant and the conduits may transfer heat from the molten metal, through the surface of the conduits, and to the coolant prior to its exit at outlet line 804. The Ta components may be welded together. The air-exposed surfaces of the Ta heat exchanger components such as the conduits 801 may be anodized to prevent corrosion. Alternatively, the Ta conduits 801 may comprise a coating or cladding such as a coating or cladding comprising at least one of rhenium, noble metal, Pt, Pd, Ir, Ru, Rh, TiN, CrN, ceramic, zirconia-titania-yttria (ZTY), and Mullite, or another of the disclosure to prevent oxidation of the outside of the Ta conduits. The Ta components may be clad with stainless steel. The cladding may comprise a plurality of pieces that are joined together by mean such as welds or glue such as a glue having stability to at least to 1000° C. such as J-B Weld 37901 which is rated to 1300° C. The steel shell 806 may comprise a liner or coating of at least the bottom section to collect any leaked gallium such as a Ta liner or a ZTY or Mullite coating. The heat exchanger comprising Ta such as one comprising Ta conduits 801 may be modular wherein a plurality of heat exchanger modules serves as the heat exchanger rather than a single heat exchanger of the cumulative size of the modules to avoid thermal expansion failure.

Alternatively, at least one Ta component may be replaced with a Ta coated component such as a Ta electroplated one wherein the Ta coated component comprises stainless steel or other metal having about a matching coefficient of thermal expansion (e.g. Invar, Kovar, or other SS or metal). Rhenium (MP 3185° C.) is resistant to attack from gallium, Galinstan, silver, and copper and is resistant to oxidation by oxygen and water. In another embodiment, the heat exchanger comprises at least one Re coated component such as a Re electroplated one wherein the Re coated component comprises stainless steel or other metal having about a matching coefficient of thermal expansion (e.g. Invar, Kovar, or other SS or metal). In another embodiment, at least one Ta component may be replaced with a component comprising or coated with at least one of 347 SS or Cr—Mo SS, W, Mo, Nb, Nb(94.33 wt %)-Mo(4.86 wt %)-Zr(0.81 wt %), Os, Ru, Hf, Re, and silicide coated Mo.

Another exemplary heat exchanger comprises quartz, SiC, Si₃N₄, yttria stabilized zirconia, or BN conduits 801, manifolds 802, distributors 805, heat exchanger inlet line 803, heat exchanger outlet line 804, shell 806, external coolant inlet 807, external coolant outlet 808, and baffles 809. The components may be joined by fusing, gluing with a quartz, SiC, or BN adhesive, or by joints or unions such as ones comprising flanges and gaskets such as carbon (Graphoil) gaskets. Exemplary SiC heat exchangers comprise (i) plate, (ii) block in shell, (iii) SiC annular groove, and (iv) shell and tube heat exchanges by a manufacturer such as GAB Neumann (https://www.gab-neumann.com). Si may be added to the molten metal such as gallium in a small wt % such as less than 5 wt % to prevent SiC degradation. The heat exchanger may comprise a blower or compressor 811 to force air though the channels of the SiC block. An exemplary EM pump 810 is the Pyrotek Model 410 comprising a SiC liner and capable of operating at 1000° C. In an embodiment comprising Ga molten metal coolant, at least one connection may comprise a material such as one of the disclosure that is resistant to forming an alloy with gallium. In an exemplary embodiment, at least one of the heat exchanger inlet 803, heat exchanger inlet manifold 803a, heat exchanger inlet line 803b, heat exchanger outlet 804, heat exchanger outlet manifold 804a, and heat exchanger outlet line 804 comprises a ceramic such as BN, carbon that may be SiC coated, W, Ta, vanadium, 347 SS or Cr—Mo SS, Mo, Nb, Nb(94.33 wt %)-Mo(4.86 wt %)-Zr(0.81 wt %), Os, Ru, Hf, Re, and silicide coated Mo.

The seals between components such as those connecting at least two of the pump 810, heat exchanger inlet 803, heat exchanger inlet manifold 803a, heat exchanger inlet line 803b, heat exchanger outlet 804, heat exchanger outlet manifold 804a, and heat exchanger outlet line 804b may comprise glued joints, welded joints, or flanged joints with gaskets such as ceramic gaskets such as ones comprising Thermiculite (e.g. Flexitallic), or carbon gaskets such as Graphoil or Graphilor. A carbon gasket may be hermetically sealed with a coating such as Resbond, SiC paste, or thermal paste, cladding, or protected from oxidation by a housing. In an embodiment the seal may comprise a malleable metal such as Ta wherein the sealed component may also comprise the malleable metal. In an embodiment, the seal may comprise two ceramic faces that are precision machined and pushed together by a compression means such as springs.

In an embodiment wherein the molten metal in the conduits 801 is maintained in a lower temperature such as a temperature below at least one of 750° C., 650° C., 550° C., 450° C., and 350° C., the heat exchange pump 810 may comprise a mechanical pump such as one with a ceramic impeller and housing to avoid alloy formation. The EM pump may comprise a flow meter such as an electromagnetic flow meter and a controller to monitor and control the flow of the molten metal through, for example, the heat exchanger components such as at its entrance, exit, in the manifolds, in the distributors, in the conduits, or combinations thereof wherein the flow meters may be positioned to sense flow through one or more of these components.

In an exemplary embodiment, the shell 806 of a SiC block in shell or shell and SiC tubes heat exchanger may comprise a material such as Kovar or Invar stainless steel having a coefficient of thermal expansion that about matches that of SiC such that the expansion of the shell is about the same as that of the SiC block or SiC tubes. The shell 806 may comprise and expansion means such as a bellows. Alternatively, the heat exchanger shell 806 may comprise two sections that overlap to allow for expansion. The joint such as a ship lap or tongue and groove joint may seal by expansion.

In an embodiment, the heat exchanger comprises at least one of a protection circuit and protection software to control the EM pump to prevent thermal shock of at least one heat exchanger component such as a ceramic one such as a SiC block of a block in shell heat exchanger or a SiC tube of a shell and tubes heat exchanger.

The heat exchanger may comprise carbon components such as at least one of carbon conduits 801, manifolds 802, distributors 805, heat exchanger inlet line 803, and heat exchanger outlet line 804, 806, external coolant inlet 807, external coolant outlet 808, and baffles 809. The carbon components may be at least one of glued together or fastened with gasketed joints such as ones comprising Graphoil gaskets. The surfaces exposed to air may be coated with an oxidation resistant coating such as SiC such as CVD SiC or SiC glaze. An exemplary heat exchanger is the shell and tube design of GAB Neumann (https://www.gab-neumann.com) wherein the external surfaces such those of the conduits 801 are coated with SiC. Alternatively, the external surfaces may be clad in an oxidation resistant material such as stainless steel. In another embodiment, SunCell® components such as EM pump components or heat exchanger components that react with air such as carbon or Ta ones may be housed in a hermetically sealable or vacuum capable housing that may be either evacuated or filled with an inert gas such as a noble gas such as argon or nitrogen to protect the housed SunCell® components from oxidation at high temperature. The gallium line from the EM pump to the heat exchanger inlet 803 may comprise a metal that does not react with carbon at the operating temperature, so that a metal to carbon connection such as a gasketed one such as a carbon gasketed flange connection does not react to form carbide. An exemplary metal that does not react with carbon at 1000° C. is nickel or a nickel or rhenium plated metal such as nickel or rhenium plated stainless steel.

In an exemplary embodiment shown in FIGS. 31E-G, the components that contact molten gallium comprise carbon, and the components that contact air coolant comprise stainless steel. Conduit liners 801a, manifolds or bonnets 802, heat exchanger inlet line 803, and heat exchanger outlet line 804 comprise carbon, and conduits 801, distributors 805, shell 806, external coolant inlet 807, external coolant outlet 808, and baffles 809 comprise stainless steel. Each stainless-steel conduit 801 is welded to the corresponding distributor 805 at each end. The distributors 805 are welded to the shell 806 such that air coolant only contacts stainless steel. The bonnets 802, inlet 803 and outlet 804 are inside of a stainless-steel housing 806a that has a welded-in inlet 803c line and welded-in outlet line 804c connected to the carbon heat exchanger inlet line 803 and outlet line 804 inside of the housing 806a wherein the connections comprise gasketed flanged unions. The gaskets may comprise carbon. Each distributors 805 may comprise two pieces, one outer piece 805a comprising carbon glued to the ends of the liners 801a and an inner piece comprising stainless steel welded to the housing 806a and the shell 806. The line 803 from the gallium circulation EM pump 810 and the return line 804 to the reservoir 5c may comprise an expansion joint such as a bellows or spring-loaded joint.

In an embodiment, the heat exchanger comprising carbon components such as ones that are exposed to air such as conduits 801 further comprises a carbon combustion products detector such as a smoke detector and a protection system to avoid failure of the component and potential fire involving the molten metal such as gallium. The protection system may comprise a fire suppression system such as those known in the art such as a fire extinguisher system or a set of values that close off the air flow to the chamber of the shell 806 such a valves at the external coolant inlet 807 and outlet 808.

Anodic films may be formed on the surface of titanium, zinc, magnesium, niobium, zirconium, hafnium, and tantalum. Exemplary oxides of Nb, Ta, and Zr are more stable than gallium oxide. In an embodiment, at least one component of the SunCell® and the heat exchanger comprises metal that forms an anodic or oxide film or coat. The oxide coat may at least one of (i) protect the component from forming an alloy with the molten metal such at least one of gallium, Galinstan, silver, and copper and (ii) protect the component from oxidation. In an exemplary embodiment, the component comprises at least one of Nb, Ta, and Zr that may comprise a protective oxide coat. In an embodiment of a SunCell® component, the component may be anodized to form the protective oxide coat which may protect the component from forming an alloy with the molten metal such as gallium, Galinstan, silver, and copper and protect the component from oxidation by the hydrino reaction mixture. In an embodiment of a heat exchanger component, the component that is exposed to air may be anodized to protect it from air oxidation.

In an embodiment, shown in FIG. 31H, the exchanger comprises a plurality of modular units 813 of the heat exchanger of the disclosure. The molten metal may flow from the reservoir 5c through a heat exchanger inlet line 803b to a heat exchanger inlet manifold 803a to the inlet 803 of each heat exchanger module 813. The molten metal may be pumped back to the reservoir 5c by EM pump 810 that maintains molten metal flow through each heat exchanger outlet 804, outlet manifold 804a, and heat exchanger outlet line 804b.

In an embodiment, the heat exchanger may comprise a primary loop and a secondary loop wherein the molten metal of the reservoir 5c is maintained separate in a primary loop from a coolant such as a molten metal or molten salt coolant in the secondary loop. Heat is exchanged from the primary to the secondary loop by a first stage heat exchanger and heat is delivered to the load by a secondary stage heat exchanger. In an embodiment, the secondary loop comprises a molten metal or molten salt heat exchanger. In an embodiment, the molten-gallium to air heat exchanger may comprise a commercial molten-gallium to air heat exchanger or a commercial molten-salt to air heat exchanger wherein the latter may compatible with a modification comprising the replacement of the molten salt with molten gallium.

The heat exchanger may comprise a plurality of stages such as a two-stage heat exchanger wherein a first gas or liquid comprises the external coolant in the first stage, and a second gas or liquid comprises the external coolant in a second stage. Heat is transferred from the first external coolant to the second through a heat exchanger such as a gas-to-gas heat exchanger. An exemplary two-stage heat exchanger comprises carbon conduits 801, manifolds 802, distributors 805, heat exchanger inlet line 803, heat exchanger outlet line 804, shell 806, external coolant inlet 807, external coolant outlet 808, and baffles 809. The components may be joined by gluing with a carbon adhesive or by joints or unions such as ones comprising flanges and gaskets such as carbon (Graphoil) gaskets. The first external coolant may comprise a noble gas such as helium or nitrogen that transfers the heat though the gas-to-gas heat exchanger to the second external coolant comprising air.

In an embodiment, the first stage heat exchanger comprises carbon such as a graphite annular groove heat exchanger, block in shell heat exchanger, shell and tube heat exchanger from GAB Neumann (https://www.gab-neumann.com) wherein gallium exchanges heat with silver as the external coolant in a first stage and the silver exchanges its heat with another external coolant such as air in the second stage. The second stage heat exchanger may comprise a shell-and-tube design such as that shown in FIG. 31D. In another embodiment, the first stage heat exchanger such as a shell and tube heat exchanger comprises tantalum.

In an embodiment, the external coolant blower 811 comprises the compressor of a gas turbine that supplies compressed air through the heat exchanger external coolant inlet 807. The air may flow over the conduits 801. The heated air may exit the heat exchanger external coolant outlet 808 and flow into the power section of a gas turbine wherein the SunCell® 812 and heat exchanger 813 comprise a thermal power source of an external-combustor-type gas turbine mechanical or electrical power generator.

In an embodiment, at least one heat exchanger component such as the inlet 803 and outlet lines 804, distributor 805, manifolds 802, and conduits 801 are at least one of coated or lined with a material that resists alloy formation with the molten metal such as gallium or otherwise prevents corrosion of the component. The coating or liner may comprise one of the disclosure such as BN, carbon, quartz, zirconia-titania-yttria, Mullite, or alumina. In an exemplary embodiment, the molten metal comprises gallium, at least one heat exchanger component such as the inlet 803 and outlet lines 804, distributor 805, manifolds 802, and conduits 801 comprises stainless steel, and the liner comprises quartz or another ceramic. The stainless steel may be replaced by Kovar or Invar avoid thermal expansion and contraction mismatch with the ceramic liner such as one comprising with quartz. In an alternative exemplary embodiment, the conduits comprise nickel, each with a carbon liner.

In an embodiment, the heat exchanger may be internal versus external to the SunCell® reservoir. At least one the heat exchanger manifold may comprise the reservoir 5c. The EM pump that circulates the molten metal such as gallium through the heat exchanger conduits may comprise at least one of the injector EM pump 5ka and another pump.

In an embodiment, the heat exchanger may comprise two end manifolds 802 with a plurality of tubes 801 that connect the manifolds. Alternatively, the heat exchanger comprises one or more zigzagged conduits that connects the manifolds. The manifolds may further serve as reservoirs. The conduits may be embedded in a system or array of cooling fins. The heat exchanger may comprise a truck radiator type wherein the water coolant is replaced by molten metal, and the water pump is replaced by a molten metal pump such as an EM pump. The radiator may be cooled by an external coolant such as air or water. The external coolant may be transported by a blower or water pump, respectively, that forces the flow of the external coolant such as air or water through the cooling fins. The fins may comprise a material with a high heat transfer coefficient such as copper, nickel, or Ni—Cu alloy.

In another embodiment, the heat exchanger may comprise a plate heat exchanger such as one made by Alfa-Laval comprising parallel plates with the external coolant such as air and the SunCell® molten metal flowing in alternate channels between the plates.

In an embodiment, the heat exchanger may comprise a boiler such as a steam boiler. In an embodiment, the liquid molten metal heat exchanger comprises conduits comprising boiler tubes 801 that serve to heat water in a pressurized vessel 806 comprising a boiler. The conduits 801 may be positioned inside of a pressurized vessel 806 comprising a boiler. The molten metal may be pumped through the conduits 801 wherein the thermal power flows into a pool of water to form at least one of super-heated water and steam in the boiler. The superheated water may be converted to steam in a steam generator.

In an exemplary embodiment, the boiler comprises a cylindrical shell with longitudinal conduits in the shell wherein external water coolant flows longitudinally through the shell and the along the conduits that may comprise surface protrusions to at least one of increase the conduit surface area and create turbulence to enhance the heat transfer from the conduits to the water. The cylindrical shell may be oriented vertically. In an embodiment, the baseplate 5kk1 may have openings for coolant flow. Additionally, the baseplate 5kk1 may at least one of comprise a thin plate such as one in the thickness range of about 0.1 mm and 5 mm and comprise a metal with a higher heat transfer coefficient such as W, Ta, Nb, or Cr—Mo SS plate to improve the baseplate cooling.

In an embodiment the SunCell® and heat exchanger comprises at least one temperature measurement device such as a thermocouple or thermistor that may be at least one of surface mounted to a component, immersed in the molten metal, and exposed to the gas or plasma in the reaction cell chamber 5b31. The temperature of at least one of the walls of the reaction cell chamber, the EM pump tube 5k6, and the heat exchanger components such as at least one of the conduits 801, manifolds 802, distributors 805, heat exchanger inlet line 803, and heat exchanger outlet line 804 may be monitored by at least one surface mounted thermocouple that may be bonded to the surface of the component. The bonding may comprise a weld or ceramic glue such as one with a high heat transfer coefficient. The glue may comprise BN or SiC.

In an embodiment, the SunCell® comprises a vacuum system comprising a vacuum line to the reaction cell chamber and a vacuum pump to evacuate the gases from the reaction cell chamber on an intermittent or continuous basis. In an embodiment, the SunCell® comprises condenser to condense at least one hydrino reaction reactant or product. The condenser may be in-line with the vacuum pump or comprise a gas conduit connection with the vacuum pump. The vacuum system may further comprise a condenser to condense at least one reactant or product flowing from the reaction cell chamber. The condenser may cause the condensate, condensed reactant or product, to selectively flow back into the reaction cell chamber. The condenser may be maintained in a temperature range to cause the selective flow of the condensate back to the reaction cell chamber. The flow may be means of active or passive transport such as by pumping or by gravity flow, respectively. In an embodiment, the condenser may comprise a means to prevent particle flow such as gallium or gallium oxide nanoparticles from the reaction cell chamber into the vacuum system such as at least one of a filter, zigzag channel, and an electrostatic precipitator. In an embodiment, the vacuum pump may be cooled by means such as water or force air cooling.

In an exemplary tested embodiment, the reaction cell chamber was maintained at a pressure range of about 1 Torr to 20 Torr while flowing 10 sccm of H₂ and injecting 4 ml of H₂O per minute while applying active vacuum pumping. The DC voltage was about 28 V and the DC current was about 1 kA. The reaction cell chamber was a SS cube with edges of 9-inch length that contained 47 kg of molten gallium. The electrodes comprised a 1-inch submerged SS nozzle of a DC EM pump and a counter electrode comprising a 4 cm diameter, 1 cm thick W disc with a 1 cm diameter lead covered by a BN pedestal. The EM pump rate was about 30-40 ml/s. The gallium was polarized positive and the W pedestal electrode was polarized negative. The SunCell® output power was about 150 kW measured using the product of the mass, specific heat, and temperature rise of the gallium and SS reactor.

In an embodiment, the reaction mixture may comprise an additive comprising a species such as a metal or compound that reacts with at least one of oxygen and water. The additive may be regenerated. The regeneration may be achieved by at least one system of the SunCell®. The regeneration system may comprise at least one of a thermal, plasma, and electrolysis system. The additive may be added to a reaction mixture comprising molten silver. In an embodiment, the additive may comprise gallium that may be added to molten silver that comprises the molten metal. In an embodiment, water may be supplied to the reaction cell chamber. The water may be supplied by an injector. The gallium may react with water supplied to the reaction mixture to form hydrogen and gallium. The hydrogen may react with some residual HOH that serves as the hydrino catalyst. The gallium oxide may be regenerated by an electrolysis system. The gallium metal and oxygen produced reduced by the electrolysis system may be pumped back to the reaction cell chamber and exhausted for the cell, respectively.

In an embodiment, hydrogen gas may be added to the reaction mixture to eliminate the gallium oxide film formed by the reaction of injected water with gallium. The hydrogen gas in the reaction cell chamber may be in at least one pressure range of about 0.1 Torr to 100 atm, 1 Torr to 1 atm, and 1 Torr to 10 Torr. The hydrogen may be flowed into the reaction cell chamber at a rate per liter of reaction cell chamber volume in at least range of about 0.001 sccm to 10 liter per minute, 0.001 sccm to 10 liter per minute, and 0.001 sccm to 10 liter per minute.

In an embodiment, hydrogen may serve as the catalyst. The source of hydrogen to supply nH (n is an integer) as the catalyst and H atoms to form hydrino may comprise H₂ gas that may be supplied through a hydrogen permeable membrane such as a Pd or Pd—Ag such as 23% Ag/77% Pd alloy membrane in the EM pump tube 5k4 wall using a mass flow controller to control the hydrogen flow from a high-pressure water electrolyzer. The use of hydrogen as the catalyst as a replacement for HOH catalyst may avoid the oxidation reaction of at least one cell component such as a carbon reaction cell chamber 5b31. Plasma maintained in the reaction cell chamber may dissociate the H₂ to provide the H atoms. The carbon may comprise pyrolytic carbon to suppress the reaction between the carbon and hydrogen.

### Solid Fuel SunCell®

In an embodiment, the SunCell® comprises a solid fuel that reacts to form at least one reactant to form hydrinos. The hydrino reactants may comprise atomic H and a catalyst to form hydrinos. The catalyst may comprise nascent water, HOH. The reactant may be at least partially regenerated in situ in the SunCell®. The solid fuel may be regenerated by a plasma or thermal driven reaction in the reaction cell chamber 5b31. The regeneration may be achieved by at least one of the plasma and thermal power maintained and released in the reaction cell chamber 5b31. The solid fuel reactants may be regenerated by supplying a source of the element that is consumed in the formation of hydrino or products comprising hydrinos such as lower energy hydrogen compounds and compositions of matter. The SunCell® may comprise at least one of a source of H and oxygen to replace any lost by the solid fuel during propagation of the hydrino reaction in the SunCell®. The source of at least one of H and O may comprise at least one of H₂, H₂O, and O₂. In an exemplary regenerative embodiment, H₂ that is consumed to form H₂(1/4) is replaced by addition of at least one of H₂ and H₂O wherein H₂O may further serve as the source of at least one of HOH catalyst and O₂. Optimally, at least one of CO₂ and a noble gas such as argon may be a component of the reaction mixture wherein CO₂ may serve as a source of oxygen to form HOH catalyst.

In an embodiment, the SunCell® further comprises an electrolysis cell to regenerate at least some of at least one starting material from any products formed in the reaction cell chamber. The starting material may comprise at least one of the reactants of the solid fuel wherein the product may form by the solid fuel reaction to form hydrino reactants. The starting material may comprise the molten metal such as gallium or silver. In an embodiment, the molten metal is non-reactive with the molten metal. An exemplary non-reactive molten metal comprises silver. The electrolysis cell may comprise at least one of the reservoirs 5c, the reaction cell chamber 5b31, and a separate chamber external to at least one of the reservoir 5c and the reaction cell chamber 5b31. The electrolysis cell may comprise at least (i) two electrodes, (ii) inlet and outlet channels and transporters for a separate chamber, (iii) an electrolyte that may comprise at least one of the molten metal, and the reactants and the products in at least one of the reservoir, the reaction cell chamber, and the separate chamber, (iv) an electrolysis power supply, and (v) controller for the electrolysis and controllers and power sources for the transporters into and out of the electrolysis cell where applicable. The transporter may comprise one of the disclosure.

In an embodiment, a solid fuel reaction forms H₂O and H as products or intermediate reaction products. The H₂O may serve as a catalyst to form hydrinos. The reactants comprise at least one oxidant and one reductant, and the reaction comprises at least one oxidation-reduction reaction. The reductant may comprise a metal such as an alkali metal. The reaction mixture may further comprise a source of hydrogen, and a source of H₂O, and may optionally comprise a support such as carbon, carbide, boride, nitride, carbonitrile such as TiCN, or nitrile. The support may comprise a metal powder. The source of H may be selected from the group of alkali, alkaline earth, transition, inner transition, rare earth hydrides, and hydrides of the present disclosure. The source of hydrogen may be hydrogen gas that may further comprise a dissociator such as those of the present disclosure such as a noble metal on a support such as carbon or alumina and others of the present disclosure. The source of water may comprise a compound that dehydrates such as a hydroxide or a hydroxide complex such as those of Al, Zn, Sn, Cr, Sb, and Pb. The source of water may comprise a source of hydrogen and a source of oxygen. The oxygen source may comprise a compound comprising oxygen. Exemplary compounds or molecules are O₂, alkali or alkali earth oxide, peroxide, or superoxide, TeO₂, SeO₂, PO₂, P₂O₅, SO₂, SO₃, M₂SO₄, MHSO₄, CO₂, M₂S₂O₈, MMnO₄, M₂Mn₂O₄, MₓH_{y}PO₄ (x, y=integer), POBr₂, MClO₄, MNO₃, NO, N₂O, NO₂, N₂O₃, Cl₂O₇, and O₂ (M=alkali; and alkali earth or other cation may substitute for M). Other exemplary reactants comprise reagents selected from the group of Li, LiH, LiNO₃, LiNO, LiNO₂, Li₃N, Li₂NH, LiNH₂, LiX, NH₃, LiBH₄, LiAlH₄, Li₃AlH₆, LiOH, Li₂S, LiHS, LiFeSi, Li₂CO₃, LiHCO₃, Li₂SO₄, LiHSO₄, Li₃PO₄, Li₂HPO₄, LiH₂PO₄, Li₂MoO₄, LiNbO₃, Li₂B₄O₇ (lithium tetraborate), LiBO₂, Li₂WO₄, LiAlCl₄, LiGaCl₄, Li₂CrO₄, Li₂Cr₂O₇, Li₂TiO₃, LiZrO₃, LiAlO₂, LiCoO₂, LiGaO₂, Li₂GeO₃, LiMn₂O₄, Li₄SiO₄, Li₂SiO₃, LiTaO₃, LiCuCl₄, LiPdCl₄, LiVO₃, LiIO₃, LiBrO₃, LiXO₃ (X=F, Br, Cl, I), LiFeO₂, LiIO₄, LiBrO₄, LiIO₄, LiXO₄ (X=F, Br, Cl, I), LiScOₙ, LiTiOₙ, LiVOₙ, LiCrOₙ, LiCr₂Oₙ, LiMn₂Oₙ, LiFeOₙ, LiCoOₙ, LiNiOₙ, LiNi₂Oₙ, LiCuOₙ, and LiZnOₙ, where n=1, 2,3, or 4, an oxyanion, an oxyanion of a strong acid, an oxidant, a molecular oxidant such as V₂O₃, I₂O₅, MnO₂, Re₂O₇, CrO₃, RuO₂, AgO, PdO, PdO₂, PtO, PtO₂, and NH₄X wherein X is a nitrate or other suitable anion given in the CRC, and a reductant. Another alkali metal or other cation may substitute for Li. Additional sources of oxygen may be selected from the group of MCoO₂, MGaO₂, M₂GeO₃, MMn₂O₄, M₄SiO₄, M₂SiO₃, MTaO₃, MVO₃, MIO₃, MFeO₂, MIO₄, MClO₄, MScOₙ, MTiOₙ, MVOₙ, MCrOₙ, MCr₂Oₙ, MMn₂Oₙ, MFeOₙ, MCoOₙ, MNiOₙ, MNi₂Oₙ, MCuOₙ, and MZnOₙ, where M is alkali and n=1, 2,3, or 4, an oxyanion, an oxyanion of a strong acid, an oxidant, a molecular oxidant such as V₂O₃, I₂O₅, MnO₂, Re₂O₇, CrO₃, RuO₂, AgO, PdO, PdO₂, PtO, PtO₂, I₂O₄, I₂O₅, I₂O₉, SO₂, SO₃, CO₂, N₂O, NO, NO₂, N₂O₃, N₂O₄, N₂O₅, Cl₂O, ClO₂, Cl₂O₃, Cl₂O₆, Cl₂O₇, PO₂, P₂O₃, and P₂O₅. The reactants may be in any desired ratio that forms hydrinos. An exemplary reaction mixture is 0.33 g of LiH, 1.7 g of LiNO₃ and the mixture of 1 g of MgH₂ and 4 g of activated C powder. Additional suitable exemplary reactions to form at least one of the reacts H₂O catalyst and H₂ are given in Tables 1, 2, and 3.

TABLE 1
Thermally reversible reaction cycles regarding H₂O catalyst and H₂. [L. C. Brown, G. E.
Besenbruch, K. R. Schultz, A. C. Marshall, S. K. Showalter, P. S. Pickard and J. F. Funk,
Nuclear Production of Hydrogen Using Thermochemical Water-Splitting Cycles, a preprint
of a paper to be presented at the International Congress on Advanced Nuclear Power preprint
of a paper to be presented at the International Congress on Advanced Nuclear Power Plants
(ICAPP) in Hollywood, Florida, Jun. 19-13, 2002, and published in the Proceedings.]

| Cycle | Name | T/E* | T (° C.) | Reaction |
|---|---|---|---|---|
| 1 | Westinghouse | T | 850 | 2H₂SO₄(g) → 2SO₂(g) + 2H₂O(g) + O₂(g) |
| | | E | 77 | SO₂(g) + 2H₂O(a) → → H₂SO₄(a) + H₂(g) |
| 2 | Ispra Mark 13 | T | 850 | 2H₂SO₄(g) → 2SO₂(g) + 2H₂O(g) + O₂(g) |
| | | E | 77 | 2HBr(a) → Br₂(a) + H₂(g) |
| | | T | 77 | Br₂(1) + SO₂(g) + 2H₂O(l) → 2HBr(g) + H₂SO₄(a) |
| 3 | UT-3 Univ. of Tokyo | T | 600 | 2Br₂(g) + 2CaO → 2CaBr₂ + O₂(g) |
| | | T | 600 | 3FeBr₂ + 4H₂O → Fe₃O₄ + 6HBr + H₂(g) |
| | | T | 750 | CaBr₂ + H₂O → CaO + 2HBr |
| | | T | 300 | Fe₃O4 + 8HBr → Br₂ + 3FeBr₂ + 4H₂O |
| 4 | Sulfur-Iodine | T | 850 | 2H₂SO₄(g) → 2SO₂(g) + 2H₂O(g) + O₂(g) |
| | | T | 450 | 2HI → I₂(g) + H₂(g) |
| | | T | 120 | I₂ + SO₂(a) + 2H₂O → 2HI(a) + H₂SO₄(a) |
| 5 | Julich Center EOS | T | 800 | 2Fe₃O₄ + 6FeSO₄ → 6Fe₂O₃ + 6SO₂ + O₂(g) |
| | | T | 700 | 3FeO + H₂O → Fe₃O₄ + H₂(g) |
| | | T | 200 | Fe₂O₃ + SO₂ → FeO + FeSO₃ |
| 6 | Tokyo Inst. Tech. Ferrite | T | 1000 | 2MnFe₂O₄ + 3Na₂CO₃ + H₂O → 2Na₃MnFe₂O₆ + 3CO₂(g) + |
| | | | | H₂(g) |
| | | T | 600 | 4Na₃MnFe₂O₆ + 6CO₂(g) → 4MnFe₂O₄ + 6Na₂CO₃ + |
| | | | | O₂(g) |
| 7 | Hallett Air Products 1965 | T | 800 | 2Cl₂(g) + 2H₂O(g) → 4HCl(g) + O₂(g) |
| | | E | 25 | 2HCl → Cl₂(g) + H₂(g) |
| 8 | Gaz de France | T | 725 | 2K + 2KOH → 2K₂O + H₂(g) |
| | | T | 825 | 2K₂O → 2K + K₂O₂ |
| | | T | 125 | 2K₂O₂ + 2H₂O → 4KOH + O₂(g) |
| 9 | Nickel Ferrite | T | 800 | NiMnFe₄O₆ + 2H₂O → NiMnFe₄O₈ + 2H₂(g) |
| | | T | 800 | NiMnFe₄O₈ → NiMnFe₄O₆ + O₂(g) |
| 10 | Aachen Univ Julich 1972 | T | 850 | 2Cl₂(g) + 2H₂O(g) → 4HCl(g) + O₂(g) |
| | | T | 170 | 2CrCl₂ + 2HCl → 2CrCl₃ + H₂(g) |
| | | T | 800 | 2CrCl₃ → 2CrCl₂ + Cl₂(g) |
| 11 | Ispra Mark 1C | T | 100 | 2CuBr₂ + Ca(OH)₂ → 2CuO + 2CaBr₂ + H₂O |
| | | T | 900 | 4CuO(s) → 2Cu₂O(s) + O₂(g) |
| | | T | 730 | CaBr₂ + 2H₂O → Ca(OH)₂ + 2HBr |
| | | T | 100 | Cu₂O + 4HBr → 2CuBr₂ + H₂(g) + H₂O |
| 12 | LASL-U | T | 25 | 3CO₂ + U₃O₈ + H₂O → 3UO₂CO₃ + H₂(g) |
| | | T | 250 | 3UO₂CO₃ → 3CO₂(g) + 3UO₃ |
| | | T | 700 | 6UO₃(s) → 2U₃O₈(s) + O₂(g) |
| 13 | Ispra Mark 8 | T | 700 | 3MnCl₂ + 4H₂O → Mn₃O₄ + 6HCl + H₂(g) |
| | | T | 900 | 3MnO₂ → Mn₃O₄ + O₂(g) |
| | | T | 100 | 4HCl + Mn₃O₄ → 2MnCl₂(a) + MnO₂ + 2H₂O |
| 14 | Ispra Mark 6 | T | 850 | 2Cl₂(g) + 2H₂O(g) → 4HCl(g) + O₂(g) |
| | | T | 170 | 2CrCl₂ + 2HCl → 2CrCl₃ + H₂(g) |
| | | T | 700 | 2CrCl₃ + 2FeCl₂ → 2CrCl₂ + 2FeCl₃ |
| | | T | 420 | 2FeCl₃ → Cl₂(g) + 2FeCl₂ |
| 15 | Ispra Mark 4 | T | 850 | 2Cl₂(g) + 2H₂O(g) → 4HCl(g) + O₂(g) |
| | | T | 100 | 2FeCl₂ + 2HCl + S → 2FeCl₃ + H₂S |
| | | T | 420 | 2FeCl₃ → Cl₂(g) + 2FeCl₂ |
| | | T | 800 | H₂S → S + H₂(g) |
| 16 | Ispra Mark 3 | T | 850 | 2Cl₂(g) + 2H₂O(g) → 4HCl(g) + O₂(g) |
| | | T | 170 | 2VOCl₂ + 2HCl → 2VOCl₃ + H₂(g) |
| | | T | 200 | 2VOCl₃ → Cl₂(g) + 2VOCl₂ |
| 17 | Ispra Mark 2 (1972) | T | 100 | Na₂O•MnO₂ + H₂O → 2NaOH(a) + MnO₂ |
| | | T | 487 | 4MnO₂(s) → 2Mn₂O₃(s) + O₂(g) |
| | | T | 800 | Mn₂O₃ + 4NaOH → 2Na₂O•MnO₂ + H₂(g) + H₂O |
| 18 | Ispra CO/Mn3O4 | T | 977 | 6Mn₂O₃ → 4Mn₃O₄ + O₂(g) |
| | | T | 700 | C(s) + H₂O(g) → CO(g) + H₂(g) |
| | | T | 700 | CO(g) + 2Mn₃O₄ → C + 3Mn₂O₃ |
| 19 | Ispra Mark 7B | T | 1000 | 2Fe₂O₃ + 6Cl₂(g) → 4FeCl₃ + 3O₂(g) |
| | | T | 420 | 2FeCl₃ → Cl₂(g) + 2FeCl₂ |
| | | T | 650 | 3FeCl₂ + 4H₂O → Fe₃O₄ + 6HCl + H₂(g) |
| | | T | 350 | 4Fe₃O₄ + O₂(g) → 6Fe₂O₃ |
| | | T | 400 | 4HCl + O₂(g) → 2Cl₂(g) + 2H₂O |
| 20 | Vanadium Chloride | T | 850 | 2Cl₂(g) + 2H₂O(g) → 4HCl(g) + O₂(g) |
| | | T | 25 | 2HCl + 2VCl₂ → 2VCl₃ + H₂(g) |
| | | T | 700 | 2VCl₃ → VCl₄ + VCl₂ |
| | | T | 25 | 2VCl₄ → Cl₂(g) + 2VCl₃ |
| 21 | Ispra Mark 7A | T | 420 | 2FeCl₃(l) → Cl₂(g) + 2FeCl₂ |
| | | T | 650 | 3FeCl₂ + 4H₂O(g) → Fe₃O₄ + 6HCl(g) + H₂(g) |
| | | T | 350 | 4Fe₃O₄ + O₂(g) → 6Fe₂O₃ |
| | | T | 1000 | 6Cl₂(g) + 2Fe₂O₃ → 4FeCl₃(g) + 3O₂(g) |
| | | T | 120 | Fe₂O₃ + 6HCl(a) → 2FeCl₃(a) + 3H₂O(l) |
| 22 | GA Cycle 23 | T | 800 | H₂S(g) → S(g) + H₂(g) |
| | | T | 850 | 2H₂SO₄(g) → 2SO₂(g) + 2H₂O(g) + O₂(g) |
| | | T | 700 | 3S + 2H₂O(g) → 2H₂S(g) + SO₂(g) |
| | | T | 25 | 3SO₂(g) + 2H₂O(l) → 2H₂SO₄(a) + S |
| | | T | 25 | S(g) + O₂(g) → SO₂(g) |
| 23 | US -Chlorine | T | 850 | 2Cl₂(g) + 2H₂O(g) → 4HCl(g) + O₂(g) |
| | | T | 200 | 2CuCl + 2HCl → 2CuCl₂ + H₂(g) |
| | | T | 500 | 2CuCl₂ → 2CuCl + Cl₂(g) |
| 24 | Ispra Mark | T | 420 | 2FeCl₃ → Cl₂(g) + 2FeCl₂ |
| | | T | 150 | 3Cl₂(g) + 2Fe₃O₄ + 12HCl → 6FeCl₃ + 6H₂O + O₂(g) |
| | | T | 650 | 3FeCl₂ + 4H₂O → Fe₃O₄ + 6HCl + H₂(g) |
| 25 | Ispra Mark 6C | T | 850 | 2Cl₂(g) + 2H₂O(g) → 4HCl(g) + O₂(g) |
| | | T | 170 | 2CrCl₂ + 2HCl → 2CrCl₃ + H₂(g) |
| | | T | 700 | 2CrCl₃ + 2FeCl₂ → 2CrCl₂ + 2FeCl₃ |
| | | T | 500 | 2CuCl₂ → 2CuCl + Cl₂(g) |
| | | T | 300 | CuCl + FeCl₃ → CuCl₂ + FeCl₂ |

*T = thermochemical, E = electrochemical.

TABLE 2
Thermally reversible reaction cycles regarding H₂O catalyst and H₂.
[C. Perkins and A.W. Weimer, Solar-Thermal Production of
Renewable Hydrogen, AIChE Journal, 55 (2), (2009), pp. 286-293.]

| Cycle | Reaction Steps |
|---|---|
| High | |
| Temperature | |
| Cycles | |
| Zn/ZnO | $ZnO {\to }^{1600 ‐ 1800 ° C .} Zn + \frac{1}{2} {O}_{2}$ |
| | $Zn + {H}_{2} O {\to }^{400 ° C .} ZnO + {H}_{2}$ |
| FeO/Fe₃O₄ | ${Fe}_{3} {O}_{4} {\to }^{2000 ‐ 2300 ° C .} 3 FeO + \frac{1}{2} {O}_{2}$ |
| | $3 FeO + {H}_{2} O {\to }^{400 ° C .} {Fe}_{3} {O}_{4} + {H}_{2}$ |
| Cadmium carbonate | $CdO {\to }^{1450 ‐ 1500 ° C .} Cd + \frac{1}{2} {O}_{2}$ |
| | $Cd + {H}_{2} O + {CO}_{2} {\to }^{350 ° C .} {CdCO}_{3} + {H}_{2}$ |
| | ${CdCO}_{3} {\to }^{500 ° C .} {CO}_{2} + CdO$ |
| Hybrid cadmium | $CdO {\to }^{1450 ‐ 1500 ° C .} Cd + \frac{1}{2} {O}_{2}$ |
| | $Cd + 2 {H}_{2} O {\to }^{25 ° C . , electrochemical} {Cd ( OH )}_{2} + {H}_{2}$ |
| | ${Cd ( OH )}_{2} {\to }^{375 ° C .} CdO + {H}_{2} O$ |
| Sodium manganese | ${Mn}_{2} {O}_{3} {\to }^{1400 ‐ 1600 ° C .} 2 MnO + \frac{1}{2} {O}_{2}$ |
| | $2 MnO + 2 NaOH {\to }^{627 ° C .} 2 {NaMnO}_{2} + {H}_{2}$ |
| | $2 {NaMnO}_{2} + {H}_{2} O {\to }^{25 ° C .} {Mn}_{2} {O}_{3} + 2 NaOH$ |
| M-Ferrite (M = Co, Ni, Zn) | ${Fe}_{3 - x} {M}_{x} {O}_{4} {\to }^{1200 ‐ 1400 ° C .} {Fe}_{3 - x} {M}_{x} {O}_{4 - δ} + \frac{δ}{2} {O}_{2}$ |
| | ${Fe}_{3 - x} {M}_{x} {O}_{4 - δ} + {δH}_{2} O {\to }^{1000 ‐ 1200 ° C .} {Fe}_{3 - x} {M}_{x} {O}_{4} + {δH}_{2}$ |
| Low | |
| Temperature | |
| Cycles | |
| Sulfur-Iodine | ${H}_{2} {SO}_{4} {\to }^{850 ° C .} {SO}_{2} + {H}_{2} O + \frac{1}{2} {O}_{2}$ |
| | ${I}_{2} + {SO}_{4} + 2 {H}_{2} O {\to }^{100 ° C .} 2 HI + {H}_{2} {SO}_{4}$ |
| | $2 HI {\to }^{300 ° C .} {I}_{2} + {H}_{2}$ |
| Hybrid sulfur | ${H}_{2} {SO}_{4} {\to }^{850 ° C .} {SO}_{2} + {H}_{2} O + \frac{1}{2} {O}_{2}$ |
| | ${SO}_{2} + 2 {H}_{2} O {\to }^{77 ° C . , electrochemical} {H}_{2} {SO}_{4} + {H}_{2}$ |
| Hybrid copper chloride | ${Cu}_{2} {OCl}_{2} {\to }^{550 ° C .} 2 CuCl + \frac{1}{2} {O}_{2}$ |
| | $2 Cu + 2 HCl {\to }^{425 ° C .} {H}_{2} + 2 CuCl$ |
| | $4 CuCl {\to }^{25 ° C . , electrochemical} 2 Cu + 2 {CuCl}_{2}$ |
| | $2 {CuCl}_{2} + {H}_{2} O {\to }^{325 ° C .} {Cu}_{2} {OCl}_{2} + 2 HCl$ |

TABLE 3
Thermally reversible reaction cycles regarding H₂O catalyst and H₂. [S. Ahanades, P. Charvin, G. Flamant, P. Neveu, Screening of Water-Splitting
Thermochemical Cycles Potentially Attractive for Hydrogen Production by Concentrated Solar Energy, Energy, 31, (2006), pp. 2805-2822.]

| | | | Number | | | |
|---|---|---|---|---|---|---|
| | | | of | Maximum | | |
| | | List of | chemical | temperature | | |
| No ID | Name of the cycle | elements | steps | (° C.) | Reactions | |
| 6 | ZnO/Zn | Zn | 2 | 2000 | ZnO → Zn + 1/2O₂ | (2000° C.) |
| | | | | | Zn + H₂O → ZnO + H₂ | (1100° C.) |
| 7 | Fe₃O₄/FeO | Fe | 2 | 2200 | Fe₃O₄ → 3FeO + 1/2O₂ | (2200° C.) |
| | | | | | 3FeO + H₂O → Fe₃O₄ + H₂ | (400° C.) |
| 194 | In₂O₃/In₂O | In | 2 | 2200 | In₂O₃ → In₂O + O₂ | (2200° C.) |
| | | | | | In2O + 2H₂O → In₂O₃ + 2H₂ | (800° C.) |
| 194 | SnO₂/Sn | Sn | 2 | 2650 | SnO₂ → Sn + O₂ | (2650° C.) |
| | | | | | Sn + 2H₂O → SnO₂ + 2H₂ | (600° C.) |
| 83 | MnO/MnSO₄ | Mn, S | 2 | 1100 | MnSO₄ → MnO + SO₂ + 1/2O₂ | (1100° C.) |
| | | | | | MnO + H₂O + SO₂ → MnSO₄ + H₂ | (250° C.) |
| 84 | FeO/FeSO₄ | Fe, S | 2 | 1100 | FeSO₄ → FeO + SO₂ + 1/2O₂ | (1100° C.) |
| | | | | | FeO + H₂O + SO₂ → FeSO₄ + H₂ | (250° C.) |
| 86 | CoO/CoSO₄ | Co, S | 2 | 1100 | CoSO₄ → CoO + SO₂ + 1/2O₂ | (1100° C.) |
| | | | | | CoO + H₂O + SO₂ → CoSO₄ + H₂ | (200° C.) |
| 200 | Fe₃O₄/FeCl₂ | Fe, Cl | 2 | 1500 | Fe₃O₄ + 6HCl → 3FeCl₂ + 3H₂O + 1/2O₂ | (1500° C.) |
| | | | | | 3FeCl₂ + 4H₂O → Fe₃O₄ + 6HCl + H₂ | (700° C.) |
| 14 | FeSO₄ Julich | Fe, S | 3 | 1800 | 3FeO(s) + H₂O → Fe₃O₄(s) + H₂ | (200° C.) |
| | | | | | Fe₃O₄(s) + FeSO₄ → 3Fe₂O₃(s) + 3SO₂(g) + 1/2O₂ | (800° C.) |
| | | | | | 3Fe₂O₃(s) + 3SO₂ → 3FeSO₄ + 3FeO(s) | (1800° C.) |
| 85 | FeSO₄ | Fe, S | 3 | 2300 | 3FeO(s) + H₂O → Fe₃O₄(s) + H₂ | (200° C.) |
| | | | | | Fe₃O₄(s) + 3SO₃(g) → 3FeSO₄ + 1/2O₂ | (300° C.) |
| | | | | | FeSO₄ → FeO + SO₃ | (2300° C.) |
| 109 | C7 IGT | Fe, S | 3 | 1000 | Fe₂O₃(s) + 2SO₂(g) + H₂O → 2FeSO₄(s) + H₂ | (125° C.) |
| | | | | | 2FeSO₄(s) → Fe₂O₃(s) + SO₂(g) + SO₃(g) | (700° C.) |
| | | | | | SO₃(g) → SO₂(g) + 1/2O₂(g) | (1000° C.) |
| 21 | Shell Process | Cu, S | 3 | 1750 | 6Cu(s) + 3H₂O → 3Cu₂O(s) + 3H₂ | (500° C.) |
| | | | | | Cu₂O(s) + 2SO₂ + 3/2O₂ → 2CuSO₄ | (300° C.) |
| | | | | | 2Cu₂O(s) + 2CuSO₄ → 6Cu + 2SO₂ + 3O₂ | (1750° C.) |
| 87 | CuSO₄ | Cu, S | 3 | 1500 | Cu₂O(s) + H₂O(g) → Cu(s) + Cu(OH)₂ | (1500° C.) |
| | | | | | Cu(OH)₂ + SO₂(g) → CuSO₄ + H₂ | (300° C.) |
| | | | | | CuSO₄ + Cu(s) → Cu₂O(s) + SO₂ + 1/2O₂ | (1500° C.) |
| 110 | LASL BaSO₄ | Ba, Mo, S | 3 | 1300 | SO₂ + H₂O + BaMoO₄ → BaSO₃ + MoO₃ + H₂O | (300° C.) |
| | | | | | BaSO₃ + H₂O → BaSO₄ + H₂ | |
| | | | | | BaSO₄(s) + MoO₃(s) → BaMoO₄(s) + SO₂(g) + 1/2O₂ | (1300° C.) |
| 4 | Mark 9 | Fe, Cl | 3 | 900 | 3FeCl₂ + 4H₂O → Fe3O₄ + 6HCl + H₂ | (680° C.) |
| | | | | | Fe₃O₄ + 3/2Cl₂ + 6HCl → 3FeCl₃ + 3H₂O + 1/2O₂ | (900° C.) |
| | | | | | 3FeCl₃ → 3FeCl₂ + 3/2Cl₂ | (420° C.) |
| 16 | Euratom 1972 | Fe, Cl | 3 | 1000 | H₂O + Cl₂ → 2HCl + 1/2O₂ | (1000° C.) |
| | | | | | 2HCl + 2FeCl₂ → 2FeCl₃ + H₂ | (600° C.) |
| | | | | | 2FeCl₃ → 2FeCl₂ + Cl₂ | (350° C.) |
| 20 | Cr, Cl Julich | Cr, Cl | 3 | 1600 | 2CrCl₂(s, T_{f} = 815° C.) + 2HCl → 2CrCl₃(s) + H₂ | (200° C.) |
| | | | | | 2CrCl₃(s, T_{f} = 1150° C.) → 2CrCl₂(s) + Cl₂ | (1600° C.) |
| | | | | | H₂O + Cl₂ → 2HCl + 1/2O₂ | (1000° C.) |
| 27 | Mark 8 | Mn, Cl | 3 | 1000 | 6MnCl₂(l) + 8H₂O → 2Mn₃O₄ + 12HCl + 2H₂ | (700° C.) |
| | | | | | 3Mn₃O₄(s) + 12HCl → 6MnCl₂(s) + 3MnO₂(s) + 6H₂O | (100° C.) |
| | | | | | 3MnO₂(s) → Mn₃O₄(s) + O₂ | (1000° C.) |
| 37 | Ta Funk | Ta, Cl | 3 | 2200 | H₂O + Cl₂ → 2HCl + 1/2O₂ | (1000° C.) |
| | | | | | 2TaCl₂ + 2HCl → 2TaCl₃ + H₂ | (100° C.) |
| | | | | | 2TaCl₃ → 2TaCl₂ + Cl₂ | (2200° C.) |
| 78 | Mark 3 | V, Cl | 3 | 1000 | Cl₂(g) + H₂O(g) → 2HCl(g) + 1/2O₂(g) | (1000° C.) |
| | Euratom JRC | | | | 2VOCl₂(s) + 2HCl(g) → 2VOCl₃(g) + H₂(g) | (170° C.) |
| | Ispra (Italy) | | | | 2VOCl₃(g) → Cl₂(g) + 2VOCl₂(s) | (200° C.) |
| 144 | Bi, Cl | Bi, Cl | 3 | 1700 | H₂O + Cl₂ → 2HCl + 1/2O₂ | (1000° C.) |
| | | | | | 2BiCl₂ + 2HCl → 2BiCl₃ + H₂ | (300° C.) |
| | | | | | 2BiCl₃(T_{f} = 233° C., T_{eb} = 441° C.) → 2BiCl₂ + Cl₂ | (1700° C.) |
| 146 | Fe, Cl Julich | Fe, Cl | 3 | 1800 | 3Fe(s) + 4H₂O → Fe₃O₄(s) + 4H₂ | (700° C.) |
| | | | | | Fe₃O₄ + 6HCl → 3FeCl₂(g) + 3H₂O + 1/2O₂ | (1800° C.) |
| | | | | | 3FeCl₂ + 3H₂ → 3Fe(s) + 6HCl | (1300° C.) |
| 147 | Fe, Cl Cologne | Fe, Cl | 3 | 1800 | 3/2FeO(s) + 3/2Fe(s) + 2.5H₂O → Fe₃O₄(s) + 2.5H₂ | (1000° C.) |
| | | | | | Fe₃O₄ + 6HCl → 3FeCl₂(g) + 3H₂O + 1/2O₂ | (1800° C.) |
| | | | | | 3FeCl₂ + H₂O + 3/2H₂ → _{3/2}FeO(s) + 3/2Fe(s) + 6HCl | (700° C.) |
| 25 | Mark 2 | Mn, Na | 3 | 900 | Mn₂O₃(s) + 4NaOH → 2Na₂O•MnO₂ + H₂O + H₂ | (900° C.) |
| | | | | | 2Na₂O•MnO₂ + 2H₂O → 4NaOH + 2MnO₂(s) | (100° C.) |
| | | | | | 2MnO₂(s) → Mn₂O₃(s) + 1/2O₂ | (600° C.) |
| 28 | Li, Mn LASL | Mn, Li | 3 | 1000 | 6LiOH + 2Mn₃O₄ → 3Li₂O•Mn₂O₃ + 2H₂O + H₂ | (700° C.) |
| | | | | | 3Li₂O•Mn₂O₃ + 3H₂O → 6LiOH + 3Mn₂O₃ | (80° C.) |
| | | | | | 3Mn₂O₃ → 2Mn₃O₄ + 1/2O₂ | (1000° C.) |
| 199 | Mn PSI | Mn, Na | 3 | 1500 | 2MnO + 2NaOH → 2NaMaO₂ + H₂ | (800° C.) |
| | | | | | 2NaMnO₂ + H₂O → Mn₂O₃ + 2NaOH | (100° C.) |
| | | | | | Mn₂O₃(l) → 2MnO(s) + 1/2O₂ | (1500° C.) |
| 178 | Fe, M ORNL | Fe, | 3 | 1300 | 2Fe₃O₄ + 6MOH → 3MFeO₂ + 2H₂O + H₂ | (500° C.) |
| | | (M = Li, | | | 3MFeO₂ + 3H₂O → 6MOH + 3Fe₂O₃ | (100° C.) |
| | | K, Na) | | | 3Fe₂O₃(s) → 2Fe₃O₄(s) + 1/2O₂ | (1300° C.) |
| 33 | Sn Souriau | Sn | 3 | 1700 | Sn(l) + 2H₂O → SnO₂ + 2H₂ | (400° C.) |
| | | | | | 2SnO₂(s) → 2SnO + O₂ | (1700° C.) |
| | | | | | 2SnO(s) → SnO₂ + Sn(l) | (700° C.) |
| 177 | Co ORNL | Co, Ba | 3 | 1000 | CoO(s) + xBa(OH)₂(s) → | |
| | | | | | BaₓCoO_{y}(s) + (y − x − 1)H₂ + (1 + 2x − y) H₂O | (850° C.) |
| | | | | | BaₓCoO_{y}(s) + xH₂O → xBa(OH)₂(s) + CoO(y − x)(s) | (100° C.) |
| | | | | | CoO(y − x)(s) → CoO(s) + (y − x − 1)/2O₂ | (1000° C.) |
| 183 | Ce, Ti ORNL | Ce, Ti, Na | 3 | 1300 | 2CeO₂(s) + 3TiO₂(s) → Ce₂O₃•3TiO₂ + 1/2O₂ | (800-1300° C.) |
| | | | | | Ce₂O₃•3TiO₂ + 6NaOH → 2CeO₂ + 3Na₂TiO₃ + | (800° C.) |
| | | | | | 2H₂O + H₂ | |
| | | | | | CeO₂ + 3NaTiO₃ + 3H₂O → CeO₂(s) + 3TiO₂(s) + | (150° C.) |
| | | | | | 6NaOH | |
| 269 | Ce, Cl GA | Ce, Cl | 3 | 1000 | H₂O + Cl₂→ 2HCl + 1/2O₂ | (1000° C.) |
| | | | | | 2CeO₂ + 8HCl → 2CeCl₃ + 4H₂O + Cl₂ | (250° C.) |
| | | | | | 2CeCl₃ + 4H₂O → 2CeO₂ + 6HCl + H₂ | (800° C.) |

Reactants to form H₂O catalyst may comprise a source of O such as an O species and a source of H. The source of the O species may comprise at least one of O₂, air, and a compound or admixture of compounds comprising O. The compound comprising oxygen may comprise an oxidant. The compound comprising oxygen may comprise at least one of an oxide, oxyhydroxide, hydroxide, peroxide, and a superoxide. Suitable exemplary metal oxides are alkali oxides such as Li₂O, Na₂O, and K₂O, alkaline earth oxides such as MgO, CaO, SrO, and BaO, transition oxides such as NiO, Ni₂O₃, FeO, Fe₂O₃, and CoO, and inner transition and rare earth metals oxides, and those of other metals and metalloids such as those of Al, Ga, In, Si, Ge, Sn, Pb, As, Sb, Bi, Se, and Te, and mixtures of these and other elements comprising oxygen. The oxides may comprise a oxide anion such as those of the present disclosure such as a metal oxide anion and a cation such as an alkali, alkaline earth, transition, inner transition and rare earth metal cation, and those of other metals and metalloids such as those of Al, Ga, In, Si, Ge, Sn, Pb, As, Sb, Bi, Se, and Te such as MM′₂ₓO₃ₓ₊₁ or MM′₂ₓO₄ (M=alkaline earth, M′=transition metal such as Fe or Ni or Mn, x=integer) and M₂M′₂ₓO₃ₓ₊₁ or M₂M′₂ₓO₄ (M=alkali, M′=transition metal such as Fe or Ni or Mn, x=integer). Suitable exemplary metal oxyhydroxides are AlO(OH), ScO(OH), YO(OH), VO(OH), CrO(OH), MnO(OH) (α-MnO(OH) groutite and γ-MnO(OH) manganite), FeO(OH), CoO(OH), NiO(OH), RhO(OH), GaO(OH), InO(OH), Ni_{1/2}Co_{1/2}O(OH), and Ni_{1/3}Co_{1/3}Mn_{1/3}O(OH). Suitable exemplary hydroxides are those of metals such as alkali, alkaline earth, transition, inner transition, and rare earth metals and those of other metals and metalloids such as such as Al, Ga, In, Si, Ge, Sn, Pb, As, Sb, Bi, Se, and Te, and mixtures. Suitable complex ion hydroxides are Li₂Zn(OH)₄, Na₂Zn(OH)₄, Li₂Sn(OH)₄, Na₂Sn(OH)₄, Li₂Pb(OH)₄, Na₂Pb(OH)₄, LiSb(OH)₄, NaSb(OH)₄, LiAl(OH)₄, NaAl(OH)₄, LiCr(OH)₄, NaCr(OH)₄, Li₂Sn(OH)₆, and Na₂Sn(OH)₆. Additional exemplary suitable hydroxides are at least one from Co(OH)₂, Zn(OH)₂, Ni(OH)₂, other transition metal hydroxides, Cd(OH)₂, Sn(OH)₂, and Pb(OH). Suitable exemplary peroxides are H₂O₂, those of organic compounds, and those of metals such as M₂O₂ where M is an alkali metal such as Li₂O₂, Na₂O₂, K₂O₂, other ionic peroxides such as those of alkaline earth peroxides such as Ca, Sr, or Ba peroxides, those of other electropositive metals such as those of lanthanides, and covalent metal peroxides such as those of Zn, Cd, and Hg. Suitable exemplary superoxides are those of metals MO₂ where M is an alkali metal such as NaO₂, KO₂, RbO₂, and CsO₂, and alkaline earth metal superoxides. In an embodiment, the solid fuel comprises an alkali peroxide and hydrogen source such as a hydride, hydrocarbon, or hydrogen storage material such as BH₃NH₃. The reaction mixture may comprise a hydroxide such as those of alkaline, alkaline earth, transition, inner transition, and rare earth metals, and Al, Ga, In, Sn, Pb, and other elements that form hydroxides and a source of oxygen such as a compound comprising at least one an oxyanion such as a carbonate such as one comprising alkaline, alkaline earth, transition, inner transition, and rare earth metals, and Al, Ga, In, Sn, Pb, and others of the present disclosure. Other suitable compounds comprising oxygen are at least one of oxyanion compound of the group of aluminate, tungstate, zirconate, titanate, sulfate, phosphate, carbonate, nitrate, chromate, dichromate, and manganate, oxide, oxyhydroxide, peroxide, superoxide, silicate, titanate, tungstate, and others of the present disclosure. An exemplary reaction of a hydroxide and a carbonate is given by

Ca(OH)₂+Li₂CO₃ to CaO+H₂O+Li₂O+CO₂ (60)

In other embodiments, the oxygen source is gaseous or readily forms a gas such as NO₂, NO, N₂O, CO₂, P₂O₃, P₂O₅, and SO₂. The reduced oxide product from the formation of H₂O catalyst such as C, N, NH₃, P, or S may be converted back to the oxide again by combustion with oxygen or a source thereof as given in Mills Prior Applications. The cell may produce excess heat that may be used for heating applications, or the heat may be converted to electricity by means such as a Rankine or Brayton system. Alternatively, the cell may be used to synthesize lower-energy hydrogen species such as molecular hydrino and hydrino hydride ions and corresponding compounds.

In an embodiment, the reaction mixture to form hydrinos for at least one of production of lower-energy hydrogen species and compounds and production of energy comprises a source of atomic hydrogen and a source of catalyst comprising at least one of H and O such those of the present disclosure such as H₂O catalyst. The reaction mixture may further comprise an acid such as H₂SO₃, H₂SO₄, H₂CO₃, HNO₂, HNO₃, HClO₄, H₃PO₃, and H₃PO₄ or a source of an acid such as an acid anhydride or anhydrous acid. The latter may comprise at least one of the group of SO₂, SO₃, CO₂, NO₂, N₂O₃, N₂O₅, Cl₂O₇, PO₂, P₂O₃, and P₂O₅. The reaction mixture may comprise at least one of a base and a basic anhydride such as M₂O (M=alkali), M′O (M′=alkaline earth), ZnO or other transition metal oxide, CdO, CoO, SnO, AgO, HgO, or Al₂O₃. Further exemplary anhydrides comprise metals that are stable to H₂O such as Cu, Ni, Pb, Sb, Bi, Co, Cd, Ge, Au, Ir, Fe, Hg, Mo, Os, Pd, Re, Rh, Ru, Se, Ag, Tc, Te, Tl, Sn, W, Al, V, Zr, Ti, Mn, Zn, Cr, and In. The anhydride may be an alkali metal or alkaline earth metal oxide, and the hydrated compound may comprise a hydroxide. The reaction mixture may comprise an oxyhydroxide such as FeOOH, NiOOH, or CoOOH. The reaction mixture may comprise at least one of a source of H₂O and H₂O. The H₂O may be formed reversibly by hydration and dehydration reactions in the presence of atomic hydrogen. Exemplary reactions to form H₂O catalyst are

Mg(OH)₂ to MgO+H₂O (61)

2LiOH to Li₂O+H₂O (62)

H₂CO₃ to CO₂+H₂O (63)

2FeOOH to Fe₂O₃+H₂O (64)

In an embodiment, H₂O catalyst is formed by dehydration of at least one compound comprising phosphate such as salts of phosphate, hydrogen phosphate, and dihydrogen phosphate such as those of cations such as cations comprising metals such as alkali, alkaline earth, transition, inner transition, and rare earth metals, and those of other metals and metalloids such as those of Al, Ga, In, Si, Ge, Sn, Pb, As, Sb, Bi, Se, and Te, and mixtures to form a condensed phosphate such as at least one of polyphosphates such as [PₙO₃ₙ₊₁]⁽ⁿ⁺²⁾⁻, long chain metaphosphates such as [(PO₃)ₙ]ⁿ⁻, cyclic metaphosphates such as [(PO₃)ₙ]ⁿ⁻ with n≥3, and ultraphosphates such as P₄O₁₀. Exemplary reactions are

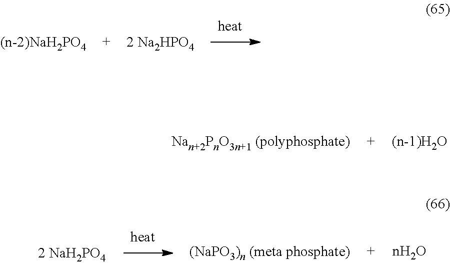

The reactants of the dehydration reaction may comprise R—Ni that may comprise at least one of Al(OH)₃, and Al₂O₃. The reactants may further comprise a metal M such as those of the present disclosure such as an alkali metal, a metal hydride MH, a metal hydroxide such as those of the present disclosure such as an alkali hydroxide and a source of hydrogen such as H₂ as well as intrinsic hydrogen. Exemplary reactions are

2Al(OH)₃+ to Al₂O₃+3H₂O (67)

Al₂O₃+2NaOH to 2NaAlO₂+H₂O (68)

3MH+Al(OH)₃+ to M₃Al+3H₂O (69)

MoCu+2MOH+4O₂ to M₂MoO₄+CuO+H₂O(M=Li,Na,K,Rb,Cs) (70)

The reaction product may comprise an alloy. The R—Ni may be regenerated by rehydration. The reaction mixture and dehydration reaction to form H₂O catalyst may comprise and involve an oxyhydroxide such as those of the present disclosure as given in the exemplary reaction:

3Co(OH)₂ to 2CoOOH+Co+2H₂O (71)

The atomic hydrogen may be formed from H₂ gas by dissociation. The hydrogen dissociator may be one of those of the present disclosure such as R—Ni or a noble metal or transition metal on a support such as Ni or Pt or Pd on carbon or Al₂O₃. Alternatively, the atomic H may be from H permeation through a membrane such as those of the present disclosure. In an embodiment, the cell comprises a membrane such as a ceramic membrane to allow H₂ to diffuse through selectively while preventing H₂O diffusion. In an embodiment, at least one of H₂ and atomic H are supplied to the cell by electrolysis of an electrolyte comprising a source of hydrogen such as an aqueous or molten electrolyte comprising H₂O. In an embodiment, H₂O catalyst is formed reversibly by dehydration of an acid or base to the anhydride form. In an embodiment, the reaction to form the catalyst H₂O and hydrinos is propagated by changing at least one of the cell pH or activity, temperature, and pressure wherein the pressure may be changed by changing the temperature. The activity of a species such as the acid, base, or anhydride may be changed by adding a salt as known by those skilled in the art. In an embodiment, the reaction mixture may comprise a material such as carbon that may absorb or be a source of a gas such as H₂ or acid anhydride gas to the reaction to form hydrinos. The reactants may be in any desired concentrations and ratios. The reaction mixture may be molten or comprise an aqueous slurry.

In another embodiment, the source of the H₂O catalyst is the reaction between an acid and a base such as the reaction between at least one of a hydrohalic acid, sulfuric, nitric, and nitrous, and a base. Other suitable acid reactants are aqueous solutions of H₂SO₄, HCl, HX (X-halide), H₃PO₄, HClO₄, HNO₃, HNO, HNO₂, H₂S, H₂CO₃, H₂MoO₄, HNbO₃, H₂B₄O₇ (M tetraborate), HBO₂, H₂WO₄, H₂CrO₄, H₂Cr₂O₇, H₂TiO₃, HZrO₃, MAlO₂, HMn₂O₄, HIO₃, HIO₄, HClO₄, or an organic acidic such as formic or acetic acid. Suitable exemplary bases are a hydroxide, oxyhydroxide, or oxide comprising an alkali, alkaline earth, transition, inner transition, or rare earth metal, or Al, Ga, In, Sn, or Pb.

In an embodiment, the reactants may comprise an acid or base that reacts with base or acid anhydride, respectively, to form H₂O catalyst and the compound of the cation of the base and the anion of the acid anhydride or the cation of the basic anhydride and the anion of the acid, respectively. The exemplary reaction of the acidic anhydride SiO₂ with the base NaOH is

4NaOH+SiO₂ to Na₄SiO₄+2H₂O (72)

wherein the dehydration reaction of the corresponding acid is

H₄SiO₄ to 2H₂O+SiO₂ (73)

Other suitable exemplary anhydrides may comprise an element, metal, alloy, or mixture such as one from the group of Mo, Ti, Zr, Si, Al, Ni, Fe, Ta, V, B, Nb, Se, Te, W, Cr, Mn, Hf, Co, and Mg. The corresponding oxide may comprise at least one of MoO₂, TiO₂, ZrO₂, SiO₂, Al₂O₃, NiO, Ni₂O₃, FeO, Fe₂O₃, TaO₂, Ta₂O₅, VO, VO₂, V₂O₃, V₂O₅, B₂O₃, NbO, NbO₂, Nb₂O₅, SeO₂, SeO₃, TeO₂, TeO₃, WO₂, WO₃, Cr₃O₄, Cr₂O₃, CrO₂, CrO₃, MnO, Mn₃O₄, Mn₂O₃, MnO₂, Mn₂O₇, HfO₂, Co₂O₃, CoO, Co₃O₄, Co₂O₃, and MgO. In an exemplary embodiment, the base comprises a hydroxide such as an alkali hydroxide such as MOH (M=alkali) such as LiOH that may form the corresponding basic oxide such as M₂O such as Li₂O, and H2O. The basic oxide may react with the anhydride oxide to form a product oxide. In an exemplary reaction of LiOH with the anhydride oxide with the release of H₂O, the product oxide compound may comprise Li₂MoO₃ or Li₂MoO₄, Li₂TiO₃, Li₂ZrO₃, Li₂SiO₃, LiAlO₂, LiNiO₂, LiFeO₂, LiTaO₃, LiVO₃, Li₂B₄O₇, Li₂NbO₃, Li₂SeO₃, Li₃PO₄, Li₂SeO₄, Li₂TeO₃, Li₂TeO₄, Li₂WO₄, Li₂CrO₄, Li₂Cr₂O₇, Li₂MnO₄, Li₂HfO₃, LiCoO₂, and MgO. Other suitable exemplary oxides are at least one of the group of As₂O₃, As₂O₅, Sb₂O₃, Sb₂O₄, Sb₂O₅, Bi₂O₃, SO₂, SO₃, CO₂, NO₂, N₂O₃, N₂O₅, Cl₂O₇, PO₂, P₂O₃, and P₂O₅, and other similar oxides known to those skilled in the art. Another example is given by Eq. (91). Suitable reactions of metal oxides are

2LiOH+NiO to Li₂NiO₂+H₂O (74)

3LiOH+NiO to LiNiO₂+H₂O+Li₂O+½H₂ (75)

4LiOH+Ni₂O₃ to 2Li₂NiO₂+2H₂O+½O₂ (76)

2LiOH+Ni₂O₃ to 2LiNiO₂+H₂O (77)

Other transition metals such as Fe, Cr, and Ti, inner transition, and rare earth metals and other metals or metalloids such as Al, Ga, In, Si, Ge, Sn, Pb, As, Sb, Bi, Se, and Te may substitute for Ni, and other alkali metal such as Li, Na, Rb, and Cs may substitute for K. In an embodiment, the oxide may comprise Mo wherein during the reaction to form H₂O, nascent H₂O catalyst and H may form that further react to form hydrinos. Exemplary solid fuel reactions and possible oxidation reduction pathways are

3MoO₂+4LiOH→2Li₂MoO₄+Mo+2H₂O (78)

2MoO₂+4LiOH→2Li₂MoO₄+2H₂ (79)

O²⁻→½O₂+2e⁻ (80)

2H₂O+2e⁻→2OH⁻+H₂ (81)

2H₂O+2e⁻→2OH⁻+H+H(1/4) (82)

Mo⁴⁺+4e⁻→Mo (83)

The reaction may further comprise a source of hydrogen such as hydrogen gas and a dissociator such as Pd/Al₂O₃. The hydrogen may be any of proteium, deuterium, or tritium or combinations thereof. The reaction to form H₂O catalyst may comprise the reaction of two hydroxides to form water. The cations of the hydroxides may have different oxidation states such as those of the reaction of an alkali metal hydroxide with a transition metal or alkaline earth hydroxide. The reaction mixture and reaction may further comprise and involve H₂ from a source as given in the exemplary reaction:

LiOH+2Co(OH)₂+½H₂ to LiCoO₂+3H₂O+Co (84)

The reaction mixture and reaction may further comprise and involve a metal M such as an alkali or an alkaline earth metal as given in the exemplary reaction:

M+LiOH+Co(OH)₂ to LiCoO₂+H₂O+MH (85)

In an embodiment, the reaction mixture comprises a metal oxide and a hydroxide that may serve as a source of H and optionally another source of H wherein the metal such as Fe of the metal oxide can have multiple oxidation states such that it undergoes an oxidation-reduction reaction during the reaction to form H₂O to serve as the catalyst to react with H to form hydrinos. An example is FeO wherein Fe²⁺ can undergo oxidation to Fe³⁺ during the reaction to form the catalyst. An exemplary reaction is

FeO+3LiOH to H₂O+LiFeO₂+H(1/p)+Li₂O (86)

In an embodiment, at least one reactant such as a metal oxide, hydroxide, or oxyhydroxide serves as an oxidant wherein the metal atom such as Fe, Ni, Mo, or Mn may be in an oxidation state that is higher than another possible oxidation state. The reaction to form the catalyst and hydrinos may cause the atom to undergo a reduction to at least one lower oxidation state. Exemplary reactions of metal oxides, hydroxides, and oxyhydroxides to form H₂O catalyst are

2KOH+NiO to K₂NiO₂+H₂O (87)

3KOH+NiO to KNiO₂+H₂O+K₂O+½H₂ (88)

2KOH+Ni₂O₃ to 2KNiO₂+H₂O (89)

4KOH+Ni₂O₃ to 2K₂NiO₂+2H₂O+½O₂ (90)

2KOH+Ni(OH)₂ to K₂NiO₂+2H₂O (91)

2LiOH+MoO₃ to Li₂MoO₄+H₂O (92)

3KOH+Ni(OH)₂ to KNiO₂+2H₂O+K₂O+½H₂ (93)

2KOH+2NiOOH to K₂NiO₂+2H₂O+NiO+½O₂ (94)

KOH+NiOOH to KNiO₂+H₂O (95)

2NaOH+Fe₂O₃ to 2NaFeO₂+H₂O (96)

Other transition metals such as Ni, Fe, Cr, and Ti, inner transition, and rare earth metals and other metals or metalloids such as Al, Ga, In, Si, Ge, Sn, Pb, As, Sb, Bi, Se, and Te may substitute for Ni or Fe, and other alkali metals such as Li, Na, K, Rb, and Cs may substitute for K or Na. In an embodiment, the reaction mixture comprises at least one of an oxide and a hydroxide of metals that are stable to H₂O such as Cu, Ni, Pb, Sb, Bi, Co, Cd, Ge, Au, Ir, Fe, Hg, Mo, Os, Pd, Re, Rh, Ru, Se, Ag, Tc, Te, Tl, Sn, W, Al, V, Zr, Ti, Mn, Zn, Cr, and In. Additionally, the reaction mixture comprises a source of hydrogen such as H₂ gas and optionally a dissociator such as a noble metal on a support. In an embodiment, the solid fuel or energetic material comprises mixture of at least one of a metal halide such as at least one of a transition metal halide such as a bromide such as FeBr₂ and a metal that forms a oxyhydroxide, hydroxide, or oxide and H₂O. In an embodiment, the solid fuel or energetic material comprises a mixture of at least one of a metal oxide, hydroxide, and an oxyhydroxide such as at least one of a transition metal oxide such as Ni₂O₃ and H₂O.

The exemplary reaction of the basic anhydride NiO with acid HCl is

2HCl+NiO to H₂O+NiCl₂ (97)

wherein the dehydration reaction of the corresponding base is

Ni(OH)₂ to H₂O+NiO (98)

The reactants may comprise at least one of a Lewis acid or base and a Bronsted-Lowry acid or base. The reaction mixture and reaction may further comprise and involve a compound comprising oxygen wherein the acid reacts with the compound comprising oxygen to form water as given in the exemplary reaction:

2HX+POX₃ to H₂O+PX₅ (99)

(X=halide). Similar compounds as POX₃ are suitable such as those with P replaced by S. Other suitable exemplary anhydrides may comprise an oxide of an element, metal, alloy, or mixture that is soluble in acid such as an hydroxide, oxyhydroxide, or oxide comprising an alkali, alkaline earth, transition, inner transition, or rare earth metal, or Al, Ga, In, Sn, or Pb such as one from the group of Mo, Ti, Zr, Si, Al, Ni, Fe, Ta, V, B, Nb, Se, Te, W, Cr, Mn, Hf, Co, and Mg. The corresponding oxide may comprise MoO₂, TiO₂, ZrO₂, SiO₂, Al₂O₃, NiO, FeO or Fe₂O₃, TaO₂, Ta₂O₅, VO, VO₂, V₂O₃, V₂O₅, B₂O₃, NbO, NbO₂, Nb₂O₅, SeO₂, SeO₃, TeO₂, TeO₃, WO₂, WO₃, Cr₃O₄, Cr₂O₃, CrO₂, CrO₃, MnO, Mn₃O₄, Mn₂O₃, MnO₂, Mn₂O₇, HfO₂, Co₂O₃, CoO, Co₃O₄, Co₂O₃, and MgO. Other suitable exemplary oxides are of those of the group of Cu, Ni, Pb, Sb, Bi, Co, Cd, Ge, Au, Ir, Fe, Hg, Mo, Os, Pd, Re, Rh, Ru, Se, Ag, Tc, Te, Tl, Sn, W, Al, V, Zr, Ti, Mn, Zn, Cr, and In. In an exemplary embodiment, the acid comprises a hydrohalic acid and the product is H₂O and the metal halide of the oxide. The reaction mixture further comprises a source of hydrogen such as H₂ gas and a dissociator such as Pt/C wherein the H and H₂O catalyst react to form hydrinos.

In an embodiment, the solid fuel comprises a H₂ source such as a permeation membrane or H₂ gas and a dissociator such as Pt/C and a source of H₂O catalyst comprising an oxide or hydroxide that is reduced to H₂O. The metal of the oxide or hydroxide may form metal hydride that serves as a source of H. Exemplary reactions of an alkali hydroxide and oxide such as LiOH and Li₂O are

LiOH+H₂ to H₂O LiH (100)

Li₂O+H₂ to LiOH+LiH (101)

The reaction mixture may comprise oxides or hydroxides of metals that undergo hydrogen reduction to H₂O such as those of Cu, Ni, Pb, Sb, Bi, Co, Cd, Ge, Au, Ir, Fe, Hg, Mo, Os, Pd, Re, Rh, Ru, Se, Ag, Tc, Te, Tl, Sn, W, Al, V, Zr, Ti, Mn, Zn, Cr, and In and a source of hydrogen such as H₂ gas and a dissociator such as Pt/C.

In another embodiment, the reaction mixture comprises a H₂ source such as H₂ gas and a dissociator such as Pt/C and a peroxide compound such as H₂O₂ that decomposes to H₂O catalyst and other products comprising oxygen such as O₂. Some of the H₂ and decomposition product such as O₂ may react to also form H₂O catalyst.

In an embodiment, the reaction to form H₂O as the catalyst comprises an organic dehydration reaction such as that of an alcohol such as a polyalcohol such as a sugar to an aldehyde and H₂O. In an embodiment, the dehydration reaction involves the release of H₂O from a terminal alcohol to form an aldehyde. The terminal alcohol may comprise a sugar or a derivative thereof that releases H₂O that may serve as a catalyst. Suitable exemplary alcohols are meso-erythritol, galactitol or dulcitol, and polyvinyl alcohol (PVA). An exemplary reaction mixture comprises a sugar+hydrogen dissociator such as Pd/Al₂O₃+H₂. Alternatively, the reaction comprises a dehydration of a metal salt such as one having at least one water of hydration. In an embodiment, the dehydration comprises the loss of H₂O to serve as the catalyst from hydrates such as aqua ions and salt hydrates such as BaI₂ 2H₂O and EuBr₂ nH₂O.

In an embodiment, the reaction to form H₂O catalyst comprises the hydrogen reduction of a compound comprising oxygen such as CO, an oxyanion such as MNO₃ (M=alkali), a metal oxide such as NiO, Ni₂O₃, Fe₂O₃, or SnO, a hydroxide such as Co(OH)₂, oxyhydroxides such as FeOOH, CoOOH, and NiOOH, and compounds, oxyanions, oxides, hydroxides, oxyhydroxides, peroxides, superoxides, and other compositions of matter comprising oxygen such as those of the present disclosure that are hydrogen reducible to H₂O. Exemplary compounds comprising oxygen or an oxyanion are SOCl₂, Na₂S₂O₃, NaMnO₄, POBr₃, K₂S₂O₈, CO, CO₂, NO, NO₂, P₂O₅, N₂O₅, N₂O, SO₂, I₂O₅, NaClO₂, NaClO, K₂SO₄, and KHSO₄. The source of hydrogen for hydrogen reduction may be at least one of H₂ gas and a hydride such as a metal hydride such as those of the present disclosure. The reaction mixture may further comprise a reductant that may form a compound or ion comprising oxygen. The cation of the oxyanion may form a product compound comprising another anion such as a halide, other chalcogenide, phosphide, other oxyanion, nitride, silicide, arsenide, or other anion of the present disclosure. Exemplary reactions are

4NaNO₃(c)+5MgH₂(c) to 5MgO(c)+4NaOH(c)+3H₂O(l)+2N₂(g) (102)

P₂O₅(c)+6NaH(c) to 2Na₃PO₄(c)+3H₂O(g) (103)

NaClO₄(c)+2MgH₂(c) to 2MgO(c)+NaCl(c)+2H₂O(l) (104)

KHSO₄+4H₂ to KHS+4H₂O (105)

K₂SO₄+4H₂ to 2KOH+2H₂O+H₂S (106)

LiNO₃+4H₂ to LiNH₂+3H₂O (107)

GeO₂+2H₂ to Ge+2H₂O (108)

CO₂+H₂ to C+2H₂O (109)

PbO₂+2H₂ to 2H₂O+Pb (110)

V₂O₅+5H₂ to 2V+5H₂O (111)

Co(OH)₂+H₂ to CO+2H₂ (112)

Fe₂O₃+3H₂ to 2Fe+3H₂O (113)

3Fe₂O₃+H₂ to 2Fe₃O₄+H₂O (114)

Fe₂O₃+H₂ to 2FeO+H₂O (115)

Ni₂O₃+3H₂ to 2Ni+3H₂O (116)

3Ni₂O₃+H₂ to 2Ni₃O₄+H₂O (117)

Ni₂O₃+H₂ to 2NiO+H₂O (118)

3FeOOH+½H₂ to Fe₃O₄+2H₂O (119)

3NiOOH+½H₂ to Ni₃O₄+2H₂O (120)

3CoOOH+½H₂ to Co₃O₄+2H₂O (121)

FeOOH+½H₂ to FeO+H₂O (122)

NiOOH+½H₂ to NiO+H₂O (123)

CoOOH+½H₂ to CoO+H₂O (124)

SnO+H₂ to Sn+H₂O (125)

The reaction mixture may comprise a source of an anion or an anion and a source of oxygen or oxygen such as a compound comprising oxygen wherein the reaction to form H₂O catalyst comprises an anion-oxygen exchange reaction with optionally H₂ from a source reacting with the oxygen to form H₂O. Exemplary reactions are

2NaOH+H₂+S to Na₂S+2H₂O (126)

2NaOH+H₂+Te to Na₂Te+2H₂O (127)

2NaOH+H₂+Se to Na₂Se+2H₂O (128)

LiOH+NH₃ to LiNH₂+H₂O (129)

In another embodiment, the reaction mixture comprises an exchange reaction between chalcogenides such as one between reactants comprising O and S. An exemplary chalcogenide reactant such as tetrahedral ammonium tetrathiomolybdate contains the ([MoS₄]²⁻) anion. An exemplary reaction to form nascent H₂O catalyst and optionally nascent H comprises the reaction of molybdate [MoO₄]²⁻ with hydrogen sulfide in the presence of ammonia:

[NH₄]₂[MoO₄]+4H₂S to [NH₄]₂[MoS₄]+4H₂O (130)

In an embodiment, the reaction mixture comprises a source of hydrogen, a compound comprising oxygen, and at least one element capable of forming an alloy with at least one other element of the reaction mixture. The reaction to form H₂O catalyst may comprise an exchange reaction of oxygen of the compound comprising oxygen and an element capable of forming an alloy with the cation of the oxygen compound wherein the oxygen reacts with hydrogen from the source to form H₂O. Exemplary reactions are

NaOH+½H₂+Pd to NaPb+H₂O (131)

NaOH+½H₂+Bi to NaBi+H₂O (132)

NaOH+½H₂+2Cd to Cd₂Na+H₂O (133)

NaOH+½H₂+4Ga to Ga₄Na+H₂O (134)

NaOH+½H₂+Sn to NaSn+H₂O (135)

NaAlH₄+Al(OH)₃+5Ni to NaAlO₂+Ni₅Al+H₂O+5/2H₂ (136)

In an embodiment, the reaction mixture comprises a compound comprising oxygen such as an oxyhydroxide and a reductant such as a metal that forms an oxide. The reaction to form H₂O catalyst may comprise the reaction of an oxyhydroxide with a metal to from a metal oxide and H₂O. Exemplary reactions are

2MnOOH+Sn to 2MnO+SnO+H₂O (137)

4MnOOH+Sn to 4MnO+SnO₂+2H₂O (138)

2MnOOH+Zn to 2MnO+ZnO+H₂O (139)

In an embodiment, the reaction mixture comprises a compound comprising oxygen such as a hydroxide, a source of hydrogen, and at least one other compound comprising a different anion such as halide or another element. The reaction to form H₂O catalyst may comprise the reaction of the hydroxide with the other compound or element wherein the anion or element is exchanged with hydroxide to from another compound of the anion or element, and H₂O is formed with the reaction of hydroxide with H₂. The anion may comprise halide. Exemplary reactions are

2NaOH+NiCl₂+H₂ to 2NaCl+2H₂O+Ni (140)

2NaOH+I₂+H₂ to 2NaI+2H₂O (141)

2NaOH+XeF₂+H₂ to 2NaF+2H₂O+Xe (142)

BiX₃(X=halide)+4Bi(OH)₃ to 3BiOX+Bi₂O₃+6H₂O (143)

The hydroxide and halide compounds may be selected such that the reaction to form H₂O and another halide is thermally reversible. In an embodiment, the general exchange reaction is

NaOH+½H₂+1/yMₓCl_{y}=NaCl+6H₂O+x/yM (171)

wherein exemplary compounds MₓCl_{y} are AlCl₃, BeCl₂, HfCl₄, KAgCl₂, MnCl₂, NaAlCl₄, ScCl₃, TiCl₂, TiCl₃, UCl₃, UCl₄, ZrCl₄, EuCl₃, GdCl₃, MgCl₂, NdCl₃, and YCl₃. At an elevated temperature the reaction of Eq. (171) such as in the range of about 100° C. to 2000° C. has at least one of an enthalpy and free energy of about 0 kJ and is reversible. The reversible temperature is calculated from the corresponding thermodynamic parameters of each reaction. Representative are temperature ranges are NaCl—ScCl₃ at about 800K-900K, NaCl—TiCl₂ at about 300K-400K, NaCl—UCl₃ at about 600K-800K, NaCl—UCl₄ at about 250K-300K, NaCl—ZrCl₄ at about 250K-300K, NaCl—MgCl₂ at about 900K-1300K, NaCl—EuCl₃ at about 900K-1000K, NaCl—NdCl₃ at about >1000K, and NaCl—YCl₃ at about >1000K.

In an embodiment, the reaction mixture comprises an oxide such as a metal oxide such a alkali, alkaline earth, transition, inner transition, and rare earth metal oxides and those of other metals and metalloids such as those of Al, Ga, In, Si, Ge, Sn, Pb, As, Sb, Bi, Se, and Te, a peroxide such as M₂O₂ where M is an alkali metal such as Li₂O₂, Na₂O₂, and K₂O₂, and a superoxide such as MO₂ where M is an alkali metal such as NaO₂, KO₂, RbO₂, and CsO₂, and alkaline earth metal superoxides, and a source of hydrogen. The ionic peroxides may further comprise those of Ca, Sr, or Ba. The reaction to form H₂O catalyst may comprise the hydrogen reduction of the oxide, peroxide, or superoxide to form H₂O. Exemplary reactions are

Na₂O+2H₂ to 2NaH+H₂O (144)

Li₂O₂+H₂ to Li₂O+H₂O (145)

KO₂+3/2H₂ to KOH+H₂O (146)

In an embodiment, the reaction mixture comprises a source of hydrogen such as at least one of H₂, a hydride such as at least one of an alkali, alkaline earth, transition, inner transition, and rare earth metal hydride and those of the present disclosure and a source of hydrogen or other compound comprising combustible hydrogen such as a metal amide, and a source of oxygen such as O₂. The reaction to form H₂O catalyst may comprise the oxidation of H₂, a hydride, or hydrogen compound such as metal amide to form H₂O. Exemplary reactions are

2NaH+O₂ to Na₂O+H₂O (147)

H₂+½O₂ to H₂O (148)

LiNH₂+2O₂ to LiNO₃+H₂O (149)

2LiNH₂+3/2O₂ to 2LiOH+H₂O+N₂ (150)

In an embodiment, the reaction mixture comprises a source of hydrogen and a source of oxygen. The reaction to form H₂O catalyst may comprise the decomposition of at least one of source of hydrogen and the source of oxygen to form H₂O. Exemplary reactions are

NH₄NO₃ to N₂O+2H₂O (151)

NH₄NO₃ to N₂+½O₂+2H₂O (152)

H₂O₂ to ½O₂+H₂O (153)

H₂O₂+H₂ to 2H₂O (154)

The reaction mixtures disclosed herein further comprise a source of hydrogen to form hydrinos. The source may be a source of atomic hydrogen such as a hydrogen dissociator and H₂ gas or a metal hydride such as the dissociators and metal hydrides of the present disclosure. The source of hydrogen to provide atomic hydrogen may be a compound comprising hydrogen such as a hydroxide or oxyhydroxide. The H that reacts to form hydrinos may be nascent H formed by reaction of one or more reactants wherein at least one comprises a source of hydrogen such as the reaction of a hydroxide and an oxide. The reaction may also form H₂O catalyst. The oxide and hydroxide may comprise the same compound. For example, an oxyhydroxide such as FeOOH could dehydrate to provide H₂O catalyst and also provide nascent H for a hydrino reaction during dehydration:

4FeOOH to H₂O+Fe₂O₃+2FeO+O₂+2H(1/4) (155)

wherein nascent H formed during the reaction reacts to hydrino. Other exemplary reactions are those of a hydroxide and an oxyhydroxide or an oxide such as NaOH+FeOOH or Fe₂O₃ to form an alkali metal oxide such as NaFeO₂+H₂O wherein nascent H formed during the reaction may form hydrino wherein H₂O serves as the catalyst. The oxide and hydroxide may comprise the same compound. For example, an oxyhydroxide such as FeOOH could dehydrate to provide H₂O catalyst and also provide nascent H for a hydrino reaction during dehydration:

4FeOOH to H₂O+Fe₂O₃+2FeO+O₂+2H(1/4) (156)

wherein nascent H formed during the reaction reacts to hydrino. Other exemplary reactions are those of a hydroxide and an oxyhydroxide or an oxide such as NaOH+FeOOH or Fe₂O₃ to form an alkali metal oxide such as NaFeO₂+H₂O wherein nascent H formed during the reaction may form hydrino wherein H₂O serves as the catalyst. Hydroxide ion is both reduced and oxidized in forming H₂O and oxide ion. Oxide ion may react with H₂O to form OH⁻. The same pathway may be obtained with a hydroxide-halide exchange reaction such as the following

2M(OH)₂+2M′X₂→H₂O+2MX₂+2M′O+½O₂+2H(1/4) (157)

wherein exemplary M and M′ metals are alkaline earth and transition metals, respectively, such as Cu(OH)₂+FeBr₂, Cu(OH)₂+CuBr₂, or Co(OH)₂+CuBr₂. In an embodiment, the solid fuel may comprise a metal hydroxide and a metal halide wherein at least one metal is Fe. At least one of H₂O and H₂ may be added to regenerate the reactants. In an embodiment, M and M′ may be selected from the group of alkali, alkaline earth, transition, inner transition, and rare earth metals, Al, Ga, In, Si, Ge, Sn, Pb, Group 13, 14, 15, and 16 elements, and other cations of hydroxides or halides such as those of the present disclosure. An exemplary reaction to form at least one of HOH catalyst, nascent H, and hydrino is

4MOH+4M′X→H₂O+2M′₂O+M₂O+2MX+X₂+2H(1/4) (158)

In an embodiment, the reaction mixture comprises at least one of a hydroxide and a halide compound such as those of the present disclosure. In an embodiment, the halide may serve to facilitate at least one of the formation and maintenance of at least one of nascent HOH catalyst and H. In an embodiment, the mixture may serve to lower the melting point of the reaction mixture.

An acid-base reaction is another approach to H₂O catalyst. Exemplary halides and hydroxides mixtures are those of Bi, Cd, Cu, Co, Mo, and Cd and mixtures of hydroxides and halides of metals having low water reactivity of the group of Cu, Ni, Pb, Sb, Bi, Co, Cd, Ge, Au, Ir, Fe, Hg, Mo, Os, Pd, Re, Rh, Ru, Se, Ag, Tc, Te, Tl, Sn, W, and Zn. In an embodiment, the reaction mixture further comprises H₂O that may serves as a source of at least one of H and catalyst such as nascent H₂O. The water may be in the form of a hydrate that decomposes or otherwise reacts during the reaction.

In an embodiment, the solid fuel comprises a reaction mixture of H₂O and an inorganic compound that forms nascent H and nascent H₂O. The inorganic compound may comprise a halide such as a metal halide that reacts with the H₂O. The reaction product may be at least one of a hydroxide, oxyhydroxide, oxide, oxyhalide, hydroxyhalide, and hydrate. Other products may comprise anions comprising oxygen and halogen such as XO⁻, XO₂⁻, XO₃⁻, and XO₄⁻ (X=halogen). The product may also be at least one of a reduced cation and a halogen gas. The halide may be a metal halide such as one of an alkaline, alkaline earth, transition, inner transition, and rare earth metal, and Al, Ga, In, Sn, Pb, S, Te, Se, N, P, As, Sb, Bi, C, Si, Ge, and B, and other elements that form halides. The metal or element may additionally be one that forms at least one of a hydroxide, oxyhydroxide, oxide, oxyhalide, hydroxyhalide, hydrate, and one that forms a compound having an anion comprising oxygen and halogen such as XO⁻, XO₂⁻, XO₃⁻, and XO₄⁻ (X=halogen). Suitable exemplary metals and elements are at least one of an alkaline, alkaline earth, transition, inner transition, and rare earth metal, and Al, Ga, In, Sn, Pb, S, Te, Se, N, P, As, Sb, Bi, C, Si, Ge, and B. An exemplary reaction is

5MX₂+7H₂O to MXOH+M(OH)₂+MO+M₂O₃+11H(1/4)+9/2X₂ (159)

wherein M is a metal such as a transition metal such as Cu and X is halogen such as Cl.

In an embodiment, the solid fuel or energetic material comprises a source of singlet oxygen. An exemplary reaction to generate singlet oxygen is

NaOCl+H₂O₂ to O₂+NaCl+H₂O (160)

In another embodiment, the solid fuel or energetic material comprises a source of or reagents of the Fenton reaction such as H₂O₂.

The solid fuels and reactions may be at least one of regenerative and reversible by at least one the SunCell® plasma or thermal power and the methods disclosed herein and in Mills Prior Applications such as Hydrogen Catalyst Reactor, PCT/US08/61455, filed PCT Apr. 24, 2008; Heterogeneous Hydrogen Catalyst Reactor, PCT/US09/052072, filed PCT Jul. 29, 2009; Heterogeneous Hydrogen Catalyst Power System, PCT/US10/27828, PCT filed Mar. 18, 2010; Electrochemical Hydrogen Catalyst Power System, PCT/US11/28889, filed PCT Mar. 17, 2011; H₂O-Based Electrochemical Hydrogen-Catalyst Power System, PCT/US12/31369 filed Mar. 30, 2012, and CIHT Power System, PCT/US13/041938 filed May 21, 2013 herein incorporated by reference in their entirety.

In an embodiment, the regeneration reaction of a hydroxide and halide compound mixture such as Cu(OH)₂+CuBr₂ may by addition of at least one H₂ and H₂O. Exemplary, thermally reversible solid fuel cycles are

T1002CuBr₂+Ca(OH)₂→2CuO+2CaBr₂+H₂O (161)

T730CaBr₂+2H₂O→Ca(OH)₂+2HBr (162)

T100CuO+2HBr→CuBr₂+H₂O (163)

T1002CuBr₂+Cu(OH)₂→2CuO+2CaBr₂+H₂O (164)

T730CuBr₂+2H₂O Cu(OH)₂+2HBr (165)

T100CuO+2HBr→CuBr₂+H₂O (166)

In an embodiment, wherein at least one of an alkali metal M such as K or Li, and nH (n=integer), OH, O, 2O, O₂, and H₂O serve as the catalyst, the source of H is at least one of a metal hydride such as MH and the reaction of at least one of a metal M and a metal hydride MH with a source of H to form H. One product may be an oxidized M such as an oxide or hydroxide. The reaction to create at least one of atomic hydrogen and catalyst may be an electron transfer reaction or an oxidation-reduction reaction. The reaction mixture may further comprise at least one of H₂, a H₂ dissociator such as at least one of the SunCell® and those of the present disclosure such as Ni screen or R—Ni and an electrically conductive support such as these dissociators and others as well as supports of the present disclosure such as carbon, and carbide, a boride, and a carbonitride. An exemplary oxidation reaction of M or MH is

4MH+Fe₂O₃ to +H₂O+H(1/p)+M₂O+MOH+2Fe+M (167)

wherein at least one of H₂O and M may serve as the catalyst to form H(1/p).

In an embodiment, the source of oxygen is a compound that has a heat of formation that is similar to that of water such that the exchange of oxygen between the reduced product of the oxygen source compound and hydrogen occurs with minimum energy release. Suitable exemplary oxygen source compounds are CdO, CuO, ZnO, SO₂, SeO₂, and TeO₂. Others such as metal oxides may also be anhydrides of acids or bases that may undergo dehydration reactions as the source of H₂O catalyst are MnOₓ, AlOₓ, and SiOₓ. In an embodiment, an oxide layer oxygen source may cover a source of hydrogen such as a metal hydride such as palladium hydride. The reaction to form H₂O catalyst and atomic H that further react to form hydrino may be initiated by heating the oxide coated hydrogen source such as metal oxide coated palladium hydride. In an embodiment, the reaction to form the hydrino catalyst and the regeneration reaction comprise an oxygen exchange between the oxygen source compound and hydrogen and between water and the reduced oxygen source compound, respectively. Suitable reduced oxygen sources are Cd, Cu, Zn, S, Se, and Te. In an embodiment, the oxygen exchange reaction may comprise those used to form hydrogen gas thermally. Exemplary thermal methods are the iron oxide cycle, cerium(IV) oxide-cerium(III) oxide cycle, zinc zinc-oxide cycle, sulfur-iodine cycle, copper-chlorine cycle and hybrid sulfur cycle and others known to those skilled in the art. In an embodiment, the reaction to form hydrino catalyst and the regeneration reaction such as an oxygen exchange reaction occurs simultaneously in the same reaction vessel. The conditions such a temperature and pressure may be controlled to achieve the simultaneity of reaction. Alternately, the products may be removed and regenerated in at least one other separate vessel that may occur under conditions different than those of the power forming reaction as given in the present disclosure and Mills Prior Applications.

The solid fuel may comprise different ions such as alkali, alkaline earth, and other cations with anions such as halides and oxyanions. The cation of the solid fuel may comprise at least one of alkali metals, alkaline earth metals, transition metals, inner transition metals, rare earth metals, Li, Na, K, Rb, Cs, Mg, Ca, Sr, Ba, Ga, Al, V, Zr, Ti, Mn, Zn, Li, Na, K, Rb, Cs, Mg, Ca, Sr, Ba, Al, V, Zr, Ti, Mn, Zn, Cr, Sn, In, Cu, Ni, Pb, Sb, Bi, Co, Cd, Ge, Au, Fe, Hg, Mo, Os, Pd, Re, Rh, Ru, Se, Ag, Tc, Te, Tl, W, and other cations known in the art that form ionic compounds. The anion may comprise at least one of a hydroxide, a halide, oxide, chalcogenide, sulfate, phosphate, phosphide, nitrate, nitride, carbonate, chromate, silicide, arsenide, boride, perchlorate, periodate, cobalt magnesium oxide, nickel magnesium oxide, copper magnesium oxide, aluminate, tungstate, zirconate, titanate, manganate, carbide, metal oxide, nonmetal oxide; oxide of alkali, alkaline earth, transition, inner transition, and earth metals, and Al, Ga, In, Sn, Pb, S, Te, Se, N, P, As, Sb, Bi, C, Si, Ge, and B, and other elements that form an oxide or oxyanion; LiAlO₂, MgO, CaO, ZnO, CeO₂, CuO, CrO₄, Li₂TiO₃, or SrTiO₃, an oxide comprising an element, metal, alloy, or mixture of the group of Mo, Ti, Zr, Si, Al, Ni, Fe, Ta, V, B, Nb, Se, Te, W, Cr, Mn, Hf, and Co; MoO₂, TiO₂, ZrO₂, SiO₂, Al₂O₃, NiO, FeO or Fe₂O₃, TaO₂, Ta₂O₅, VO, VO₂, V₂O₃, V₂O₅, B₂O₃, NbO, NbO₂, Nb₂O₅, SeO₂, SeO₃, TeO₂, TeO₃, WO₂, WO₃, Cr₃O₄, Cr₂O₃, CrO₂, CrO₃, MnO, Mn₃O₄, Mn₂O₃, MnO₂, Mn₂O₇, HfO₂, CoO, Co₂O₃, Co₃O₄, Li₂MoO₃ or Li₂MoO₄, Li₂TiO₃, Li₂ZrO₃, Li₂SiO₃, LiAlO₂, LiNiO₂, LiFeO₂, LiTaO₃, LiVO₃, Li₂B₄O₇, Li₂NbO₃, Li₂PO₄, Li₂SeO₃, Li₂SeO₄, Li₂TeO₃, Li₂TeO₄, Li₂WO₄, Li₂CrO₄, Li₂Cr₂O₇, Li₂MnO₃, Li₂MnO₄, Li₂HfO₃, LiCoO₂, Li₂MoO₄, MoO₂, Li₂WO₄, Li₂CrO₄, and Li₂Cr₂O₇, S, Li₂S, MoO₂, TiO₂, ZrO₂, SiO₂, Al₂O₃, NiO, FeO or Fe₂O₃, TaO₂, Ta₂O₅, VO, VO₂, V₂O₃, V₂O₅, P₂O₃, P₂O₅, B₂O₃, and other anions known in the art that form ionic compounds.

In an embodiment, the NH₂ group of an amide such as LiNH₂ serves as the catalyst wherein the potential energy is about 81.6 eV or about 3×27.2 eV. Similar to the reversible H₂O elimination or addition reaction of between acid or base to the anhydride and vice versa, the reversible reaction between the amide and imide or nitride results in the formation of the NH₂ catalyst that further reacts with atomic H to form hydrinos. The reversible reaction between amide, and at least one of imide and nitride may also serve as a source of hydrogen such as atomic H.

### Solid Fuel Molten and Electrolysis Cells

In an embodiment, a reactor to form thermal power and lower energy hydrogen species such as H(1/p) and H₂(1/p) wherein p is an integer comprises a molten salt that serves as a source of at least one of H and HOH catalyst. The molten salt may comprise a mixture of salts such as a eutectic mixture. The mixture may comprise at least one of a hydroxide and a halide such as a mixture of at least one of alkaline and alkaline earth hydroxides and halides such as LiOH—LiBr or KOH—KCl. The reactor may further comprise a heater, a heater power supply, and a temperature controller to maintain the salt in a molten state. The source of at least one of H and HOH catalyst may comprise water. The water may be dissociated in the molten salt. The molten salt may further comprise an additive such as at least one of an oxide and a metal such as a hydrogen dissociator metal such as at least one comprising Ti, Ni, and a noble metal such as Pt or Pd to provide at least one of H and HOH catalyst. In an embodiment, H and HOH may be formed by reaction of at least one of the hydroxide, the halide, and water present in the molten salt. In an exemplary embodiment, at least one of H and HOH may be formed by dehydration of MOH (M=alkali): 2MOH to M₂O+HOH; MOH+H2O to MOOH+2H; MX+H2O (X=halide) to MOX+2H wherein dehydration and exchange reaction may be catalyzed by MX. Other embodiments of the reactions of the molten salt are given in the solid fuels disclosure wherein these reactions may comprise SunCell® solid fuel reactants and reactions as well.

In an embodiment, a reactor to form thermal power and lower energy hydrogen species such as H(1/p) and H₂(1/p) wherein p is an integer comprises an electrolysis system comprising at least two electrodes, and electrolysis power supply, an electrolysis controller, a molten salt electrolyte, a heater, a temperature sensor, and a heater controller to maintain a desired temperature, and a source at least one of H and HOH catalyst. The electrodes may be stable in the electrolyte. Exemplary electrodes are nickel and noble metal electrodes. Water may be supplied to the cell and a voltage such as a DC voltage may be applied to the electrodes. Hydrogen may form at the cathode and oxygen may form at the anode. The hydrogen may react with HOH catalyst also formed in the cell to form hydrino. The HOH catalyst may be from added water. The energy from the formation of hydrino may produce heat in the cell. The cell may be well insulated such that the heat from the hydrino reaction may reduce the amount of power required for the heater to maintain the molten salt. The insulation may comprise a vacuum jacket or other thermal insulation known in the art such as ceramic fiber insulation. The reactor may further comprise a heat exchanger. The heat exchanger may remove excess heat to be delivered to an external load.

The molten salt may comprise a hydroxide with at least one other salt such as one chosen from one or more other hydroxides, halides, nitrates, sulfates, carbonates, and phosphates. In an embodiment, the salt mixture may comprise a metal hydroxide and the same metal with another anion of the disclosure such as halide, nitrate, sulfate, carbonate, and phosphate. The molten salt may comprise at least one salt mixture chosen from CsNO₃—CsOH, CsOH—KOH, CsOH—LiOH, CsOH—NaOH, CsOH—RbOH, K₂CO₃—KOH, KBr—KOH, KCl—KOH, KF—KOH, KI—KOH, KNO₃—KOH, KOH—K₂SO₄, KOH—LiOH, KOH—NaOH, KOH—RbOH, Li₂CO₃—LiOH, LiBr—LiOH, LiNO₃—LiOH, LiOH—NaOH, LiOH—RbOH, Na₂CO₃—NaOH, NaBr—NaOH, NaCl—NaOH, NaF—NaOH, NaOH, NaNO₃—NaOH, NaOH—Na₂SO₄, NaOH—RbOH, RbCl—RbOH, RbNO₃—RbOH, NaOH—NaX, KOH—KX, RbOH—RbX, CsOH—CsX, Mg(OH)₂—MgX₂, Ca(OH)₂—CaX₂, Sr(OH)₂—SrX₂, or Ba(OH)₂—BaX₂ wherein X=F, Cl, Br, or I, and LiOH, NaOH, KOH, RbOH, CsOH, Mg(OH)₂, Ca(OH)₂, Sr(OH)₂, or Ba(OH)₂ and one or more of AlX₃, VX₂, ZrX₂, TiX₃, MnX₂, ZnX₂, CrX₂, SnX₂, InX₃, CuX₂, NiX₂, PbX₂, SbX₃, BiX₃, CoX₂, CdX₂, GeX₃, AuX₃, IrX₃, FeX₃, HgX₂, MoX₄, OsX₄, PdX₂, ReX₃, RhX₃, RuX₃, SeX₂, AgX₂, TcX₄, TeX₄, TlX, and WX₄ wherein X=F, Cl, Br, or I. The molten salt may comprise a cation that is common to the anions of the salt mixture electrolyte; or the anion is common to the cations, and the hydroxide is stable to the other salts of the mixture. The mixture may be a eutectic mixture. The cell may be operated at a temperature of about that of the melting point of the eutectic mixture but may be operated at higher temperatures. The electrolysis voltage may be at least one range of about 1V to 50 V, 2 V to 25 V, 2V to 10 V, 2 V to 5 V, and 2 V to 3.5 V. The current density may be in at least one range of about 10 mA/cm² to 100 A/cm², 100 mA/cm² to 75 A/cm², 100 mA/cm² to 50 A/cm², 100 mA/cm² to 20 A/cm², and 100 mA/cm² to 10 A/cm².

In another embodiment, the electrolysis thermal power system further comprises a hydrogen electrode such as a hydrogen permeable electrode. The hydrogen electrode may comprise H₂ gas permeated through a metal membrane such as Ni, V, Ti, Nb, Pd, PdAg, or Fe designated by Ni(H₂), V(H₂), Ti(H₂), Nb(H₂), Pd(H₂), PdAg(H₂), Fe(H₂), or 430 SS(H₂). Suitable hydrogen permeable electrodes for a alkaline electrolyte comprise Ni and alloys such as LaNi5, noble metals such as Pt, Pd, and Au, and nickel or noble metal coated hydrogen permeable metals such as V, Nb, Fe, Fe—Mo alloy, W, Mo, Rh, Zr, Be, Ta, Rh, Ti, Th, Pd, Pd-coated Ag, Pd-coated V, Pd-coated Ti, rare earths, other refractory metals, stainless steel (SS) such as 430 SS, and others such metals known to those skilled in the Art. The hydrogen electrode designated M(H₂) wherein M is a metal through which H₂ is permeated may comprise at least one of Ni(H₂), V(H₂), Ti(H₂), Nb(H₂), Pd(H₂), PdAg(H₂), Fe(H₂), and 430 SS(H₂). The hydrogen electrode may comprise a porous electrode that may sparge H₂. The hydrogen electrode may comprise a hydride such as a hydride chosen from R—Ni, LaNi₅H₆, La₂Co₁Ni₉H₆, ZrCr₂H_{3.8}, LaNi_{3.55}Mn_{0.4}Al_{0.3}Co_{0.75}, ZrMn_{0.5}Cr_{0.2}V_{0.1}Ni_{1.2}, and other alloys capable of storing hydrogen, AB₅ (LaCePrNdNiCoMnAl) or AB₂ (VTiZrNiCrCoMnAlSn) type, where the “AB),” designation refers to the ratio of the A type elements (LaCePrNd or TiZr) to that of the B type elements (VNiCrCoMnAlSn), AB₅-type: MmNi_{3.2}Co_{1.0}Mn_{0.6}Al_{0.11}Mo_{0.09} (Mm=misch metal: 25 wt % La, 50 wt % Ce, 7 wt % Pr, 18 wt % Nd), AB₂-type: Ti_{0.51}Zr_{0.49}V_{0.70}Ni_{1.18}Cr_{0.12} alloys, magnesium-based alloys, Mg_{1.9}Al_{0.1}Ni_{0.8}Co_{0.1}Mn_{0.1} alloy, Mg_{0.72}Sc_{0.28}(Pd_{0.012}+Rh_{0.012}), and Mg₈₀Ti₂₀, Mg₈₀V₂₀, La_{0.8}Nd_{0.2}Ni_{2.4}Co_{2.5}Si_{0.1}, LaNi₅₋ₓMₓ (M=Mn, Al), (M=Al, Si, Cu), (M=Sn), (M=Al, Mn, Cu) and LaNi₄Co, MmNi_{3.55}Mn_{0.44}Al_{0.3}Co_{0.75}, LaNi_{3.55}Mn_{0.44}Al_{0.3}Co_{0.75}, MgCu₂, MgZn₂, MgNi₂, AB compounds, TiFe, TiCo, and TiNi, ABₙ compounds (n=5, 2, or 1), AB₃₋₄ compounds, ABₓ (A=La, Ce, Mn, Mg; B=Ni, Mn, Co, Al), ZrFe₂, Zr_{0.5}Cs_{0.5}Fe₂, Zr_{0.8}Sc_{0.2}Fe₂, YNi₅, LaNi₅, LaNi_{4.5}Co_{0.5}, (Ce, La, Nd, Pr)Ni₅, Mischmetal-nickel alloy, Ti_{0.98}Zr_{0.02}V_{0.43}Fe_{0.09}Cr_{0.05}Mn_{1.5}, La₂Co₁Ni₉, FeNi, and TiMn₂. In an embodiment, the electrolysis cathode comprises at least one of a H₂O reduction electrode and the hydrogen electrode. In an embodiment, the electrolysis anode comprises at least one of a OH⁻ oxidation electrode and the hydrogen electrode.

In an embodiment of the disclosure, the electrolysis thermal power system comprises at least one of [M′″/MOH-M′halide/M″(H₂)], [M′″/M(OH)₂-M′halide/M″(H₂)], [M″(H₂)/MOH-M′halide/M′″], and [M″(H₂)/M(OH)₂-M′ halide/M′″], wherein M is an alkali or alkaline earth metal, M′ is a metal having hydroxides and oxides that are at least one of less stable than those of alkali or alkaline earth metals or have a low reactivity with water, M″ is a hydrogen permeable metal, and M′″ is a conductor. In an embodiment, M′ is metal such as one chosen from Cu, Ni, Pb, Sb, Bi, Co, Cd, Ge, Au, Ir, Fe, Hg, Mo, Os, Pd, Re, Rh, Ru, Se, Ag, Tc, Te, Tl, Sn, W, Al, V, Zr, Ti, Mn, Zn, Cr, In, Pt, and Pb. Alternatively, M and M′ may be metals such as ones independently chosen from Li, Na, K, Rb, Cs, Mg, Ca, Sr, Ba, Al, V, Zr, Ti, Mn, Zn, Cr, Sn, In, Cu, Ni, Pb, Sb, Bi, Co, Cd, Ge, Au, Ir, Fe, Hg, Mo, Os, Pd, Re, Rh, Ru, Se, Ag, Tc, Te, Tl, and W. Other exemplary systems comprise [M″/MOH M″ X/M′ (H₂)] and [M′(H₂)/MOH M′X/M″)] wherein M, M′, M″, and M′″ are metal cations or metal, X is an anion such as one chosen from hydroxides, halides, nitrates, sulfates, carbonates, and phosphates, and M′ is H₂ permeable. In an embodiment, the hydrogen electrode comprises a metal such as at least one chosen from V, Zr, Ti, Mn, Zn, Cr, Sn, In, Cu, Ni, Pb, Sb, Bi, Co, Cd, Ge, Au, Ir, Fe, Hg, Mo, Os, Pd, Re, Rh, Ru, Se, Ag, Tc, Te, Tl, W, and a noble metal. In an embodiment, the electrochemical power system comprises a hydrogen source, a hydrogen electrode capable of providing or forming atomic H, an electrode capable of forming at least one of H, H₂, OH, OH⁻, and H₂O catalyst, a source of at least one of O₂ and H₂O, a cathode capable of reducing at least one of H₂O and O₂, an alkaline electrolyte, and a system to collect and recirculate at least one of H₂O vapor, N₂, and O₂, and H₂. The sources of H₂, water, and oxygen may comprise ones of the disclosure.

In an embodiment, H₂O supplied to the electrolysis system may serve as the HOH catalyst that catalyzes H atoms formed at the cathode to hydrinos. H provided by the hydrogen electrode may also serve as the H reactant to form hydrino such as H(1/4) and H₂ (1/4). In another embodiment, the catalyst H₂O may be formed by the oxidation of OH⁻ at the anode and the reaction with H from a source. The source of H may be from at least one of the electrolysis of the electrolyte such as one comprising at least one of hydroxide and H₂O and the hydrogen electrode. The H may diffuse from the cathode to the anode. Exemplary cathode and anode reactions are:

### Cathode Electrolysis Reaction

2H₂O+2e− to H₂+2OH− (168)

### Anode Electrolysis Reactions

½H₂+OH⁻ to H₂O+e⁻ (169)

H₂+OH⁻ to H₂O+e⁻+H(1/4) (170)

OH⁻+2H to H₂O+e⁻+H(1/4) (171)

Regarding the oxidation reaction of OH⁻ at the anode to form HOH catalyst, the OH⁻ may be replaced by reduction of a source of oxygen such as O₂ at the cathode. In an embodiment, the anion of the molten electrolyte may serve as a source of oxygen at the cathode. Suitable anions are oxyanions such as C₃²⁻, SO₄²⁻, and PO₄³⁻. The anion such as CO₃²⁻ may form a basic solution. An exemplary cathode reaction is

### Cathode

CO₃²⁻+4e⁻+3H₂O to C+6OH⁻ (172)

The reaction may involve a reversible half-cell oxidation-reduction reaction such as

CO₃²⁻+H₂O to CO₂+2OH⁻ (173)

The reduction of H₂O to OH⁻+H may result in a cathode reaction to form hydrinos wherein H₂O serves as the catalyst. In an embodiment, CO₂, SO₂, NO, NO₂, PO₂ and other similar reactants may be added to the cell as a source of oxygen.

In addition to molten electrolytic cells, the possibility exists to generate H₂O catalyst in molten or aqueous alkaline or carbonate electrolytic cells wherein H is produced on the cathode. Electrode crossover of H formed at the cathode by the reduction of H₂O to OH⁻+H can give rise to the reaction of Eq. (171). Alternatively, there are several reactions involving carbonate that can give rise H₂O catalyst such as those involving a reversible internal oxidation-reduction reaction such as

CO₃²⁻+H₂O→CO₂+2OH⁻ (174)

as well as half-cell reactions such as

CO₃²⁻+2H→H₂O+CO₂+2e⁻ (175)

CO₂+½O₂+2e⁻→CO₃²⁻ (176)

### Hydrino Compounds or Compositions of Matter

The hydrino compounds comprising lower-energy hydrogen species such as molecular hydrino may be identified by (i) time of flight secondary ion mass spectroscopy (ToF-SIMS) and electrospray time of flight secondary ion mass spectroscopy (ESI-ToF) that may record the unique metal hydrides, hydride ion, and clusters of inorganic ions with bound H₂(1/4) such as in the form of an M+2 monomer or multimer units such as K⁺[H₂(1/4):K₂CO₃]ₙ and K⁺[H₂(1/4): KOH]ₙ wherein n is an integer; (ii) Fourier transform infrared spectroscopy (FTIR) that may record at least one of the H₂(1/4) rotational energy at about 1940 cm⁻ and libation bands in the finger print region wherein other high energy features of known functional groups may be absent, (iii) proton magic-angle spinning nuclear magnetic resonance spectroscopy (¹H MAS NMR) that may record an upfield matrix peak such as one in the −4 ppm to −6 ppm region, (iv) X-ray diffraction (XRD) that may record novel peaks due to the unique composition that may comprise a polymeric structure, (v) thermal gravimetric analysis (TGA) that may record a decomposition of the hydrogen polymers at very low temperature such as in the region of 200° C. to 900° C. and provide the unique hydrogen stoichiometry or composition such as FeH or K₂CO₃H₂, (vi) e-beam excitation emission spectroscopy that may record the H₂(1/4) ro-vibrational band in the 260 nm region comprising peaks spaced at 0.25 eV; (vii) photoluminescence Raman spectroscopy that may record the second order of the H₂(1/4) ro-vibrational band in the 260 nm region comprising peaks spaced at 0.25 eV; (viii) at least one of the first order H₂(1/4) ro-vibrational band in the 260 nm region comprising peaks spaced at 0.25 eV recorded by e-beam excitation emission spectroscopy and the second order of the H₂(1/4) ro-vibrational band recorded by photoluminescence Raman spectroscopy may reversibly decrease in intensity with temperature when thermal cooled by a cryocooler; (ix) ro-vibrational emission spectroscopy wherein the ro-vibrational band of H₂(1/p) such as H₂(1/4) may be excited by high-energy light such as light of at least the energy of the ro-vibrational emission; (x) Raman spectroscopy that may record at least one of a continuum Raman spectrum in the range of 40 to 8000 cm⁻¹ and a peak in the range of 1500 to 2000 cm⁻¹ due to at least one of paramagnetic and nanoparticle shifts; (xi) spectroscopy on the ro-vibrational band of H₂(1/4) in the gas phase or embedded in a liquid or solid such as a crystalline matrix such as one comprising KCl that is excited with a plasma such as a helium or hydrogen plasma such as a microwave, RF, or glow discharge plasma; (xii) Raman spectroscopy that may record the H₂(1/4) rotational peak at about one or more of 1940 cm⁻¹±10% and 5820 cm⁻¹±10%, (xiii) X-ray photoelectron spectroscopy (XPS) that may record the total energy of H₂(1/4) at about 495-500 eV, (xiv) gas chromatography that may record a negative peak wherein the peak may have a faster migration time than helium or hydrogen, (xv) electron paramagnetic resonance (EPR) spectroscopy that may record at least one of an H₂(1/4) peak with a g factor of about 2.0046±20%, a splitting of the EPR spectrum into two main peaks with a separation of about 1 to 10 G wherein each main peak is sub-split into a series of peaks with spacing of about 0.1 to 1 G, and proton splitting such as a proton-electron dipole splitting energy of about 1.6×10⁻² eV±20% and a hydrogen product comprising a hydrogen molecular dimer [H₂(1/4)]₂ wherein the EPR spectrum shows an electron-electron dipole splitting energy of about 9.9×10⁻⁵ eV±20% and a proton-electron dipole splitting energy of about 1.6×10⁻² eV±20%, (xvi) quadrupole moment measurements such as magnetic susceptibility and g factor measurements that record a H₂(1/p) quadrupole moment/e of about

$$\frac{1.70127 {a}_{0}^{2}}{{p}^{2}} ,$$

and (xvii) high pressure liquid chromatography (HPLC) that shows chromatographic peaks having retention times longer than that of the carrier void volume time using an organic column with a solvent such as one comprising water or water-methanol-formic acid and eluents such as a gradient water+ammonium acetate+formic acid and acetonitrile/water+ammonium acetate+formic acid wherein the detection of the peaks by mass spectroscopy such as ESI-ToF shows fragments of at least one ionic or inorganic compound such as NaGaO₂-type fragments from a sample prepared by dissolving Ga₂O₃ from the SunCell® in NaOH. Hydrino molecules may form at least one of dimers and solid H₂(1/p). In an embodiment, the end over end rotational energy of integer J to J+1 transition of H₂(1/4) dimer ([H₂(1/4)]₂) and D₂(1/4) dimer ([D₂(1/4)]₂) are about (J+1)44.30 cm⁻¹ and (J+1)22.15 cm⁻¹, respectively. In an embodiment, at least one parameter of [H₂(1/4)]₂) is (i) a separation distance between H₂(1/4) molecules of about 1.028 Å, (ii) a vibrational energy between H₂(1/4) molecules of about 23 cm⁻¹, and (iii) a van der Waals energy between H₂(1/4) molecules of about 0.0011 eV. In an embodiment, at least one parameter of solid H₂(1/4) is (i) a separation distance between H₂(1/4) molecules of about 1.028 Å, (ii) a vibrational energy between H₂(1/4) molecules of about 23 cm⁻¹, and (iii) a van der Waals energy between H₂(1/4) molecules of about 0.019 eV. In an embodiment, a hydrino compound such as GaOOH:H₂(1/4) comprises a novel crystalline structure compared to the non-hydrino analogue GaOOH such as a hexagonal versus orthorhombic structure as recorded by X-ray diffraction (XRD) and transmission electron microscopy (TEM) Novel crystal pattern by TEM or XRD. At least one of the rotational and vibrational spectra may be recorded by at least one of FTIR and Raman spectroscopy wherein the bond dissociation energy and separation distance may also be determined from the spectra. The solution of the parameters of hydrino products is given in Mills GUTCP [which is herein incorporate by reference, available at https://brilliantlightpower.com] such as in Chapters 5-6, 11-12, and 16.

In an embodiment, an apparatus to collect molecular hydrino in gaseous, physi-absorbed, liquefied, or in other state comprises a source of macro-aggregates or polymers comprising lower-energy hydrogen species, a chamber to contain the macro-aggregates or polymers comprising lower-energy hydrogen species, a means to thermally decompose the macro-aggregates or polymers comprising lower-energy hydrogen species in the chamber, and a means to collect the gas released from the macro-aggregates or polymers comprising lower-energy hydrogen species. The decomposition means may comprise a heater. The heater may heat the first chamber to a temperature greater than the decomposition temperature of the macro-aggregates or polymers comprising lower-energy hydrogen species such as a temperature in at least one range of about 10° C. to 3000° C., 100° C. to 2000° C., and 100° C. to 1000° C. The means to collect the gas from decomposition of macro-aggregates or polymers comprising lower-energy hydrogen species may comprise a second chamber. The second chamber may comprise at least one of a gas pump, a gas valve, a pressure gauge, and a mass flow controller to at least one of store and transfer the collected molecular hydrino gas. The second chamber may further comprise a getter to absorb molecular hydrino gas or a chiller such as a cryogenic system to liquefy molecular hydrino. The chiller may comprise a cryopump or dewar containing a cryogenic liquid such as liquid helium or liquid nitrogen.

The means to form macro-aggregates or polymers comprising lower-energy hydrogen species may further comprise a source of field such as a source of at least one of an electric field or a magnetic field. The source of the electric field may comprise at least two electrodes and a source of voltage to apply the electric field to the reaction chamber wherein the aggregate or polymers are formed. Alternatively, the source of electric field may comprise an electrostatically charged material. The electrostatically charged material may comprise the reaction cell chamber such as a chamber comprising carbon such as a Plexiglas chamber. The detonation of the disclosure may electrostatically charge the reaction cell chamber. The source of the magnetic field may comprise at least one magnet such as a permanent, electromagnet, or a superconducting magnet to apply the magnetic field to the reaction chamber wherein the aggregate or polymers are formed.

Molecular hydrino (such as those which may be generated in the power generation systems described herein) may be uniquely identified by their spectroscopic signatures such as those determined by electron paramagnetic resonance spectroscopy (EPR) as well as electron nuclear double resonance spectroscopy (ENDOR). In an embodiment, the lower-energy hydrogen product may comprise a metal in a diamagnetic chemical state such as a metal oxide, and is further absent any free non-hydrino radical species wherein an electron paramagnetic resonance (EPR) spectroscopy peak is observed due to the presence of H₂(1/p) such as H₂(1/4). A hydrino reaction cell chamber comprising a means to detonate a wire to serve as at least one of a source of reactants and a means to propagate the hydrino reaction to form at least one of H₂(1/4) molecules, inorganic compounds such as metal oxides, hydroxides, hydrated inorganic compounds such as hydrated metal oxides and hydroxides further comprising H₂(1/p) such as H₂(1/4), and macro-aggregates or polymers comprising lower-energy hydrogen species such as molecular hydrino comprises a wire detonation system is shown in FIG. 33. In an embodiment, the atmosphere of the reaction cell chamber may be conditioned to form the web-like product from wire denotations comprises carbon dioxide in addition to water vapor. The carbon dioxide may enhance the bonding of molecular hydrino to the growing web fibers wherein the CO₂ may react with the metal oxide formed from the wire metal during the blast to form the corresponding metal carbonate or hydrogen carbonate.

The electron magnetic moments of a plurality of hydrino molecules such as H₂(1/4) may give rise to permanent magnetization. Molecular hydrinos may give rise to bulk magnetism when magnetic moments of a plurality of hydrino molecules interact cooperatively and wherein multimers such as dimers may occur. Magnetism of dimers, aggregates, or polymers comprising molecular hydrino may arise from interactions of the cooperatively aligned magnetic moments. The magnetism may be much greater in the case that the magnetism is due to the interaction of the permanent electron magnetic moment of an additional species having at least one unpaired electrons such as iron atoms.

A self-assembly mechanism may comprise a magnetic ordering in addition to van der Waals forces. It is well known that the application of an external magnetic field causes colloidal magnetic nanoparticles such as magnetite (Fe₂O₃) suspended in a solvent such as toluene to assemble into linear structures. Due to the small mass and high magnetic moment molecular hydrino magnetically self assembles even in the absence of a magnetic field. In an embodiment to enhance the self-assembly and to control the formation of alternative structures of the hydrino products, an external magnetic field is applied to the hydrino reaction such as the wire detonation. The magnetic field may be applied by placing at least one permanent magnet in the reaction chamber. Alternatively, the detonation wire may comprise a metal that serves as a source of magnetic particles such as magnetite to drive the magnetic self-assembly of molecular hydrino wherein the source may be the wire detonation in water vapor or another source.

In an embodiment, hydrino products such as hydrino compounds or macroaggregates may comprise at least one other element of the periodic chart other than hydrogen. The hydrino products may comprise hydrino molecules and at least one other element such as at least one a metal atom, metal ion, oxygen atom, and oxygen ion. Exemplary hydrino products may comprise H₂(1/p) such as H₂(1/4) and at least one of Sn, Zn, Ag, Fe, Ga, Ga₂O₃, GaOO, SnO, ZnO, AgO, FeO, and Fe₂O₃.

Molecular hydrino can also form dimers that could be shown by EPR spectroscopy. Consider the splitting energy of interaction with two axially aligned magnetic moments of a H₂(1/4) dimer. With the substitution of a Bohr magneton μ_{B} for each axially aligned magnetic moment and the H₂(1/4) dimer separation given by Mills Eq. (16.202) for |r| into Mills Eq. (16.223), the energy E_{mag [H}_{₂}_{(1/4)]}_{₂}_{e-dipole} to flip the spin direction of two electron magnetic moments of [H₂(1/4)]₂ is

$$\begin{matrix}{E}_{m {g [ {H}_{2} ( 1 / 4 ) ]}_{2} e ‐ dipole} = - \frac{2 {μ}_{0} {μ}_{B}^{2}}{4 π {r}^{3}} \\ = - \frac{{{μ}_{0} ( 9.27 \; 400949 \times {10}^{- 24} {JT}^{- 1} )}^{2}}{2 {π ( 1 \text{.028} \times {10}^{- 10} m )}^{3}} \\ = - 1.584 \times {10}^{- 23} J = \\ - 9.885 \times {10}^{- 5} eV = 2 3.9 GHz\end{matrix} \qquad ( 16.244 )$$

The energy (Mills Eq. (16.220)) may be further influenced by presence of multimers of greater order than two, such as trimers, tetramers, pentamers, hexamers, etc. and by internal bulk magnetism of the hydrino compound. The energy shift due to a plurality of multimers may be determined by vector addition of the superimposed magnetic dipole interactions given by Mills Eq. (16.223) with the corresponding distances and angles. The unpaired electron of molecular hydrino may give rise to non-zero or finite bulk magnetism such as paramagnetism, superparamagnetism and even ferromagnetism when the magnetic moments of a plurality of hydrino molecules interact cooperatively. Molecular hydrino may give rise to non-zero or finite bulk magnetism such as paramagnetism, superparamagnetism and even ferromagnetism when the magnetic moments of a plurality of hydrino molecules interact cooperatively. Superparamagnetism and ferromagnetism are favored when a molecular hydrino macroaggregate additionally comprises ferromagnetic atoms such as iron. Macroaggregates that are stable beyond room temperature may form by magnetic assembly and bonding. The magnetic energies become on the order of 0.01 eV, comparable to ambient laboratory thermal energies. The EPR spectrum of compounds having magnetization which causes excitation at lower B field and de-excitation at higher B field may be observed to have corresponding downfield and upfield shifts of the spectral features, respectively. Even though the effect may be small, it may still be observable due to the very small splitting energies that are between 1000 and 10,000 times smaller than the H Lamb shift. In the case of the GaOOH:H₂(1/4) sample, the EPR spectrum recorded at Delft University [F. Hagen, R. Mills, “Distinguishing Electron Paramagnetic Resonance signature of molecular hydrino”, Nature, (2020), in progress.] showed remarkably narrow line widths due to the dilute presence of H₂(1/4) molecules trapped in GaOOH cages that comprised a diamagnetic matrix.

The bonding of molecular hydrino molecules H₂ (1/4) to form a solid at room to elevated temperatures is due to van der Waals forces that are much greater for molecular hydrino than molecular hydrogen due to the decreased dimensions and greater packing as shown in Mills GUTCP. Due to its intrinsic magnetic moment and van der Waals forces, molecular hydrino may self assemble into macroaggregates. In an embodiment, hydrino such as H₂(1/p) such as H₂(1/4) may form polymers, tubes, chains, cubes, fullerene, and other macrostructures.

In an embodiment, the compositions of matter comprising lower-energy hydrogen species such as molecular hydrino (“hydrino compound”) may be separated magnetically. The hydrino compound may be cooled to further enhance the magnetism before being separated magnetically. The magnetic separation method may comprise moving a mixture of compounds containing the desired hydrino compound through a magnetic field such that the hydrino compound is preferentially retarded in mobility relative to the remainder of the mixture or moving a magnet over the mixture to separate the hydrino compound from the mixture. In an exemplary embodiment, hydrino compound is separated from nonhydrino products of the wire detonations by immersing the detonation product material in liquid nitrogen and using magnetic separation wherein the cryo-temperature increases the magnetism of the hydrino compound product. The separation may be enhanced at the boiling surface of the liquid nitrogen.

In addition to being negatively charged, in an embodiment, the hydrino hydride ion H⁻ (1/p) comprises a doublet state with an unpaired electron that gives rise to a Bohr magneton of magnetic moment. A hydrino hydride ion separator may comprise at least one of a source of electric field and magnetic field to separate hydrino hydride ions from a mixture of ions based on the differential and selective forces maintained on the hydrino hydride ion based on at least one of the charge and magnetic moment of the hydrino hydride ion. In an embodiment, the hydrino hydride ion may be accelerated in an electric field and deflected to a collector based on the unique mass to charge ratio of the hydrino hydride ion. The separator may comprise a hemispherical analyzer or a time of flight analyzer type device. In another embodiment, the hydrino hydride ion may be collected by magnetic separation wherein a magnetic field is applied to a sample by a magnet and the hydrino hydride ions selectively stick to the magnet to be separated. The hydrino hydride ions may be separated together with a counter ion.

In an embodiment, a hydrino species such as atomic hydrino, molecular hydrino, or hydrino hydride ion is synthesized by the reaction of H and at least one of OH and H₂O catalyst. In an embodiment, the product of at least one of the SunCell® reaction and the energetic reactions such as ones comprising shot or wire ignitions of the disclosure to form hydrinos is a hydrino compound or species comprising a hydrino species such as H₂(1/p) complexed with at least one of (i) an element other than hydrogen, (ii) an ordinary hydrogen species such as at least one of H⁺, ordinary H₂, ordinary H⁻, and ordinary H₃⁺, an organic molecular species such as an organic ion or organic molecule, and (iv) an inorganic species such as an inorganic ion or inorganic compound. The hydrino compound may comprise an oxyanion compound such as an alkali or alkaline earth carbonate or hydroxide, oxyhydroxides such as GaOOH, AlOOH, and FeOOH, or other such compounds of the present disclosure. In an embodiment, the product comprises at least one of M₂CO₃.H₂ (1/4) and MOH.H₂ (1/4) (M=alkali or other cation of the present disclosure) complex. The product may be identified by ToF-SIMS or electrospray time of flight secondary ion mass spectroscopy (ESI-ToF) as a series of ions in the positive spectrum comprising M(M₂CO₃.H₂ (1/4))ₙ⁺ and M(MOH.H₂ (1/4))ₙ⁺, respectively, wherein n is an integer and an integer and integer p>1 may be substituted for 4. In an embodiment, a compound comprising silicon and oxygen such as SiO₂ or quartz may serve as a getter for H₂(1/4). The getter for H₂(1/4) may comprise a transition metal, alkali metal, alkaline earth metal, inner transition metal, rare earth metal, combinations of metals, alloys such as a Mo alloy such as MoCu, and hydrogen storage materials such as those of the present disclosure.

The compounds comprising hydrino species synthesized by the methods of the present disclosure may have the formula MH, MH₂, or M₂H₂, wherein M is an alkali cation and H is a hydrino species. The compound may have the formula MHₙ wherein n is 1 or 2, M is an alkaline earth cation and H is hydrino species. The compound may have the formula MHX wherein M is an alkali cation, X is one of a neutral atom such as halogen atom, a molecule, or a singly negatively charged anion such as halogen anion, and H is a hydrino species. The compound may have the formula MHX wherein M is an alkaline earth cation, X is a singly negatively charged anion, and H is H is a hydrino species. The compound may have the formula MHX wherein M is an alkaline earth cation, X is a double negatively charged anion, and H is a hydrino species. The compound may have the formula M₂HX wherein M is an alkali cation, X is a singly negatively charged anion, and H is a hydrino species. The compound may have the formula MHₙ wherein n is an integer, M is an alkaline cation and the hydrogen content Hₙ of the compound comprises at least one hydrino species. The compound may have the formula M₂Hₙ wherein n is an integer, M is an alkaline earth cation and the hydrogen content Hₙ of the compound comprises at least one hydrino species. The compound may have the formula M₂XHₙ wherein n is an integer, M is an alkaline earth cation, X is a singly negatively charged anion, and the hydrogen content Hₙ of the compound comprises at least one hydrino species. The compound may have the formula M₂X₂Hₙ wherein n is 1 or 2, M is an alkaline earth cation, X is a singly negatively charged anion, and the hydrogen content Hₙ of the compound comprises at least one hydrino species. The compound may have the formula M₂X₃H wherein M is an alkaline earth cation, X is a singly negatively charged anion, and H is a hydrino species. The compound may have the formula M₂XHₙ wherein n is 1 or 2, M is an alkaline earth cation, X is a double negatively charged anion, and the hydrogen content Hₙ of the compound comprises at least one hydrino species. The compound may have the formula M₂XX′H wherein M is an alkaline earth cation, X is a singly negatively charged anion, X′ is a double negatively charged anion, and H is hydrino species. The compound may have the formula MM′Hₙ wherein n is an integer from 1 to 3, M is an alkaline earth cation, M′ is an alkali metal cation and the hydrogen content Hₙ of the compound comprises at least one hydrino species. The compound may have the formula MM′XHₙ wherein n is 1 or 2, M is an alkaline earth cation, M′ is an alkali metal cation, X is a singly negatively charged anion and the hydrogen content Hₙ of the compound comprises at least one hydrino species. The compound may have the formula MM′XH wherein M is an alkaline earth cation, M′ is an alkali metal cation, X is a double negatively charged anion and H is a hydrino species. The compound may have the formula MM′XX′H wherein M is an alkaline earth cation, M′ is an alkali metal cation, X and X′ are singly negatively charged anion and H is a hydrino species. The compound may have the formula MXX′Hₙ wherein n is an integer from 1 to 5, M is an alkali or alkaline earth cation, X is a singly or double negatively charged anion, X′ is a metal or metalloid, a transition element, an inner transition element, or a rare earth element, and the hydrogen content Hₙ of the compound comprises at least one hydrino species. The compound may have the formula MHₙ wherein n is an integer, M is a cation such as a transition element, an inner transition element, or a rare earth element, and the hydrogen content Hₙ of the compound comprises at least one hydrino species. The compound may have the formula MXHₙ wherein n is an integer, M is an cation such as an alkali cation, alkaline earth cation, X is another cation such as a transition element, inner transition element, or a rare earth element cation, and the hydrogen content Hₙ of the compound comprises at least one hydrino species. The compound may have the formula (MHₘMCO₃)ₙ wherein M is an alkali cation or other +1 cation, m and n are each an integer, and the hydrogen content Hₘ of the compound comprises at least one hydrino species. The compound may have the formula (MHₘMNO₃)ₙ⁺nX⁻ wherein M is an alkali cation or other +1 cation, m and n are each an integer, X is a singly negatively charged anion, and the hydrogen content Hₘ of the compound comprises at least one hydrino species. The compound may have the formula (MHMNO₃)ₙ wherein M is an alkali cation or other +1 cation, n is an integer and the hydrogen content H of the compound comprises at least one hydrino species. The compound may have the formula (MHMOH)ₙ wherein M is an alkali cation or other +1 cation, n is an integer, and the hydrogen content H of the compound comprises at least one hydrino species. The compound including an anion or cation may have the formula (MHₘM′X)ₙ wherein m and n are each an integer, M and M′ are each an alkali or alkaline earth cation, X is a singly or double negatively charged anion, and the hydrogen content Hₘ of the compound comprises at least one hydrino species. The compound including an anion or cation may have the formula (MHₘM′X′)ₙ⁺nX⁻ wherein m and n are each an integer, M and M′ are each an alkali or alkaline earth cation, X and X′ are a singly or double negatively charged anion, and the hydrogen content Hₘ of the compound comprises at least one hydrino species. The anion may comprise one of those of the disclosure. Suitable exemplary singly negatively charged anions are halide ion, hydroxide ion, hydrogen carbonate ion, or nitrate ion. Suitable exemplary double negatively charged anions are carbonate ion, oxide, or sulfate ion.

The hydrino compounds of the present invention are preferably greater than 0.1 atomic percent pure. More preferably, the compounds are greater than 1 atomic percent pure. Even more preferably, the compounds are greater than 10 atomic percent pure. Most preferably, the compounds are greater than 50 atomic percent pure. In another embodiment, the compounds are greater than 90 atomic percent pure. In another embodiment, the compounds are greater than 95 atomic percent pure.

### Properties of Reaction Products

Since hydrino compounds (or reaction products having the spectroscopic signatures as described herein) interact with a column comprising an organic packing such as the C18 column during chromatography such as high-performance liquid chromatography (HPLC), hydrino compounds (e.g., such as those generated during operation of the SunCell®) may be extracted from an aqueous solution such as an aqueous base solution such as an aqueous NaOH or KOH solution using an organic solvent such as at least one of a hydrocarbon, alcohol, ether dimethyl formamide, and carbonate. In an embodiment, chromatography with a stationary phase comprising an organic compound such as HPLC with a C18 column packing is used to at least one of separate, purify, and identify compounds comprising lower-energy hydrogen such as ones comprising molecular hydrino due to an interaction between the compounds comprising lower-energy hydrogen and the stationary phase. The lower-energy hydrogen moiety of the compound further comprising at least one inorganic moiety may give rise to an interaction with the stationary phase of the column having at least some organic character whereby in the absence of the lower-energy hydrogen moiety, the interaction would be negligible or absent. In an embodiment, a compound comprising lower energy hydrogen such a molecular hydrino may be purified from at least one of a solution and a mixture of compounds by column or film chromatography. The eluant may comprise at least one of water and at least one organic solvent such an acetonitrile, formic acid, an alcohol, an ether, DMSO, and another such solvent known in the art. The column packing may comprise an organic type stationary phase.

Josephson junctions such as ones of superconducting quantum interference devices (SQUIDs) link magnetic flux in quantized units of the magnetic flux quantum or fluxon

$$\frac{h}{2 e} .$$

The same behavior was predicted and observed for the linkage of magnetic flux by hydrino hydride ion and molecular hydrino. The former was observed in the visible emission spectrum of H⁻(1/2) during the binding of a free electron to the corresponding atom, H(1/2). The linkage of fluxons by molecular hydrino was observed by electron paramagnetic resonance spectroscopy involving microwave irradiation of H₂ (1/4) in an Applied Magnetic Field wherein resonant absorption caused a spin-flip transition involving spin-orbital coupling with the quantized magnetic flux linkage. The linkage of fluxons by molecular hydrino was also observed by Raman spectroscopy involving infrared, visible, or ultraviolet laser irradiation of H₂(1/4) wherein resonant absorption caused a rotational transition involving spin-orbital coupling with the quantized magnetic flux linkage. The linkage of fluxons by molecular hydrino was further observed by Raman spectroscopy involving infrared irradiation of H₂(1/4) wherein resonant absorption caused a rotational transition involving spin-orbital coupling with the quantized magnetic flux linkage when a magnetic field was applied to change the selection rules for infrared absorption. The phenomenon of flux linkage by hydrino species such as H⁻(1/p) and H₂ (1/p) has utility in enabling hydrino SQUIDs and hydrino SQUID-type electronic elements such as logic gates, memory elements and other electronic measurement or actuator devices such as magnetometers, sensors, and switches utilizing the unique characteristics of these hydrino reaction products. For example, a computer logic gate or memory element that operates at even elevated temperature versus cryogenic ones, may be a single molecular hydrino such as H₂(1/4) that is 4³ or 64 times smaller than molecular hydrogen.

The hydrino SQUIDs and hydrino SQUID-type electronic element may comprise least one of an input current and input voltage circuit and an output current and output voltage circuit to at least one of sense and change the flux linkage state of at least one of the hydrino hydride ion and molecular hydrino. The circuits may comprise AC resonant circuits such as radio frequency RLC circuits. The hydrino SQUIDs and hydrino SQUID-type electronic element may further comprise at least one source of electromagnetic radiation such as a source of at least one of microwave, infrared, visible, or ultraviolet radiation. The source of radiation may comprise a laser or a microwave generator. The laser radiation may be applied in a focused manner by lens or fiber optics. The hydrino SQUIDs and hydrino SQUID-type electronic element may further comprise a source of magnetic field applied to at least one of the hydrino hydride ion and molecular hydrino. The magnetic field may be tunable. The turnability of at least one of the source of radiation and magnetic field may enable the selective and controlled achievement of resonance between the source of electromagnetic radiation and the magnetic field.

In an embodiment, an intrinsic or extrinsic magnet field or magnetization may allow molecular hydrino transitions comprising at least one of an electron spin flip, molecular rotational, spin rotation, spin-orbital coupling, and magnetic flux linkage transition to be allowed. Metal foils such as ferromagnetic ones such as Ni, Fe, or Co foils comprising hydrino on the surface may show these molecular hydrino transitions in the Raman spectrum. In another embodiment, a molecular hydrino compound such as GaOOH:H₂(1/4) may be subject to the external applied magnetic field of a magnet to allow these molecular hydrino transition such as one observable by Raman spectroscopy. The molecular hydrino transitions may also be enhanced by a surface enhanced effect such as one that occurs when the molecular hydrino is on the surface of a conductor such as on a metal surface such as observed by Surface enhanced Raman (SER). Exemplary metal surfaces are foils of Ni, Cu, Cr, Fe, stainless steel, Ag, Au, and other metal or metal alloy.

In an embodiment, molecular hydrino gas such as H₂(1/4) is soluble in condensed gases such as a noble gas such are liquid argon, liquid nitrogen, liquid CO₂ or a solid gas such as solid CO₂. In the case that hydrino is more soluble than hydrogen, liquid argon may be used to selectively collect and enrich molecular hydrino gas from a source such as one comprising a mixture of H₂ and molecular hydrino gas such as gas from the SunCell®. In an embodiment, the gas from the SunCell® is bubbled through liquid argon that serves as a getter due to the solubility of molecular hydrino in liquid argon. In an embodiment, the loss rate of gaseous molecular hydrino from a sealed vessel may be decreased by adding another gas such as argon which retains molecular hydrino.

As described above, the power generation systems of the present disclosure operate via a reaction with unique signatures which may be used to characterize the system. These products may be collected in a variety of different manners. In an embodiment, the solvent for hydrino collection. In an embodiment, the solvent may be magnetic such as paramagnetic such that molecular hydrino has some absorption interaction due to the magnetism of molecular hydrino. Exemplary solvents are liquid oxygen, oxygen dissolved in another liquid such as water, NO, NO₂, B₂, ClO₂, SO₂, N₂O wherein NO₂, O₂, NO, B₂, and ClO₂ are paramagnetic. Alternatively, hydrino gas may be bubbled through a solid solvent such as a solid that is a gas at room temperature such as solid CO₂. The hydrino gas may be directly collected. Alternatively, the resulting solution may be filtered, skimmed, decanted, or centrifuged to collect the non-soluble compounds comprising hydrino such as hydrino macroaggregates.

Solid getters may also be used to trap hydrino gas such as that produced in the SunCell® at one temperature such as a cryogenic temperature and released at a higher temperature upon warming or heating. The getter may comprise an oxide or a hydroxide such as a metal oxide, hydroxide, or a carbonate. Additional exemplary getters are at least one of an alkali hydroxide such as KOH or an alkaline earth hydroxide such as Ca(OH)₂, a carbonate such as K₂CO₃, mixtures of getters such as a hydroxide and a carbonate such as Ca(OH)₂+Li₂CO₃, an alkali halide such as KCl or LiBr, a nitrate such as NaNO₃, and a nitrite such as NaNO₂. Getters such as FeOOH, Fe(OH)₃, and Fe₂O₃ may be paramagnetic. In an embodiment, the getter may comprise a magnetic compound, material, liquid, or species such as paramagnetic nanoparticles such as ones comprising Mn, Cu, or Ti, or magnetic nanoparticles such as ferromagnetic metal nanoparticles such as Ni, Fe, Co, CoSm, Alnico, and other ferromagnetic metal nanoparticles. The magnetic compound, material, liquid, or species may be dispersed in the surface of a magnet. The magnet may be maintained at cryogenic temperature. In an exemplary embodiment, the molecular hydrino getter comprises iron, nickel, or cobalt powder dispersed on a permanent magnetic such as a CoSm or neodymium permanent magnet placed in the vacuum line section that is immersed in a cryogen such as liquid nitrogen. In an embodiment, the getter such as a magnetic material such as Fe metal powder is placed in at least one of inside of the reaction cell chamber and in proximity to and connected to the reaction cell chamber. The getter may be contained in a vessel such as a crucible. The vessel may be covered to prevent the molten metal from contacting the getter. The cover may be at least one of capable of high temperature operation, resistant to alloy formation with the molten metal, and permeable to hydrino gas. An exemplary cover is thin porous carbon, BN, silica, quartz, or other ceramic cover.

In an embodiment, molecular hydrino may be released from a composition of matter such as the getters used in the SunCell® which comprise hydrino by treatment with an anhydrous acid such as CO₂ (carbionic acid), HNO₃, H₂SO₄, HCl(g) or HF(g). The acid may be neutralized in an aqueous trap, and the molecular hydrino gas collected in at least one of the isolated salt from neutralization and a cryotrap such as one comprising CO₂(s). At least one of an acid and base may be selected to form a desired compound comprising molecular hydrino. In an exemplary embodiment, NaNO₃ or KNO₃ comprising hydrino is formed by dissolving gallium oxide or gallium oxyhydroxide collected from the SunCell® in aqueous NaOH or KOH and neutralizing the solution with HNO₃.

In an embodiment, at least one of potassium and sodium gallate are neutralized with carbonic acid formed by bubbling CO₂ through the solution to form K₂CO₃:H₂(1/4) and Na₂CO₃:H₂(1/4). An exemplary, analysis of the potassium carbonate analogue by gallium-ToF-SIMS showed K{K₂CO₃:H₂(1/4)}ₙ, n=integer in the positive spectrum.

In an embodiment, strong acid neutralization of a basic solution comprising molecular hydrino such as that from Ga₂O₃ collected for a hydrino reaction run of the SunCell® and dissolved in base such as an alkali or alkaline earth hydroxide such as NaOH or KOH results in the formation of GaOOH comprising molecular hydrino such as GaOOH:H₂(1/4). Exemplary strong acids are HCl and HNO₃. Neutralization with a weak acid such as carbonic acid results on the formation of GaOOH comprising molecular hydrino and a compound or a mixture of compounds comprising at least one of gallium, oxide, hydroxide, carbonate, water, and the cation of the base such as potassium gallium carbonate hydrate such as K₂Ga₂C₂O₈(H₂O)₃.

Alternatively, molecular hydrino may be released from a compound comprising hydrino by at least one of application of high temperature such as in the range of about 100° C. to 3400° C., application of plasma, high-energy ion or electron bombardment, application of at least one of high power and high energy light such as by irradiation of the compound with a high-power UV lamp or flash lamp, and laser irradiation such as irradiation by a UV laser such as one emitting 325 nm laser light, a frequency doubled argon ion laser line (244 nm), or a HeCd laser.

In an embodiment, molecular hydrino gas may be obtained by formation of a compound comprising molecular hydrino and then cooling the compound to a temperature (release temperature) at which the molecular hydrino is no longer soluble or stably bound and is released as the free molecular hydrino gas. The release temperature may be a cryogenic temperature such as one in at least one range of about 0.1 K to 272 K, 2 K to 75 K, and 3 K to 150 K. The compound may comprise molecular hydrino such as H₂(1/4) and an oxide or oxyhydroxide such as one comprising at least one of Fe, Zn, Ga, and Ag. The compound may be formed by high current detonation of the corresponding wire in an atmosphere comprising water vapor or by detonation of a shot comprising entrapped water according to the disclosure. In exemplary embodiment, at least one compound comprising molecular hydrino and at least one of (i) Fe and Zn oxide and oxyhydroxide formed by high current detonation of the corresponding metal wire in the presence of water vapor and (ii) silver oxide formed by the air detonation of silver shots comprising water is cooled below liquid nitrogen temperature to release molecular hydrino gas.

In an embodiment, molecular hydrino trapped in, absorbed on, or bonded to a getter or an alloy, oxide or oxyhydroxide is formed by at least one method of (i) wire detonation of metal wire such as ones comprising at least one of silver, Mo, W, Cu, Ti, Ni, Co, Zr, Hf, Ta, and a rare earth according to the disclosure, (ii) ball milling or heating a KOH—KCl mixture, other halide-hydroxide mixtures such as Cu(OH)₂+FeCl₃, other oxyhydroxides such as are AlO(OH), ScO(OH), YO(OH), VO(OH), CrO(OH), MnO(OH) (α-MnO(OH) groutite and γ-MnO(OH) manganite), FeO(OH), CoO(OH), NiO(OH), RhO(OH), GaO(OH), InO(OH), Ni_{1/2}Co_{1/2}O(OH), and Ni_{1/3}Co_{1/3}Mn_{1/3}O(OH), and (iii) operation of the SunCell® according to the disclosure. In the latter case, an additive reactant or getter may be added to the molten metal such as gallium. The additive reactant may form the corresponding alloy, oxide, or oxyhydroxide. An exemplary additive or getter comprises at least one of Ga₂O₃, gallium-stainless steel (SS), iron-gallium, nickel gallium, and chromium-gallium alloys, SS alloy oxides, SS metal, nickel, iron, and chromium. Molecular hydrino may be stored in the getter or material to which it is bound or incorporated by maintaining the getter or material at low temperature such as cryogenic temperature. The cryogenic temperature may be maintained with a cryogen such as liquid nitrogen or CO₂(s).

In an embodiment, molecular hydrino is released as a free gas from an oxide or oxyhydroxide compound comprising molecular hydrino by dissolving the compound in a molten salt such as an alkali or alkaline earth halide or a eutectic mixture of salts such as those given in http://www.crct.polymtl.ca/fact/documentation/FTsalt/FTsalt_Figs.htm which is herein incorporated by reference in its entirety. An exemplary salt mixture with a dissolved oxide is MgCl₂—MgO http://www.crct.polymtl.ca/fact/phase diagram.php?file=MgCl2-MgO.jpg&dir=FTsalt.

In an embodiment, gaseous product collected directly from the SunCell® or gaseous product collected from that released from solid products of the SunCell® are flowed through a recombiner such as a CuO recombiner to remove hydrogen gas, and the enriched hydrino gas is condensed in a valved, sealable cryochamber on a cryofinger or cold stage of a cryopump or in a cryotrap such as a cryotrap comprising solid CO₂ cooled by liquid nitrogen. Molecular hydrino gas may be co-condensed with at least one other gas or absorbed in a co-condensed gas such as one or more of argon, nitrogen, and oxygen that may serve as a solvent. In an exemplary embodiment, gallium oxide collected from the SunCell® following a hydrino reaction run is dissolved in aqueous base such as KOH(aq), and the gasses released comprising hydrino and hydrogen are flowed through a cryotrap comprising solid CO₂ cooled by liquid nitrogen wherein the collected hydrino gas is enriched relative to hydrogen. When sufficient liquid is accumulated, the cryochamber may be sealed and allowed to warn to vaporize the condensed liquid. The resulting gas may be used for industrial or analytical purposes. For example, the gas may be injected through a chamber valve into a gas chromatograph or into a cell for electron beam emission spectroscopy. In an alternative embodiment, the molecular hydrino gas may be directly flowed into the cryofinger chamber and condensed wherein the cryofinger may be operated at a temperature above 20.3 K (the boiling point of H₂ at atm pressure) so that hydrogen is not co-condensed.

In an embodiment wherein molecular hydrino is condensed cryogenically by means such as a cryotrap or cryopump, hydrogen may co-condense in the cryotrap or cryopump at a pressure and temperature outside of the range of pure hydrogen due to presence of molecular hydrino which may increase the hydrogen boiling point. In an embodiment, molecular hydrino gas may be added to hydrogen gas to increase its boiling point for the purpose of storing liquid hydrogen wherein at least one of the energy and equipment required for hydrogen storage are reduced.

In an embodiment, the hydrino reaction mixture further comprises a molecular hydrino getter such as at least one of metals, elements, and compounds such as inorganic compounds such as metal oxides. The molecular hydrino getter may be mixed with the molten metal of the reaction cell chamber and reservoir to serve as a collector, binder, absorber, or getter for molecular hydrino formed in the reaction cell chamber. The molecular hydrino may serve to bind or aggregate the added metal or compound to form particles. Molecular hydrino may serve the same role with metals of an alloy or metal oxides formed from materials that the molten metal contacts such as stainless-steel elements or oxides thereof. The particles may be isolated from the molten metal. The particles may be separated by melting the molten metal comprising the particles and allowing the particles to separate. The particles may float to the top of the mixture during separation and be slimmed from the molten metal surface. Alternatively, more dense particles may sink, and the molten metal may be decanted to enrich the molecular-hydrino-containing particle content of the mixture. The particles may be further purified by methods known in the art such as dissolving the undesired component in a suitable solvent with precipitation of the desired particles. The purification of the particles may also be achieved by recrystallization from a suitable solution. Molecular hydrino gas may be released by heating, cryogenic cooling, acid solubilization, molten salt solubilization, and other methods of the disclosure.

In an embodiment, the buildup of the particles comprising molecular hydrino inhibits the hydrino reaction by means such as product inhibition. The particles may be removed by means such as mechanical means to reduce the reaction rate inhibition.

As described above, the power generation systems of the present disclosure operate via a reaction with unique signatures which may be used to characterize the system. These products may be collected in a variety of different manners such as by using a cryopump or cryotrap. Fractional liquid gas cryogenic distillation columns are rated in terms of plates related to the condensation surface area and number of differential separations. The condensation of hydrino depends on pressure, temperature, dwell time, flow rate, and condensation surface area. In an embodiment, these parameters are controlled to optimize the collection of hydrino gas of a desired purity. In a further embodiment, the cryopump or cryotrap may comprise at least one surface-area enhancer to improve hydrino gas condensation and separation such as at least one of structures such as protrusions and a particulate material with a large surface area such as glass or ceramic beads (sand), a powder such as one comprising an inorganic compound or metal, and a mesh such as a metal cloth, weave, or sponge. The surface-area enhancer may be position inside of a cooled collection cavity or tube of the cryopump or cryotrap such as the cryopump tube. The surface-area enhancer may be selected to avoid blocking the flow of gas at least partially comprising molecular hydrino through the cryopump or cryotrap. In an exemplary embodiment, the cryopump or cryotrap collection vessel or tube comprises a section of a chromatographic column such as a stainless-steel column packed with zeolite or similar gas permeable matrix with a large surface area to condense molecular hydrino.

In an embodiment shown in FIG. 33, a system 500 to form macro-aggregates or polymers comprising lower-energy hydrogen species comprises a chamber 507 such as a Plexiglas chamber, a metal wire 506, a high voltage capacitor 505 with ground connection 504 that may be charged by a high voltage DC power supply 503, and a switch such as a 12 V electric switch 502 and a triggered spark gap switch 501 to close the circuit from the capacitor to the metal wire 506 inside of the chamber 507 to cause the wire to detonate. The chamber may comprise water vapor and a gas such as atmospheric air or a noble gas.

An exemplary system to form macro-aggregates or polymers comprising lower-energy hydrogen species comprises a closed rectangular cuboid Plexiglas chamber having a length of 46 cm and a width and height of 12.7 cm, a 10.2 cm long, 0.22˜0.5 mm diameter metal wire mounted between two Mo poles with Mo nuts at a distance of 9 cm from the chamber floor, a 15 kV capacitor (Westinghouse model 5PH349001AAA, 55 uF) charged to about 4.5 kV corresponding to 557 J, a 35 kV DC power supply to charge the capacitor, and a 12 V switch with a triggered spark gap switch (Information Unlimited, model-Trigatron10, 3 kJ) to close the circuit from the capacitor to the metal wire inside of the chamber to cause the wire to detonate. The wire may comprise a Mo (molybdenum gauze, 20 mesh from 0.305 mm diameter wire, 99.95%, Alpha Aesar), Zn (0.25 mm diameter, 99.993%, Alpha Aesar), Fe—Cr—Al alloy (73%-22%-4.8%, 31 gauge, 0.226 mm diameter, KD Cr—Al—Fe alloy wire Part No #1231201848, Hyndman Industrial Products Inc.), or Ti (0.25 mm diameter, 99.99%, Alpha Aesar) wire. In an exemplary run, the chamber contained air comprising about 20 Torr of water vapor. The high voltage DC power supply was turned off before closing the trigger switch. The peak voltage of about 4.5 kV discharged as a damped harmonic oscillator over about 300 us at a peak current of 5 kA. Macro-aggregates or polymers comprising lower-energy hydrogen species formed in about 3-10 minutes after the wire detonation. Analytical samples were collected from the chamber floor and wall, as well as on a Si wafer placed in the chamber. The analytical results matched the hydrino signatures of the disclosure.

In an embodiment, hydrino gas such as H₂(1/4) may be enriched from the SunCell® by cryro-distillation. Alternatively, hydrino gas may be at least one of formed in situ by maintaining a plasma comprising H₂O such as H₂O in a noble gas such as argon. The plasma may be in a pressure range of about 0.1 mTorr to 1000 Torr. The H₂O plasma may comprise another gas such as a noble gas such as argon. In an exemplary embodiment, atmospheric pressure argon plasma comprising 1 Torr H₂O vapor is maintained by a plasma source such as one of the disclosure such as an electron beam, glow, RF, or microwave discharge source.

In an embodiment, a hydrino species such as molecular hydrino is at least one of suspended and dissolved in a liquid or solvent such as water such that the presence of the hydrino species in the liquid or solvent changes at least one physical property of the liquid or solvent such as at least one of surface tension, boiling point, freezing point, viscosity, spectrum such as infrared spectrum, and rate of evaporation. In an exemplary embodiment, a reaction product of a hydrino reaction product comprising lower-energy hydrogen comprising a white polymeric compound formed by dissolving Ga₂O₃ and gallium-stainless steel metal (˜0.1-5%) alloy collected from a hydrino reaction run in the SunCell® in aqueous KOH, allowing fibers to grow, and float to the surface where they were collected by filtration increases the evaporation of water and changes its FTIR spectrum. In an embodiment, molecular hydrino gas is bubbled through water and is absorbed to change the surface tension to permit the formation of a water bridge between two beakers containing water.

In an embodiment wherein molecular hydrino is condensed cryogenically by mean such as a cryotrap or cryopump, hydrogen may co-condense in the cryotrap or cryopump at a pressure and temperature outside of the range of pure hydrogen due to presence of molecular hydrino which may increase the hydrogen boiling point. In an embodiment, molecular hydrino gas may be added to hydrogen gas to increase its boiling point for the purpose of storing liquid hydrogen wherein at least one of the energy and equipment required for hydrogen storage are reduced.

In embodiment, a hydrino molecular gas laser comprises molecular hydrino gas (H₂(1/p) p=2, 3, 4, 5, . . . , 137) or a source of molecular hydrino gas such as a SunCell®, a laser cavity containing molecular hydrino gas, a source of excitation of rotation energy levels of the molecular hydrino gas, and laser optics. The laser optics may comprise mirrors at the ends of the cavity comprising molecular hydrino gas in excited rotational states. One of the mirrors may be semitransparent to permit the laser light to be emitted from the cavity. The source excitation of at least one H₂(1/p) rotational energy level may comprise at least one of a laser, a flash lamp, a gas discharge system such as a glow, microwave, radio frequency (RF), inductively couples RF, capacitively coupled RF, or other plasma discharge system known in the art. The at least one rotational energy level excited by the source may be a combination of the energy levels given by Eqs. (22-49) of GUTCP and with exemplary energies as illustrated in Example 10. The hydrino molecular laser may further comprise an external or internal field source such as a source of electric or magnetic field to cause at least one desired molecular hydrino rotational energy level to be populated wherein the level may comprise at least one of a desired spin-orbital and fluxon linkage energy shift. The laser transition may occur between an inverted population of a selected rotational state to that of lower energy that is less populated. The laser cavity, optics, excitation source, and external field source are selected to achieve the desired inverted population and stimulated emission to the desired less populated lower-energy state.

Molecular hydrino laser may comprise a solid-state laser. The laser may comprise a solid laser medium such as one comprising molecular hydrino trapped in a solid matrix wherein the hydrino molecules may be free rotors. The solid medium may replace the gas cavity of a molecular hydrino gas laser. The laser may comprise laser optics at the ends of the solid laser medium such as mirrors and a window to support laser light emission from the laser medium. The solid laser medium may be at least partially transparent to the laser light created by the lasing transition of the inverted molecular hydrino population that is resonant with the laser cavity comprising the solid medium. Exemplary solid lasing media are GaOOH:H₂(1/4), KCl:H₂(1/4), and silicon having trapped molecular hydrino such as Si(crystal):H₂(1/4). In each case, the laser wavelength is selected to be transmitted by the solid laser medium.

In an embodiment of a SunCell mesh network comprising a plurality of SunCell-transmitter-receiver nodes that transmit and received electromagnetic signals in at least one frequency band, the frequency of the band may be high frequency due to the ability to position nodes locally with short separation distance. As the number of nodes increases, the spacing node spacing may decrease allowing the adventitious use of higher frequency signals than those used in cell phone or wireless internet transmission and reception due to the shorter separation of the nodes compared to the separation of antennas of the later wherein higher frequency microwave signals have a shorter range. The frequency may be in at least one range of about 0.1 GHz to 500 GHz, 1 GHz to 250 GHz, 1 GHz to 100 GHz, 1 GHz to 50 GHz, and 1 GHz to 25 GHz.

### EXPERIMENTAL

### Example 1: SunCell® Operation

The SunCell® shown in FIG. 25 was manufactured and well insulated with silica-alumina fiber insulation, 2500 sccm H₂ and 250 sccm O₂ gases were flowed over Pt/Al₂O₃ beads. The SunCell® was heated to a temperature in the range of 900° C. to 1400° C. With continued maintenance of the H₂ and O₂ flow and EM pumping, the plasma forming reaction self-sustained in the absence of ignition power as evidenced by an increase in the temperature over time in the absence of the input ignition power.

### Example 2: SunCell® Operation

A quartz SunCell® with two crossed EM pump injectors such as the SunCell® shown in FIG. 10 was manufactured and operated to create a sustainable plasma forming reaction. Two molten metal injectors, each comprising an induction-type electromagnetic pump comprising an exemplary Fe based amorphous core, pumped Galinstan streams such that they intersected to create a triangular current loop that linked a 1000 Hz transformer primary. The current loop comprised the streams, two Galinstan reservoirs, and a cross channel at the base of the reservoirs. The loop served as a shorted secondary to the 1000 Hz transformer primary. The induced current in the secondary maintained a plasma in atmospheric air at low power consumption. Specifically, (i) the primary loop of the ignition transformer operated at 1000 Hz, (ii) the input voltage was 100 V to 150 V, and (iii) the input current was 25 Å. The 60 Hz voltage and current of the EM pump current transformer were 300 V and 6.6 Å, respectively. The electromagnet of each EM pump was powered at 60 Hz, 15-20 A through a series 299 g capacitor to match the phase of the resulting magnetic field with the Lorentz cross current of the EM pump current transformer. The transformer was powered by a 1000 Hz AC power supply.

### Example 3: SunCell® Operation

A Pyrex SunCell® with one EM pump injector electrode and a pedestal counter electrode with a connecting jumper cable 414a between them was manufactured similar to the SunCell® shown in FIG. 29. The molten metal injector comprising a DC-type electromagnetic pump, pumped a Galinstan stream that connected with the pedestal counter electrode to close a current loop comprising the stream, the EM pump reservoir, and the jumper cable connected at each end to the corresponding electrode bus bar and passing through a 60 Hz transformer primary. The loop served as a shorted secondary to the 60 Hz transformer primary. The induced current in the secondary maintained a plasma in atmospheric air at low power consumption. The induction ignition system is enabling of a silver-or-gallium-based-molten-metal SunCell® power generator of the disclosure wherein reactants are supplied to the reaction cell chamber according to the disclosure. Specifically, (i) the primary loop of the ignition transformer operated at 60 Hz, (ii) the input voltage was 300 V peak, and (iii) the input current was 29 A peak. The maximum induction plasma ignition current was 1.38 kA.

### Example 4: SunCell® Operation

A reaction cell chamber was maintained at a pressure range of about 1 to 2 atm with 4 ml/min H₂O injection. The DC voltage was about 30 V and the DC current was about 1.5 kA. The reaction cell chamber was a 6-inch diameter stainless steel sphere such as one shown in FIG. 25 that contained 3.6 kg of molten gallium. The electrodes comprised a 1-inch submerged SS nozzle of a DC EM pump and a counter electrode comprising a 4 cm diameter, 1 cm thick W disc with a 1 cm diameter lead covered by a BN pedestal. The EM pump rate was about 30-40 ml/s. The gallium was polarized positive with a submerged nozzle, and the W pedestal electrode was polarized negative. The gallium was well mixed by the EM pump injector. The SunCell® output power was about 85 kW measured using the product of the mass, specific heat, and temperature rise of the gallium and SS reactor.

### Example 5: SunCell® Operation

2500 sccm of H₂ and 25 sccm O₂ was flowed through about 2 g of 10% Pt/Al₂O₃ beads held in an external chamber in line with the H₂ and O₂ gas inlets and the reaction cell chamber. Additionally, argon was flowed into the reaction cell chamber at a rate to maintain 50 Torr chamber pressure while applying active vacuum pumping. The DC ignition voltage was about 20 V and the DC current was about 1.25 kA. The SunCell® output power was about 120 kW measured using the product of the mass, specific heat, and temperature rise of the gallium and SS reactor.

### Example 6: SunCell® Operation

A SunCell comprising an 8 inch diameter 4130 Cr—Mo SS cell with a Mo liner along the reaction cell chamber wall using a glow discharge hydrogen dissociator and recombiner similar to the power generation system illustrated in FIG. 26. Theglow discharge was connected directly the flange 409a of the reaction cell chamber by a 0.75 inch OD set of Conflat flanges, the glow discharge voltage was 260 V; the glow discharge current was 2 Å; the hydrogen flow rate was 2000 sccm; the oxygen flow rate was 1 sccm; the operating pressure was 5.9 Torr; the gallium temperature was maintained at 400° C. with water bath cooling; the ignition current and voltage were 1300 A and 26-27V; the EM pump rate was 100 g/s, and the output power was over 300 kW for an input ignition power of 29 kW corresponding to a gain of at least 10 times.

### Example 7: SunCell® Operation

A reaction cell chamber was maintained at a pressure range of about 1 Torr to 20 Torr while flowing 10 sccm of H₂ and injecting 4 ml of H₂O per minute while applying active vacuum pumping. The DC voltage was about 28 V and the DC current was about 1 kA. The reaction cell chamber was a SS cube with edges of 9-inch length that contained 47 kg of molten gallium. The electrodes comprised a 1-inch submerged SS nozzle of a DC EM pump and a counter electrode comprising a 4 cm diameter, 1 cm thick W disc with a 1 cm diameter lead covered by a BN pedestal. The EM pump rate was about 30-40 ml/s. The gallium was polarized positive and the W pedestal electrode was polarized negative. The SunCell® output power was about 150 kW measured using the product of the mass, specific heat, and temperature rise of the gallium and SS reactor.

### Example 8: SunCell® Operation

A SunCell with a 6-inch diameter spherical cell comprising Galinstan as the molten metal was manufactured. The plasma forming reaction was supplied with 750 sccm H₂ and 30 O₂ sccm mixed in an oxyhydrogen torch and flowed through a recombiner chamber comprising 1 g of 10% Pt/Al₂O₃ at greater than 90° C. before flowing into the cell. In addition, the reaction cell chamber was supplied with 1250 sccm of H₂ that was flowed through a second recombiner chamber comprising 1 g of 10% Pt/Al₂O₃ at greater than 90° C. before flowing into the cell. Each of the three gas supplies was controlled by a corresponding mass flow controller. The combined flow of H₂ and O₂ provided nascent HOH catalyst and atomic H, and the second H₂ supply provided additional atomic H. The reaction plasma was maintained with a DC input of about 30-35 V and about 1000 A. The input power measured by VI integration was 34.6 kW, and the output power of 129.4 kW was measured by molten metal bath calorimetry wherein the gallium in the reservoir and the reaction cell chamber served as the bath.

### Example 9: SunCell® Operation

A SunCell with a 4 inch-sided cell preloaded with 2500 sccm H₂ and 70 sccm O₂ and comprising a Ta liner on the walls of the reaction cell chamber was manufactured and operated. A current in the range of 3000 A to 1500 A was supplied by a capacitor bank charged to 50 V was supplied to ignite the plasma forming reaction. The capacitor bank comprised 3 parallel banks of 18 capacitors (Maxwell Technologies K2 Ultracapacitor 2.85V/3400F) in series that provided a total bank voltage capability of 51.3V with a total bank capacitance of 566.7 Farads. The input power was 83 kW, and the output power was 338 kW. The 6-inch diameter spherical cell supplied with 4000 sccm H₂ and 60 sccm O₂, a current in the range of 3000 A to 1500 A was supplied by the capacitor bank charged to 50 V. The input power was 104 kW, and the output power was 341 kW.

### Example 10: Spectroscopic Measurements

Several of the hydrino spectroscopic signatures were confirmed by experiments as described in WO 2020/148709 which is hereby incorporated in its entirety. It will be understood that these spectroscopic signatures may be found in the reaction products of the plasma forming reactions described herein. An extensive array of spectroscopic and energetic signature measurements are provided herein.

EPR and Raman spectroscopy recorded on GaOOH:H₂(1/4):H₂O formed by a hydrogen reaction as well as electron beam emission spectroscopy recorded on gas released by thermal decomposition of GaOOH:H₂(1/4):H₂O dispositively confirmed that the compound comprised spectral features of H₂(1/4), and the gas was identified as H₂(1/4) gas. The EPR peaks were each assigned to a spin flip transition with spin-orbital splitting and fluxon linkage splitting. Both the Raman and e-beam spectra show the same splitting, except the Raman involved a rotational principal transition. It is remarkable, that the Raman lines recorded on GaOOH:H₂(1/4):H₂O match those of DIBs. The assignment of all of the 380 DIBs listed by L. M. Hobbs, et al. Astrophysical Journal 680 (2008): 1256-1270 has been made to H₂(1/4) rotational transitions with spin-orbital splitting and fluxon sub-splitting.

Another signature characteristic of the nascent HOH and atomic hydrogen reaction mechanism is the observation of extraordinarily fast H produced from the reaction. Plasmas from sources such as glow, RF, and microwave discharges that are ubiquitous in diverse applications ranging from light sources to material processing are now increasingly becoming the focus of a debate over the explanation of the results of ion-energy-characterization studies on specific hydrogen “mixed gas' plasmas. In mixtures of argon and hydrogen, the hydrogen emission lines are significantly broader than any argon line.

Historically, mixed hydrogen-argon plasmas have been characterized by determining the excited hydrogen atom energies from measurements of the line broadening of one or more of the Balmer α, β, and lines of atomic hydrogen at 656.28, 486.13, and 434.05α, respectively. Broadened Balmer lines have been explained in terms of Doppler broadening due to the various models involving acceleration of charges such as H⁺, H₂⁺, and H₃⁺ in the high fields (e.g., over 10 kV/cm) present in the cathode fall region herein called field-acceleration models (FAM). However, the field-acceleration mechanism, which is directional, position dependent, and is not selective of any particular ion cannot explain the Gaussian Doppler distribution, position independence of the fast H energy, absence of the broadening of the molecular hydrogen and argon lines, gas composition dependence of the hydrogen mixed plasma, and is often not internally consistent or consistent with measured densities and cross sections.

The energetic chemical reactions of the present disclosure of hydrogen as the source of broadening explains all of the aspects of the atomic H line broadening such as lack of an applied-field dependence, the observation that only particular hydrogen-mixed plasmas show the extraordinary broadening. Specifically, nascent HOH and mH can serve to form fast protons and electrons from ionization to conserve the m27.2 eV energy transfer from H. These fast ionized protons recombine with free electrons in excited states to emit broadened H lines as described in Akhtar, et al. J Phys D: App. Phys 42 (2009): 135207, Mills, et al. Int. J. Hydrogen Energy 34 (2009): 6467, and Mills et al. Int. J Hydrogen Energy 33 (2008): 802. Of the noble gases, HOH is uniquely present in argon-H₂ plasmas because oxygen is co-condensed with argon during purification from air, and H catalyst is present in hydrogen plasmas from dissociation of H₂. Water vapor plasmas also show extreme selective broadening of over 150 eV [51, 52, 55] and further show atomic hydrogen population inversion [58-60] also due to free electron-hot-proton recombination following resonant energy transfer from atomic hydrino to HOH catalyst.

An extensive array of additional spectroscopic and energetic signature measurements of hydrogen products are presented herein that match the theoretical hydrino state of hydrogen. These “hydrino signals” cannot be assigned to any known species since they have one or more extraordinary features such as (i) the signals are outside of an energy range of those of known species, (ii) the signals have a physical characteristic unique to hydrino, there is an absence of other signatures that are required for the alternative assignment, or hydrino has an alternative combination of signatures absent that of known species, (iii) the signature is totally novel, and (iv) in the exemplary case of energetics, the energy or power-related signature is much greater than that of a known species, an alternative explanation does not exist, or an alternative is eliminated upon further investigation.

### Parameters and Magnetic Energies Due to the Spin Magnetic Moment of H₂(1/4)

The model of the atom predicted the theoretical existence of the hydrino, or energy states of the hydrogen atom that exist below the −13.6 eV energy state of atomic hydrogen. Akin to the case of molecular hydrogen, two hydrino atoms may react to form molecular hydrino. Based on the theory, molecular hydrino H₂(1/p) comprises (i) two electrons bound in a minimum energy, equipotential, prolate spheroidal, two-dimensional current membrane comprising a molecular orbital (MO), (ii) two Z=1 nuclei such as two protons at the foci of the prolate spheroid, and (iii) a photon wherein the photon equation of each state is different from that of an excited H₂ state in that the photon increases the central field by an integer rather than decreasing the central prolate spheroidal field to that of a reciprocal integer of the fundamental charge at each nucleus centered on the foci of the spheroid, and the electrons of H₂(1/p) are superimposed in the same shell at the same position versus being in separate positions. The interaction of the integer hydrino state photon electric field with each electron of the MO, electron 1 and electron 2, gives rise to a nonradiative radial monopole such that the state is stable. To meet the boundary conditions that each corresponding photon is matched in direction with each electron current and that the electron angular momentum is h are satisfied, one half of electron 1 and one half of electron 2 may be spin up and matched with the two photons of the two electrons on the MO, and the other half of electron 1 may be spin up and the other half of electron 2 may be spin down such that one half of the currents are paired and one half of the currents are unpaired. Thus, the spin of the MO is ½(↑↑+↓↑) where each arrow designates the spin vector of one electron. The two photons that bind the two electrons in the molecular hydrino state are phase-locked to the electron currents and circulate in opposite directions. Given the indivisibility of each electron and the condition that the MO comprises two identical electrons, the force of the two photons is transferred to the totality of the electron MO comprising a linear combination of the two identical electrons to satisfy the central force balance. The resulting angular momentum and magnetic moment of the unpaired current density are ℏ and a Bohr magneton μ_{B}, respectively.

Due to its unpaired electron, molecular hydrino is electron paramagnetic resonance (EPR) spectroscopy active. Moreover, due to the unpaired electron in a common molecular orbital with a paired electron, the EPR spectrum is uniquely characteristic and may identify molecular hydrino as described in Hagen, et al. “Distinguishing Electron Paramagnetic Resonance Signature of Molecular Hydrino,” Nature, in progress, which is hereby incorporated by reference in its entirety.

The predicted EPR spectrum was confirmed experimentally as shown in Hagen. A 9.820295 GHz EPR spectrum was performed on a white polymeric compound identified by X-ray diffraction (XRD), energy-dispersive X-ray spectroscopy (EDS), transmission electron spectroscopy (TEM), scanning electron microscopy (SEM), time-of-flight secondary ionization mass spectroscopy (ToF-SIMs), Rutherford backscattering spectroscopy (RBS), and X-ray photoelectron spectroscopy (XPS) as GaOOH:H₂ (1/4).

Briefly, the GaOOH:H₂(1/4) was formed by dissolving Ga₂O₃ and gallium-stainless steel metal (˜0.1-5%) alloy collected from a reaction run in a SunCell® in 4M aqueous KOH, allowing fibers to grow, and float to the surface where they were collected by filtration. The white fibers were not soluble in concentrated acid or base, whereas control GaOOH is. No white fibers formed in control solutions. Control GaOOH showed no EPR spectrum. The experimental EPR shown in FIGS. 34A-C was acquired by Professor Fred Hagen, TU Delft, with a high sensitivity resonator at a microwave power of −28 dB and a modulation amplitude of 0.02 G, that can be changed to 0.1 G. The average error between EPR spectrum and theory for peak positions given in Table 4 was 0.097 G. The EPR spectrum was replicated by Bruker (Bruker Scientific LLC, Bileria, Mass.) using two instruments on two samples as shown in FIGS. 34A-C.

These measured EPR signals match those theoretically predicted for hydrinos. Specifically, the observed principal peak at g=2.0045(5)) can be assigned to the theoretical peak having a g-factor of 2.0046386. This principal peak was split into a series of pairs of peaks with members separated by energies matching E_{S/O} corresponding to each electron spin-orbital coupling quantum number m. The results confirmed the spin-orbital coupling between the spin magnetic moment of the unpaired electron and an orbital diamagnetic moment induced in the paired electron alone or in combination with rotational current motion about the semimajor molecular axis that shifted the flip energy of the spin magnetic moment. The data further matched the theoretically predicted one-sided tilt of the spin-orbital splitting energies wherein the downfield shift was observed to increase with quantum number m due to the magnetic energies U_{S/OMag} of the corresponding magnetic flux linked during a spin-orbital transition.

The EPR spectrum recorded at different frequencies showed that the peak assigned the g factor of 2.0046386 remained at constant g factor. Moreover, the peaks, shifted by the fixed spin-orbital splitting energies relative to this true g-factor peak, exactly maintained the separation of the spin-orbital splitting energies independent of frequency as predicted. The GaOOH:H₂(1/4) EPR spectrum recorded at Delft University showed remarkably narrow line widths due to the dilute presence of H₂(1/4) molecules trapped in GaOOH cages that comprised a diamagnetic matrix. The structure of GaOOH:H₂ (1/4) and electronic state of H₂ (1/4) permitted the observations of unprecedented low splitting energies that are between 1000 and 10,000 times smaller than the H Lamb shift. The pattern of integer-spaced peaks predicted for the EPR spectrum very similar to that experimentally observed on the hydrino hydride ion shown as described in Mills et al. Int. J Hydrogen Energy 28 (2003): 825, Mills et al. Cent Eur J Phys 8 (2010): 7, Mills et al. J Opt Mat 27 (2004): 181, and Mills, et al. Res J Chem Env 12 (2008): 42, and WO 2020/0148709 (see, e.g., FIG. 61) each of which are incorporated by reference in their entirety—with the exception that the orbital is an atomic orbital in these references.

The EPR spectrum showing the principal peak with an assigned g-factor of 2.0046386 and fine structure comprising spin-orbital and spin-orbital magnetic energy splitting with fluxon sub-splitting was observed superimposed on a broad background feature with a center at about the position of the principal peak. It was observed that the fine structure features broadened into a continuum that overlaid the broad background feature as the temperature was lowered into a cryogenic range with the peak assigned to the downfield member corresponding to the electron spin-orbital coupling quantum number m=0.5 being less sensitive to a decrease in temperature than the corresponding upfield peak. The same trend was also observed with increasing microwave power wherein the higher energy transition saturated at a higher power. Thus, the peak assigned to downfield member corresponding to the electron spin-orbital coupling quantum number m=0.5 was selectively observed over the corresponding upfield peak. The higher sensitivity of the upfield peak to low temperature and microwave power is excepted since it corresponds to de-excitation of a spin-orbital energy level during the spin flip transition wherein the spin-orbital energy level requires thermal excitation to be populated. Thus, the population decreases with temperature due to a decreased source of thermal excitation, and the population is smaller than the unexcited population so that it is more easily depleted with microwave power.

Additionally, the GaOOH:H₂(1/4) sample was observed by TEM to comprise two different morphological and crystalline forms of GaOOH. Observed morphologically polymeric crystals comprising hexagonal crystalline structure were very sensitive to the TEM electron beam, whereas rods having orthorhombic crystalline structure were not electron beam sensitive. The latter crystals' morphology and crystalline structure matches those of the literature for control GaOOH that lacks molecular hydrino inclusion. The hexagonal phase is likely the source of the fine structure EPR spectrum and the orthorhombic phase is likely the source of the broad background EPR feature. Cooling may selectively eliminate, e.g., by microwave power saturation, the observed near free-gas-like EPR spectral behavior of H₂(1/4) trapped in the hexagonal crystalline matrix. Any deviations from theory could be due to the influence of the proton of GaOOH and those of water. Also, matrix orientation in the magnetic field, matrix interactions and interactions between one or more H₂(1/4) could cause some shifts.

Deuterium substitution was performed to eliminate an alternative assignment of any EPR spectral lines as being nuclear split lines. The power released from power generation systems when H₂ was replaced by D₂ was decreased by at least 1/3. The deuterated analog of GaOOH:H₂(1/4), GaOOH:HD(1/4), was confirmed by Raman spectroscopy as shown as discussed below wherein GaOOH:HD(1/4) was also formed by using D₂O in the plasma forming reaction. The deuterated analog required a month to form from 4 M potassium hydroxide versus under three days for GaOOH:H₂(1/4). The EPR spectrum of the deuterated analog shown in FIG. 5 only showed a singlet with no fine structure.

The g factor and profile matched that of the singlet of GaOOH:H₂(1/4) wherein the singlet in both cases was assigned to the orthorhombic phase. The XRD of the deuterated analog matched that of the hydrogen analog, both comprising gallium oxyhydroxide. TEM confirmed that the deuterated analog comprised 100% orthorhombic phase. The phase preference of the deuterated analog may be due to a different hydrino concentration and kinetic isotope effect which could have also reduced the concentration.

The unpaired electron of molecular hydrino may give rise to non-zero or finite bulk magnetism such as paramagnetism, superparamagnetism and even ferromagnetism when the magnetic moments of a plurality of hydrino molecules interact cooperatively. Matrix magnetism manifest as an upfield shifted matrix peak due to the magnetism of molecular hydrino was also observed by ¹H MAS nuclear magnetic resonance spectroscopy (NMR) (see Mills et al. Int. J. Hydrogen Energy 39 (2014): 11930, hereby incorporated by reference in its entirety, and superparamagnetism was observed using a vibrating sample magnetometer to measure the magnetic susceptibility of compounds comprising molecular hydrino.

### Raman Measurements on Hydrogen Products Produced During SunCell® Operation

Raman samples of H₂ (1/4) absorbed on metallic surfaces and in metallic and ionic lattices by magnetic dipole and van der Waals forces were produced by (i) high voltage electrical detonation or Fe wires in an atmosphere comprising water vapor, (ii) low voltage, high current electrical detonation of hydrated silver shots, (iii) ball milling or heating FeOOH and hydrated alkali halide-hydroxide mixtures, and (iv) maintaining a plasma reaction of atomic H and nascent HOH in a power generation system as described herein (see, e.g., FIGS. 16.19A and 16.19B) comprising a molten gallium injector that electrically shorts two plasma electrodes with the molten gallium to maintain an arc current plasma state. Excess power of over 300 kW was measured by water and molten metal bath calorimetry. Raman spectra were recorded on these materials using the Horiba Jobin Yvon LabRAM Aramis Raman spectrometer with (i) a 785 nm laser, (ii) a 442 nm laser, and (iii) a HeCd 325 nm laser in microscope mode with a magnification of 40×.

Nickel foil Raman samples were prepared by flowing a reaction mixture comprising 2000 standard cubic centimeters per minute (sccm) H₂ and 1 sccm O₂ into a one-liter reaction volume SunCell® shown in FIGS. 16.19A and 16.19B. The SunCell® comprised an 8-inch diameter 4130 Cr—Mo steel cell with a Mo liner along the reaction cell chamber wall. The SunCell® further comprised molten gallium in a reservoir, an electromagnet pump that served as an electrode and pumped the gallium vertically against a W counter electrode, a low-voltage-high-current ignition power source that maintained a hydrino reaction plasma by maintaining a high current between the electrodes, and a glow discharge hydrogen dissociator and recombiner connected directly to the top flange of the SunCell® reaction cell chamber by a 0.75-inch OD set of Conflat flanges. The glow discharge voltage was 260 V. The glow discharge current was 2 Å. The operating pressure was 5.9 Torr. The gallium temperature was maintained at 400° C. with water bath cooling. Arc plasma was maintained by an ignition current of 1300 A at a voltage of 26-27 V. The electromagnetic pump rate was 100 g/s, and the output power was over 300 kW for an input ignition power of 29 kW corresponding to a gain of 10 times. The Ni foils (1×1×0.1 cm) to make the Raman samples were placed in the molten gallium. The reaction was run for 10 minutes, and the cloth-wipe-cleaned surfaces of the foils were analyzed by Raman spectroscopy using a Horiba Jobin Yvon LabRAM Aramis Raman spectrometer with (i) a 785 nm laser and (ii) a 442 nm laser, and a Horiba Jobin-Yvon Si CCD detector (Model number DU420A-OE-324) and a 300 line/mm grating.

The Raman spectrum (2500 cm⁻¹ to 11,000 cm⁻′) obtained using a Horiba Jobin Yvon LabRam ARAMIS spectrometer with a 785 nm laser on a Ni foil prepared by immersion in the molten gallium of a SunCell® that maintained a plasma reaction for 10 minutes is shown in FIGS. 36A-C. The energies E_{Raman} of all of the novel lines matched either:

(i) the pure H₂ (1/4) J′=3 rotational transition with spin-orbital coupling energy and fluxon linkage energy; or

(ii) the concerted transition comprising the J=0 to J′=2, 3 rotational transitions with the J=0 to J=1 spin rotational transition; or

(iii) the double transition for final rotational quantum numbers J′ₚ=2 and J′_{c}=1 with energies given by the sum of the independent transitions.

The use of the combination of a Si CCD detector with a detection energy range of about 4000 cm⁻¹ with a 785 nm laser wherein the photon energy plus the laser heating energy is capable of exciting rotational emission with an upper energy limit of about 14,500 cm⁻¹ enables the detection of sets of multi-order emission spectral lines within spectral windows that very nearly match the ranges of separations of the 785 nm multi-order laser lines. The laser multi-order lines are observed in 2^{nd}, 3^{rd}, 4^{th}, 5^{th}, and 6^{th} order at energies E_{Raman,order m} of 6371, 8495, 9557, 10,193, 10,618 cm⁻¹, respectively (FIGS. 36A-C) wherein all of the 785 nm laser multi-order lines have a photon energy of 12,742 cm⁻¹ (1.58 eV).

$${E}_{Raman , order m} = 12 , 742 ( 1 - \frac{1}{m} ) {cm}^{- 1} ; m = 2 , 3 , 4 , 5 , 6 , …$$

The assignments to sets of multi-order emission spectral lines within specific spectral ranges corresponding to the laser excitation energy range and the detector range matches the decrease in energy separation between members of one set versus the members of the next higher energy, higher order set and the decrease in line intensities between members of a given set as the wavenumber increases (FIGS. 36A-C).

The Raman peaks assigned to H₂ (1/4) rotational transitions in Table 7B have also been observed on hydrated silver shots that were detonated with a current of about 35,000 A as well as SunCell® gallium and Cr, Fe, and stainless-steel foils immersed in the gallium wherein the Raman spectra were run post a SunCell® plasma reaction as in the case of the Ni foils. Raman spectra on pure gallium samples as a function of depth showed that the Raman peaks decreased in intensity with depth and were only found in trace on the negatively polarized W electrode which confirmed previous observations that the hydrino reaction occurs in the plasma at the surface and proximal space above the positive electrode, the positively polarized molten gallium in this case. This is consistent with the rate-increasing mechanism of recombining ions and electrons to decrease the space charge caused by the energy transfer to the catalyst and its consequent ionization.

Spectroscopic signatures of H₂ (1/4) were also observed as a product of the SunCell® reaction by collection and purification of a reaction product from the molten gallium of the SunCell® following an energy generation run. Specifically, a 10-minute-duration reaction plasma run was maintained in the SunCell®, and a white polymeric compound (GaOOH:H₂(1/4)) was formed by dissolving Ga₂O₃ and gallium-stainless steel metal alloy (˜0.1-5%) collected from the SunCell® gallium post run in aqueous 4M KOH, allowing fibers to grow, and float to the surface where they were collected by filtration. The Raman spectrum (2200 cm⁻¹ to 11,000 cm⁻′) shown in FIG. 37A was obtained using a Horiba Jobin Yvon LabRam ARAMIS spectrometer with a 785 nm laser on the GaOOH:H₂(1/4). All of the novel lines matched those of either (i) the pure H₂ (1/4) J=0 to J′=3 rotational transition, (ii) the concerted transitions comprising the J=0 to J′=2,3 rotational transitions with the J=0 to J=1 spin rotational transition, or (iii) the double transition for final rotational quantum numbers J′ₚ=2 and J′_{c}=1. Corresponding spin-orbital coupling and fluxon coupling were also observed with the pure, concerted, and double transitions. The peaks matched the peaks measured in the previous Raman experiments, except that a second set of peaks was additionally observed, shifted 150 cm⁻¹ relative to the set observed on Ni foil (FIGS. 36A-C). This is likely due to the presence of two phases of GaOOH:H₂(1/4) that was confirmed by XRD and TEM and was the source of two distinct spectra in the EPR.

Using a Horiba Jobin Yvon LabRam ARAMIS with a 785 nm laser, the Raman spectrum was recorded on copper electrodes post ignition of a 80 mg silver shot comprising 1 mole % H₂O wherein the detonation was achieved by applying a 12 V 35,000 A current with a spot welder. A peak optical power of extreme ultraviolet emission was 20 MW. The Raman spectrum (2200 cm⁻¹ to 11,000 cm⁻¹) is shown in FIG. 37B.

HD(1/4) product of the SunCell® was formed by propagating a reaction in the SunCell® with 250 μl of D₂O injected into the reaction cell chamber every 30 seconds replacing the H₂ and O₂ gas mixture as the source of atomic hydrogen and HOH catalyst. A 10-minute-duration reaction plasma run was maintained in the SunCell®, and a white polymeric compound (GaOOH:HD(1/4)) was formed by dissolving Ga₂O₃ and gallium-stainless steel metal alloy (˜0.1-5%) collected from the SunCell® gallium post run in aqueous 4M KOH, allowing fibers to grow, and float to the surface where they were collected by filtration.

The Raman spectrum (2500 cm⁻¹ to 11,000 cm⁻¹) was obtained using a Horiba Jobin Yvon LabRam ARAMIS spectrometer with a 785 nm laser GaOOH:HD(1/4) (FIGS. 38A-C). The Raman peaks clearly shifted with deuterium substitution as evident by comparison of the spectrum of pure hydrogen molecular hydrino (FIGS. 36A-C) and the spectrum of the deuterated molecular hydrino shown in FIGS. 38A-C. In the latter case, the energies E_{Raman} of all of the novel lines matched either:

(i) the pure H₂ (1/4) J′=3, 4 rotational transition with spin-orbital coupling energy and fluxon linkage energy;

(ii) the concerted transitions comprising the J=0 to J′=3 rotational transitions with the J=0 to J=1 spin rotational transition with corresponding spin-orbital coupling energy;

(iii) the double transition for final rotational quantum numbers J′ₚ=3; J′_{c}=1.

Infrared spectroscopic rotational transitions are forbidden for symmetrical diatomic molecules with no electric dipole moment. However, since molecular hydrino uniquely possesses an unpaired electron, the application of a magnetic field to align the magnetic dipole of molecular hydrino is a means to break the selection rules to permit a novel transition in H₂(1/4), in addition to the effect of an intrinsic magnetic field of a sample. Concerted rotation and spin-orbital coupling is another mechanism for permitting otherwise forbidden transitions. Using the absorbance mode of a Thermo Scientific Nicolet iN10 MX spectrometer equipped with a cooled MCT detector, FTIR analysis was performed on solid-sample pellets of GaOOH:H₂(1/4) (GaOOH impregnated with hydrogen products produced from SunCell operation) with the presence and absence of an applied magnetic field using a Co—Sm magnet having a field strength of about 2000 G. The spectrum shown in FIG. 39A shows that the application of the magnetic field gave rise to an FTIR peak at 4164 cm⁻¹ which is a match to the concerted rotational and spin-orbital transition J=0 to J′=1, m=0.5. Other than H₂ which is not present in the sample, there is no known assignment due to the high energy of the peak. In addition, a substantial increased intensity of a sharp peak at 1801 cm⁻¹ was observed. This peak was is not observed in the FTIR of control GaOOH. The peak matched the concerted rotational and spin-orbital transition J=0 to J′=0, m=−0.5, m_{Φ3/2}=2.5. A higher sensitivity scale of the 4000-8500 cm⁻¹ region (FIG. 39B) shows additional peaks at (i) 4899 cm⁻¹ that matched the concerted rotational and spin-orbital transition J=0 to J′=1, m=2, m_{Φ3/2}=−1; (ii) 5318 cm⁻¹ that matched the pure rotational and spin-orbital transition J=0 to J′=2, m=−1, and (iii) 6690 cm⁻¹ that matched the pure rotational and spin-orbital transition J=0 to J′=2, m=1.5, m_{Φ}=1.5.

The influence of magnetic materials on the selection rules to observe molecular hydrino rotational transitions involving interaction with the free electron was investigated. Raman samples comprising solid web-like fibers were prepared by wire detonation of an ultrahigh purity Fe wire in a rectangular cuboid Plexiglas chamber having a length of 46 cm and a width and height of 12.7 cm.

A 10.2 cm long, 0.25 mm diameter Fe metal wire (99.995%, Alfa Aesar #10937-G1) was mounted between two Mo poles with Mo nuts at a distance of 9 cm from the chamber floor, a 15 kV capacitor (Westinghouse model 5PH349001AAA, 55 μF) was charged to about 4.5 kV corresponding to 557 J by a 35 kV DC power supply, and a 12 V switch with a triggered spark gap switch (Information Unlimited, model-Trigatron10, 3 kJ) was used to close the circuit from the capacitor to the metal wire inside of the chamber to detonate the wire. The detonation chamber contained air comprising 20 Torr of water vapor controlled by a humidifier and a water vapor sensor. The water vapor served as a source of HOH catalyst and atomic H to form molecular hydrino H₂ (1/4). The high voltage DC power supply was turned off before closing the trigger switch. The peak voltage of about 4.5 kV was discharged as a damped harmonic oscillator over about 300 μs at a peak current of 5 kA. Web-like fibers formed in about 3-10 minutes after the wire detonation. Analytical samples were collected from the chamber floor and walls, as well as on a Si wafer placed in the chamber. Raman spectra were recorded on the web material using the Horiba Jobin Yvon LabRAM Aramis Raman spectrometer with a HeCd 325 nm laser in microscope mode with a magnification of 40× or with a 785 nm laser.

The Raman spectra obtained using a Horiba Jobin Yvon LabRam ARAMIS spectrometer with a 785 nm laser on solid web-like fibers prepared by wire detonation of an ultrahigh purity Fe wire in air maintained with 20 Torr of water vapor are shown in FIGS. 40A and 40B. As shown in the 3420 cm⁻¹ to 4850 cm⁻¹ Raman spectral region (FIG. 40A), a periodic series of peaks was observed. The series of peaks was confirmed to originate from the sample by treating the Fe-web:H₂(1/4) sample with HCl. As shown in FIG. 40A, all of the Raman peaks were eliminated by the acid treatment of the Fe-web sample by reaction of iron oxides, iron oxyhydroxide, and iron hydroxide species of the sample to form FeCl₃ and H₂O. Similarly, KCl also showed no peaks over this spectral range further demonstrating that the periodic peaks were not due to an etalon or other artifact of the optics. It was confirmed by the manufacturer, Horiba Instruments, Inc., that the infrared CCD detector (Horiba Aramis Raman spectrometer with a Synapse CCD camera Model: 354308, S/N: MCD-1393BR-2612, 1024×256CCD Front Illuminated Open Electrode) is front illuminated which also precludes the possibility of an etalon artifact. Due to the extraordinary high energies, the transitions cannot be assigned to any prior known compound.

### Example 11: Water Bath Calorimetry (WBC)

The power balances of SunCells® were independently measured by three experts using molten metal bath and water bath calorimetry. Molten metal calorimetry tests were performed on four-inch cubical or six-inch spherical stainless-steel plasma cells, each incorporating an internal mass of liquid gallium or Galinstan which served as a molten metal bath for calorimetric determination of the power balance of a plasma reaction maintained in the plasma cell. The molten metal also acted as cathode in formation and operation of the very-low voltage, high-current plasma while a tungsten electrode acted as the anode when electrical contact was made between the electrodes by electromagnetic pump injection of the molten metal from the cathode to anode. The plasma formation depended on the injection of either 2000 sccm H₂/20 sccm O₂ or 3000 sccm H₂/50 sccm O₂. The excess powers in the range of 197 kW to 273 kW with gains in the range of 2.3 to 2.8 times the power to maintain the hydrogen plasma reactions are given in the Tables 17-18. There was no chemical change observed in cell components as determined by energy dispersive X-ray spectroscopy (EDS). The power from the combustion of the H₂/1% O₂ fuel and HOH catalyst source was negligible (16.5 W for 50 sccm O₂ flow) and occurred outside of the cell. Thus, the theoretical maximum excess power from conventional chemistry was zero.

Water bath calorimetry (WBC) can be a highly accurate method of energy measurement due to its inherent ability for complete capture and precise qualification of the released energy. However, submersion of the SunCell® in a water bath lowers its wall temperature significantly relative to operation in air. The hydrino reaction rate increases with temperature, current density, and wall temperature wherein the latter facilitates a high molecular hydrino permeation rate through the wall to avoid product inhibition. In order to evaluate the absolute output energy produced by SunCells® while maintaining favorable operating conditions of high gallium and wall temperatures, the cell was operated suspended on a cable for the duration of a power production phase, and then the cell was lowered into a water bath using an electric winch. The thermal inventory of the entire submerged cell assembly was transferred to the water bath in the form of an increase in the water temperature and steam production. Following equilibration of the cell temperature to that of the water bath, the cell was hoisted from the water bath and the increase in thermal inventory of the water bath was quantified by recording the bath temperature rise and the water lost to steam by measuring the water weight loss. The water bath calorimetry comprising a lever system with a counter balancing water tank and a digital scale to accurately measure the water loss to steam is shown in FIG. 41.

These WBC tests also featured cylindrical cells, each incorporating an internal mass of liquid gallium which served as a molten metal reservoir with a corresponding thermal sink. The molten gallium also acted as an electrode in the formation and operation of the very-low voltage, high-current hydrino-reaction-driven plasma while a tungsten electrode acted as the opposing electrode when electrical contact was made between the electrodes by electromagnetic pump injection of the molten metal from the reservoir to the W electrode. The plasma formation depended on the injection of hydrogen gas with about 8% oxygen gas and the application of high current at low voltage using a DC power source. The excess powers in the range of 273 kW to 342 kW with gains in the range of 3.9 to 4.7 times the power to maintain the hydrogen plasma reactions are given in the Tables 1-5. There was no chemical change observed in cell components as determined by energy dispersive X-ray spectroscopy (EDS) performed on the gallium following the reaction. The power from the combustion of the H₂/8% O₂ fuel and HOH catalyst source was limited by the trace oxygen and was negligible. The input power from the EM pump power was also negligible.

TABLE 1
Dr. Mark Nansteel validated 273 kW of power produced
by a hydrino plasma reaction maintained in a SunCell ® using
molten metal bath calorimetry.

| | Input | Output | Input | Output | | Net Excess |
|---|---|---|---|---|---|---|
| Duration | Energy | Energy | Power | Power | Power | Power |
| (s) | (kJ) | (kJ) | (kW) | (kW) | Gain | (kW) |
| 1.27 | 212.9 | 485.8 | 167.6 | 382.5 | 2.28 | 273 |

TABLE 2
Dr. Randy Booker and Dr. Stephen Tse validated 200 kW
of power produced by a hydrino plasma reaction maintained
in a SunCell ® using molten metal bath calorimetry.

| | Input | Output | Input | Output | | Net Excess |
|---|---|---|---|---|---|---|
| Duration | Energy | Energy | Power | Power | Power | Power |
| (s) | (kJ) | (kJ) | (kW) | (kW) | Gain | (kW) |
| 2.917 | 422.1 | 1058.1 | 144.7 | 362.8 | 2.51 | 218.1 |
| 5.055 | 554.7 | 1548.1 | 109.7 | 306.25 | 2.79 | 196.5 |

TABLE 3
Dr. Randy Booker validated 296 kW of power produced
by a hydrino plasma reaction maintained in a SunCell ® using
water bath calorimetry.

| | Input | Output | Input | Output | | Net Excess |
|---|---|---|---|---|---|---|
| Duration | Energy | Energy | Power | Power | Power | Power |
| (s) | (kJ) | (kJ) | (kW) | (kW) | Gain | (kW) |
| 2.115 | 193 | 818.4 | 91.2 | 386.9 | 4.24 | 296 |

TABLE 4
Dr. Stephen Tse validated up to 342 kW of power
produced by a hydrino plasma reaction maintained
in a SunCell ® using water bath calorimetry.

| | Input | Output | Input | Output | | Net Excess |
|---|---|---|---|---|---|---|
| Duration | Energy | Energy | Power | Power | Power | Power |
| (s) | (kJ) | (kJ) | (kW) | (kW) | Gain | (kW) |
| 2.115 | 192.95 | 915.35 | 91.2 | 432.8 | 4.74 | 341.6 |

TABLE 5
Dr. Mark Nansteel validated up to 273 kW of power produced
by a hydrino plasma reaction maintained in an advanced
tube-type SunCell ® using water bath calorimetry.
The power density was a remarkable 5 MW/liter.

| | Input | Output | Input | Output | | Net Excess |
|---|---|---|---|---|---|---|
| Duration | Energy | Energy | Power | Power | Power | Power |
| (s) | (kJ) | (kJ) | (kW) | (kW) | Gain | (kW) |
| 274.9 | 274.9 | 1080.2 | 93.2 | 366.2 | 3.93 | 273.0 |

The thermal tests were further performed on cells immersed in the water bath using the water weight lost to steam production over a test duration to quantify the power balance. Each cell comprised a cylindrical 4130 Cr—Mo steel reaction chamber measuring 20 cm ID, 14.3 cm in height, and 1.25 mm thick with cylindrical reservoir attached to the base having dimensions of 5.4 cm height and 10.2 cm ID that contained 6 kg of gallium. The continuous steam power of commercial scale, quality, and power density that developed was observed to be controllable by changing temperature and glow discharge dissociation recombination of the H₂ and trace O₂ reactants flowed into the cell. Specially, three variations of the basic cell design allowed for testing of these operational parameters. The cell wall was coated with a ceramic coating to prevent gallium alloy formation, and the cell was operated at about 200° C. Next, the reaction cell chamber was modified by the addition of a concentric three-layer liner comprising, from the cell wall to the plasma, (i) an outer 1.27 cm thick, full-length carbon cylinder, (ii) a 1 mm thick, full length Nb cylinder, and (ii) 4 mm thick, 10.2 mm high W plates arranged in a hexagon. The plates completely covered the region of intense plasma between the W molten metal injector electrode and the W counter electrode. The liner served as thermal insulation to increase the gallium temperature to over 400° C. and also protected the wall from the observed more intense plasma.

The cell comprising the liner was further modified with the addition of a glow discharge cell to dissociate H₂ gas to atomic H and also to form nascent HOH. The kinetically favorable high temperature reaction condition observed in the performance of the molten metal cells occurred because these cells were absent water cooling. Since 1 eV temperature corresponds to 11,600 K gas temperature, the equivalent of very high reaction mixture temperature was achieved under water cooling conditions. The glow discharge cell comprised a 3.8 cm diameter stainless steel tube of 10.2 cm length that was bolted at its base to the top of the reaction cell chamber by Conflat flanges. The positive glow discharge electrode was a stainless-steel rod powered by a high-voltage feed through on top of the glow discharge cell, and the body was grounded to serve as the counter electrode. A reaction gas mixture of 3000 sccm H₂ and 1 sccm O₂ was flowed through the top of the discharge cell and out the bottom into the reaction cell chamber.

The power developed due to the hydrino reaction doubled from an average of 26 kW to 55.5 kW with an increase in operating temperature from ˜200° C. to over 400° C. The power was further boosted by the operation of the glow discharge cell to activate the gas reactants wherein the hydrino power was observed to about double again to 93 kW. The results are given in Table 6. The combination of elevated temperature and glow discharge activation have a dramatic effect of the excess power. The results match expectations for a catalytic chemical reaction between H and HOH catalyst based on hydrino theory.

TABLE 6
Dr. Mark Nansteel validated 93 kW of power produced by a plasma reaction
maintained in a SunCell ® using mass balance in the production
of steam. The hydrino reaction was shown to be dependent on operating
temperature and activation of the gas reactants by a glow discharge plasma.

| | Gallium | | Input | Output | Input | Output | | Net Excess |
|---|---|---|---|---|---|---|---|---|
| | Temperature | Duration | Energy | Energy | power | Power | Power | Power |
| Discharge | (° C.) | (s) | (kJ) | (kJ) | (kW) | (kW) | Gain | (kW) |
| Yes | 196 | 302 | 10,346 | 16,480 | 34.26 | 54.57 | 1.59 | 20.3 |
| Yes | 177 | 296 | 9341 | 18,708 | 31.56 | 63.20 | 2.00 | 31.7 |
| No | 458 | 167 | 6951 | 16,264 | 41.62 | 97.39 | 2.34 | 55.8 |
| Yes | 425 | 200 | 7800 | 26,392 | 39.00 | 131.96 | 3.38 | 93.0 |

### CONCLUSIONS

Hydrino and subsequently molecular hydrino H₂ (1/4) was formed by catalytic reaction of atomic hydrogen with the resonant energy acceptor of 3×27.2 eV, nascent H₂O, wherein the reaction rate was greatly increased by applying an arc current to recombine ions and electrons formed by the energy transfer to HOH that is consequently ionized. H₂(1/4) bound to metal oxides and absorbed in metallic and ionic lattices by van der Waals forces was produced by (i) high voltage electrical detonation Fe wires in an atmosphere comprising water vapor, (ii) low voltage, high current electrical detonation of hydrated silver shots, (iii) ball milling or heating hydrated alkali halide-hydroxide mixtures, and (iv) maintaining a plasma reaction of H and HOH in a so-called SunCell® comprising a molten gallium injector that electrically shorts two plasma electrodes with the molten gallium to maintain an arc current plasma state. Excess power at the 340 kW level was measured by water and molten metal bath calorimetry. Samples predicted to comprise molecular hydrino H₂(1/4) product were analyzed by multiple analytical methods with results that follow.

H₂(1/4) comprises an unpaired electron which enables the electronic structure of this unique hydrogen molecular state to be determined by electron paramagnetic resonance (EPR) spectroscopy. Specially, the H₂(1/4) EPR spectrum comprises a principal peak with a g-factor of 2.0046386 that is split into a series of pairs of peaks with members separated by spin-orbital coupling energies that are a function of the corresponding electron spin-orbital coupling quantum numbers. The unpaired electron magnetic moment induces a diamagnetic moment in the paired electron of the H₂(1/4) molecular orbital based on the diamagnetic susceptibility of H₂(1/4). The corresponding magnetic moments of the intrinsic paired-unpaired current interactions and those due to relative rotational motion about the internuclear axis give rise to the spin-orbital coupling energies. The EPR spectral results confirmed the spin-orbital coupling between the spin magnetic moment of the unpaired electron and an orbital diamagnetic moment induced in the paired electron by the unpaired electron that shifted the flip energy of the spin magnetic moment. Each spin-orbital splitting peak was further sub-split into a series of equally spaced peaks that matched integer fluxon energies that are a function of the electron fluxon quantum number corresponding to the number of angular momentum components involved in the transition. The evenly spaced series of sub-splitting peaks was assigned to flux linkage in units of the magnetic flux quantum h/2e during the coupling between the paired and unpaired magnetic moments while a spin flip transition occurred. Additionally, the spin-orbital splitting increased with spin-orbital coupling quantum number on the downfield side of the series of pairs of peaks due to magnetic energies that increased with accumulated magnetic flux linkage by the molecular orbital. For an EPR frequency of 9.820295 GHz, the downfield peak positions B_{S/Ocombined}^{downfield} due to the combined shifts due to the magnetic energy and the spin-orbital coupling energy are

$${B}_{S / Ocombined}^{downfield} = ( 0.35001 - m 3.99427 \times {10}^{- 4} - ( 0.5 ) \frac{{( 2 π m 3 \text{.99427} \times {10}^{- 4} )}^{2}}{0.1750} ) T .$$

The upfield peak positions B_{S/O}^{upfield} with quantized spin-orbital splitting energies E_{S/O} and electron spin-orbital coupling quantum numbers m=0.5, 1, 2, 3, 5 . . . are

$${B}_{S / O}^{upfield} = 0.35001 ( 1 + m [ \frac{7.426 \times {10}^{27} J}{h 9.820295 GHz} ] ) T = ( 0.35001 + m 3.99427 \times {10}^{- 4} ) T .$$

The separations ΔB_{Φ} of the integer series of peaks at each spin-orbital peak position are

$$Δ {B}_{Φ}^{downfield} = ( 0.35001 - m 3 \text{.99427} \times {10}^{- 4} - ( 0.5 ) \frac{{( 2 π m3 \text{.99427} \times {10}^{- 4} )}^{2}}{0.175} ) [ \frac{{m}_{Φ} 5 \text{.7830} \times {10}^{- 28} J}{h 9.820 \; 295 GHz} ] \times {10}^{4} G \\ and Δ {B}_{Φ}^{upfield} = ( 0.35001 + m 3.99427 \times {10}^{- 4} ) [ \frac{{m}_{Φ} 5 \text{.7830} \times {10}^{- 28} J}{h 9.820295 GHz} ] \times {10}^{4} G$$

for electron fluxon quantum numbers m_{Φ}=1, 2,3. These EPR results were first observed at TU Delft by Dr. Hagen.

The pattern of integer-spaced peaks of the EPR spectrum of H₂(1/4) is very similar to the periodic pattern observed in the high-resolution visible spectrum of the hydrino hydride ion. The hydrino hydride ion comprising a paired and unpaired electron in a common atomic orbital also demonstrated the phenomena of flux linkage in quantized units of h/2e. Moreover, the same phenomena were observed when the rotational energy levels of H₂(1/4) were excited by laser irradiation during Raman spectroscopy and by collisions of high energy electrons form an electron beam with H₂(1/4). It is extraordinary that the EPR, Raman, and electron-beam excitation spectra give the same information about the structure of molecular hydrino in energy ranges that differ by reciprocal of the H₂(1/4) diamagnetic susceptibility coefficient: 1/7×10⁻⁷=1.4×10⁶, wherein the induced diamagnetic orbital magnetic moment active during EPR was replaced by the orbital molecular rotational magnetic moment active during Raman and electron-beam excitation of rotational transitions.

Josephson junctions such as ones of superconducting quantum interference devices (SQUIDs) link magnetic flux in quantized units of the magnetic flux quantum or fluxon

$$\frac{h}{2 e} .$$

The same behavior was predicted and observed for the linkage of magnetic flux by hydrino hydride ion and molecular hydrino controlled by applying specific frequencies of electromagnetic radiation over the range of microwave to ultraviolet. The hydrino species such as H₂(1/4) is enabling of a computer logic gate or memory element that operates at even elevated temperature versus cryogenic ones and may be a single molecule 4³ or 64 times smaller than molecular hydrogen. Molecular hydrino comprising a magnetic hydrogen molecule enables many other applications in other fields as well. A gaseous contrast agent in magnetic resonance imaging (MRI) is but one example.

Specifically, the exemplary Raman transition rotation is about a semiminor axis perpendicular to the internuclear axis. The intrinsic electron spin angular momentum aligns either parallel or perpendicular to the corresponding molecular rotational angular momentum along the molecular rotational axis, and a concerted rotation of the spin current occurs during the molecular rotational transition. The interaction of the corresponding magnetic moments of the intrinsic spin and the molecular rotation give rise to the spin-orbital coupling energies that are a function of the spin-orbital quantum number. The Raman spectral results confirmed the spin-orbital coupling between the spin magnetic moment of the unpaired electron and the orbital magnetic moment due to molecular rotation. The energies of the rotational transitions were shifted by these spin-orbital coupling energies as a function of the corresponding electron spin-orbital coupling quantum numbers. Molecular rotational peaks shifted by spin-orbital energies are further shifted by fluxon linkage energies with each energy corresponding to its electron fluxon quantum number dependent on the number of angular momentum components involved in the rotational transition. The observed sub-splitting or shifting of Raman spectral peaks was assigned to flux linkage in units of the magnetic flux quantum h/2e during the spin-orbital coupling between spin and molecular rotational magnetic moments while the rotational transition occurred. All of the novel lines matched those of (i) either the pure H₂(1/4) J=0 to J′=3 rotational transition with spin-orbital coupling and fluxon coupling:

E_{Raman}=ΔE_{J=0→J′}+E_{S/O,rot}+E_{Φ,rot}=11701 cm⁻¹+m528 cm⁻¹+m_{Φ}, 31 cm⁻¹, (ii) the concerted transitions comprising the J=0 to J′=2,3 rotational transitions with the J=0 to J=1 spin rotational transition:

E_{Raman}=ΔE_{J=0→J′}+E_{S/O,rot}+E_{Φ,rot}=7801 cm⁻¹(13,652 cm⁻¹)+m528 cm⁻¹+m_{Φ3/2}46 cm⁻¹, or (iii) the double transition for final rotational quantum numbers J′ₚ=2 and J′_{c}=1:

$${E}_{Raman} = Δ {E}_{J = 0 \to {J}_{P}^{′} = 2} + Δ {E}_{J = 0 \to {J}_{c}^{′} = 1} + {E}_{S / O , rot} + {E}_{Φ , rot} = 9 \; 751 {cm}^{- 1} + m 528 {cm}^{- 1} + {m}_{Φ} 31 {cm}^{- 1} + {m}_{Φ 3 / 2} 46 {cm}^{- 1} .$$

Corresponding spin-orbital coupling and fluxon coupling were also observed with the pure, concerted, and double transitions.

Predicted H₂(1/4) UV Raman peaks recorded on the hydrino complex GaOOH:H₂(1/4):H₂O were observed in the 12,250-15,000 cm⁻¹ region wherein the complexed water suppressed intense fluorescence of the 325 nm laser. H₂(1/4) UV Raman peaks were also observed from Ni foils exposed to the hydrino reaction plasma. All of the novel lines matched the concerted pure rotational transition ΔJ=3 and ΔJ=1 spin transition with spin-orbital coupling and fluxon linkage splittings: E_{Raman}=ΔE_{J=0→3}+ΔE_{J=0→1}+E_{S/O,rot}+E_{Φ,rot}=13,652 cm⁻¹+m528 cm⁻¹+m_{Φ}31 cm⁻¹. Nineteen of the observed Raman lines match those of unassignable astronomical lines associated with the interstellar medium called diffuse interstellar bands (DIBs). The assignment of all of the 380 DIBs listed by Hobbs to H₂(1/4) rotational transitions with spin-orbital splitting and fluxon sub-splitting match those reported by Hobbs [L. M. Hobbs, D. G. York, T. P. Snow, T. Oka, J. A. Thorburn, M. Bishof, S. D. Friedman, B. J. McCall, B. Rachford, P. Sonnentrucker, D. E. Welty, A Catalog of Diffuse Interstellar Bands in the Spectrum of HD 204827″, Astrophysical Journal, Vol. 680, No. 2, (2008), pp. 1256-1270, http://dibdata.org/HD204827.pdf, https://iopscience.iop.org/article/10.1086/587930/pdf, each of which are hereby incorporated by reference in their entirety]. Molecular hydrino rotational transitional energies cover a broad range of frequencies from infrared to ultraviolet which enables molecular lasers spanning the corresponding wavelengths.

The rotational energies are dependent on the reduced mass which changed by a factor of ¾ upon substitution of one deuteron for one proton of molecular hydrino H₂(1/4) to form HD(1/4). The rotational energies of the HD(1/4) Raman spectrum shifted relative to that of H₂(1/4) as predicted. All of the novel lines matched those of (i) either the pure HD(1/4) J=0 to J′=3,4 rotational transition with spin-orbital coupling and fluxon coupling: E_{Raman}=ΔE_{J=0→J′}+E_{S/O,rot}+E_{Φ,rot}=8776 cm⁻¹(14,627 cm⁻¹)+m528 cm⁻¹+m_{Φ}31 cm⁻¹, (ii) the concerted transitions comprising the J=0 to J′=3 rotational transitions with the J=0 to J=1 spin rotational transition:

$${E}_{Raman} = Δ {E}_{J = 0 \to {J}^{′}} + {E}_{S / O , rot} + {E}_{Φ , rot} = 10 , 239 {cm}^{- 1} + m 528 {cm}^{- 1} + {m}_{Φ3 / 2} 46 {cm}^{- 1} ,$$

or (iii) the double transition for final rotational quantum numbers J′ₚ=3; J′_{c}=1:

$$\begin{matrix}{E}_{Raman} = Δ {E}_{J = 0 \to {J}_{P}^{′} = 2} + Δ {E}_{J = 0 \to {J}_{c}^{′} = 1} + {E}_{S / O , rot} + {E}_{Φ , rot} \\ = 11 , 701 {cm}^{- 1} + m 528 {cm}^{- 1} + \\ {m}_{Φ} 31 {cm}^{- 1} + {m}_{Φ 3 / 2} 46 {cm}^{- 1} .\end{matrix}$$

Corresponding spin-orbital coupling and fluxon coupling were also observed with both the pure and concerted transition.

Akin to the case of molecular hydrino H₂(1/4) trapped in a GaOOH lattice that serves as cages for essentially free gas EPR spectra, H₂(1/4) in a noble gas mixture provides an interaction-free environment to observe ro-vibrational spectra. H₂(1/4)-noble gas mixtures that were irradiated with high energy electrons of an electron beam showed equal, 0.25 eV spaced line emission in the ultraviolet (150-180 nm) region with a cutoff at 8.25 eV that matched the H₂(1/4) v=1 to v=0 vibrational transition with a series of rotational transitions corresponding to the H₂(1/4) P-branch. The spectral fit was a good match to 4²0.515 eV−4²(J+1)0.01509; J=0, 1, 2, 3 . . . wherein 0.515 eV and 0.01509 eV are the vibrational and rotational energies of ordinary molecular hydrogen, respectively. In addition, small satellite lines were observed that matched the rotational spin-orbital splitting energies that were also observed by Raman spectroscopy. The rotational spin-orbital splitting energy separations matched m528 cm⁻¹ m=1,1.5 wherein 1.5 involves the m=0.5 and m=1 splittings.

The spectral emission of the H₂(1/4) P-branch rotational transitions with thev=1 to v=0 vibrational transition was also observed by electron beam excitation of H₂(1/4) trapped in a KCl crystalline matrix. The rotational peaks matched those of a free rotor, whereas the vibrational energy was shifted by the increase in the effective mass due to interaction of the vibration of H₂(1/4) with the KCl matrix. The spectral fit was a good match to 5.8 eV−4²(J+1)0.01509; J=0, 1, 2,3 . . . comprising peaks spaced at 0.25 eV. The relative magnitude of the H₂(1/4) vibrational energy shift matched the relative effect on the ro-vibrational spectrum caused by ordinary H₂ being trapped in KCl.

Using Raman spectroscopy with a high energy laser, a series of 1000 cm⁻¹ (0.1234 eV) equal-energy spaced Raman peaks were observed in the 8000 cm⁻¹ to 18,000 cm⁻¹ region wherein conversion of the Raman spectrum into the fluorescence or photoluminescence spectrum revealed a match as the second order ro-vibrational spectrum of H₂(1/4) corresponding to the e-beam excitation emission spectrum of H₂(1/4) in a KCl matrix given by 5.8 eV−4² (J+1)0.01509; J=0, 1, 2,3 . . . and comprising the matrix shifted v=1 to v=0 vibrational transition with 0.25 eV energy-spaced rotational transition peaks.

Infrared transitions of H₂(1/4) are forbidden because of its symmetry that lacks an electric dipole moment. However, it was observed that application of a magnetic field in addition to an intrinsic magnetic field permitted molecular rotational infrared excitation by coupling to the aligned magnetic dipole of H₂(1/4). Coupling with spin-orbital transitions also allowed the transitions.

The allowed double ionization of H₂(1/4) by the Compton effect corresponding to the total energy of 496 eV was observed by X-ray photoelectron spectroscopy (XPS) on samples comprising H₂(1/4) due the reaction of H with HOH with incorporation in crystalline inorganic and metallic lattices.

H₂(1/4) was further observed by gas chromatography that showed a gas from hydrino producing reactions with a faster migration rate than that of any known gas considering that hydrogen and helium have the fastest prior known migration rates and corresponding shortest retention times. Molecular hydrino may serve as a cryogen, a gaseous heat transfer agent, and an agent for buoyancy.

Extreme ultraviolet (EUV) spectroscopy recorded extreme ultraviolet continuum radiation with a 10.1 nm cutoff corresponding to the hydrino reaction transition H to H(1/4) catalyzed by HOH catalyst.

MAS NMR of molecular hydrino trapped in protic matrix represents a means to exploit the unique magnetic characteristic of molecular hydrino for its identification via its interaction with the matrix. A unique consideration regarding the NMR spectrum is the possible molecular hydrino quantum states. Proton magic-angle spinning nuclear magnetic resonance spectroscopy (¹H MAS NMR) recorded an upfield matrix-water peak in the −4 ppm to −5 ppm region, the signature of the unpaired electron of molecular hydrino and the resulting magnetic moment.

Molecular hydrino may give rise to bulk magnetism such as paramagnetism, superparamagnetism and even ferromagnetism when the magnetic moments of a plurality of hydrino molecules interact cooperatively. Superparamagnetism was observed using a vibrating sample magnetometer to measure the magnetic susceptibility of compounds comprising molecular hydrino.

Complexing of H₂(1/4) gas to inorganic compounds comprising oxyanions such a K₂CO₃ and KOH was confirmed by the unique observation of M+2 multimer units such as K⁺[H₂: K₂CO₃]ₙ and K⁺[H₂: KOH]ₙ wherein n is an integer by exposing K₂CO₃ and KOH to a molecular hydrino gas source and running time of flight secondary ion mass spectroscopy (ToF-SIMS) and electrospray time of flight secondary ion mass spectroscopy (ESI-ToF), and the hydrogen content was identified as H₂(1/4) by other analytical techniques. In addition to inorganic polymers such as K⁺[H₂: K₂CO₃]ₙ, the ToF-SIMS spectra showed an intense H⁻ peak due to the stability of hydrino hydride ion.

HPLC showed inorganic hydrino compounds behaving like organic molecules as evidenced by a chromatographic peak on an organic molecular matrix column that fragmented into inorganic ions.

Signatures of the high energetics and power release of the hydrino reaction were evidenced by (i) extraordinary Doppler line broadening of the H Balmer a line of over 100 eV in plasmas that comprised H atoms and HOH or H catalyst such as argon-H₂, H₂, and H₂O vapor plasmas, (ii) H excited state line inversion, (iii) anomalous H plasma afterglow duration, (iv) shockwave propagation velocity and the corresponding pressure equivalent to about 10 times more moles of gunpowder with only about 1% of the power coupling to the shockwave, (v) optical power of up to 20 MW, and (vi) calorimetry of hydrino solid fuels, hydrino electrochemical cells, and the SunCell® wherein the latter was validated at a power level of 340,000 W. The H inversion, optical, and shock effects of the hydrino reaction have practical applications of an atomic hydrogen laser, light sources of high power in the EUV and other spectral regions, and novel more powerful and non-sensitive energetic materials, respectively. The power balance was measured by the change in the thermal inventory of a water bath. Following a power run of a duration limited by nearly reaching the melting point of SunCell® components, the heat of the SunCell® was transferred to a water bath, and the increase in thermal inventory of the water bath was quantified by recording the bath temperature rise and the water lost to steam by measuring the water weight loss. The SunCell® was fitted to continuously operate with water bath cooling, and the continuous excess power due to the hydrino reaction was validated at a level of 100,000 W.

These analytical tests confirm the existence of hydrino, a smaller more stable form of hydrogen formed by the release of power at power densities exceeding that of other known power sources. Brilliant Light Power is developing the proprietary SunCell® to harness this green power source, initially for thermal applications, and then electrical. The energetic plasma formed by the hydrino reaction enables novel direct power conversion technologies in addition to conventional Rankine, Brayton, and Stirling cycles. A novel magnetohydrodynamic cycle has potential for electrical power generation at 23 MW/liter power densities at greater than 90% efficiency [R. Mills, M. W. Nansteel, “Oxygen and Silver Nanoparticle Aerosol Magnetohydrodynamic Power Cycle”, Journal of Aeronautics & Aerospace Engineering, Vol. 8, Iss. 2, No 216, whichi is hereby incorporated by reference in its entirety].

As various changes can be made in the above-described subject matter without departing from the scope and spirit of the present disclosure, it is intended that all subject matter contained in the above description, or defined in the appended claims, be interpreted as descriptive and illustrative of the present disclosure. Many modifications and variations of the present disclosure are possible in light of the above teachings. Accordingly, the present description is intended to embrace all such alternatives, modifications and variances which fall within the scope of the appended claims.

All documents cited or referenced herein and all documents cited or referenced in the herein cited documents, together with any manufacturer's instructions, descriptions, product specifications, and product sheets for any products mentioned herein or in any document incorporated by reference herein, are hereby incorporated by reference, and may be employed in the practice of the disclosure.

1. A power generation system comprising:
a) at least one vessel capable of a maintaining a pressure below atmospheric comprising a reaction chamber;
b) two electrodes configured to allow a molten metal flow therebetween to complete a circuit;
c) a power source connected to said two electrodes to apply a current therebetween when said circuit is closed;
d) a plasma generation cell to induce the formation of a first plasma from a gas; wherein effluence of the plasma generation cell is directed towards the circuit;
wherein when current is applied across the circuit, the effluence of the plasma generation cell undergoes a reaction to producing a second plasma and reaction products; and
e) a power adapter configured to convert and/or transfer energy from the second plasma into mechanical, thermal, and/or electrical energy.

2. The power generation system according to claim 1, wherein said gas in the plasma generation cell comprises a mixture of hydrogen (H₂) and oxygen (O₂).

3. (canceled)

4. The power generation system according to claim 1, wherein said molten metal is Gallium.

5. The power generation system according to claim 1, wherein said reaction products have at least one spectroscopic signature as described herein.

6-7. (canceled)

8. The power generation system according to claim 1, wherein said second plasma is formed in a reaction cell, wherein the walls reaction cell chamber comprise a first and a second section,
the first section composed of stainless steel;
the second section comprising a refractory metal different than the metal in the first section;
wherein the union between the different metals is formed by a lamination material.

9. The power system of claim 1, comprising
a molten metal injector system comprising at least one reservoir that contains some of the molten metal, a molten metal pump system configured to deliver the molten metal in the reservoir and through an injector tube to provide a molten metal stream between the two electrodes, and at least one non-injector molten metal reservoir for receiving the molten metal stream.

10-13. (canceled)

14. The power system of claim 1, wherein the gas mixture supplied to the plasma generation cell to produce the first plasma comprises a non-stoichiometric H₂/O₂ mixture that is flowed through the plasma cell to create a reaction mixture capable of undergoing the reaction with sufficient exothermicity to produce the second plasma.

15. The power system of claim 14 wherein the non-stoichiometric H₂/O₂ mixture passes through a glow discharge to produce an effluence of atomic hydrogen and nascent H₂O;
the glow discharge effluence is directed into a reaction chamber where the ignition current is supplied between two electrodes, and
upon interaction of the effluence with the biased molten metal, the reaction between the nascent water and the atomic hydrogen is induced, for example, upon the formation of arc current.

16-21. (canceled)

22. The power system of claim 1 wherein an inert gas (e.g., argon) is injected into the vessel.

23. The power system of claim 1 further comprising a water micro-injector configured to inject water into the vessel.

24. The power system of claim 9 wherein the molten metal injection system further comprises the two electrodes in the molten metal reservoir and the non-injection molten metal reservoir; and the ignition system comprises a source of electrical power or ignition current to supply opposite voltages to the injector and non-injector reservoir electrodes; wherein the source of electrical power supplies current and power flow through the stream of molten metal to cause the reaction of the reactants to form a plasma inside of the vessel.

25-28. (canceled)

29. The power system of claim 1 wherein the injector reservoir comprises an electrode of the two electrodes in contact with the molten metal therein, and the non-injector reservoir comprises the other electrode of the two electrodes that makes contact with the molten metal provided by the injector system.

30-33. (canceled)

34. The power system of claim 1 further comprising a condenser to condense molten metal vapor and metal oxide particles and vapor and returns them to the reaction cell chamber.

35. The power system of claim 34 further comprising a vacuum line wherein the condenser comprises a section of the vacuum line from the reaction cell chamber to the vacuum pump that is vertical relative to the reaction cell chamber and comprises an inert, high-surface area filler material that condenses the molten metal vapor and metal oxide particles and vapor and returns them to the reaction cell chamber while permitting the vacuum pump to maintain a vacuum pressure in the reaction cell chamber.

36. The power system of claim 1 wherein the vessel comprises a light transparent photovoltaic (PV) window to transmit light from the inside of the vessel to a photovoltaic converter and at least one of a vessel geometry and at least one baffle comprising a spinning window.

37-39. (canceled)

40. The power system of claim 1 further comprising a heat exchanger comprising one of a (i) plate, (ii) block in shell, (iii) SiC annular groove, (iv) SiC polyblock, and (v) shell and tube heat exchanger.

41-45. (canceled)

46. An electrode system comprising:
a) a first electrode and a second electrode;
b) a stream of molten metal in electrical contact with said first and second electrodes;
c) a circulation system comprising a pump to draw said molten metal from a reservoir and convey it through a conduit to produce said stream of molten metal exiting said conduit;
d) a source of electrical power configured to provide an electrical potential difference between said first and second electrodes;
wherein said stream of molten metal is in simultaneous contact with said first and second electrodes to create an electrical current between said electrodes and complete a circuit.

47-50. (canceled)

51. A system for generating a plasma comprising:
a) the electrode system of claim 46;
b) a power source connected to said first and second electrodes to apply a current therebetween when said circuit is closed;
c) a recombiner cell to induce the formation of nascent water and atomic hydrogen from a gas; wherein effluence of the recombiner is directed towards the circuit;
wherein when current is applied across the circuit, the effluence of the recombiner cell undergoes a reaction to produce a plasma.

52-65. (canceled)

66. A method, comprising:
a) electrically biasing a molten metal;
b) directing the effluence of a plasma generation cell to interact with the biased molten metal and induce the formation of a plasma.

67-78. (canceled)
